(19) United States
(12) Patent Application Publication
(10) Pub. No.: US 2023/0268095 A1
(43) Pub. Date: Aug. 24, 2023

(54) IMPACT AMELIORATION SYSTEM FOR NUCLEAR FUEL STORAGE

(71) Applicant: Holtec International, Camden, NJ (US)

(72) Inventors: Krishna P. SINGH, Jupiter, FL (US); John D. GRIFFITHS, Deptford, NJ (US); Frederick R. BIDRAWN, Haddonfield, NJ (US)

(21) Appl. No.: 18/140,795

(22) Filed: Apr. 28, 2023

Related U.S. Application Data
(63) Continuation-in-part of application No. 17/132,102, filed on Dec. 23, 2020.
Application No. 17/132,102 is a continuation-in-part of application No. 17/165,224, filed on Feb. 2, 2021.
Application No. 17/165,224 is a continuation-in-part of application No. 17/831,809, filed on Jun. 3, 2022.
Application No. 17/831,809 is a continuation of application No. 17/181,439, filed on Feb. 22, 2021, now Pat. No. 11,373,775.
Application No. 17/181,439 is a continuation-in-part of application No. 17/868,486, filed on Jul. 19, 2022.
Application No. 17/868,486 is a continuation of application No. 17/220,560, filed on Apr. 1, 2021, now Pat. No. 11,443,862.
Application No. 17/220,560 is a continuation-in-part of application No. 17/357,068, filed on Jun. 24, 2021.
Application No. 17/357,068 is a continuation-in-part of application No. 17/527,476, filed on Nov. 16, 2021.
(60) Provisional application No. 62/954,083, filed on Dec. 27, 2019.
(60) Provisional application No. 62/969,183, filed on Feb. 3, 2020.
(60) Provisional application No. 62/979,640, filed on Feb. 21, 2020.
(60) Provisional application No. 63/003,431, filed on Apr. 1, 2020.
(60) Provisional application No. 63/043,812, filed on Jun. 25, 2020.
(60) Provisional application No. 63/123,706, filed on Dec. 10, 2020.
(60) Provisional application No. 63/118,350, filed on Nov. 25, 2020.

(51) Int. Cl. G21F 5/12

(52) U.S. Cl. CPC G21F 5/12

(57) ABSTRACT

An impact amelioration system for nuclear fuel storage components in one embodiment includes a fuel storage canister and outer cask receiving the canister. The canister is configured for storing spent nuclear fuel or other high level radioactive waste. A plurality of impact limiter assemblies are disposed on the bottom closure plate of the cask at the canister interface. Each impact limiter assembly comprises an impact limiter plug frictionally engaged with a corresponding plug hole formed in the cask closure plate. The canister rests on tops of the plugs, which may protrude upwards beyond the top surface of the bottom closure lid. The plugs and holes may mating tapered and frictionally engaged surfaces. During a cask drop event, the canister drives the plugs deeper into the plug holes and elastoplastically deform to dissipate the kinetic impact energy and protect the structural integrity of the canister and its contents.

### CROSS-REFERENCE TO RELATED APPLICATIONS

This application is a continuation-in-part of U.S. patent application Ser. No. 17/132,102 filed Dec. 23, 2020, which claims the benefit of U.S. Provisional Patent Application No. 62/954,083 filed Dec. 27, 2019. The disclosures of each of which are incorporated by reference herein in their respective entireties, for all purposes.

This application is a continuation-in-part of U.S. patent application Ser. No. 17/165,224 filed Feb. 2, 2021, which claims the benefit of U.S. Provisional Patent Application No. 62/969,183 filed Feb. 3, 2020. The disclosures of each of which are incorporated by reference herein in their respective entireties, for all purposes.

This application is a continuation-in-part of U.S. patent application Ser. No. 17/831,809 filed Jun. 3, 2022, which is a continuation of U.S. patent application Ser. No. 17/181,439 filed Feb. 22, 2021, now U.S. Pat. No. 11,373,775 issued on Jun. 28, 2022, which claims the benefit of U.S. Provisional Patent Application No. 62/979,640 filed Feb. 21, 2020. The disclosures of each of which are incorporated by reference herein in their respective entireties, for all purposes.

This application is a continuation-in-part of U.S. patent application Ser. No. 17/868,486 filed Jul. 19, 2022, which is a continuation of U.S. patent application Ser. No. 17/220,560 filed Apr. 1, 2021, now U.S. Pat. No. 11,443,862 issued on Sep. 13, 2022, which claims the benefit of U.S. Provisional Patent Application No. 63/003,431 filed Apr. 1, 2020. The disclosures of each of which are incorporated by reference herein in their respective entireties, for all purposes.

This application is a continuation-in-part of U.S. patent application Ser. No. 17/357,068 filed Jun. 24, 2021, which claims the benefit of U.S. Provisional Patent Application No. 63/043,812 filed Jun. 25, 2020. The disclosures of each of which are incorporated by reference herein in their respective entireties, for all purposes.

This application is a continuation-in-part of U.S. patent application Ser. No. 17/527,476 filed Nov. 16, 2021, which claims the benefit of U.S. Provisional Patent Application No. 63/123,706 filed Dec. 10, 2020, and U.S. Provisional Patent Application No. 63/118,350 filed Nov. 25, 2020. The disclosures of each of which are incorporated by reference herein in their respective entireties, for all purposes.

### BACKGROUND

The present invention relates generally to systems and vessels for storing high level radioactive waste such as used or spent nuclear fuel (SNF), and more particularly to an improved system which ameliorates the effects of a forceful impact on such nuclear fuel storage vessels and concomitantly the SNF assemblies stored therein.

In the operation of nuclear reactors, the nuclear energy source is in the form of hollow Zircaloy tubes filled with enriched uranium, collectively arranged in multiple assemblages referred to as fuel assemblies. When the energy in the fuel assembly has been depleted to a certain predetermined level, the used or “spent” nuclear fuel (SNF) assemblies are removed from the nuclear reactor. The standard structure used to package used or spent fuel assemblies discharged from light water reactors for off-site shipment or on-site dry storage is known as the fuel basket. The fuel basket is essentially an assemblage of prismatic storage cells each of which is sized to store one fuel assembly that comprises a plurality of individual spent nuclear fuel rods. The fuel basket is arranged inside a cylindrical metallic fuel storage canister, which is often referred to as a multi-purpose canister (MPC) that forms the primary nuclear waste containment barrier. Such MPCs are available from Holtec International of Camden, N.J. The fuel assemblies are typically loaded into the canister while submerged in the spent fuel pool of the reactor containment structure to minimize radiation exposure to personnel.

The fuel canister loaded with SNF (or other high level radioactive waste) is then placed into an outer overpack or cask, which forms the secondary containment, for safe transport and storage of the multiple spent fuel assemblies. Casks are heavy radiation shielded containers used to store and/or transfer the SNF canister from the spent fuel pool (“transfer cask”) in the nuclear reactor containment structure to a more remote staging area for interim term storage such as in the dry cask storage system of an on-site or off-site independent spent fuel storage installation (ISFSI) until a final repository for spent nuclear fuel is available from the federal government.

Drop events involving heavy loads such as nuclear waste fuel casks are among the more serious accidents in industry. In the nuclear industry, an accidental drop of a cask onto a stationary reinforced concrete surface is a typical postulated scenario involving a hard and heavy object slamming onto a highly inflexible surface. Classical dynamics teaches us that the deceleration g-load under such an impact scenario is roughly proportional to the square root of the stiffness of the impacting interface. The more rigid the impactor and the stationary target, the higher is the g-load. Reducing the g-load is essential to minimize the physical damage to the colliding bodies; which is critically important if one of the two bodies contains a hazardous radioactive material such as spent nuclear fuel.

Accordingly, there remains a need for improvements in controlling and reducing the g-load associated with impacts occurring with the foregoing nuclear waste storage systems.

The present invention relates generally to systems and vessels for storing high level radioactive nuclear waste such as used or spent nuclear fuel (SNF), and more particularly to an improved unventilated storage cask system for storing nuclear waste.

In the operation of nuclear reactors, the nuclear energy source is in the form of hollow Zircaloy tubes filled with enriched uranium, collectively arranged in multiple assemblages referred to as fuel assemblies. When the energy in the fuel assembly has been depleted to a certain predetermined level, the used or “spent” nuclear fuel (SNF) assemblies are removed from the nuclear reactor. The standard structure used to package used or spent fuel assemblies discharged from light water reactors for off-site shipment or on-site dry storage is known as the fuel basket. The fuel basket is essentially an assemblage of prismatic storage cells each of which is sized to store one fuel assembly that comprises a plurality of individual spent nuclear fuel rods.

The fuel basket is arranged inside a cylindrical metallic nuclear waste fuel canister, which is often referred to as a multi-purpose canister (MPC). Such MPCs are available from Holtec International of Camden, N.J. The fuel assemblies are typically loaded into the canister while submerged in the spent fuel pool of the reactor containment structure to minimize radiation exposure to personnel.

An essential attribute of such a fuel storage MPC is that it is designed and manufactured to provide safe radiological confinement to its contents and satisfies the criterion of “leak tight” (against particulate and gaseous radiological matter) as defined in the USNRC regulatory guidance documents. Such a waste package, however, is not autonomously capable of providing protection against neutrons and gamma radiation emanating from its contents which would, if exposed to biological life would be deadly. Therefore, the MPC needs to be stored in a heavily radiation-shielded outer cask that permits as little radiation as possible to escape to the environment. The storage cask must also be able to transmit and dissipate the decay heat generated inside the MPC by the decaying fuel assemblies to the ambient environment. Effective heat rejection and effective reduction of radiation are thus the twin functions of the storage cask, also referred to in the industry as an “overpack” or “storage module.”

The storage cask used to store the loaded canister has historically been in the form of a ventilated cask wherein ambient ventilation air enters the cask near the bottom and exits near the top thereby convectively removing heat emitted by the canister. Ventilated cask designs are widely used for storing nuclear waste fuel canisters with aggregate heat loads as high as 50 kW. However, such ventilated cask suffer from one potential vulnerability in marine environments where the salt-laden ambient ventilation air can induce stress corrosion cracking (SCC) in the canister's austenitic stainless-steel confinement boundary. SCC is a well-documented problem encountered in the nuclear fuel storage industry. Ventilated overpacks also need to be surveilled regularly to ensure that their vent passages are not blocked which an diminish heat rejection from the cask.

Accordingly, there remains a need for an improved nuclear waste storage cask that provides the necessary heat dissipation and radiation blockage functions, but eliminates the risk of initiating stress corrosion cracking on the exterior surfaces of the waste fuel canister inside the cask.

The present invention relates generally to systems and vessels for transporting and storing high level radioactive nuclear waste materials, and more particularly to a box-type cask in one embodiment for transport and storage of radioactive nuclear waste materials.

The overpacks or casks used to store neutron activated metal and other radiated non-fissile high level radioactive waste, such as that resulting from operation nuclear power generation plants or other type facilities, is typically an open-top cylindrical structure with a bolted circular lid. Such a cask is inefficient to load all types of nuclear waste materials not limited to spent nuclear fuel into the cask. The radiation waste materials are often too large and/or may be irregular shaped for insertion through the narrow top access opening in such cylindrical casks which leads to the internal storage cavity. Further, the act of tightening the bolts once the cylindrical cask is packed with nuclear waste materials is a time consuming which exposes the workers to radiation dosage in proportion to the time needed to complete the tedious installation of the closure bolts.

Accordingly, there remains a need for an improved nuclear waste storage cask that can accommodate a wide variety of waste materials, and which can further be closed and sealed in an expedient manner to reduce radiation exposure of operating personnel handling the cask.

The present application provides a nuclear waste storage system comprising a radiation-shielded nuclear waste storage cask which overcomes the shortcomings of the foregoing cylindrical type storage casks described above for storing a wide variety of different nuclear waste materials. In one embodiment, a longitudinally elongated box-type cask is disclosed comprising an essentially rectangular body with rectilinear cross sectional internal storage cavity configured for holding nuclear waste material, and a matching rectangular closure lid. The elongated large top opening leading into the storage cavity extends for a majority of the longitudinal length of the cask. In contrast to the small circular opening at the top of cylindrical casks, the present rectangular opening allows large and irregular shaped radioactive metal pieces of waste material to be loaded inside the cask storage cavity in an efficient and expedient manner without undue handling by operating personnel, thereby reducing potential radiation dosage.

In one embodiment, the closure lid be coupled and sealed to the cask body to close the top opening through a quick connect-disconnect joint that does not utilize any threaded fasteners. Instead, a slider locking mechanism comprising mechanically interlocking protrusions provided on peripheral portions of each of the lid and correspondingly cask body around the cask top opening is employed. While the lid remains stationary on the cask body, the locking protrusions on the lid are slideably relative to the locking protrusions on the cask body between locked and unlocked positions or states. The locking protrusions may be arrayed and spaced apart perimetrically around the lid and cask body. The locking protrusions may be wedge-shaped in one embodiment to produce a wedging-action when mutually engaged which effectively locks the lid to the cask body and seals the nuclear waste contents inside the cask. A gasket at the lid to cask body interface is compressed by the wedging-action to form a gas-tight seal of the cask storage cavity which completes the containment barrier. There is no exchange of air between the ambient environment and the storage cavity in one embodiment.

The term “nuclear waste material” as used herein shall be broadly construed to mean any type or form of radioactive waste material which has been irradiated by a source of radiation. Such irradiation may occur in a nuclear power generation plant with nuclear reactor, or other types of facilities. As one non-limiting example, the radioactive nuclear waste materials may be associated with decommissioning or repair/maintenance of a nuclear facility, and may therefore include a wide variety of sizes and shapes of pieces of equipment (including parts of the reactor), structural components/members, parts, debris, scrap, or similar which have been irradiated and generate radiation.

In one aspect, a cask for containing radioactive materials comprises: a cask body comprising an opening forming a passageway into an internal storage cavity of the cask; a closure lid configured to be detachably coupled to the cask body to enclose the opening; and a locking mechanism comprising at least one first locking member and at least one second locking member, the first and second locking members slideable relative to one another to alter the locking mechanism between: (1) a first state in which the closure lid can be removed from the cask body; and (2) a second state in which the first and second locking members engage one another to prevent the closure lid from being removed from the cask body.

According to another aspect, a cask for containing radioactive materials comprises: a longitudinal axis; an axially elongated cask body defining a top opening forming an entrance to an internal storage cavity of non-cylindrical cross-sectional configuration, the cavity configured for holding radioactive waste materials; and a closure lid detachably coupled to the cask body at the top opening.

According to another aspect, a method for locking a radioactive waste storage cask comprises: positioning a closure lid on a cask body over an opening leading into an internal storage cavity; inserting a peripheral array of first locking protrusions on the lid between and through a peripheral array of second locking protrusions disposed on the cask body around the opening; slideably moving the first locking protrusions beneath the second locking protrusions; and frictionally engaging the first locking protrusions with the second locking protrusions; wherein the lid cannot be removed from the cask body.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

The present invention relates generally to systems and vessels for storing and transporting high level radioactive nuclear waste such as used or spent nuclear fuel (SNF), and more particularly to a wet cask storage system with overpressurization protection.

A typical module or cask employed to store and transport fissile radioactive waste such as SNF uses an inert gas such as helium to protect the elongated zirconia metal tubes (also referred to as tube cladding) of the fuel rods from oxidation. Such casks insert gas filled casks are referred to as a “dry cask.” Multiple fuel rods are bundled together in a support structure referred to as a fuel assembly which are well known in the art without undue elaboration here. The fuel assemblies are liftable structures typically having a rectangular cuboid shape for U.S. reactors which are configured for insertion into the reactor as self-supporting units.

A gas filled dry cask (“dry cask”) holding multiple such fuel assembly units, however, is not perfect from the standpoint of controlling the temperature of the heat-emitting nuclear waste fuel because the heat rejection rate from such a vessel is inhibited by the low thermal conductivity of the gaseous media. This exposes the zirconia fuel rod tubes (cladding) to oxidation and damage, thereby adversely affecting the structural integrity of the containment provided by the tubes for the fissionable nuclear fuel material (e.g. uranium ceramic pellets) packed inside the fuel rods.

Improvements in cask storage systems for radioactive nuclear waste is desired.

The present invention relates generally to ventilated overpacks or cask used for dry storage and/or transport of high level nuclear waste from nuclear power generating plants or other nuclear facilities, and more particularly to such a cask with controllable ventilation air flow.

In the operation of nuclear reactors, the nuclear energy source is typically in the form of a plurality of hollow Zircaloy tubes each filled with enriched uranium pellets, which are collectively arranged in assemblages referred to as fuel assemblies. When the energy in the fuel assembly has been depleted to a certain predetermined level, the fuel assembly is removed from the nuclear reactor and referred to as used or spent nuclear fuel (“SNF”). The standard structure used to package or store the SNF assemblies discharged from light water reactors for off-site shipment or on-site dry storage is an all-welded stainless steel container. Such containers are well known and may be variously referred to as multi-purpose canisters (MPCs) such as those available from Holtec International of Camden, N.J., or dry storage canisters (DSCs).

Regardless of their name, these SNF canisters are characterized by a relatively thin-walled stainless shell to effectively transmit heat emitted by the decaying the SNF assemblies across the canister's wall boundary. The stainless steel shell has several full through-thickness continuous seam welds, including longitudinal seam welds and girth welds such as those that connect the shell to the top and bottom end closure plates. A fuel basket is typically arranged inside a metallic storage canister which defines an array of prismatic-shaped storage cells each of which is sized to hold a single fuel assembly, which in turn comprises a plurality of individual spent nuclear fuel rods.

A single heat-emitting canister is in turn stored and enclosed inside its own outer vertically ventilated module referred to as an overpack or cask. The casks comprise heavy radiation shielding which block gamma and neutron radiation emitted from the SNF assemblies which passes through the canister shell and end plates. The ventilated casks are used for safe transport and/or storage of the multiple spent fuel assemblies within the inner fuel basket.

In addition to emitting neutron and gamma radiation) requiring protective shielding, the highly radioactive SNF in the fuel assemblies still produces considerable heat which must be dissipated to avoid damage to the fuel assemblies stored in the canister. Ventilated casks use available ambient ventilation air to cool the canister and remove the heat emitted therefrom to protect the fuel assembly. Typically, ventilated casks have air inlet vents at bottom and air outlet vents at top. Ambient cooling air is drawn into the bottom of the cask interior cavity which holds the canisters, flows upward via natural thermal-siphon effect between the cask and canister as the air is heated by the canister, and the heated air is rejected back to the ambient environment through the air outlet vents at top.

Classical metallurgy teaches that stainless steel becomes vulnerable to stress corrosion cracking (SCC) if the material is subject to a tensile stress field and the environment has high humidity and halide species; a condition common to many marine environments. In canisters containing pressurized helium blanketing gas, the majority of which do for heat rejection purposes, tensile stress is present over the entire canister shell body. Thus, on-site canister storage facilities, often called Independent Spent Fuel Storage Installations (ISFSIs), located at the seacoast are especially vulnerable to SCC damage if subjected to prolonged exposure to the site's ambient environment. Because the relative humidity of air decreases with increasing temperature, the entering air has the highest relative humidity and the exiting air has the lowest relative humidity. Therefore, it is the bottom region of the canister, closest to the air inlets, where its wall is exposed to the most adverse conditions with the highest humidity and lowest temperature. Consequently, the threat of SCC is most acute in this lower region of the canister where the air is at its coldest and has maximum relative humidity. Under a sufficiently prolonged service condition, there is a risk of the bottom region of the canister developing SCC over time. The weld seams and the adjacent heat affected zones are particularly vulnerable to SCC.

Notably, the extent of the canister's lower region that is vulnerable to SCC increases as the decay heat generated by the contained fuel declines monotonically with time resulting in the canister wall concomitantly becoming gradually cooler. Thus, threat of SCC grows over time as the canister ages. Prior ventilated casks typically have no provisions to allow adjustment and control over the amount of ventilation air flow through the casks over time to reflect the need to keep the canister warmer at a desired temperature as its heat emission drops.

Accordingly, a need exists from an improved cask with user adjustable and controllable ventilation air flow to accommodate the changing temperature conditions of the canister over time for protection against SCC.

Used or spent nuclear fuel and radioactive waste materials are presently stored on an interim basis “on site” at commissioned and some decommissioned nuclear generating plants until the federal government provides a central permanent repository. For example, spent nuclear fuel (SNF) is stored in the reactor fuel pool after removal from the core where it continues to generate decay heat. The fuel can be transferred after a period of cooling in the pool to nuclear waste canisters which are placed in thick-walled outer vessels such as dry storage modules or casks typically constructed of concrete, steel, and iron, etc. to provide containment and radiation shielding. The casks are stored on site at the generating plant.

The concept of using consolidated interim storage (CIS) is intended to provide geographically distributed off-site storage facilities for spent nuclear fuel and other high level nuclear radioactive wastes gathered from a number of individual generating plant sites, thereby providing greater control over the widely dispersed waste stockpiles. The waste materials are stored in sealed nuclear waste canisters such as a multi-purpose canister (MPC) available from Holtec International Inc. of Camden, N.J. The canister generally includes an elongated cylindrical stainless steel shell, baseplate, and lid hermetically seal welded to the shell to form the confinement boundary for the stored fuel assemblies disposed in the canister. A fuel basket arranged inside the canister has a rectilinear honeycomb construction defining a plurality of open prismatic cells which each hold a nuclear fuel assembly. The fuel assembly comprises a plurality of nuclear fuel rods or “cladding” which contains the uranium fuel pellets that continue to emit considerable decay heat after removal from the nuclear reactor.

The nuclear waste canisters may be initially transported to the CIS facility from the generating plants for a period of time, with the eventual goal of a final move to a permanent nuclear waste repository when available from the government. Such so called independent spent fuel storage installations (ISFSI) are facilities designed for the interim storage of spent nuclear fuel comprising solid, reactor-related, greater than Class C waste, in addition to other related radioactive materials. Each ISFSI facility would typically maintain an inventory of a multitude of waste canisters containing spent nuclear fuel and/or radioactive waste materials.

Some ISFSIs comprise multiple storage modules which store nuclear waste below ground/grade and are ventilated by natural ambient cooling air. Such existing underground nuclear waste storage systems however do not meet all current needs of ISFSIs in all situations. For example, the modules may be fluidly coupled to the source of available ambient cooling air and/or each other in a manner which may deprive certain modules of the ventilation air required for optimal cooling of the radioactive waste in each module.

Improvements in such underground ventilated nuclear waste storage systems are desired.

### BRIEF SUMMARY

The present application discloses an impact amelioration or limiting system usable in nuclear waste fuel storage vessels. The system operates to ameliorate and reduce the g-load or force (gravitational) imparted to such vessels due to mutual impact between the vessels resulting from a drop event. The proposed impact limiting system design can comprise installing one or preferably more tapered impact limiter rods or plugs in closely fitting and frictionally engaged tapered plug holes formed in one of the two mutually impacting vessels. The combination tapered plug and corresponding hole collectively defines an impact limiter assembly. In one embodiment, the impacting vessels may be without limitation an outer nuclear waste transfer overpack or cask and a SNF storage canister (aka fuel canister) such as a MPC described above. The impact limiter rods or plugs and corresponding tapered plug holes may be arranged on the cask in one configuration at the interface between the bottom of the canister and bottom closure plate of the cask. The impact amelioration system is designed to absorb and dissipate at least a portion of the kinetic energy imparted to the vessels during a cask drop event, as further described herein.

The impact limiter plugs are partially embedded in their respective plug holes. Under impact during a generally vertical drop scenario, each tapered impact limiter plug that may be provided when acted upon by the canister will advance a distance deeper inside its respective tapered hole in the cask. The impact force of the plug's kinetic energy is absorbed by the combined action of interfacial friction (between engaged side surfaces of the plug and hole walls) and the elastic-plastic (elastoplastic) deformation and expansion of the plugs within the tapered holes. Accordingly, the partially embedded plugs which protrude above top surface of the bottom closure plate of the cask are driven deeper into the plug holes by the impact force. Calculations show that a suitable choice of the principal parameters such as the material of the tapered rod, angle of taper, rod diameter, and number of impact limiter rods or plugs provided results in reducing the peak g-load resulting from the impact significantly. Advantageously, this protects and minimizes or prevents the spent nuclear fuel (SNF) assemblies stored within the fuel canister from damage during the impact scenario.

A plurality of impact limiter rod or plugs and corresponding tapered plug holes may be arrayed around and partially embedded in the top surface of the bottom closure plate of the cask. The plugs protrude upwards beyond the top surface towards the canister in a pattern selected to provide impact protection in a uniform manner at the bottom or lower cask to canister interface. The canister is seated on the top surfaces of the plugs which act as pedestals that support the canister in a spaced apart manner from the cask bottom closure plate. The canister therefore does not directly contact the bottom closure plate of the cask. All quadrants of the cask bottom closure plate may include at least one impact limiter assembly (i.e. tapered plug and hole), but preferably multiple impact limiter assemblies. This ensures even distribution of the impact forces in the event of a generally straight vertical drop and/or guarantees that an off-center drop at an angle will result in at least some impact limiter assemblies being positioned to absorb the resultant impact forces and decelerate the canister to reduce peak g-loads.

An impact amelioration system for nuclear fuel storage components in one embodiment comprises: a fuel storage canister comprising a first shell extending along a vertical centerline, the canister configured for storing nuclear fuel; an outer cask defining a cavity receiving the canister, the cask comprising a second shell and a bottom closure plate attached to the second shell; a plurality of impact limiter assemblies disposed on the bottom closure plate at a canister to cask interface, each of the impact limiter assemblies comprising a plug frictionally engaged with a corresponding plug hole formed in the bottom closure plate; wherein the plugs engage the canister.

A method for ameliorating impact between components of a fuel storage system in one embodiment comprises: partially embedding a plurality of impact limiter plugs in corresponding plug holes formed in a bottom closure plate of a cask; seating the canister on the plugs, the plugs being positioned at a first depth in the plug holes; impacting the canister against the plugs with an impact force; and driving the plugs to a second depth in the plug holes deeper than the first depth.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

The present application discloses a radiation-shielded unventilated nuclear waste storage cask with heat dissipation system which effectively removes decay heat emitted from the nuclear waste fuel canister housed therein. In one embodiment, the cask comprises an inner shell, outer shell, and plurality of radial rib plates connected between the shells which convey heat away from the canister through the walls of the cask to the ambient environment. The outer shell is cooled by convection via ambient airflow and radiation effects. Radiation shielding is provided in the annulus between the shells and the rib plate therein. The rib plates further structurally reinforced the cask and play a role in lifting the cask, as further described herein.

In contrast to the typical ventilated storage casks discussed above, the present unventilated storage cask is hermetically sealed forming a pressure retention vessel configured to contain pressures in excess of atmospheric pressure. Because there is no ambient air exchanged with the sealed internal cavity of the unventilated storage cask in which the waste fuel canister is stored, the risk of initiating stress corrosion cracking (SCC) of the canister is effectively mitigated. The unventilated storage cask also includes a safety feature comprising a pressure relief mechanism to relieve the buildup of excessive pressure within the pressure vessel class cask. Excess pressure is safely released to atmosphere by a unique floating lid to cask interface design which protects the structural integrity of the unventilated cask and waste fuel canister therein. When overpressurization conditions abate, the lid automatically reseals the cask cavity.

As its design configuration indicates, the unventilated storage cask has a considerably reduced heat load capacity compared to its ventilated counterpart. Because the only heat rejection pathway available in the present unventilated storage system is via conduction through the shells of the cask and natural convection/radiation at the cask's exterior surface to the ambient, the annulus gas inside the overpack will be at an elevated temperature. Because heating of air reduces its relative humidity and a high humidity content is necessary (but not sufficient) to induce stress corrosion cracking (SCC) in the austenitic stainless steel confinement boundary of the waste fuel canister, increasing the temperature of the air surrounding the canister in the internal cavity of the cask serves to prevent the onset of SCC under extended storage conditions. A preferred alternative is to replace the air within the annular area of the cask surrounding the canister with a non-reactive gas, such for example without limitation as nitrogen or argon. Preventing SCC in long term dry storage casks of the present design is one objective of the present unventilated nuclear waste fuel storage system.

If SCC is not a major threat in the nuclear waste fuel storage environment, then it is not necessary to purge the ambient air from the cask for replacement with an inert gas. In such a case, the air pressure in the hermetically sealed cavity of the unventilated storage cask will rise in temperature roughly in accordance with the perfect gas law. To provide pressure relief under a U.S. NRC (Nuclear Regulatory Commission) postulated accident scenario to which dry cask waste fuel storage systems must be designed, such as the cask's Design Basis Fire Event, the cask closure lid bolt assemblies are installed with a small vertical gap to loosely mount the lid to the cask body with a copious preset vertical travel clearance or gap to enable the lid to slideably lift up without frictional interference from the bolts. If the air pressure within the cask is high enough to lift the lid even by a minute amount, then some air will escape reducing the pressure within the cask back to normal operating pressures. Thus, the cask is a self-regulating and self-relieving device making uncontrolled overpressure impossible, as further described herein. In some embodiments, the internal design pressure of the cask may be set equal to approximately 200% of the pressure that will equilibrate the weight of the cask closure lid.

In one aspect, an unventilated nuclear waste fuel storage system comprises: a longitudinal axis; a canister configured for storing nuclear waste fuel inside; an outer cask comprising a cask body including an inner shell, an outer shell, an annular space containing a radiation shielding material formed between the shells, and a bottom baseplate sealed to bottom ends of the shells; a radiation shielding lid selectively sealable to the cask body, the lid when positioned on the cask body collectively defining a gas tight cavity receiving the canister; a plurality of longitudinal lifting rib plates extending radially between and fixedly attached to the inner and outer shells in the annular space, each lifting rib plate comprising a threaded anchor boss fixedly attached at a top end thereof; and a plurality of threaded bolt assemblies threadably engaged with the anchor bosses which secure the lid to the cask; wherein the gas tight cavity forms a pressure vessel operable to retain pressures above atmospheric pressure within the cask.

According to another aspect, an unventilated nuclear waste fuel storage pressure vessel with self-regulating internal pressure relief mechanism comprises: a longitudinal axis; a cask body including an inner shell, an outer shell, an annular space containing a radiation shielding material formed between the shells, a bottom baseplate sealed to bottom ends of the shells, and an internal cavity configured to house a nuclear waste fuel canister therein; a plurality of upwardly open threaded anchor bosses affixed to a top end of the cask body; a radiation shielding lid loosely coupled to the top end of the cask body in a movable manner; an annular compressible gasket forming a circumferential seal between the lid and the top end of the cask body which renders the cavity gas tight; and a plurality of bolt assemblies passing through the lid and threadably engaged with the anchor bosses, the bolt assemblies configured and operable to loosely secure the lid to the cask body; the lid being movable between (1) a downward sealed position engaged with the cask body which seals the gas tight cavity of the cask; and (2) an adjustable raised relief position engaged with the bolt assemblies but ajar from the top end of the cask body to partially open the gas tight cavity thereby defining a gas overpressurization relief passageway to ambient atmosphere; wherein the cask is operable to retain an internal pressure within the cavity above atmospheric pressure.

According to another aspect, a method for protecting an unventilated nuclear waste storage system from internal overpressurization comprises: providing an unventilated cask comprising a sealable internal cavity and a plurality of threaded anchor bosses; lowering a canister containing high level nuclear waste into the cavity; positioning a radiation shielded lid on the cask, the lid being in a downward sealed position engaged with the cask making the cavity gas tight to retain pressures exceeding atmospheric; aligning a plurality of fastener holes formed in the lid with the anchor bosses; threadably engaging a threaded stud with each of the anchor bosses through the fastener holes of the lid; rotatably engaging a threaded limit stop with each of the threaded studs; positioning the limits stops on the studs such that a vertical travel gap is formed between the lid and the limit stops; wherein during a cask overpressurization condition, the lid slideably moves upward along the studs to a relief position ajar from the cask to vent excess pressure to atmosphere.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

The present application provides a nuclear waste storage system comprising a radiation-shielded nuclear waste storage cask which overcomes the shortcomings of the foregoing cylindrical type storage casks described above for storing a wide variety of different nuclear waste materials. In one embodiment, a longitudinally elongated box-type cask is disclosed comprising an essentially rectangular body with rectilinear cross sectional internal storage cavity configured for holding nuclear waste material, and a matching rectangular closure lid. The elongated large top opening leading into the storage cavity extends for a majority of the longitudinal length of the cask. In contrast to the small circular opening at the top of cylindrical casks, the present rectangular opening allows large and irregular shaped radioactive metal pieces of waste material to be loaded inside the cask storage cavity in an efficient and expedient manner without undue handling by operating personnel, thereby reducing potential radiation dosage.

In one embodiment, the closure lid be coupled and sealed to the cask body to close the top opening through a quick connect-disconnect joint that does not utilize any threaded fasteners. Instead, a slider locking mechanism comprising mechanically interlocking protrusions provided on peripheral portions of each of the lid and correspondingly cask body around the cask top opening is employed. While the lid remains stationary on the cask body, the locking protrusions on the lid are slideably relative to the locking protrusions on the cask body between locked and unlocked positions or states. The locking protrusions may be arrayed and spaced apart perimetrically around the lid and cask body. The locking protrusions may be wedge-shaped in one embodiment to produce a wedging-action when mutually engaged which effectively locks the lid to the cask body and seals the nuclear waste contents inside the cask. A gasket at the lid to cask body interface is compressed by the wedging-action to form a gas-tight seal of the cask storage cavity which completes the containment barrier. There is no exchange of air between the ambient environment and the storage cavity in one embodiment.

The term “nuclear waste material” as used herein shall be broadly construed to mean any type or form of radioactive waste material which has been irradiated by a source of radiation. Such irradiation may occur in a nuclear power generation plant with nuclear reactor, or other types of facilities. As one non-limiting example, the radioactive nuclear waste materials may be associated with decommissioning or repair/maintenance of a nuclear facility, and may therefore include a wide variety of sizes and shapes of pieces of equipment (including parts of the reactor), structural components/members, parts, debris, scrap, or similar which have been irradiated and generate radiation.

In one aspect, a cask for containing radioactive materials comprises: a cask body comprising an opening forming a passageway into an internal storage cavity of the cask; a closure lid configured to be detachably coupled to the cask body to enclose the opening; and a locking mechanism comprising at least one first locking member and at least one second locking member, the first and second locking members slideable relative to one another to alter the locking mechanism between: (1) a first state in which the closure lid can be removed from the cask body; and (2) a second state in which the first and second locking members engage one another to prevent the closure lid from being removed from the cask body.

According to another aspect, a cask for containing radioactive materials comprises: a longitudinal axis; an axially elongated cask body defining a top opening forming an entrance to an internal storage cavity of non-cylindrical cross-sectional configuration, the cavity configured for holding radioactive waste materials; and a closure lid detachably coupled to the cask body at the top opening.

According to another aspect, a method for locking a radioactive waste storage cask comprises: positioning a closure lid on a cask body over an opening leading into an internal storage cavity; inserting a peripheral array of first locking protrusions on the lid between and through a peripheral array of second locking protrusions disposed on the cask body around the opening; slideably moving the first locking protrusions beneath the second locking protrusions; and frictionally engaging the first locking protrusions with the second locking protrusions; wherein the lid cannot be removed from the cask body.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

The present application discloses a wet cask system for storing and transporting radioactive nuclear waste such as without limitation spent nuclear fuel (SNF). The system includes an unventilated and hermetically sealed cask containing a volume or inventory of water in which the SNF (e.g. fuel assemblies) is submerged. In one embodiment, the water may be borated for additional radiation shielding. The body of the cask comprises radiation shielding to block and attenuate gamma and neutron radiation emitted by the SNF assemblies.

The wet cask system preferably further includes a pressure control sub-system for limiting internal pressure in the cask during a high pressure excursion conditions. In various embodiments, the pressure control sub-system comprises one or more evacuated internal pressure control devices which may be pressure surge capacitors in one embodiment. These capacitors are configured for insertion into the cask cavity occupied by the SNF, and operable to control and mitigate high pressure surge events experienced internally within the wet cask such as those occurring under various postulated accidents and abnormal operating conditions previously described herein. Advantageously, this protects the structural integrity of the cask from such high pressurize excursions which may be caused by external factors (such as fire or degradation of the heat rejection process from the external surface of the cask) or a massive liberation of the gases encapsulated in the fuel rods due to degradation of this metal zirconia cladding described above.

Each pressure surge capacitor may be a fully welded and hermetically sealed vessel (no credible path for leakage in or out) in one embodiment comprising at least one rupture disk which seals an internal vacuum chamber inside the capacitor. Each rupture disk is designed and constructed to burst at a predesigned/predetermined pressure level or condition occurring inside the cask cavity external to the pressure surge capacitor. This allows the excess cask pressure occurring during a high pressure excursion to bleed into capacitor, thereby returning the pressure inside the cask to acceptable levels. The vacuum cavity inside each pressure surge capacitor is evacuated to sub-atmospheric (i.e. negative pressure) conditions to the greatest extend practicable. The pressure surge capacitors may have an elongated tubular configuration in some embodiments.

The wet cask with hermetically sealable cavity may be used for various applications associated with operation of a nuclear reactor such as in a nuclear power generation facility. For example, in one non-limiting application, the wet cask may be used to transfer spent nuclear fuel assemblies in a continuously submerged stated in the cask between spent fuel pools. The fuel assemblies may be loaded into the wet cask in a first pool underwater, the cask may be lifted out of the first pool and transported to and positioned in a second pool. Radiation blocking is achieved by maintaining the fuel assemblies in the water-impounded cask even during transport.

Although the cavity of the cask may be configured and have appurtenances designed to hold SNF assemblies in some embodiments, any type or form of high level radioactive nuclear waste or irradiated materials may be stored in a submerged stated in the inventory of water held by the cask. Such high level radioactive waste materials may be collectively referred to as “radioactive nuclear waste.”

In one aspect, a storage system for radioactive nuclear waste comprises: a longitudinal axis; a cask comprising a hermetically sealable internal cavity configured to hold an inventory of water sufficient to submerge the nuclear waste therein; and a pressure surge capacitor disposed in the cask, the pressure surge capacitor comprising a vacuum cavity evacuated to sub-atmospheric conditions; wherein the pressure surge capacitor is configured to suppress a pressure surge in the internal cavity of the cask.

In another aspect, a cask with overpressurization protection for storing nuclear waste fuel comprises: a longitudinal axis; a cask body comprising a removable lid assembly, a base, and a circumferential wall including radiation shielding, the cask body forming a hermetically sealed internal cavity configured for holding spent nuclear fuel submerged in an inventory of water; a pressure surge capacitor disposed in the cask, the pressure surge capacitor comprising a vacuum cavity evacuated to sub-atmospheric conditions; and the pressure surge capacitor further comprising at least one rupture disk constructed to burst at a predetermined pressure level inside the cask associated with a cask overpressurization condition; wherein the rupture disk when burst allows a portion of the water to fill the vacuum chamber to reduce pressure inside the cask.

In another aspect, a method for controlling pressure in a wet nuclear waste storage system comprises: providing a cask comprising a sealable internal cavity configured for storing nuclear waste; positioning a pressure surge capacitor in the cask, the pressure surge capacitor comprising a vacuum cavity evacuated to sub-atmospheric conditions and in fluid communication with the internal cavity; filling the cask with water; submerging the nuclear waste in the water; and sealing a lid assembly to the cask to hermetically seal the internal cavity; wherein the pressure surge capacitor is configured to suppress a pressure surge in the internal cavity of the cask. The method may further comprise after the sealing step, steps of: increasing the pressure inside the cask to exceed a predetermined burst pressure of a rupture disk of the pressure surge capacitor; bursting the rupture disk; and admitting a portion of the water into the pressure surge capacitor which reduces the pressure inside the cask.

This disclosure addresses the challenge of protecting the SNF canister from stress corrosion cracking (SCC), particularly its shell wall and weld seams, in nuclear waste fuel or other high level radioactive waste material storage site locations where the canister may be exposed to a marine environment or other environment with similarly high halide concentrations conducive to the onset of SCC.

A radiation-shielded ventilated cask for storing the canister is provided which comprises a natural ambient air ventilation system configured to provide a user adjustable and variable ventilation airflow rate. The airflow rate may be adjusted over time as needed to mitigate the threat of SCC resulting from the reduction in canister heat load (emission) over time. The variable ventilation airflow rate allows the amount of ambient air inducted into the cask interior cavity via the natural convection thermo-siphon effect to be decreased over time to keep pace with the declining heat emitted by the canister. Advantageously, the greatest threat of SCC at the lower/bottom region of the canister as previously described herein can be mitigated by maintaining the temperature of the canister at or near a canister maximum temperature limit over the life of the canister to the extent possible. The ventilation airflow rate may therefore be readily adjusted from time to time as needed to operate at that threshold temperature. In addition, the airflow rate may be adjusted seasonally if needed due to changing ambient air conditions (e.g., temperature and humidity) to maintain the foregoing desired canister maximum temperature limit.

In one embodiment, the ambient ventilation air inlet or outlet vents may be fitted with adjustable shutter plates configured to regulate the airflow rate into and through the canister. The shutter plates act as adjustable orifices to increase or decrease the vent open area, thereby correspondingly increasing or decreasing the airflow rate. In other embodiments, a fixed flow restrictor such as an orifice plate may be fitted to the air outlet of the cask which may be located in its lid.

In one aspect, a passively ventilated nuclear fuel storage cask comprises: an elongated cask body defining a top end, a bottom end, a sidewall, and an internal cavity extending between the ends along a longitudinal axis, the internal cavity being configured for holding a nuclear fuel storage canister; a plurality of cooling air inlet ducts spaced circumferentially apart around the body, the inlet ducts each forming a radial air inlet passageway fluidly coupling ambient atmosphere with a lower portion of the internal cavity; at least one cooling air outlet ducts disposed at the top end of the cask body, the at least one outlet duct forming an air outlet passageway fluidly connecting ambient atmosphere with an upper portion of the internal cavity; and a vertically adjustable shutter plate coupled to each the air inlet ducts, the shutter plate defining a flow opening area configured to throttle an inflow of cooling air through the internal cavity of the cask. The shutter plates are vertically adjustable and movable in position such as via sliding on the cask to vary the flow opening area to increase or decrease the inflow of cooling air.

In another aspect, a method for operating the foregoing passively ventilated nuclear fuel storage system comprises: providing a ventilated cask comprising an internal cavity and plurality of air inlet ducts in fluid communication with the cavity; inserting a canister containing spent nuclear fuel in the internal cavity of a cask; placing shutter plates associated with each of the air inlet ducts in a first vertical position, the first vertical position defining a first flow opening area; storing the canister in the cask for a first period of time; moving the shutter plates to a second vertical position, the second vertical position being associated with a second flow opening area different than the first flow opening area; wherein the first and second flow opening areas regulates an amount of air which can be drawn into the internal cavity of the cask heated by the canister via natural convective flow.

In another aspect, a passively ventilated nuclear fuel storage cask comprises: an elongated cask body configured for mounting a majority of its length below grade, the cask body comprising an outer shell and an inner shell defining an internal cavity extending along a longitudinal axis, the internal cavity being configured for holding a nuclear fuel storage canister; a lid attached to a top end of the cask body, the lid configured for above grade placement; a natural convective ventilation system comprising: a vertical annular downcomer formed between the inner and outer shells, the annular downcomer being in fluid communication with a lower portion of the internal cavity; a plurality of cooling air inlet ducts formed through the lid, the air inlet ducts each in fluid communication with the annular downcomer to fluidly couple the lower portion of the internal cavity with ambient atmosphere; a cooling air outlet duct formed through the lid; and a flow restrictor disposed at one end of the air outlet duct, the flow restrictor having a configuration selectable to regulate an amount of ambient air which flows through the internal cavity of the cask. The flow restrictor may be an orifice plate comprising a plurality of orifice openings.

In another aspect, a method for operating the foregoing passively ventilated nuclear fuel storage system comprises: inserting a canister containing spent nuclear fuel in an internal cavity of a cask; attaching a lid on the cask, the lid comprising an air outlet duct including a first orifice plate having a first open area, the outlet duct in fluid communication with the internal cavity of the cask; storing the canister in the cask for a first period of time; removing the first orifice plate from the lid; and installing a second orifice plate in the lid for a second period of time, the second orifice plate having a second open area different than the first open area.

In another aspect, a passively ventilated nuclear fuel storage system comprises: a storage site comprising embedment material having a top surface defining grade; a vertically elongated cask embedded in the embedment material for a majority of its length below grade, the cask comprising an outer shell and an inner shell defining an internal cavity extending along a longitudinal axis; a nuclear fuel storage canister disposed in the internal cavity of the cask below grade, the canister containing radioactive waste material; a lid attached to a top end of the cask body above grade, the lid configured for above grade placement; a natural convective ventilation system comprising: a vertical annular downcomer formed between the inner and outer shells, the annular downcomer being in fluid communication with a lower portion of the internal cavity; a plurality of cooling air inlet ducts formed through the lid, the air inlet ducts each in fluid communication with the annular downcomer to fluidly couple the lower portion of the internal cavity with ambient atmosphere; a cooling air outlet duct formed through the lid; and an orifice plate disposed at one end of the air outlet duct, the orifice plate having a configuration selectable to regulate an amount of ambient air which flows through the internal cavity of the cask. Heat emitted by the canister draws ambient cooling air through the air inlet ducts and annular downcomer into the internal cavity via natural convective thermo-siphon flow where the air is heated, and the heated air rises in the internal cavity and is discharged back to atmosphere through the air outlet duct in the lid.

The present disclosure in one aspect provides an underground naturally ventilated and passively cooled radioactive nuclear waste storage system designed for below ground/grade storage of fuel. The system comprises a plurality of modules such as CECs (cavity enclosure containers) which may be arrayed in an upright position on a subterranean concrete base pad situated below the storage site's final cleared grade of topsoil and/or engineered fill. A majority of the height of the underground CECs is therefore preferably located below grade created a low profile for protection against potential intentional or unintentional projectile impacts. The CECs in the array may be arranged in a single-file linear pattern spaced apart manner thereby forming nuclear waste storage row extending horizontally along a common longitudinal axis in in one embodiment. Multiple parallel linear rows of CECs may be provided in a CIS facility which may form an ISFSI facility.

In one embodiment, each CEC defines an internal cavity diametrically configured in cross-sectional area for holding a single cylindrical spent nuclear fuel (SNF) canister. The canister holds the SNF assemblies and/or other high level radioactive waste materials as previously described herein which continue to emit considerable amounts of heat that require dissipation in order to protect the structural integrity of fuel assemblies or other waste material. In certain other embodiments contemplated, multiple canisters may be vertically stacked one above each other in a single CEC such as disclosed in commonly owned U.S. Pat. No. 9,852,822, which is incorporated herein by reference. In this case, the CECs may be diametrically configured in cross-sectional area to hold a single canister at a single elevation in both the upper and lower positions within the CEC.

The CECs and canisters inside are cooled using a passive ambient air ventilation system unassisted by fans or blowers in preferred but non-limiting embodiments to circulate cooling air through the CECs. Heat emitted by the canister fluidly drives a convective natural thermo-siphon effect to draw ambient air through the CECs cavity in the annulus between the CEC and canister as the air inside the annulus is heated by the canister. In other possible embodiments, fans/blowers may be provided if necessary, but are less preferred since the interruption of electrical power to the CIS site may interfere with the ability to adequately cool the CECs and radioactive nuclear fuel and/or other waste material housed therein.

In preferred but non-limiting embodiments, each CEC includes a minimum of two air inlets. Two air inlets are provided in one embodiment. The air inlets are fluidly coupled via laterally and horizontally extending flow conduits directly to at least one direct source of cooling air (i.e. there are no intervening CECs in the air flow pathway defined by the flow conduits between the cooling air source and air inlets of the CEC). Further, each CEC is not fluidly coupled in a direct manner via the flow conduits to any other CEC (i.e. shell-to-shell). This advantageously minimizes fluidic air flow interaction between adjacent CECs which may result in air pressure imbalance in which those CECs containing radioactive waste materials emitting greater heat than others disproportionally draw a greater amount of the available ventilation air in the system than other CECs which may be partially starved of sufficient cooling air.

The cooling air source in some implementations may be one or more vertically-elongated and tubular/hollow ambient cooling air feeder shells. The air feeder shells may have a smaller outer diameter than the CECs, thereby allowing the CECs to be spaced as closely as possible to conserve available nuclear waste storage space at the CIS facility within each row of CECs. The air feeder shells are each in fluid communication with ambient atmosphere at top and operable to draw cooling air downwards into the shell via the natural convective thermo-siphon effect driven by the heat emitted from nuclear waste canister within the CEC. The air flows to and enters the CEC via the flow conduits, is heated by the radioactive waste in the canister, and then is exhausted back to atmosphere through the top of the CEC which may be located above grade to define an air outlet.

In some embodiments disclosed herein, the pair of air inlets of the CEC may each be fluidly coupled directly to a single discrete and separate cooling air feeder shell via the flow conduits. In other embodiments disclosed herein, the CEC is fluidly coupled directly to a pair of air feeder shells via flow conduits. In yet other embodiments disclosed herein for nuclear waste still emitting extremely high levels of heat conductively passed through the nuclear waste canister walls, a high airflow capacity system is provided in which each CEC is fluidly coupled to two pairs (i.e. four) cooling air feeder shells. In all of these embodiments, each air inlet of the CEC is fluidly coupled directly to an air feeder shell via a separate dedicated single flow conduit rather than a shared branch or header type flow conduit arrangement as in some past approaches which may prevent each CEC from receiving the required volume/flow rate of cooling air in some situations.

In any of the foregoing three possible cooling air supply arrangements of the CECs and cooling air feeder shells, the provision of at least two separate air inlets for each CEC and direct fluid coupling to one or more feeder shells advantageously improves the ability of the natural ventilation system to adequately cool each CEC to the necessary degree in order to protect the structural integrity of the SNF assemblies and/or other high level nuclear waste stored inside the canisters in the CEC. Because the ambient cooling air flowing to each CEC from one or two cooling air feeder shells does not first pass through any upstream intervening CECs such as employed in some prior systems, the flow rate of ambient cooling air supplied directly to the CEC for naturally ventilating its interior space or cavity and cooling the SNF canister is therefore not diminished. This prevents the situation in such prior ventilation systems where a vertically-oriented CEC or storage shell located at the end of a number of fluidly and serially interconnected CECs may not receive an adequate amount of cooling air due. This is due to the fact that upstream CECs may have drawn a disproportionate share of the available cooling air supply flowing through the ventilation system. By instead directly coupling each CEC directly to at least one cooling air feeder shell according to the present disclosure, the required amount of cooling air to adequately cool the canister in each CEC via the thermo-siphon fluid flow effect is assured irrespective of the level of decay heat generated by the radioactive waste material in each CEC. Air pressure imbalances between the CECs due to disparate levels of decay heat are thus also avoided.

In a nuclear waste storage system such as a CIS facility with passive ambient air ventilation system according to the present disclosure in which multiple parallel linear rows of CECs are provided, no CEC in one row may be fluidly coupled to any other CECs or cooling air feeder shells in another adjacent row either directly or indirectly (i.e. via an intervening CEC or flow conduits). This prevents fluidic interaction between CECs in adjoining rows which could result in possible pressure and flow imbalances, thereby causing disproportionate cooling of some CECs versus others as previously described herein. In addition, it bears noting that use of multiple parallel rows of CECs which are not fluidly interconnected advantageously simplifies expansion of an existing CIS facility since no prior rows of CECs need to be partially unearthed to make new fluid couplings to existing buried CECs.

The collective array of CECs according to the present disclosure may form part of an independent spent fuel storage installation (ISFSI) facility suitable for a CIS system that may include any suitable number of CECs desired. The CECs may be part of a CIS system such as HI-STORM UMAX (Holtec International Storage Module Underground Maximum Safety) which is an underground Vertical Ventilated Module (VVM) dry spent fuel storage system engineered to be fully compatible with all presently certified multi-purpose canisters (MPCs). Each HI-STORM UMAX Vertical Ventilated Module provides storage of an MPC in the vertical configuration inside a cylindrical cavity located entirely below the top-of-grade of the ISFSI. The VVM, akin to the aboveground overpack, is comprised of the CECs; each of which includes a removable top closure lid according to the present disclosure.

The nuclear waste canisters usable in the present CECs, which may contain both radioactive used or spent nuclear fuel (SNF) and/or non-fuel radioactive waste materials, may be stainless steel multi-purpose canisters (MPCs) available from Holtec International of Camden, N.J. Other canisters may be used.

The present underground nuclear waste storage system is intended to provide vanishingly low site boundary radiation dose levels and safety during catastrophic events. As an underground system, the system takes advantage of the surrounding soil/engineered fill or subgrade to provide radiation shielding, physical protection, and a low center of gravity for a stable storage installation.

According to one aspect, an underground passively ventilated nuclear waste storage system comprises: a horizontal longitudinal axis; a subterranean concrete base pad; a vertically elongated first cavity enclosure container located on the base pad and the longitudinal axis, the cavity enclosure container defining a vertical centerline axis and comprising a first air inlet, a second air inlet, an air outlet, and an internal cavity; the cavity of the first cavity enclosure container being configured for holding a nuclear waste canister which contains radioactive nuclear waste emitting heat; a vertically elongated first cooling air feeder shell in fluid communication with an ambient atmosphere and operable to draw in ambient air, the first cooling air feeder shell being fluidly coupled directly to the first air inlet of the first cavity enclosure container via a first flow conduit; a vertically elongated second cooling air feeder shell in fluid communication with the ambient atmosphere and operable to draw in ambient air, the second cooling air feeder shell being fluidly coupled directly to the second air inlet of the first cavity enclosure container via a second flow conduit. In one embodiment, the first cavity enclosure container is not fluidly coupled directly to any other cavity enclosure container.

According to another aspect, an underground passively ventilated nuclear waste storage system comprises: a horizontal longitudinal axis; a subterranean concrete base pad; a vertically elongated first cavity enclosure container located on the base pad and the longitudinal axis; a vertically elongated second cavity enclosure container located on the base pad and the longitudinal axis, the second cavity enclosure container being spaced apart from the first cavity enclosure container; the first and second cavity enclosure containers each defining a vertical centerline axis and comprising a first air inlet, a second air inlet, an air outlet, and an internal cavity; a nuclear waste canister positioned in each of the internal cavities of the first and second cavity enclosure containers, the canister emitting heat; a vertically elongated cooling air feeder shell arranged on the longitudinal axis between the first and second cavity enclosure containers, the cooling air feeder shell being in fluid communication with an ambient atmosphere and operable to draw in ambient air; the cooling air feeder shell fluidly coupled directly to the first air inlet of the first cavity enclosure container via a first flow conduit; the cooling air feeder shell fluidly coupled directly to the first air inlet of the second cavity enclosure container via a second flow conduit; wherein the first cavity enclosure container is not fluidly coupled directly to any other cavity enclosure container, and the second cavity enclosure container is not fluidly coupled directly to any other cavity enclosure container.

According to another aspect, a consolidated interim storage facility for nuclear waste comprises: a plurality of elongated cavity enclosure containers each founded on a subterranean base pad and extending vertically upwards therefrom to a concrete top pad; an engineered fill disposed between the base and top pads; the cavity enclosure containers being arranged in an array comprising a plurality of longitudinally-extending and parallel linear rows of cavity enclosure containers, each row defining a longitudinal axis and the cavity enclosure containers each being arranged on the longitudinal axis; a plurality of vertically elongated cooling air feeder shells disposed in each row on the respective longitudinal axis, one cooling air feeder shell being interposed between and fluidly coupled directly to a pair of the cavity enclosure containers on opposite sides of the cooling air feeder shell, the cooling air feeder shells each being in fluid communication with an ambient atmosphere; the one cooling air feeder shell being operable to draw in ambient air and distribute the air to directly to each pair of cavity enclosure containers; wherein the cavity enclosure containers in each row are fluidly isolated from the cavity enclosure containers in any other row.

According to another aspect, an underground passively ventilated nuclear waste storage apparatus for a consolidated interim storage facility, the apparatus comprising: a vertically elongated cavity enclosure container supported on a subterranean base pad and extending vertically upwards therefrom to a concrete top pad; an engineered fill disposed between the base and top pads; a nuclear waste canister positioned in an internal cavity of the cavity enclosure containers, the canister emitting decay heat which heats air in an annulus formed between the cavity enclosure container and the canister; a vertically elongated hollow cooling air feeder shell arranged on a lateral side of the cavity enclosure container, the cooling air feeder shell being in fluid communication with an ambient atmosphere and operable to draw in ambient air; the cooling air feeder shell fluidly coupled directly to a lower portion of the cavity by a first air inlet of the cavity enclosure container via a first flow conduit; the cooling air intake shell further fluidly coupled directly to the lower portion of the cavity by a second air inlet of the cavity enclosure container via a second flow conduit; the first and second flow conduits being fluidly coupled to a lower portion of the cooling air feeder shell; wherein a cooling air flow pathway is defined in which ambient cooling air is drawn into the cooling air feeder shell, flows through the first and second flow conduits to the lower portion of the cavity of the cavity enclosure container, flows upwards in the annulus and is heated by the canister, and exits from an air outlet at a top of the cavity enclosure container back to atmosphere.

### BRIEF DESCRIPTION OF THE DRAWINGS

The present invention will become more fully understood from the detailed description and the accompanying drawings, wherein like elements are labeled similarly and in which:

FIG. 1 is a front cross-sectional perspective view of an impact amelioration system for nuclear fuel storage according to the present disclosure including a transfer cask and fuel canister;

FIG. 2 is a side cross sectional view thereof;

FIG. 3 is an exploded view thereof;

FIG. 4A is a front elevation view thereof;

FIG. 4B is a detail taken from FIG. 4A;

FIG. 5 is a partial bottom view of the cask;

FIG. 6 is a partial top view of the cask;

FIG. 7 is a top perspective view of the bottom closure plate of the cask;

FIG. 8 is a side cross-sectional view of the bottom closure plate;

FIG. 9A is a side cross-sectional view showing an impact limiter assembly of the system comprising an impact limiter plug and mating plug hole shown in FIGS. 1-4B;

FIG. 9B is a side cross-sectional thereof showing the plug in an installed pre-impact position;

FIG. 9C is a side cross-sectional thereof showing the plug in a deeper post-impact position in the plug hole after application of an impact force resulting from a cask drop event;

FIG. 10 is a cross-sectional perspective view of the cask bottom closure plate showing a second embodiment of a impact limiter assembly;

FIG. 11 is a detail taken from FIG. 10;

FIG. 12 is a cross-sectional perspective view of the cask bottom closure plate showing a third embodiment of the impact limiter assembly;

FIG. 13 is a detail taken from FIG. 12;

FIG. 14 is a perspective view of an exemplary nuclear fuel assembly of the type which may be stored in the canister;

FIG. 15 is perspective view of a pressure vessel in the form of an unventilated cask for nuclear waste fuel storage according to the present disclosure;

FIG. 16A is a partial cross sectional view thereof;

FIG. 16B is an enlarge detail taken from FIG. 16A;

FIG. 17 is a top view of the cask;

FIG. 18 is a longitudinal cross sectional view of the cask taken from FIG. 17;

FIG. 19A is an enlarged detail showing the closure lid to cask interface and mounting details for securing the lid to the cask in a free floating manner, the lid being shown in a downward sealed position;

FIG. 19B is a similar view to FIG. 19A, but showing the lid in a raised pressure relief position ajar from the cask;

FIG. 19C is a similar view to FIG. 19A, but showing one of the lid bolt assemblies in exploded view;

FIG. 20 is a longitudinal cross sectional view of the cask taken from FIG. 17;

FIG. 21 is a partial cross-sectional view of the cask closure lid;

FIG. 22 is an enlarged detail taken from FIG. 21,

FIG. 23 is a transverse cross sectional view of the lid;

FIG. 24 is an exploded perspective view of the cask;

FIG. 25 is a side elevation view of the cask;

FIG. 26 is a side elevation view thereof showing parts of the cask closure lid in exploded view;

FIG. 27 is a partial longitudinal cross sectional view of the cask showing the nuclear waste fuel canister positioned in the internal cavity of the cask;

FIG. 28 is a perspective view of one of the lifting rib plates of the cask configured for use with the lid bolt assembly;

FIG. 29 is a bottom exploded perspective view of the lid and upper portion of the cask;

FIG. 30 is a top exploded perspective view of the lid and upper portion of the cask;

FIG. 31 is top perspective view of a polygonal cask configured for storage of nuclear waste materials according to one embodiment of the present disclosure;

FIG. 32 is an enlarged detail taken from FIG. 31;

FIG. 33 is a bottom perspective view of the cask of FIG. 31;

FIG. 34 is an exploded top perspective view thereof showing the lid removed;

FIG. 35 is an exploded bottom perspective view thereof;

FIG. 36 is a longitudinal side elevation view thereof;

FIG. 37 is a lateral end elevation view thereof;

FIG. 38 is a top plan view thereof;

FIG. 39 is a bottom plan view thereof;

FIG. 40 is a longitudinal transverse cross-sectional view thereof;

FIG. 41 is an enlarged detail taken from FIG. 40;

FIG. 42 is a top perspective view of the closure lid;

FIG. 43 is an enlarged top perspective view of an end portion of the lid;

FIG. 44 is a bottom perspective view of the lid;

FIG. 45A is a top exploded perspective view of the lid;

FIG. 45B is an enlarged detail taken from FIG. 45A;

FIG. 46 is a bottom exploded perspective view of the lid;

FIG. 47A is a partial longitudinal cross sectional view of the lid showing the cask locking mechanism in a locked position or state;

FIG. 47B is a partial longitudinal cross sectional view of the lid showing the cask locking mechanism in an unlocked position or state;

FIG. 48 is an enlarged detail in perspective view of a portion of the cask interior at the top opening showing the cask body locking protrusion arrangement;

FIG. 49 is an exploded perspective view of a portion of a longitudinal sidewall of the cask body showing a locking handle assembly in exploded view as well;

FIG. 50 is an enlarged perspective view of the locking handle assembly in the inward blocking position locked with a cable-lock security tag/seal in place;

FIG. 51 is a second enlarged perspective view of the locking handle assembly in the outward non-blocking position on the cask body;

FIG. 52 is an enlarged detail in perspective view of a portion of the cask interior at the top opening in a corner region showing the cask body locking protrusion arrangement on adjoining walls of cask body;

FIG. 53 is a transverse cross sectional view of the cask body and lid showing the lid removed;

FIG. 54 is an enlarged detail taken from FIG. 53 showing the locking handle assemblies on the longitudinal sidewalls of the cask body in the outward non-blocking position;

FIG. 55 is a transverse cross sectional view of the cask body and lid showing the lid in position on the cask body;

FIG. 56 is an enlarged detail taken from FIG. 55 showing the locking handle assemblies in the inward blocking position;

FIG. 57 is a perspective view of an actuator assembly for moving locking bars of the lid;

FIG. 58 is a cross sectional view thereof;

FIG. 59 is a first schematic diagram of a sequential method for locking the cask of FIG. 31;

FIG. 60 is a second schematic diagram thereof;

FIG. 61 is a third schematic diagram thereof;

FIG. 62 is a fourth schematic diagram thereof;

FIG. 63 is top perspective view of a pressure vessel in the form of an unventilated hermetically sealable wet cask for storing and transporting radioactive nuclear waste such as SNF according to the present disclosure;

FIG. 64 is a bottom perspective view thereof;

FIG. 65 is a top exploded perspective view thereof;

FIG. 66 is a bottom exploded perspective view thereof;

FIG. 67 is a first side view thereof;

FIG. 68 is a second side view thereof;

FIG. 69 is a top view thereof;

FIG. 70 is a bottom view thereof;

FIG. 71 is a transverse cross sectional view taken from FIG. 68 through the lid assembly of the cask;

FIG. 72 is a perspective view of a spend nuclear fuel (SNF) assembly;

FIG. 73 is a longitudinal cross sectional view of the cask;

FIG. 74 is an enlarged detail from FIG. 73;

FIG. 75 is a perspective view of a pressure surge capacitor of the cask;

FIG. 76 is a side view thereof;

FIG. 77 is an end view thereof;

FIG. 78 is a side cross sectional view thereof;

FIG. 79 is an exploded end perspective view thereof;

FIG. 80 is an enlarged detail of the cask taken from FIG. 63;

FIG. 81 is a transverse cross sectional view of the cask taken from FIG. 68;

FIG. 82 is a cross-sectional perspective view of the cask showing the pressure surge capacitor in a first mounting location in the cask;

FIG. 83 is a transverse cross-sectional of the cask showing the pressure surge capacitor in a second mounting location in the cask;

FIG. 84 is a transverse cross-sectional of the upper end of the cask showing the pressure surge capacitor in a third mounting location in the cask;

FIG. 85 is a perspective view of a fuel storage canister for storing high level nuclear radioactive waste material such as spent nuclear fuel;

FIG. 86 is a top perspective view of an above-grade passively cooled and ventilated cask according to the present disclosure for storing the canister;

FIG. 87 is an enlarged detail taken therefrom;

FIG. 88 is side view of the cask;

FIG. 89 is a first cross-sectional perspective view thereof;

FIG. 90 is an enlarged detail taken from FIG. 89;

FIG. 91 is a second cross-sectional perspective view of the cask;

FIG. 92 is a transverse cross-sectional view thereof showing the air inlet ducts;

FIG. 93 is a third cross-sectional perspective view of the cask showing details of the inlet ducts;

FIG. 94 is a perspective view of the bottom baseplate of the cask and air inlet duct structure;

FIG. 95 is a second top perspective view of the cask;

FIG. 96 is an enlarged detail of an air inlet duct of the cask taken from FIG. 95 and showing the adjustably movable shutter plate of the air inlet duct in a first upper operating position;

FIG. 97 is a view thereof but showing the adjustably movable shutter plate of the air inlet duct in a second lower operating position;

FIG. 98 is an enlarged side view of the air inlet duct of FIG. 96 showing the adjustably movable shutter plate in the first upper operating position associated with a first open flow area;

FIG. 99 is an enlarged side view of the air inlet duct of FIG. 97 showing the adjustably movable shutter plate in the second lower operating position associated with a second open flow area smaller than the first open flow area;

FIG. 100 is a top perspective view of a partial below-grade passively cooled and ventilated cask according to the present disclosure for storing the fuel storage canister, the cask body (shells) being shown embedded in embedment materials and the top lid exposed above grade;

FIG. 101 is a side view thereof;

FIG. 102 is a top view thereof;

FIG. 103 is a top perspective view of the cask alone without embedment materials;

FIG. 104 is a bottom perspective view thereof;

FIG. 105 is an exploded view thereof;

FIG. 106 is a side view thereof;

FIG. 107 is a first side cross-sectional view thereof showing the embedment materials;

FIG. 108 is an enlarged detail therefrom;

FIG. 109 is a second side cross-sectional view thereof showing the embedment materials and outlet air duct and air inlet ducts of the lid;

FIG. 110 is an enlarged detail therefrom;

FIG. 111 is an enlarged detail therefrom;

FIG. 112 is a top perspective view of the embedded cask showing the exposed lid which remains above grade and a flow restrictor comprising an orifice plate at the outlet opening of the air outlet duct in the lid;

FIG. 113 is a bottom perspective view of the weather protection cap structure of the lid;

FIG. 114 is a bottom perspective view of the lid cover structure;

FIG. 115 is a top perspective view of the flow restrictor;

FIG. 116 is a perspective view of an ISFSI facility comprising a first embodiment of a nuclear waste storage system according to the present disclosure for consolidated interim storage of spent nuclear fuel and other high level radioactive nuclear waste materials;

FIG. 117 is a top plan view thereof;

FIG. 118 is a perspective view of one of the nuclear waste storage rows of the ISFSI facility of FIGS. 116 and 117;

FIG. 119 is a first cross sectional view of a second embodiment of a nuclear waste storage system showing a cavity enclosure container (CEC) and cooling air feeder shell thereof;

FIG. 120 is a second cross sectional view thereof of the CEC alone;

FIG. 121 is a top plan view of an arrangement of multiple CECs of the second embodiment;

FIG. 122 is a perspective view of one nuclear waste storage row according to the second embodiment;

FIG. 123 is a top perspective view of the first embodiment of a nuclear waste storage system of FIGS. 116-118 showing one of the modular nuclear waste storage units including a CEC; pair of directly fluidly coupled cooling air feeder shells all mounted on a common support plate;

FIG. 124 is a bottom perspective view thereof;

FIG. 125 is a first lateral side view thereof;

FIG. 126 is a second lateral side view thereof;

FIG. 127 is a front view thereof;

FIG. 128 is a top view thereof with the top lid in place on the CEC;

FIG. 129 is a top view thereof with the top lid removed to show the internal cavity of the CEC;

FIG. 130 is a top view thereof with the top air intake housing removed from the pair of cooling air feeder shells to reveal the array of radiation attenuator plates therein;

FIG. 131 is a top perspective view thereof;

FIG. 132 is a cross-sectional perspective view thereof showing the modular nuclear waste storage unit installed on a concrete base pad below grade, a concrete top pad, and engineered fill therebetween;

FIG. 133 is a cross-sectional side view thereof;

FIG. 134 is a cross-sectional side view thereof showing multiple CECs and cooling air feeder shells; in part of the nuclear waste storage row of FIG. 118; and

FIG. 135 is a top view of a third embodiment of a nuclear waste storage system according to the present disclosure showing a pair of CECs and cooling air feeder shells.

All drawings are schematic and not necessarily to scale. Features shown numbered in certain figures which may appear un-numbered in other figures are the same features unless noted otherwise herein. A general reference herein to a figure by a whole number which includes related figures sharing the same whole number but with different alphabetical suffixes shall be construed as a reference to all of those figures unless expressly noted otherwise.

### DETAILED DESCRIPTION

The features and benefits of the invention are illustrated and described herein by reference to non-limiting exemplary (“example”) embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range. In addition, any references cited herein are hereby incorporated by reference in their entireties. In the event of a conflict in a definition in the present disclosure and that of a cited reference, the present disclosure controls.

The terms “seal weld or welding” if used herein shall be construed according to its conventional meaning in the art to be a continuous weld which forms a gas-tight hermetically sealed joint between the parts joined by the weld. The term “sealed” as may be used herein shall be construed to mean a gas-tight hermetic seal.

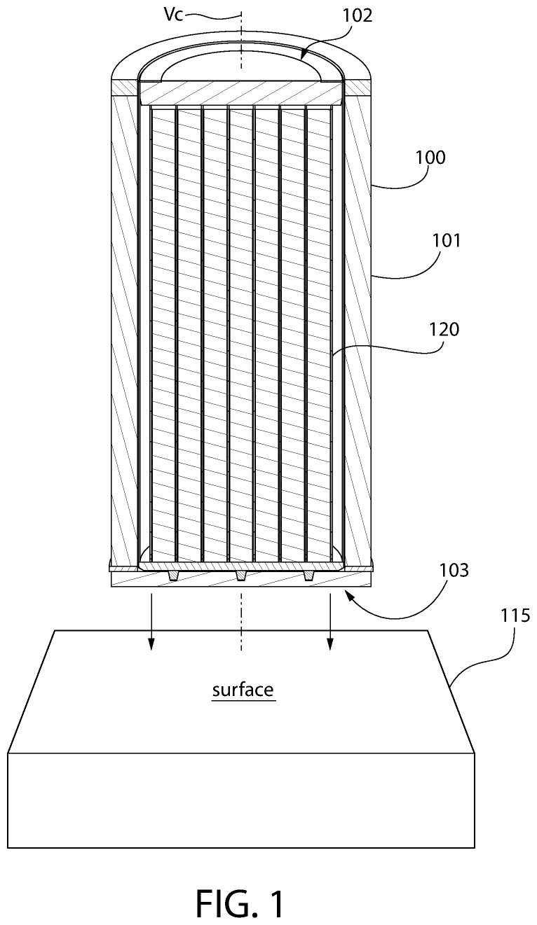

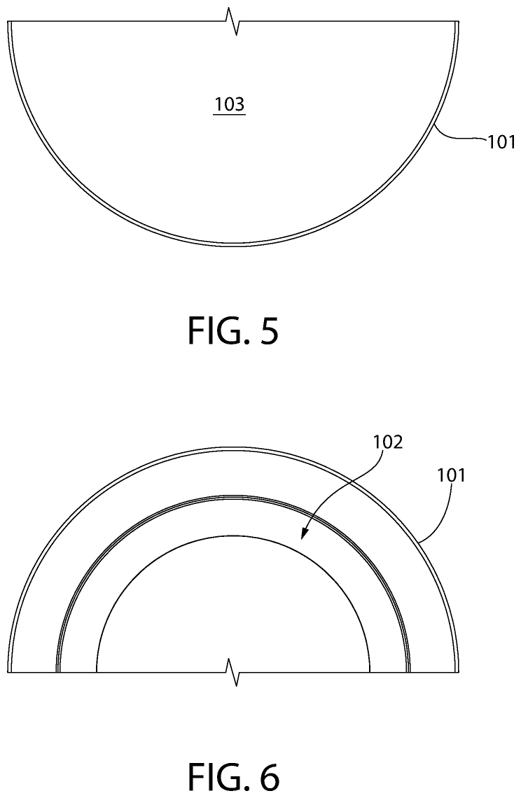

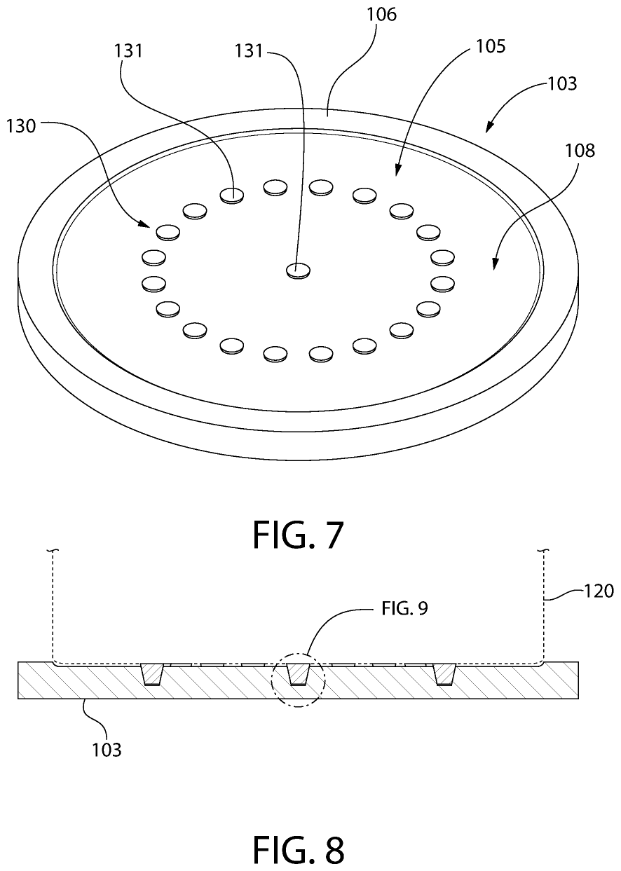

FIGS. 1-13 depicts various aspects of an impact amelioration or limiter system associated with nuclear waste storage systems comprising vessels used in the storage of spent nuclear fuel (SNF) or other irradiated high level radioactive waste materials removed from the nuclear reactor containment. The amelioration system generally comprises an outer transfer overpack or cask 100 and a waste fuel (e.g. SNF) canister 120 configured for storage inside the cask. Features of each storage vessel and the impact amelioration system will now be further described.

Canister 120 may be used for storing any type of high level radioactive nuclear waste, including without limitation spent nuclear fuel (SNF) or other forms of radioactive waste materials removed from the reactor. The SNF or simply fuel canister for short may be any commercially-available nuclear fuel/waste storage canister, such as a multi-purpose canister (MPC) available from Holtec International of Camden, N.J. or other.

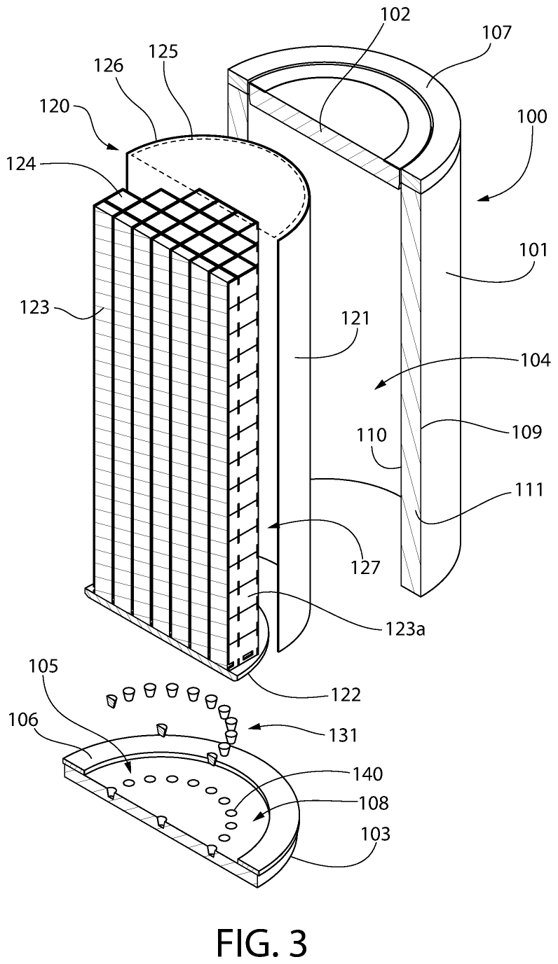

Canister 120 has a vertically elongated and metallic body comprised of a cylindrical shell 121 extending along a vertical centerline Vc which passes through the geometric center of the shell. Canister 120 includes a bottom baseplate 122 seal welded to a bottom end of the shell, and an open top 126 which may be closed by an attached lid 125 (schematically shown in dashed lines in FIG. 3 to avoid obscuring other aspects of the image). Lid 125 may be seal welded to a top end 126 of the canister shell 121 to form a hermetically sealed cavity 127 inside the canister. The foregoing canister parts may be formed of any suitable metal, such as for example without limitation steel including stainless steel for corrosion protection.

Fuel basket 123 is disposed in cavity 127 of the canister 120 and is seated on the bottom baseplate 122 as shown. The fuel basket may be welded to the baseplate for stability in some embodiments. In some embodiments, the baseplate 122 may extend laterally outwards beyond the sides of the fuel basket 123 around the entire perimeter of the fuel basket as shown.

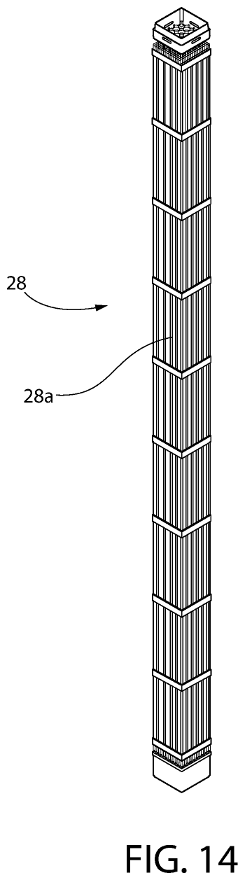

The fuel basket 123 is a honeycomb prismatic structure which in one embodiment may be formed by a plurality of interlocked and orthogonally arranged slotted plates 123a built up to a selected height in vertically stacked tiers. The plates of fuel basket 123 define a grid array of plural vertically-extending openings forming fuel assembly storage cells 124. Each cell is configured in cross-sectional area and shape to hold a single U.S. style fuel assembly 28, which contains multitude of spent nuclear fuel rods 28a (or other nuclear waste). An exemplary fuel assembly of this type having a conventional rectilinear cross-sectional configuration is shown in FIG. 14. Such fuel assemblies and the foregoing fuel basket structure are well known in the industry. The open cells 124 of the fuel basket are defined by the orthogonally intersecting slotted plates 210, and therefore have a concomitantly rectilinear cross-sectional shape (e.g. square). This gives the fuel basket an overall compound rectilinear polygonal shape in transverse cross section as shown which includes multi-faceted and stepped exterior peripheral side surfaces collectively defined by the flat lateral peripheral sidewalls of the outermost exterior slotted plates 123a.

Transfer cask 100 has a vertically elongated metallic body including a cylindrical shell 101, circular top closure plate 102 attached to the top end of the shell, and a circular bottom closure plate 103 attached to the bottom end of the shell. A top ring plate 107 may be provided which is fixedly attached to the top end of shell 101 such as via welding. A bottom ring plate 106 may be fixedly attached (e.g. seal welded) to the upper or top surface 105 of the bottom closure plate 103 at its periphery; which ring plate in turn is fixedly attached (e.g. seal welded) to the bottom end of the shell 101. The top closure plate 102 may also be seal welded to the shell 101, or in some embodiments may instead be bolted and gasketed to the cask instead to provide easier access to the canister 120. An internal cavity 104 is defined by the cask which extends for a full height of the cask. The cavity 104 is configured in dimension and transverse cross-sectional area to hold only a single fuel canister 120 in some embodiments as is conventional practice in the art.

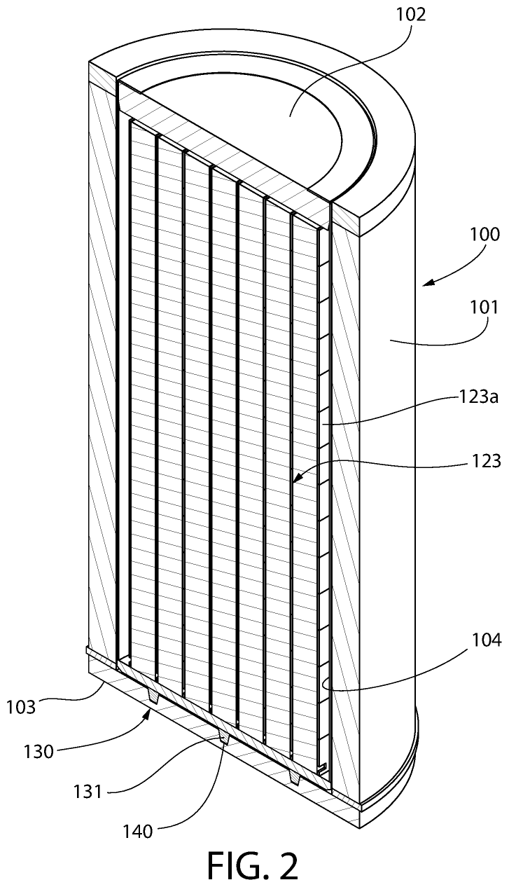

The circular bottom closure plate 103 of cask 100 may be considered somewhat cup-shaped in one embodiment in view of the raised bottom ring plate 105 which rises up a short distance above the horizontal flat top surface 105 of the bottom closure plate. This construction defines a recessed canister seating area 108 which helps center and stabilize the canister 120 when loaded into the cask. The bottom baseplate 122 of canister 120 is at least partially received in the recessed canister seating area as shown in FIGS. 1 and 2.

The cask 100 is a heavy radiation shielded storage vessel. The cylindrical shell 101 of cask 100 forms a sidewall which may have a composite construction including an outer shell member 109, inner shell member 110, and radiation shielding material(s) 111 disposed between the shell members. In some embodiments, the shielding material 110 may comprise concrete, lead, boron-containing materials, or a combination of these or other materials effective to block and/or attenuate gamma and neutron radiation emitted by the nuclear waste (e.g. fuel assemblies) stored in canister 120 when loaded into the cask 100. Any suitable types, thicknesses, and arrangement of shielding materials may be used to provide the necessary degree of shielding.

The outer and inner shell members 109, 110 of the cylindrical shell 101 of cask 100 may be formed of a suitable metal such as steel. The top and bottom closure plates 102, 103, and the top and bottom ring plates 107, 106 may similarly be formed of metal such as steel.

In conventional cask construction and deployment, the canister is seated directly onto the bottom closure plate of the cask 100 in an abutting relationship. A flat to flat interface is formed between the entirety of the bottom baseplate of the canister and the bottom closure plate of the cask. In the event the cask with canister loaded therein is dropped onto an immovable/stationary hard surface (e.g. top of concrete slab 115 or other relatively hard/compacted material) as shown in FIG. 1, there is no impact protection for the canister which might decrease the g-load or force resulting from the impact force of the cask striking the surface. The kinetic energy of the resultant impact force generated by the drop is transmitted through the bottom closure plate of the cask directly to the baseplate of the canister and then to fuel assemblies therein, which typically rest directly on the baseplate. The structural integrity of the nuclear fuel assemblies and SNF therein are therefore exposed to damage due to the unmitigated g-load or forces resulting from the drop event.

The present disclosure provides an impact amelioration or limiting system configured to absorb and minimize the actual g-load/force transmitted through the cask 100 during a drop event to protect the fuel canister 120. With continuing general reference to FIGS. 1-13, the amelioration system may comprise a plurality of impact limiter assemblies arranged at the lower canister to cask interface (i.e. bottom of canister baseplate 122 to top of cask bottom closure plate 103).

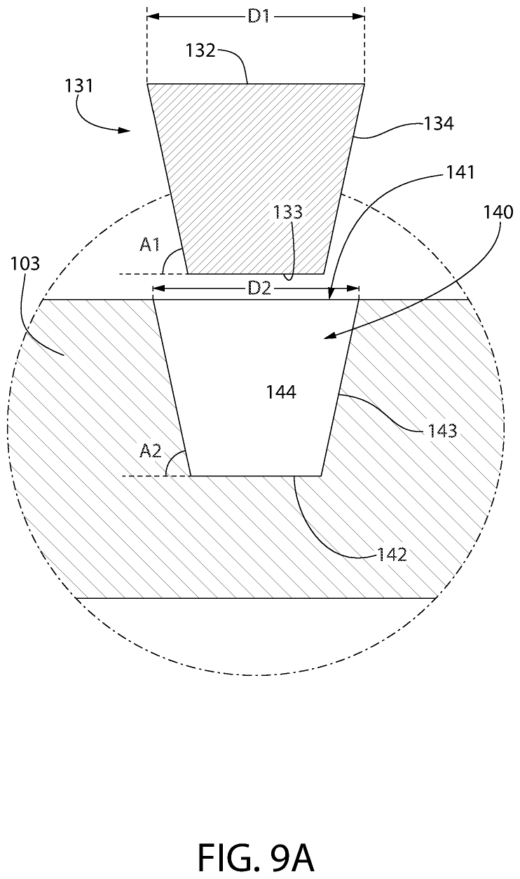

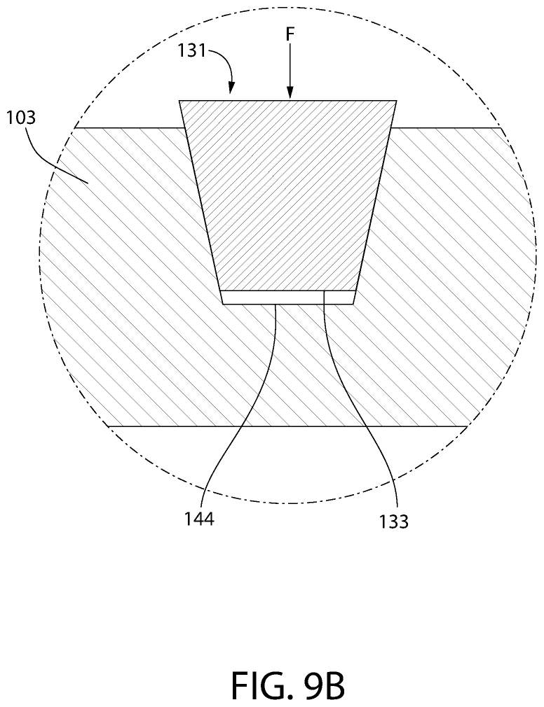

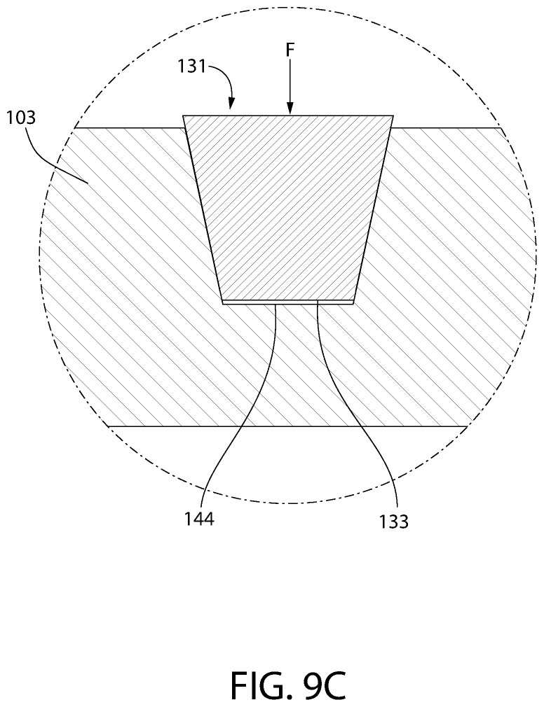

In one embodiment with specific initial reference to FIGS. 1-9C, the impact limiter assemblies 130 each comprise an impact limiter rod or plug 130 and a corresponding plug hole 140. Plug holes 140 may be complementary configured to the plugs 131 in shape/profile. In one embodiment, the sides of the plugs and plug holes may each be tapered. In one embodiment, the plugs 131 may have a frustoconical shape and at least a portion of the plug holes 140 may have a complementary frustoconical shape. In the embodiment shown in FIGS. 9A-C, the entire plug hole 140 is frustoconical in shape from top to bottom.

The impact limiter plugs 131 may comprise a solid body including a top surface 132, bottom surface 133, and sides 134 extending therebetween. The top surface may be flat and larger in surface area than the bottom surface defining an overall wedge-shaped plug. The bottom surface 133 may also be flat as shown and parallel to the top surface 132. Accordingly, sides 133 may be tapered having an angle of taper A1 which defines a plug body having a frustoconical shape as shown.

Plug holes 140 may be complementary configured to the plugs 131. Plug holes 140 comprise an open top 141 configured for at least partially receiving and embedding the plugs 131 therein, a flat closed bottom 142 formed by the cask bottom closure plate 103, and tapered sidewalls 143 extending therebetween. The open top may have larger projected open area than the closed bottom defined by bottom surface 144 of the plug hole defining a wedge-shaped hole. Accordingly, sidewalls 143 of plug hole 140 may be tapered having an angle of taper A2 which defines a plug hole having a frustoconical shape as shown. In certain embodiments, angle of taper A2 of the plug holes 140 may be the same as the angle of taper A1 of the impact limiter plugs 131. The plugs however may have a maximum diameter D1 defined by the top surface 132 which is slightly larger than the diameter D2 of the open top 141 of plug holes 140 such that the plugs cannot fully enter the plug holes and contact their bottom surfaces 144 (see, e.g. FIG. 9B in the pre-impact embedment position of the plugs in the holes). The slight oversizing of the plugs 131 and mating tapers of the plugs and their associated plug holes 140 create frictional engagement therebetween the mutually engaged plug sides 134 and plug hole sidewalls which retains the plugs in position spaced vertically above from the bottom surface 144 of the plug holes. The bottom surface 133 of plugs 131 may also be larger in diameter than the bottom surface 142 of the plug holes 140. Accordingly, the slightly larger diameter plugs 131 are prevented from slipping completely into the plug holes 140 to the bottom even though the angle of tapers A1, A2 may be the same for each feature (see, e.g. FIG. 9B pre-impact frictionally engaged position of plugs).

In certain exemplary embodiments, the angles of taper A1 and A2 of the plugs 131 and plug holes 140 respectively may be between 30 and 90 degrees, and more preferably between 60 and 90 degrees. The angles of taper A1 and A2 may be about 82 degrees (+/−3 degrees to account for fabrication tolerances) as one non-limiting example. Other suitable taper angles may be used.

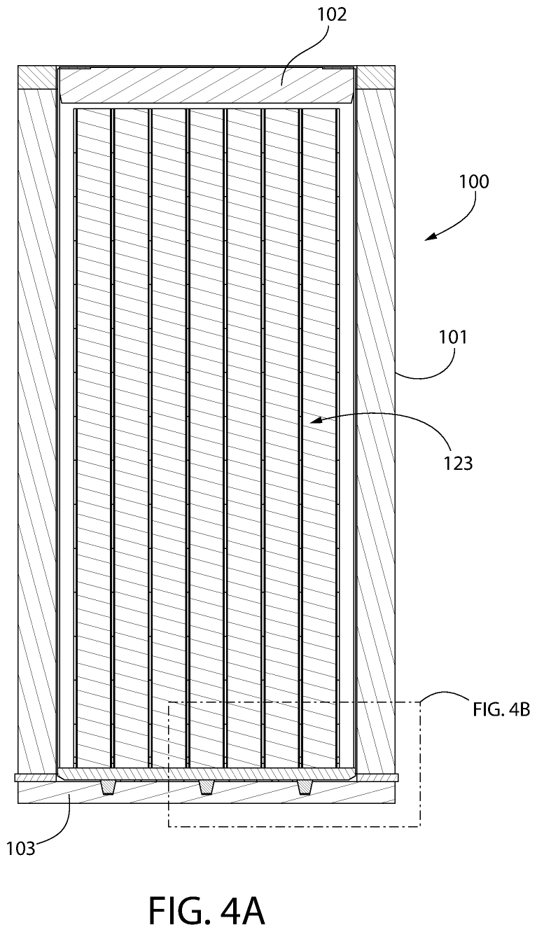

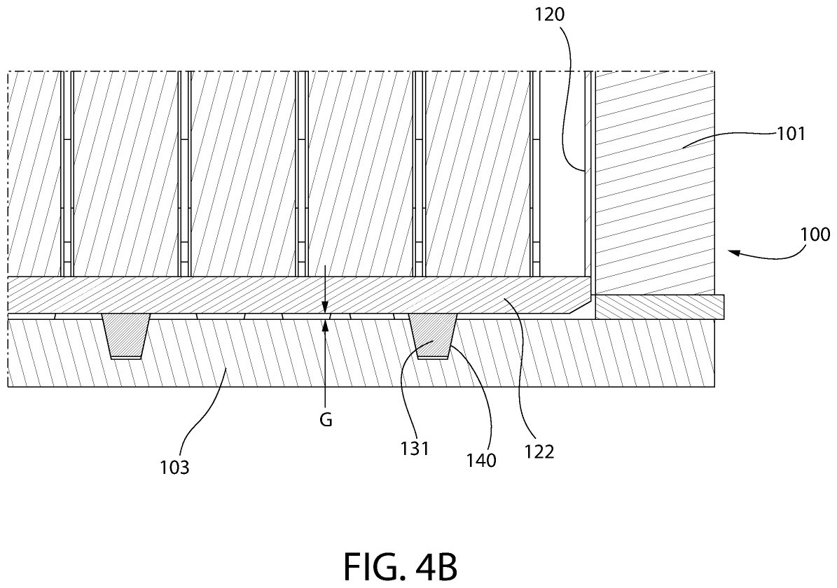

When the impact limiter plugs 131 are securely embedded in and frictionally engaged with the plug holes 140 such that the plugs are retained and cannot easily be removed by hand (see, e.g. FIG. 9B), the upper portions of the plugs protrude upward above the top surface 105 of the cask bottom closure plate 103 as shown. Top surfaces 132 of the plugs 131 are therefore elevated above the closure plate 103 forming plateaus or pedestals which collectively act as a seating surface to engage and support the bottom baseplate 122 of the canister 120 in a raised manner elevated above the top surface of the bottom closure plate. When the canister is positioned on the plugs 131, the canister is therefore spaced apart from the bottom closure plate 103 (i.e. top surface 105 thereof) by a vertical space or gap G (see, e.g. FIG. 4B). The gap G advantageously provides a buffer or cushion zone allowing the canister to gradually move downwards in the cask 100 as the plugs 131 elastoplastically deform while moving deeper into the plug holes under the kinetic impact forces generated by the cask striking a hard surface during a drop event (see, e.g. FIG. 1). The impact limiter plugs 131 deform and progress deeper in plug holes 140 due to the resultant impact forces (i.e. canister against the plugs) to decelerate the canister motion and reduce the g-load which protects the canister 120 and fuel assemblies therein. This is demonstrated in the test example described further below.

FIG. 9A shows a single impact limiter plug 131 positioned above and ready for insertion/embedment in its mating plug hole 140. To install the plug, the plug is loosely inserted and then partially driven into the plug hole by a striking device such as a hammer or other device until the plug becomes snuggly fitted in and frictionally engaged with the sidewalls 143 of the hole. This eliminates looseness of the plugs while the canister 120 is loaded into the cask 100. The frictionally and mutually engaged tapers of the sides 134 of plugs 131 and plug hole sidewalls 143 thus retain the fitted plugs in the holes via a friction fit. The plugs therefore are not loosely placed in the plug holes, but rather cannot be removed by hand when properly installed. The plugs are now partially embedded in their respective plug holes as shown in FIG. 9B and ready for service to receive and seat the canister 120 thereon when loaded into the cask 100. In this pre-impact position shown, the bottom surface 133 of plug 131 is spaced vertically apart from the bottom surface 144 of the plug hole 140. This provides space for the plug to move deeper into the plug hole as the plug is forced inwards into the hole as it undergoes elastoplastic deformation due to impact forces generated by the drop event.

In the occurrence of a cask drop event (see, e.g. FIG. 1), the cask 100 falls vertically for a distance and may strike/impact a hard surface such as that defined by a. concrete pad/slab 115. This accident may occur if the cask rigging or hoist mechanism associated with a track-driven cask crawler, which is commonly used in the industry for lifting/lowering and transporting the cask with fuel canister 120 therein, were to fail. However, other scenarios of dropping the cask, or dropping canister into the cask while loading it therein, are possible as well. The bottom closure plate 103 of the cask is the first containment vessel to impact the immovable hard surface and decelerate to zero acceleration due to gravity. The momentum of the falling canister 120 inside the cask 103 resulting from the drop causes the canister to continue its downward motion momentarily (e.g. fraction of a second) until its movement is in turn fully arrested by engagement with the impact limiter plug assemblies 130 on the bottom closure plate 103 of cask 100. The baseplate 122 of the canister 100 may remain engaged with the impact limiter plugs 131 during the fall or may slightly move ajar, depending on the height of the drop and relative weights of the cask and canister (cask typically being heavier due to its thick sidewalls which may include concrete for radiation shielding). In either event, the impact force F (g-load/force) of the canister against the impact limiter plugs 131 illustrated in FIG. 9B causes the plugs to become driven deeper into their respective plug holes 140 by overcoming the interfacial frictionally engagement forces between the sides 134 of the plugs and corresponding hole sidewalls 143 and elastoplastic deformation of the metallic plugs. This deeper second position of the plugs 131 in the holes 140 is shown in FIG. 9C. In this figure, the bottom surfaces 133 of the now more deeply embedded plugs after impact (“post-impact position) are separated from the bottom surface 144 of the plug holes by a lesser distance or space by comparison than the “pre-impact” plug position shown in FIG. 9B. Similarly, the tops of the impact limiter plugs may still protrude upward beyond the top surface 105 of the cask bottom closure plate 103, but also by a lesser amount or distance than pre-impact. In some impact events scenarios and embodiments, the tops of the plugs may be driven completely flush with the top surface of the bottom closure plate.

Due to the impact of the falling cask scenario (drop event), the plugs 131 concomitantly undergo some degree of elastoplastic deformation as they are driven deeper into their respective plug holes 140. In some cases depending on the angles of tapers A1, A2 and sizes used for the plugs and holes, and other parameters such as the metal material selected for the plugs versus the cask bottom closure plate 103, the plugs may possibly contact the bottom surface 144 of the holes depending on the magnitude of the kinetic impact force (which equates to the height of drop). In some instances, the tops of the plugs may possibly deform and mushroom due to the impact force which may reduce the penetration depth of the plugs in the holes. In either case, the deformation and frictional engagement of the plugs 131 with the sidewalls 143 of the plug holes 140 absorbs at least some of the impact force and causes the canister 120 to more gradually decelerate, thereby decreasing the g-load imparted on the canister to better protect the structural integrity of the canister and fuel assemblies stored therein. In sum, under impact, the tapered plugs 131 would advance inside the tapered holes 140 as the kinetic impact energy is dissipated by the combined action of interfacial friction therebetween and the elastic/plastic expansion action or deformation of the plugs in the plug holes.

The principal engineering parameters of the impact amelioration system such as the material selected for the tapered impact limiter plugs 131 in contrast to the cask bottom closure plate 103 which defining the corresponding plug holes 140, angle of taper A1 and A2 of the plugs and holes, plug diameter, and the number and pattern/arrangement of plugs on the bottom closure plate make possible to decrease the peak g-load imparted to the canister 120 during a cask drop event significantly.

In one non-limiting arrangement, a first group or cluster of impact limiter plug assemblies 130 (pairs of tapered plugs 131 and mating plug holes 140) may be arranged in a circular array on the bottom closure plate 103 of the cask 100 (see, e.g. FIGS. 3-4 and 7-8). The plug assemblies are circumferentially spaced apart as shown. Depending on the diameter D1 of the plugs 131, additional circular arrays may be added inside and/or outside of the array shown. Iii some embodiments, one or more a center plug assemblies 130 may be located centrally with respect to and inside of the circular array. A single plug assembly located at and intersecting the vertical centerline Vc of the canister may be provided in some embodiments. In other embodiments, a cluster of center plug assemblies 130 may be provided and arranged in any suitable pattern within the outer circular array of assemblies. The plug assemblies 130 are located within the recessed canister seating area 108 of the cask bottom closure plate 103 inside the raise annular bottom ring plate 106 as shown. This is the area which receives the bottom baseplate 122 of the fuel canister 120.

In other less preferred but possible embodiments contemplated, the arrangement of the plug assemblies 130 may be reversed to that shown. Accordingly, the plug holes 140 may be downward facing openings formed in the base plate 122 of canister 120 provided if the base plate is sufficiently thick. The tapered the plugs 131 may be embedded in the holes and protrude downwards from the base plate to engage the top surface of the cask bottom closure plate 103 when the canister is loaded therein.

### Test Example

To demonstrate the impact amelioration system concept, the case of a falling transfer cask 100 containing an MPC (canister 120) is considered with reference to FIG. 1. The transfer cask is assumed to fall from a height of 6.56 feet in this postulated scenario onto a reinforced concrete pad or slab 115. The following data characterizes the physical/mechanical parameters of the computer simulated drop test: weight of transfer cask 100 body: 120,000 pounds; weight of the loaded MPC 120: 90,000 pounds; MPC diameter 75¾ inches; thickness of the transfer cask baseplate 103: 5½ inches; Material of impact limiter rod or plug: ASME/ASTM SA479 stainless steel; Material of cask bottom closure plate 103: ASME/ASTM SA516 Grade 70.

Calculations using LS-DYNA (a state-of-the-art impact dynamics code widely used in the industry) showed the peak deceleration of the MPC to be 262 g's when the transfer cask is dropped with the MPC resting directly onto the transfer cask baseplate without impact limiter assemblies 130. Next, using the present impact amelioration system disclosed herein, the cask's bottom closure plate 103 was equipped with 16 circumferentially arranged impact limiting plugs 131 of 4-inch diameter (D1) and 82 degree included angle of taper (A1) each situated in frustoconical plug holes 140 also with 82 degree included angle of taper (A2). An equal sized impactor at the centerline Vc of the MPC 120 was also employed. When this second configuration with impact limiter assemblies 130 was employed, the peak deceleration of the MPC dropped down to 180 g's. The impact limiter plugs 131 were driven into and advanced in the holes by only 0.13 inch to achieve this substantial reduction in g-load. Therefore, by reducing the angle of taper in other configurations, the penetration of the plugs 131 into the plug holes 140 can be further increased, and the g-load correspondingly reduced further. Accordingly, the foregoing analysis demonstrates the benefits of present impact amelioration system for reducing the g-load on the canister and protecting the canister and fuel assemblies stored therein.

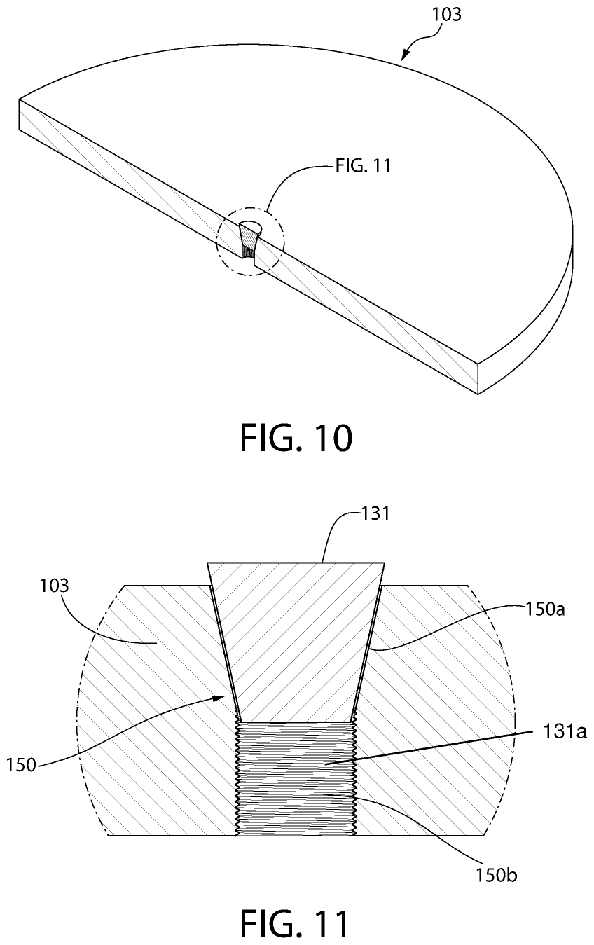

FIGS. 10 and 11 show an alternate embodiment of an impact limiter assembly. In this embodiment, the plug hole 150 includes an upper tapered portion 150a similar to that previous described herein which is frustoconical shaped. The adjoining lower portion 150b of the plug holes 150 comprises sacrificial threads configured to deform under shear forces imparted by the plugs 131 when the plugs are driven deeper into the plug holes under impact during a cask drop event. The plugs 131 have a mating threaded bottom extension 131a engaged with the threaded hole. Shearing of the threads as the plug 131 is driven deeper into the plug hole 150 after a cask drop event serves to extract impact energy from the fall. The deformation of sacrificial threads in conjunction with the frictional forces acting between the plug and hole sidewalls mutually contribute and act in unison to absorb the g-forces acting on the canister 100 during the drop event. The threaded lower portion 150b of the plug holes 150 may extend complete through the bottom surface of the cask bottom closure plate 103, or in other embodiments may have a closes bottom which does not penetrate the bottom surface of the closure plate. Either embodiment may be used. It bears noting that the threaded impact limiter plugs 131 also facilitate installation of the plugs by simply rotating the plugs to threadably engage the threaded plug holes 150, thereby retaining the plugs until the canister 120 is loaded into the transfer cask 100.

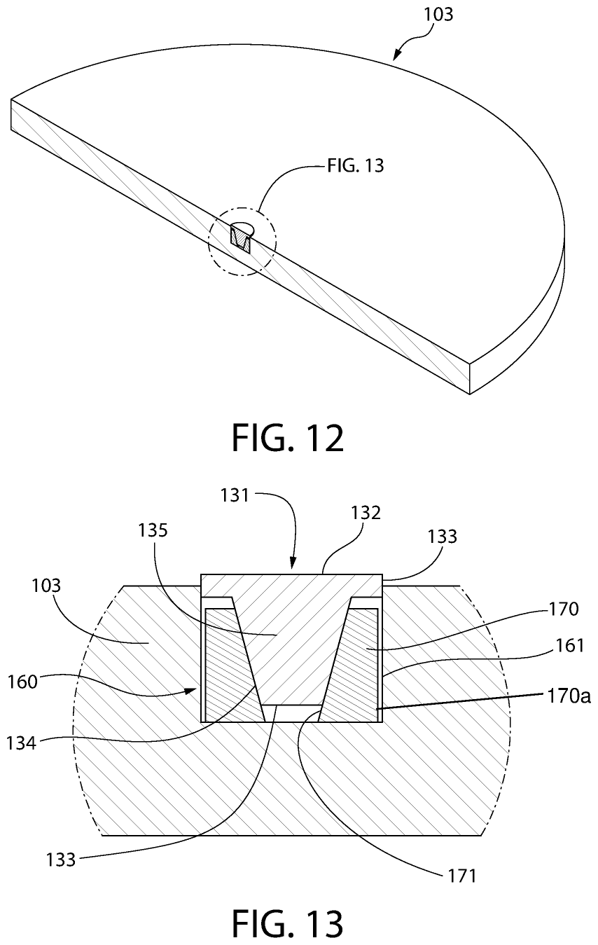

FIGS. 12 and 13 show yet another embodiment of an impact limiter assembly. In this embodiment, the plug hole 160 has straight sidewalls 161 and a closed bottom. An annular expansion ring 170 is seated in plug hole 160. Expansion ring 170 includes straight exterior sides 170a and a vertical tapered central opening 171 of frustoconical shape which may extend completely through the ring as shown. The opening 171 defines corresponding frustoconical walls which may be complementary configured in angle of taper to the angle of taper A1 of the plug 131. The top surface of the expansion ring 170 may be recessed within in plug hole 160 below the top surface 105 of the cask bottom closure plate 103 as shown.

In this present embodiment of FIGS. 12 and 13, impact limiter plug 131 retains a frustoconical shaped central portion 135 but adds a radially protruding peripheral flange 133 at the top of the plug as shown. The plug with flange may have a diameter measured at its top surface (similar to diameter D1) which in this case is smaller than the top opening of the plug hole 160 such that the flange can at least enter the plug hole 160 as shown. The central portion 135 of plug 131 still frictionally engages the central opening 171 of the expansion ring 170 to retain the plug in place in the pre-impact position shown. Preferably, the expansion ring 170 is sized in outer diameter so that a small annular space is formed between the sides of the ring and the sidewalls 161 of plug hole 160. This provides room for the ring 170 to expand under impact forces after a cask drop event.

In operation after the cask 100 is dropped, the impact limiter plug 131 is driven deeper into tapered central opening 171. The impact force F acting on the mating tapered/angled surfaces of the plug and expansion ring 170 within the central opening 171 has a lateral/horizontal force component (in additional to a vertical force component) as well understood by those skilled in the art. The horizontally acting force component deforms and expands the ring radially outwards as it is squeezed between the plug 131 and plug hole 160 to close the annular space between the ring and plug hole 160 sidewalls 161. In some instances, the ring may possibly engage the sidewalls 161 as it radially expands. The expansion ring in combination with mating tapered surfaces of the impact limiter plug 131 and expansion ring 170 act in unison to absorb and reduce the g-load imparted to the canister 120 during the cask drop event. The peripheral flange 133 of plug 131 may completely enter the plug hole 160. FIG. 13 shows the pre-impact position of the plug in the impact limiter assembly. Expansion ring 170 may be formed of any suitable metallic or non-metallic material. Preferably, the ring is formed of a material having greater ductility (i.e. softer) than the plug 131 to facilitate the expansion of the ring. In one embodiment, the expansion ring 170 is formed of metal such as steel or aluminum. In other embodiments, the ring may be formed a non-metallic material such as a dense polymer.

In view of all the foregoing embodiments of an impact amelioration system, the included taper angles of the tapered plugs 131 and plug holes 140, their material of construction and dimensions, number and arrangement/pattern of impact limiter assemblies 130 on the cask bottom closure lid 130, number and type of threads used in the embodiment of FIGS. 10-11, the height/thickness and material of the optional expansion ring 170 used in the embodiment of FIGS. 12-13, and other aspects are among the parameters that can be varied to obtain the optimal energy extraction for a specific impact scenario to protect the canister 120 and its waste fuel contents from severe damage.

The impact limiter plugs 131 can generally advance in the hole primarily by expanding/deforming the plugs in an elastoplastic manner which exceeds the yield stress of the material, and by overcoming the friction at the tapered/angled interface between the plug and mating plug holes. The plugs are therefore preferably formed of a metallic elastoplastic material such as without limitation steel which undergoes elastic and plastic deformation when the load/force exceeds the yield stress of the material. Plastic deformation beyond the yield stress connotes that the plug will retain permanent deformation and not return to its original condition (e.g. shape and dimensions). Depending on the material selected for the cask bottom closure plate 103, the sidewalls of the plug holes may similarly undergo elastic-plastic deformation to absorb some of the kinetic impact energy resulting from a cask drop event.

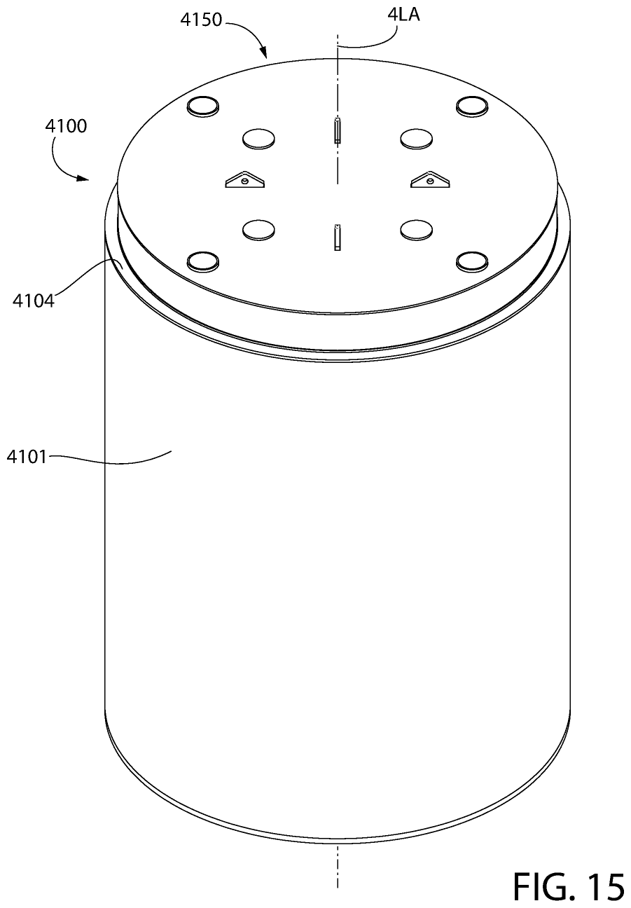

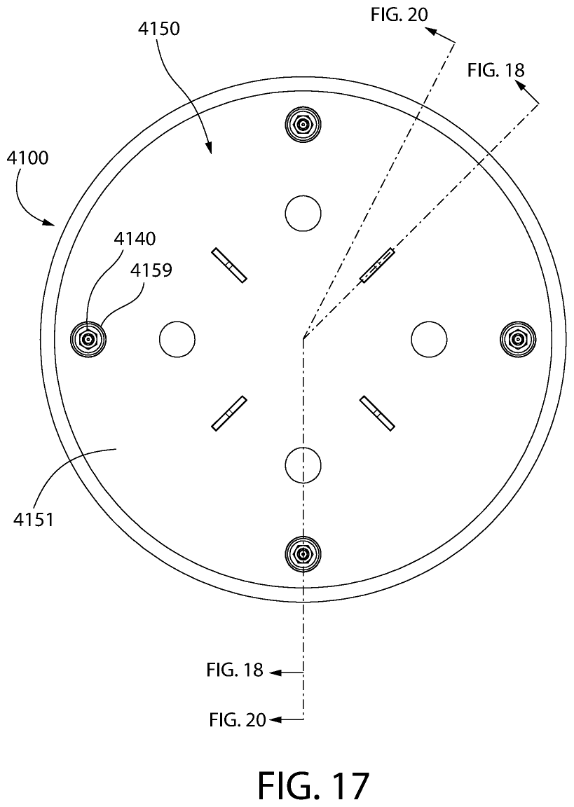

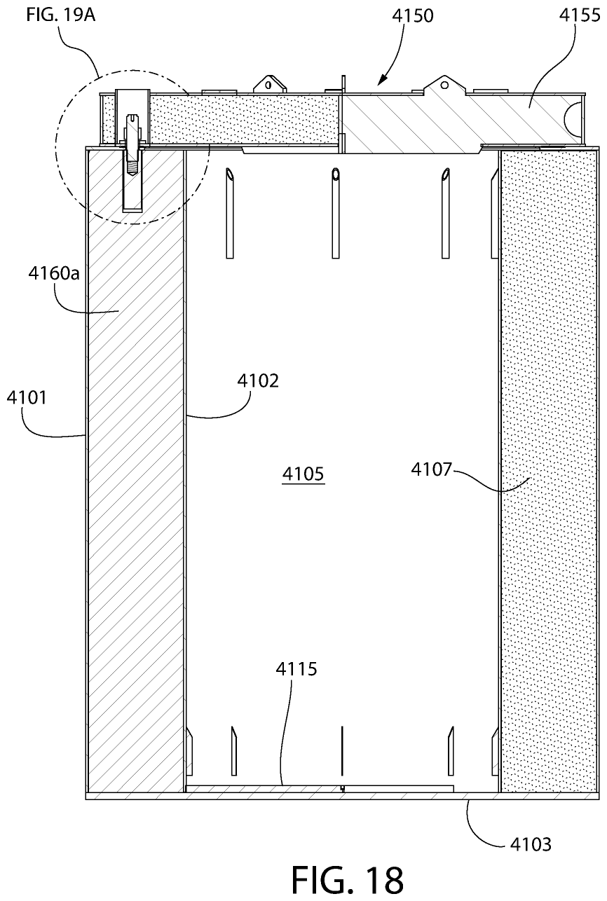

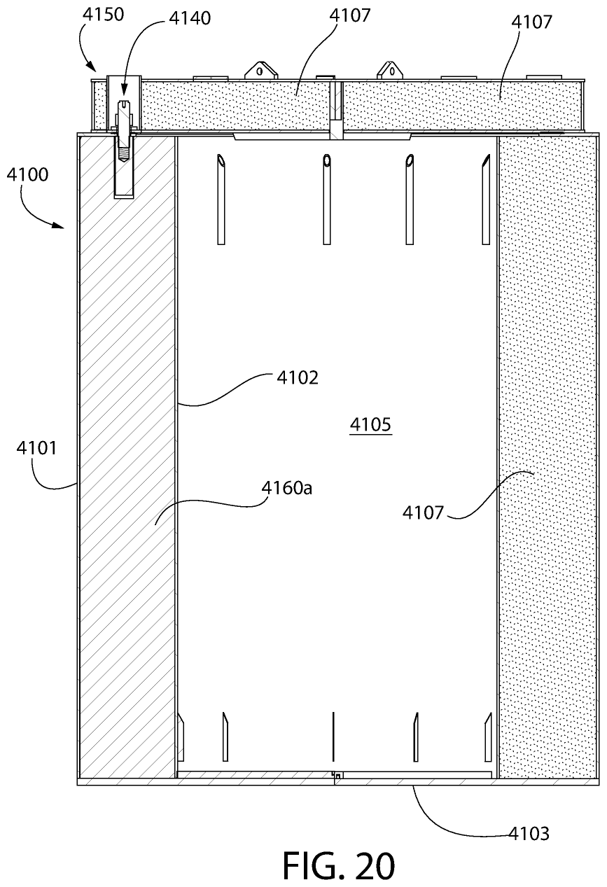

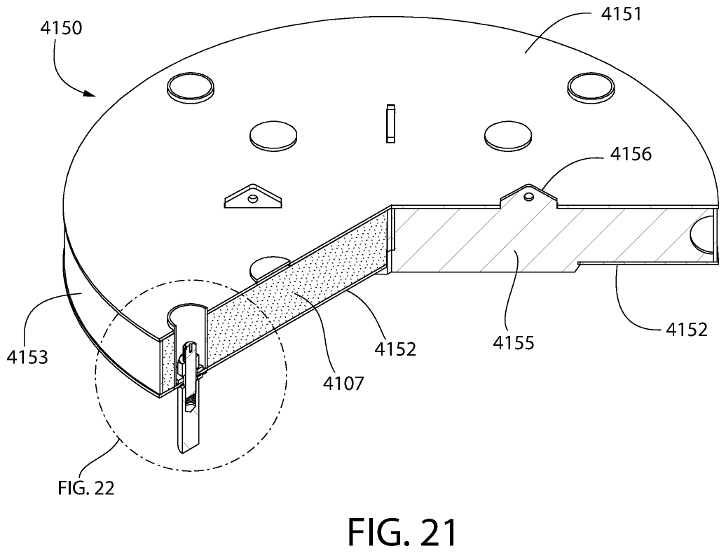

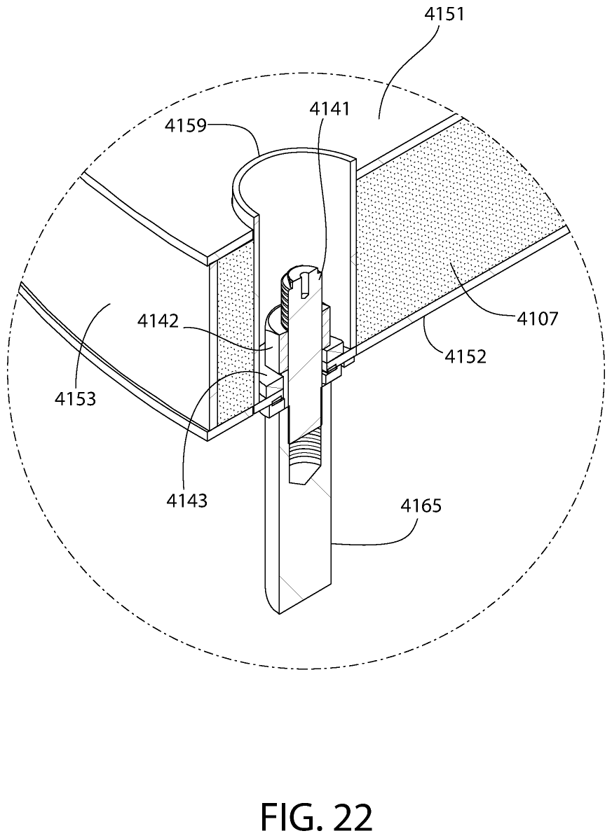

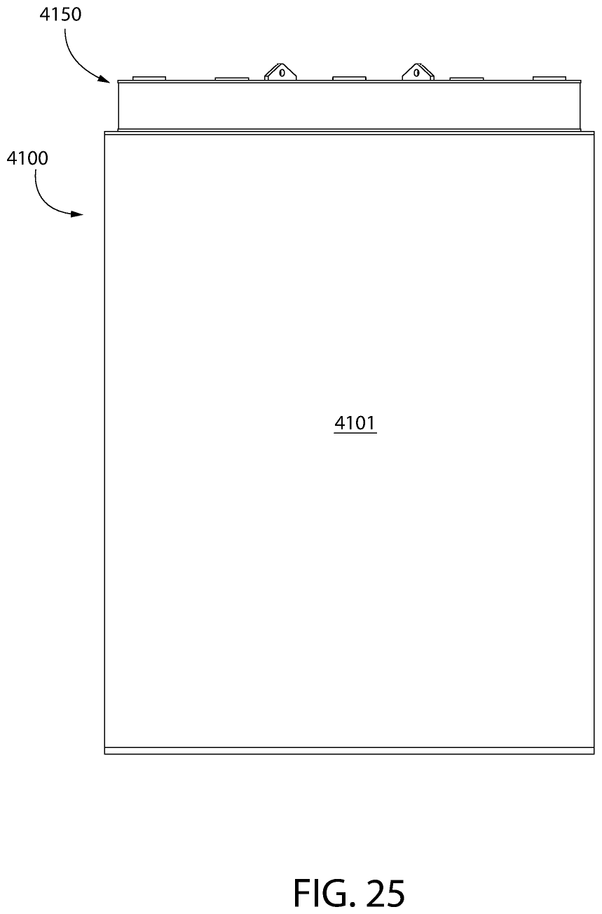

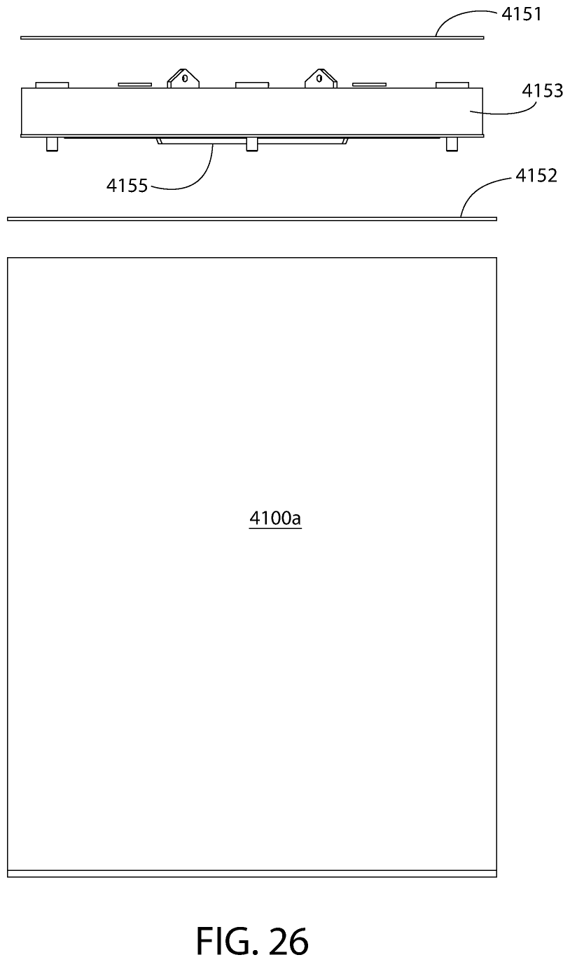

FIGS. 15-30 show various aspects of the nuclear fuel storage system comprising an unventilated nuclear fuel storage pressure vessel with a self-regulating pressure relief mechanism and integral heat dissipation system. The nuclear fuel storage system in one embodiment generally comprises a pressure vessel in the form of an outer unventilated storage cask 4100 and a high level radioactive nuclear waste (e.g., SNF) canister 4120 configured for storage inside the cask. Features of each storage vessel and other features thereof will now be further described.

Canister 4120 may be used for storing any type of high level radioactive nuclear waste, including without limitation spent nuclear fuel (SNF) or other forms of radioactive waste materials removed from the reactor. The SNF or simply fuel canister for short may be any commercially-available nuclear waste fuel canister, such as a multi-purpose canister (MPC) available from Holtec International of Camden, N.J. or other.

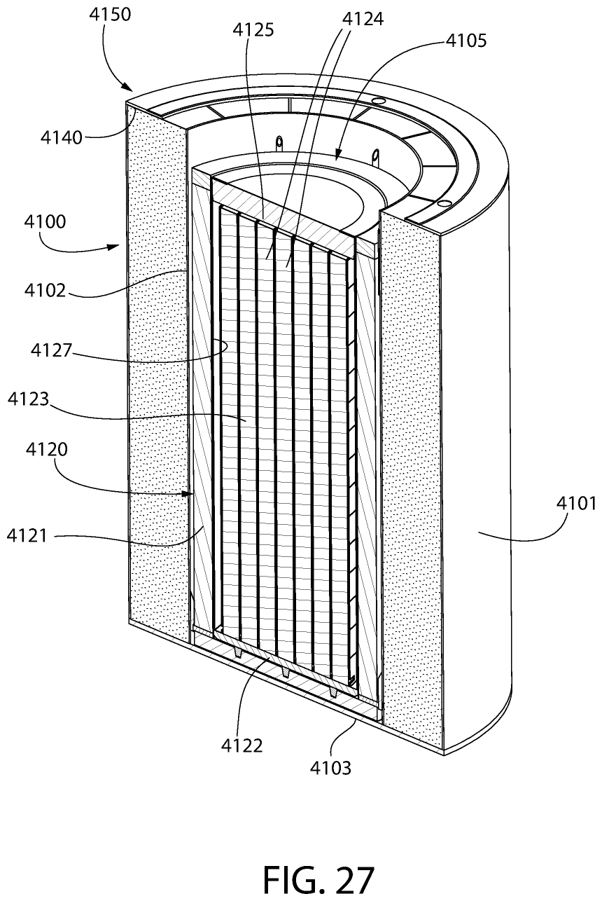

Referring momentarily to FIG. 27, waste fuel canister 4120 has a vertically elongated and metallic body comprised of a cylindrical shell 4121. Canister 4120 further includes a bottom baseplate 4122 seal welded to a bottom end of the shell, and an open top closed by an attached lid 4125. Lid 4125 may be seal welded to a top end 4126 of the canister shell 4121 to form a hermetically sealed cavity 4127 inside the canister. The foregoing canister parts may be formed of any suitable metal, such as for example without limitation steel including preferably stainless steel for corrosion protection.

Fuel basket 4123 is disposed in cavity 4127 of the canister 4120 and is seated on the bottom baseplate 4122 as shown. The fuel basket may be welded to the baseplate for stability in some embodiments. In some embodiments, the baseplate 4122 may extend laterally outwards beyond the sides of the fuel basket 4123 around the entire perimeter of the fuel basket as shown.

The fuel basket 4123 is a honeycomb prismatic structure comprising an array of vertically-extending openings forming a plurality of vertical longitudinally-extending fuel assembly storage cells 4124. Each cell is configured in cross-sectional area and shape to hold a single U.S. style fuel assembly, which contains multitude of spent nuclear fuel rods (or other nuclear waste). An example of fuel assembly of this type having a conventional rectilinear cross-sectional configuration is shown in FIG. 14 of U.S. patent application Ser. No. 17/132,102 filed Dec. 23, 2020, which is incorporated herein by reference. Such fuel assemblies and the foregoing fuel basket structure are well known in the industry. The fuel basket may be formed in various embodiments by a plurality of interlocked and orthogonally arranged slotted plates built up to a selected height in vertically stacked tiers. Other constructions of fuel baskets such as via joining multiple vertically extending tubes or other structures to the canister baseplate may be used and others used in the art may be used. The fuel basket construction is not limiting of the present invention.

With continuing reference to FIGS. 15-30, the unventilated storage cask 4100 in one embodiment is a double-walled pressure vessel comprising a vertically elongated metallic cylindrical body 4100a defining a vertical longitudinal axis 4LA passing through the vertical centerline and geometric center of the body. The cask body is an annular structure including an outer shell 4101, an inner shell 4102 spaced radially inwards therefrom and defining an annular space 4106 between the shells, a circular bottom baseplate 4103 coupled to the bottom ends of the shells, and an annular top closure plate 4104 coupled to the top ends of the shells. The shells are arranged coaxially relative to one another. Baseplate 4103 may be fixedly attached to the top and bottom ends of the shells preferably by via seal welding to form a hermetic bottom seal of the cask body. Accordingly, continuous circumferential seal welds may preferably be used to permanently join the bottom baseplate 4103 to the shells 4101, 4102.

The circumferential outer edge 4104b of top closure plate 4104 may be welded to a top end of the outer shell 4101 of the cask 4100. The top closure plate has a radially broadened ring-like plate structure which projects radially inwards from the outer shell towards the inner shell 4102. In one embodiment, as shown, top closure plate 4104 projects radially inwards towards but does not contact or engage the inner shell 4102 of the cask 4100 to partially close the annular space 4106 at top between the shells of the cask body. This arrangement provides additional space for a pressure release/relief passageway to quickly release excess pressure from the cask in the event of an internal cask overpressurization condition, as further described herein.

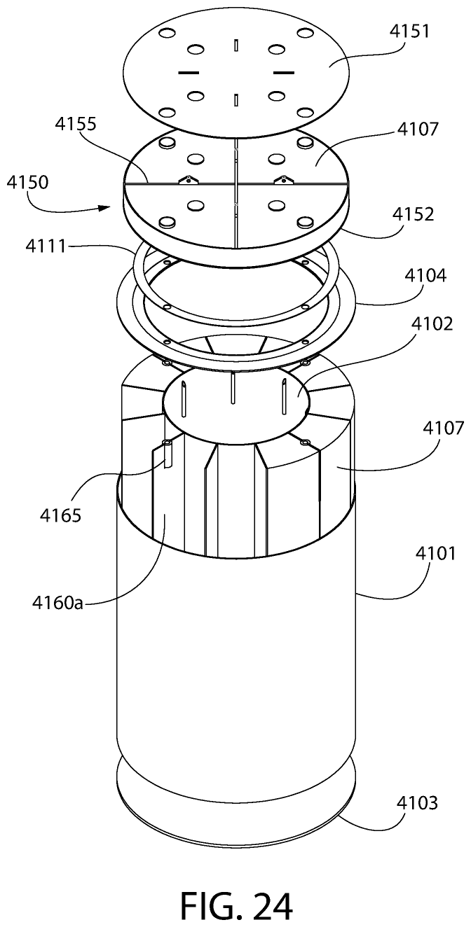

With particular emphasis on FIGS. 24 and 29-30, the top closure plate 4104 of cask 4100 comprises a plurality of fastener holes 4109 which receive bolt assemblies 4140 therethrough to threadably engage circumferentially spaced anchor bosses 4165 fixedly mounted to the top end of the cask body 4100a, as further described herein. Fastener holes 4109 are circumferentially spaced apart along a bolt circle of suitable diameter. In one embodiment, fastener holes 4109 may be circular and formed through an annular recessed gasket seating surface 4110 formed on the inner annular portion of the top closure plate 4104. The raised outer annular portion 4113 of the top closure plate may be flat and plain as shown without openings. A compressible annular gasket 4111 containing circumferentially spaced apart circular fastener apertures 4112 is received on gasket seating surface 4110. When mounted thereon, fastener apertures 4112 are concentrically alignable with fastener holes 4109 of the cask top closure ring 4104. Gasket 4111 forms a circumferential hermetic seal between the lid 4150 and top closure plate 4104 of the cask body 4100a. Any suitable natural or man-made compressible material (e.g., elastomeric, rubber, etc.) material suitable for the intended service conditions e.g., temperature, pressure, environment, etc.) may be used.

The cask body 4100a defines an internal cavity 4105 which extends longitudinally for a full height of the cask from baseplate 4103 at bottom to the top ends of outer and inner shells 4101, 4102. The cavity 4105 is configured in dimension and transverse cross-sectional area to hold only a single fuel canister 4120 in some embodiments, as is conventional practice in the art. Cavity 4105 is hermetically sealed when lid 4150 is mounted to the cask body 4100a and may therefore be pressurized to pressures above atmospheric, thereby categorizing cask 4100 as a pressure vessel for ASME code purposes. The stress field in the cask's pressure retention boundary may be qualified to the limits of Section III Subsection ND of the ASME Boiler and Pressure Vessel Code.

The cask 4100 is a heavy radiation shielded nuclear waste fuel storage pressure vessel operable to ameliorate the gamma and neutron radiation emitted by the nuclear waste fuel canister 4120 to safe levels outside the cask. Accordingly, annular space 4106 formed between outer and inner shells 4101, 4102 is filled with appropriate radiation shielding material(s) 4107. In some embodiments, the shielding material 4110 may comprise plain or reinforced concrete. Concrete densities up to 4230 pounds/cubic feet or more may be used. However other or additional shielding materials and combinations thereof may be used including without limitation lead, boron-containing materials, or a combination of these and/or other materials effective to block and/or attenuate gamma and neutron radiation emitted by the nuclear waste (e.g., fuel assemblies) stored in canister 4120 when loaded into the cask 4100. Any suitable types, thicknesses, and arrangement of shielding materials may be used to provide the necessary degree of shielding.

The outer and inner shell members 4101, 4102 of the cask 4100 may be formed of a suitable metal such as for example without limitation painted steel. The top closure plate 4104 and bottom baseplate 4103 may similarly be formed of the same metal for welding compatibility and strength.

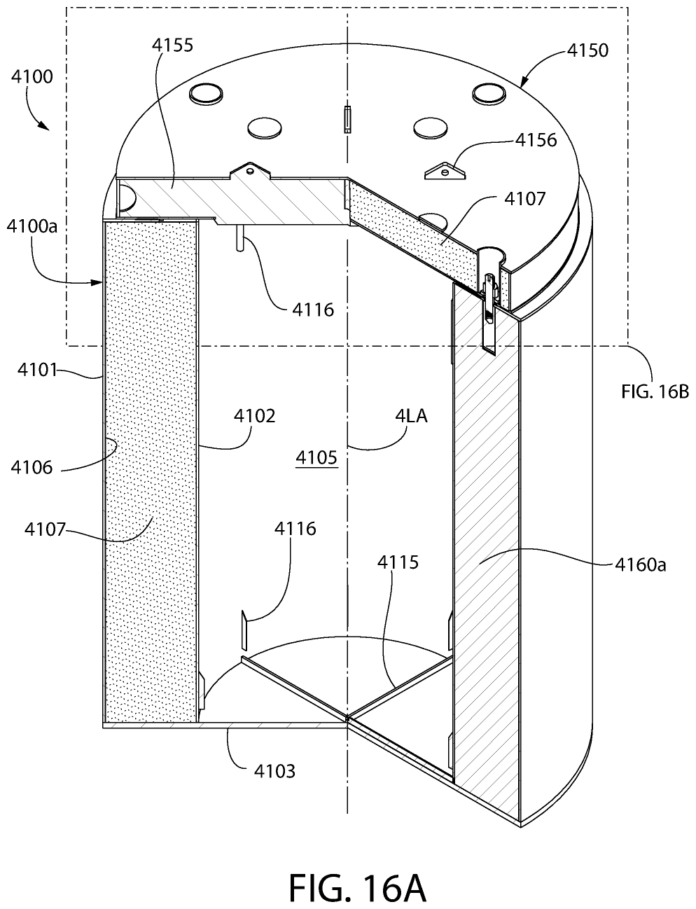

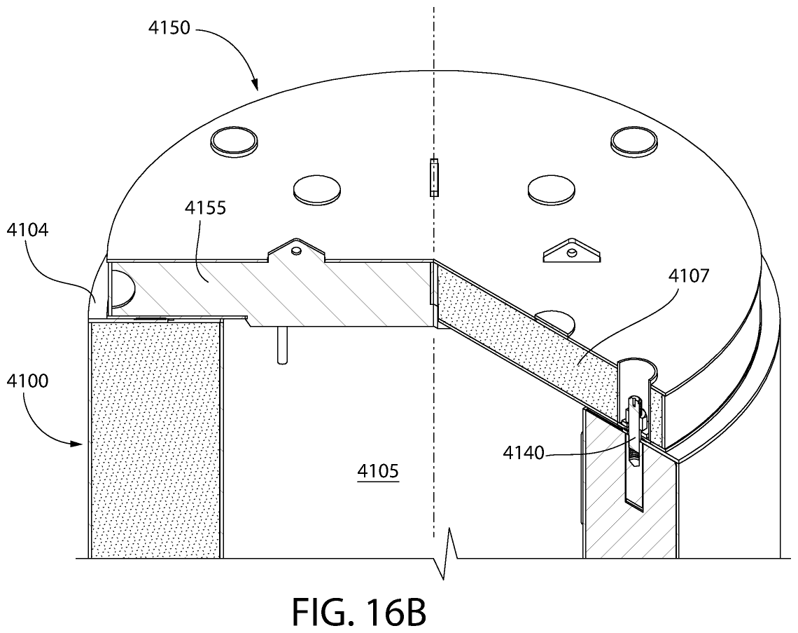

In one embodiment, a plurality of steel canister cross supports 4115 may be welded to the top surface of the baseplate 4103 (see, e.g., FIG. 16A) inside internal cavity 4105 to support the canister 4120. The cross supports elevate the bottom of the canister above the baseplate. Cross supports 4115 may be arranged in an intersecting X-pattern (cruciform) as shown; however, other suitable arrangements of the supports may be provided. In certain embodiments, a plurality of circumferentially spaced apart metallic seismic restraint tubes 4116 may be welded to the interior surface of inner shell 4102 inside cavity 4105. The tubes keep the canister 4120 centered and reduce radial/lateral movement during occurrence of a seismic event. A grouping of restraint tubes 4116 may be provided in both the upper and lower portion of cask cavity 4105 to restrain the top and bottom portions of the canister 4120.

In contrast to vertical ventilated overpacks or casks, it bears noting that the present unventilated cask 4100 has no provisions which allow for the exchange of ambient cooling air through the internal cavity 4105 of the cask to cool the canister by natural thermo-siphon convective airflow. As previously noted herein, such ventilated cask designs may be unsuitable for storage of spent nuclear fuel (SNF) in a stainless steel canister within the cask in corrosive atmospheric environments and conditions. Many SNF canisters are made of austenitic stainless steel, which is susceptible to stress corrosion cracking (SCC) in humid corrosive environments in the presence of residual tensile surface stresses remaining from the fabrication of the canisters. In coastal environments, the presence airborne salts can be especially render a stainless steel SNF canister susceptible to chloride-induced SCC.

Because the internal cavity 4105 of the present unventilated cask 4100 is gas-tight and forms a pressure vessel, a heat dissipation mechanism is necessary to cool the canister within this hermetically sealed storage environment within the cask. In addition, further structural reinforcement of the cask's skeletal steel structure is desired to enable safe lift and transport of the cask with a motorized cask crawler in view of the heavy concrete laden cask body which can readily weight in excess of 100 tons.

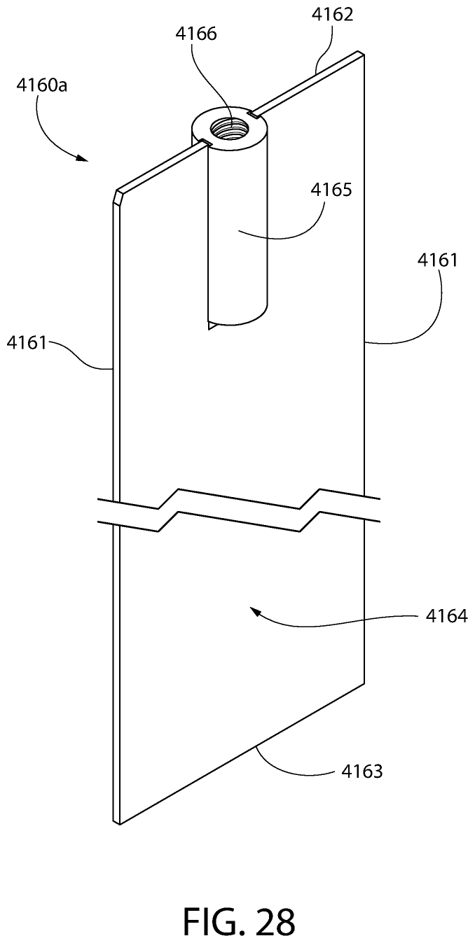

To provide both additional structural strength to the cask and a heat transfer mechanism to cool the nuclear waste fuel canister 4120 in cask 4100, the cask may include a plurality of longitudinally-extending rib plates 4160. FIG. 28 shows one form of rib plate 4160a in isolation and greater detail which contains lid mounting bosses 4165. Plain rib plates have a similar construction minus the mounting bosses, as further described below.

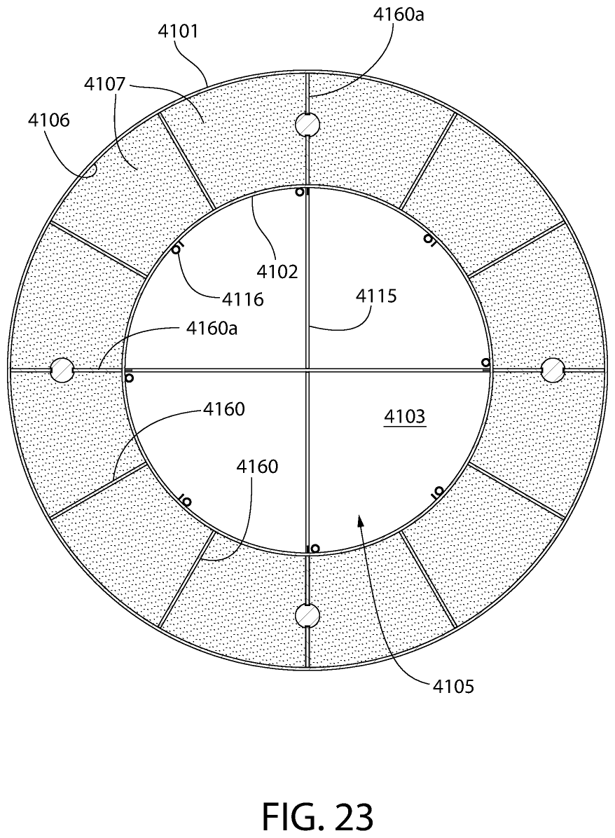

With continuing general reference to FIGS. 15-30, the longitudinal rib plates 4160 are flat sheet-like rectangular structures disposed inside annular space 4106 of cask 4100 between the inner and outer shells 4102, 4101. The ribs plates are circumferentially spaced apart and welded along opposing longitudinal edges 4161 of the plates to at least the inner and outer shells 4102, 4101. In one embodiment, longitudinally continuous fillet welds may be used which extend along the entire height of the rib plate to shells joint rib plates 4160 further include a top edge 4162, bottom edge 4163, and opposed flat and parallel major surfaces 4164. The rib plates extend radially between the inner and outer shells 4102, 4101, and in some embodiments may be arranged in diametrically opposed pairs of plates (see, e.g., FIG. 23). Rib plates 4160 extend for a full longitudinal height of the annular space 4106 of the cask from the baseplate 4103 to a top end of the cask body at the bottom surface of the top closure plate 4104 (see, e.g., FIGS. 16A, 16B, 18, and 19A). In certain embodiments, the rib plates 4160 may be welded at their top and bottom edges 4162, 4163 to the baseplate 4103 and/or top closure plate 4104 to further strengthen the cask skeletal structure. The circumferential gaps formed between rib plates 4160 within the annular space 4106 are filled with the radiation shielding material 4107, such as without limitation concrete.

It bears noting that the rib plates 4160 each provide a conductive heat transfer path between the inner shell 4102 and outer shell 4101. The interior surface of inner shell 4102 is heated by direct exposure to the waste fuel canister 4120. The heat flows radially outward through the rib plates 4160 via conduction to heat the outer shell 4101, which then becomes hot and dissipates heat to the atmosphere via convective cooling and radiation.

Some of the rib plates 4160 are configured to act as load transfer members used in lifting the cask 4100. Accordingly, lifting rib plates 4160a each comprise a threaded anchor boss 4165 fixedly attached at a top end thereof (see, e.g., FIG. 28). Anchor boss 4165 comprises a cylindrical body defining an upwardly open threaded bore 4166 positioned to threadably engage a respective mounting bolt 4140 assembly. The top of the mounting boss may be flush with the top edge 4162 of the lifting rib plate in some embodiments as shown which allows the height of the rib plate to be maximized, which in turn maximizes its heat transfer capacity. A plurality of lifting rib plates 4160a are preferably provided and spaced apart in circumferentially around the top end of the cask body. In the non-limiting illustrated embodiment, four lifting rib plates 4160a are provided spaced 90 degrees apart around the cask body as shown (see, e.g., FIG. 23); however, a greater or few number may be provided in other implementations of the cask. The lifting rib plates 4160a provide a load transfer interface with the lid 4150.

Lid 4150 is a radiation shielding structure with outer metallic casing (e.g., steel) comprising a circular top plate 4151, opposing circular bottom plate 4152, and a cylindrical outer lid shell 4153 welded to the top plate and the bottom plate of the lid forming an internal cavity 4154. Cavity 4154 is filled with radiation shielding material 4107, which may comprise concrete in some embodiments. Various other shielding materials and combinations thereof may be used as previously described herein with respect to the cask radiation shielding.

Lid 4150 further comprises a plurality of radially/laterally elongated lid lifting plates 4155, which may be arranged in an orthogonal cruciform pattern intersecting at the center of the lid (see, e.g., FIGS. 24, 29, and 30). The lifting plates are embedded in the concrete fill and comprise a lifting lug 4156 protruding upwards beyond the top plate 4151. Lifting lugs 4156 are configured with holes for rigging to an overhead hoist or crane for raising, lowering, and transporting the unventilated storage cask 4100. Accordingly, lifting plates 4155 may be welded to the top plate 4151, bottom plate 4152, and/or outer shell 4153 to provide a rigid skeletal frame for the lid 4150 capable of handling the cask 100 which generally weights in excess of 100 tons.

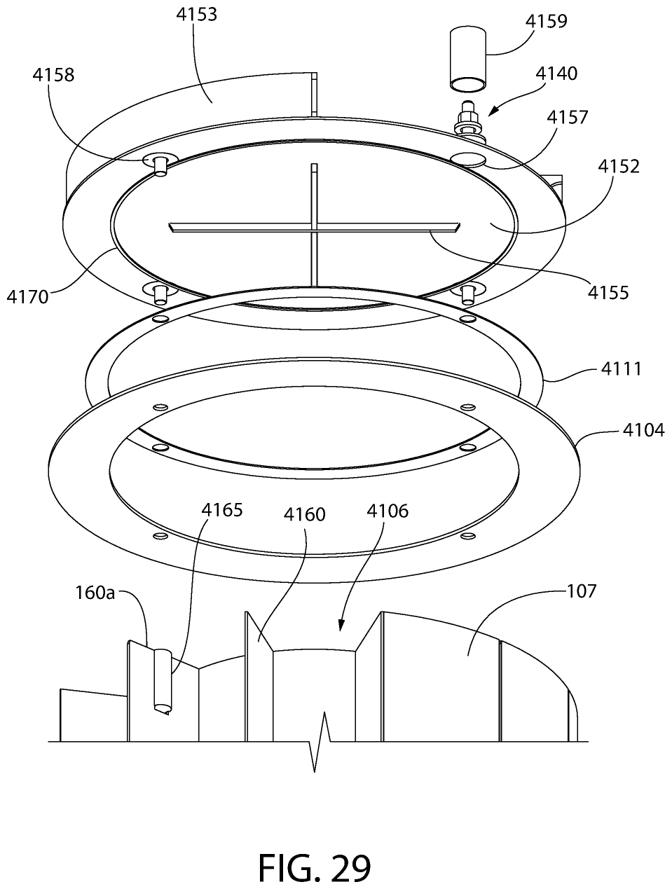

Importantly, the lifting plates 4155 and the foregoing welded lid construction further act as a heat transfer mechanism to dissipate heat emitted by the canister 4120 in the cask cavity 4105 through the lid to the ambient environment. To further enhance heat transfer, the lifting plates may penetrate the bottom plate 4152 of lid 4150 for direct exposure to the cask cavity 4105 (see, e.g., FIG. 29). Lifting plates may protrude downwards below the bottom surface of the bottom lid plate in some embodiments as shown for this purpose and also to vertical stabilize the canister 4120 within the cask against vertical movement either during transport of the cask or a seismic event.

By virtue of the thermosiphon effect occurring inside the waste fuel canister 4120 (e.g., MPC) through the fuel basket 4123, the top lid 4125 of the canister seen in FIG. 27 is the hottest part of the canister's exterior surface. The hot canister heated by heat emitted by the decaying spent fuel assemblies therein rejects heat to the bottom plate 4152 of the cask's closure lid 4150 directly above and proximate to the top of the canister by direct radiation and convection. The lid lifting plates 4155 and the physical connectivity they provide between the bottom plate 4152 and top plate 4151 of the lid directly exposed to the ambient environment thus are important to the cask's thermal performance for cooling the canister. From a personnel safety standpoint, having the hottest surface of the cask (i.e., lid 4150) located at the very top of the cask (away from the reach of surveillance personnel) is an advantageous operational feature of the nuclear waste fuel storage system.

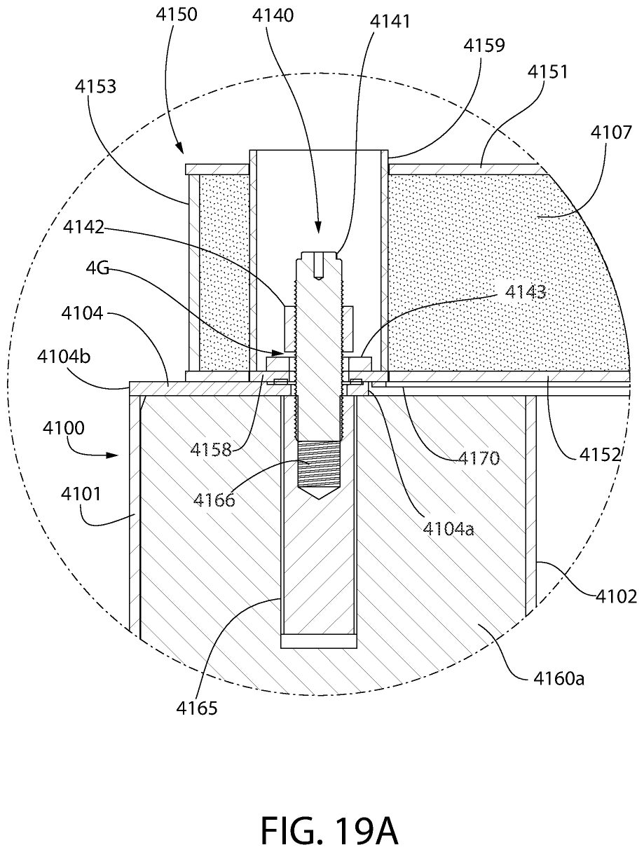

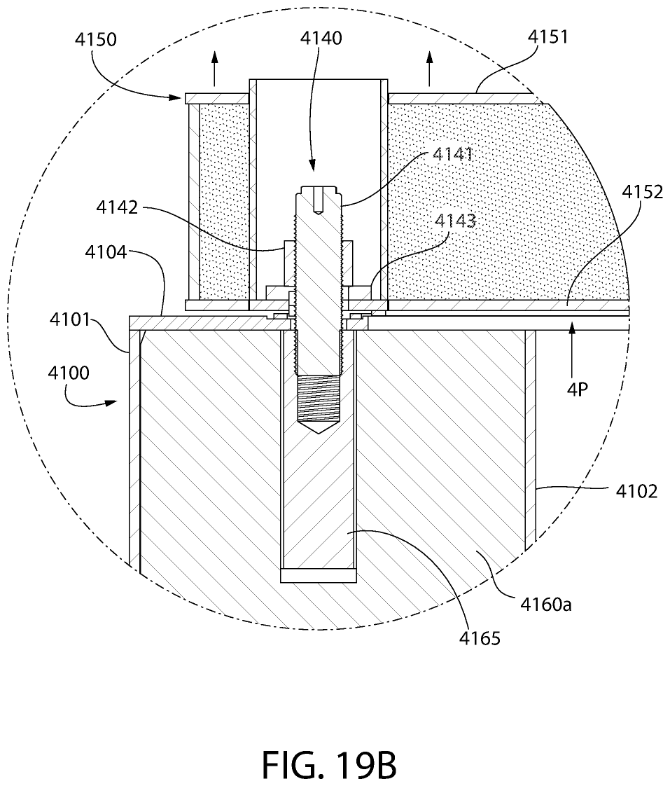

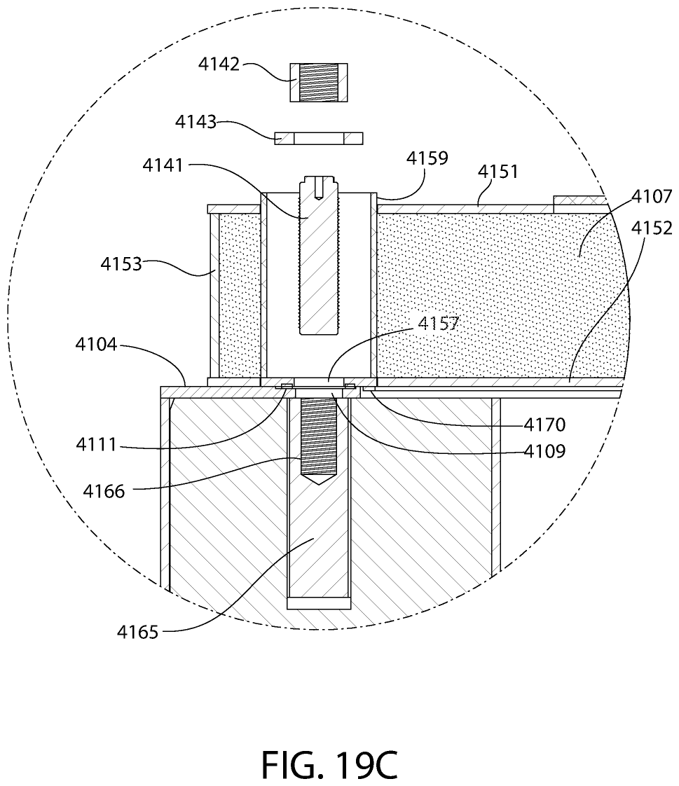

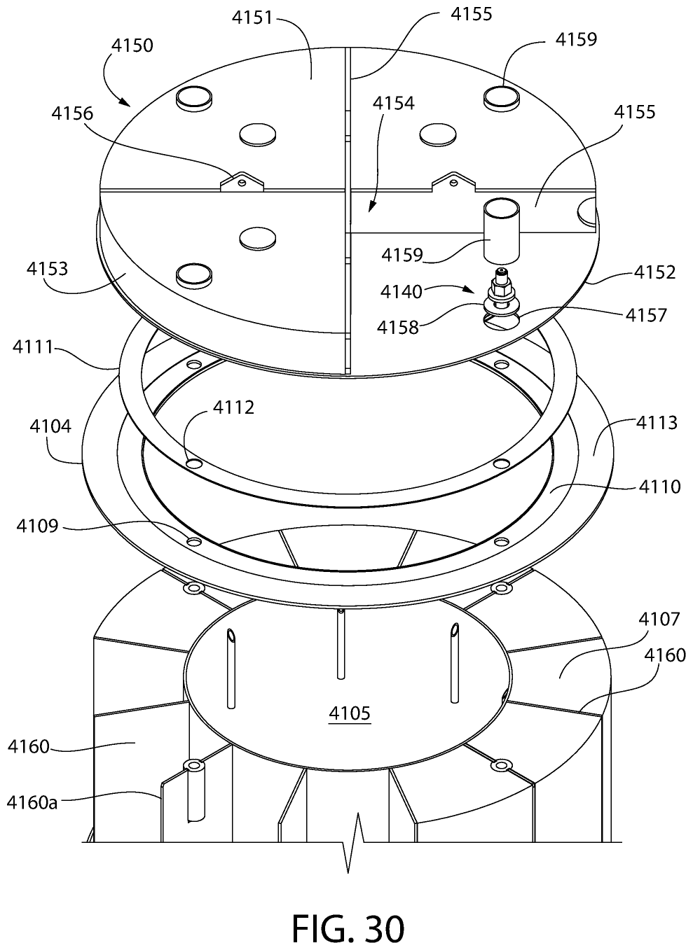

Referring specifically to FIGS. 19B and 30, bottom plate 4152 of the lid 4150 comprises a plurality of circumference lid fastener holes 4157 arranged to be concentrically aligned with fastener holes 4109 of cask top closure plate 4104 and threaded bosses 4165 of lifting rib plates 4160a. Each lid fastener hole 4157 is accessible through a respective access tube 4159 welded to bottom plate 4152. Access tubes 4159 project upwards passing through lid top plate 4151, and preferably protruding beyond and above the top plate as shown to prevent the ingress of standing water from the top surface of the lid into the tube. The access tubes are formed of steel, preferably stainless steel to prevent corrosion and accumulation of rust which might adversely affect the sliding motion of the floating lid along the bolt assemblies 4140 (e.g., the threaded studs 4141). The tubes 4159 be further be welded to the top plate 4151 in some embodiments. Access tubes 4159 are embedded in the concrete radiation shielding material in the lid 4150 (see, e.g., FIGS. 19A and 30).

For cask lid constructions where the bottom closure plate may be formed of steel which may corrode and rust, an annular hole insert plate 4158 may optionally be used which is formed of stainless steel similarly to the bolting assembly access tubes 4159. The hole insert plate is welded partially or fully around its circumference to the lid bottom plate to eliminate any pressure passage into the interior of the lid. The fastener holes 4157 of lid 4150 in this case are formed by the hole insert plates. In other embodiments, however, the insert plates 4158 may be omitted and fastener holes 4157 may be formed directly in the lid bottom plate 4152 within the access tubes 4159. Either construction may be used. The use of stainless steel to construct the access tubes 4159, hole insert plates 4158, and preferably the bolting assembly 4140 components mitigates the formation of rust which might interfere with smooth sliding movement of the floating lid 4150 along the bolt assemblies during cask overpressurization conditions. This is an exposure since rainwater will tend to accumulate inside the access tubes 4159 until the heat dissipated through the lid 4150 from the internal cavity 4107 of cask 4100 eventually evaporates the water.

Referring to FIGS. 19A-19C, 29, and 30, the threaded bolt assemblies 4140 each include a cylindrical threaded stud 4141 threadably engageable with the anchor bosses 4165 (i.e., threaded bore 4166) of the lifting rib plates 4160 through the top closure plate 4104 of the cask 4100, an internally threaded adjustable limit stop 4142 rotatably coupled to the stud for upward/downward positioning thereon, and optionally a washer 4143 which receives the stud. In one embodiment, the limits stop 4142 may be a threaded hex nut adjustable in position along the threaded stud to change a height of an installer-adjustable vertical travel gap 4G formed between the limit stop and bottom plate 4152 of the lid 4150. Where the optional washer 4143 is provided, travel gap 4G is formed between the top of the washer and the bottom surface of the lid bottom plate. Travel gap 4G defines a range of vertical travel of the lid along stud 4141. In some embodiments, travel gap 4G may be about ⅜ inch or more. Even such a small gap between the lid when raised and the cask body is effective to relieve excess internal pressure from the cask. Accordingly, lid 4150 is vertically movable relative to the cask body within a range defined by the travel gap. The forgoing bolt assembly components (stud, limit stop, and washer) are preferably formed of stainless steel to prevent corrosion and rust formation on the threaded stud 4141 which might inhibit the lid from freely sliding along the studs when rising during a cask overpressurization condition.

To provide a self-regulating cask overpressurization relief system, the radiation shielding lid 4150 is a free-floating design which is movably coupled to the top end of the cask 4100 in a hermetically sealable manner by bolt assemblies 4140, Accordingly, the bolt assemblies 4140 are configured to loosely mount the lid to the cask body, thereby allowing limited vertical movement of the lid relative to the cask body via the foregoing installer-positionable limit stops 4142 of the bolt assemblies to adjust the travel gap 4G. The weight of the lid acts in conjunction with the annular compressible gasket 4111 which forms a circumferential seal between the lid and the top end of the cask body to maintain a hermetic seal of the cask body. This forms the gas tight cavity 4105 which houses canister 4120 under normal cask operating pressures. The cask 4100 is therefore operable to retain an internal pressure within the gas tight cavity 4105 above atmospheric pressure. When the internal pressure 4P of the cask acting on the bottom surface area of the lid bottom plate 4152 exposed to the cask cavity 4105, this creates an upward acting lifting force which exceeds the weight of the lid, the lid will rise and become slightly ajar from the top closure plate 4104 of the cask to relieve the cask excess pressure (see, e.g., FIG. 19B).

Lid 4150 may further comprise a metallic raised annular shear ring 4170 protruding downwardly from a bottom surface of the lid bottom plate 4152. The shear ring is designed such that if the cask 4100 tips over, the lid will contact the cask body top plate 4104 to absorb the shear forces instead of the bolt assemblies 4140. This protects the structural integrity and lid-to-cask seal of the cask cavity 4105. Shear ring 4170 is arranged proximate to a circumferential inner edge 4104a of the top closure plate 4140 as shown in FIG. 19A for mutual engagement therebetween in the event of a cask tipping event.

Lid 4150 is slideably movable in a vertical direction by a limited amount along the bolt assemblies 4140 (i.e., threaded stud 4141 particularly) dictated by travel gap 4G. Lid 4150 is movable between: (1) a downward sealed position engaged with the cask body which seals the gas tight cavity of the cask (see, e.g., FIG. 19A); and (2) an adjustable raised relief position engaged with the bolt assemblies but ajar from the cask body to partially open the gas tight cavity thereby defining a gas overpressurization relief passageway to ambient atmosphere extending circumferentially and perimetrically around the top end of the cask body (FIG. 19B).

When an internal cask overpressurization condition occurs, the lid 4150 rises under pressure 4P to close the travel gap 4G and engage the threaded limit stop 4142 on stud 4141 with the bottom plate 4152 of the lid which arrests upward movement of the lid. The heating of the trapped volume of gas in the cask cavity 4105 (i.e., air or an inert gas pumped into the cask cavity after placement of and sealing by the lid) by the fuel assemblies stored within the SNF canister 4120 will on its own cause an increase in internal cask pressure 4P to the point limited by the weight of the free-floating lid. Such an overpressurization condition may also be associated with spent nuclear fuel dry storage system (i.e., cask) Design Basis Fire Event, or other abnormal operating condition within the cask. The U.S. NRC (Nuclear Regulatory Commission) mandates dry storage systems to meet stringent safety requirements at all times, including during the occurrence of postulated cask design basis accident events. A design basis accident is any event that could significantly affect the integrity of the storage system, such as an external fire, fuel rod rupture, and natural phenomena such as earthquakes, lightning strikes, projectile impacts, and others.

When the cask overpressurization condition abates, the relieved internal cask pressure drops back down within the cask and lid 4150 automatically returns to the downward position under its own weight to re-engage the cask body and reseal the gas tight hermetically sealed cavity 4105. In the event an overpressurization condition occurs again, the lid 4150 will again rise to relieve the excess pressure and repeat the cycle without manual intervention, thereby forming a self-regulating cask overpressurization relief system.

In view of the foregoing, a method or process for protecting an unventilated nuclear fuel storage cask from internal overpressurization will now be briefly summarized. The method includes providing the unventilated cask 4100 comprising the sealable internal cavity 4105 and a plurality of threaded anchor bosses 4165. The cavity of the cask remains upwardly open at this juncture. The method continues with lowering canister 4120 containing high level nuclear waste into the cavity 4105, and then positioning the radiation shielded lid 4150 on the cask. The lid is now in the downward sealed position engaged with the cask thereby making the cavity gas tight to retain pressures exceeding atmospheric. The method continues with aligning the plurality of fastener holes 4109 formed in the lid 4150 (e.g., in lid bottom plate 4152) with the anchor bosses. Next, the method includes threadably engaging a threaded stud 4141 of the bolt assemblies 4140 with each of the cask anchor bosses 4165 through the fastener holes 4109 of the lid, and then rotatably engaging a threaded limit stop 4142 with each of the threaded studs. This last step may be preceded by sliding a washer 4143 over each threaded stud 4141 to rest on the lid (e.g., lid bottom plate 4152 at the base of access tubes 4159) if washers are optionally used. The final step comprises rotating and positioning the limits stops 4142 on the studs 4141 such that a vertical travel gap 4G is formed between the lid and the limit stops. This position of the lid 4150 is shown in FIG. 19A. During a cask overpressurization condition wherein the upward force exerted on the bottom surface of the free-floating lid 4150 by the internal pressure of the cask exceeds the weight of the lid, the lid slideably moves upward along the studs 4141 to the relief position ajar from the cask to vent excess pressure to atmosphere. As previously described herein, when the cask overpressurization condition abates, the lid automatically returns to the downward position to re-engage the cask body and reseal the gas tight cavity for continued operation.

In some embodiments, the pressure of the cask cavity 4105 which holds the waste fuel canister 4120 air may be reduced to a low enough value such that it will remain below the ambient pressure under all service conditions. To ensure that the cask operates under sub-atmospheric conditions, it would be necessary to pump out the ambient air in the cask cavity 4105 after the canister 4120 and lid 4150 are in place. Typically, an initial pressure of about ½ atmosphere would generally be sufficient to ensure that the internal pressure of the cask 4100 remains sub-atmospheric under all operating conditions. Suitable piping connections and valving may be provided to pump the air out of the cask and establish the sub-atmospheric cask operating pressure. The cask cavity 4105 may next be optionally filled with an inert gas after mounting the lid 4150 to the cask 4100 in some embodiments. This added safety measure to protect the long term integrity of the canister confinement barrier may be used where the onset of SCC at the exterior surfaces of the canister 4120 may be an operational issue.

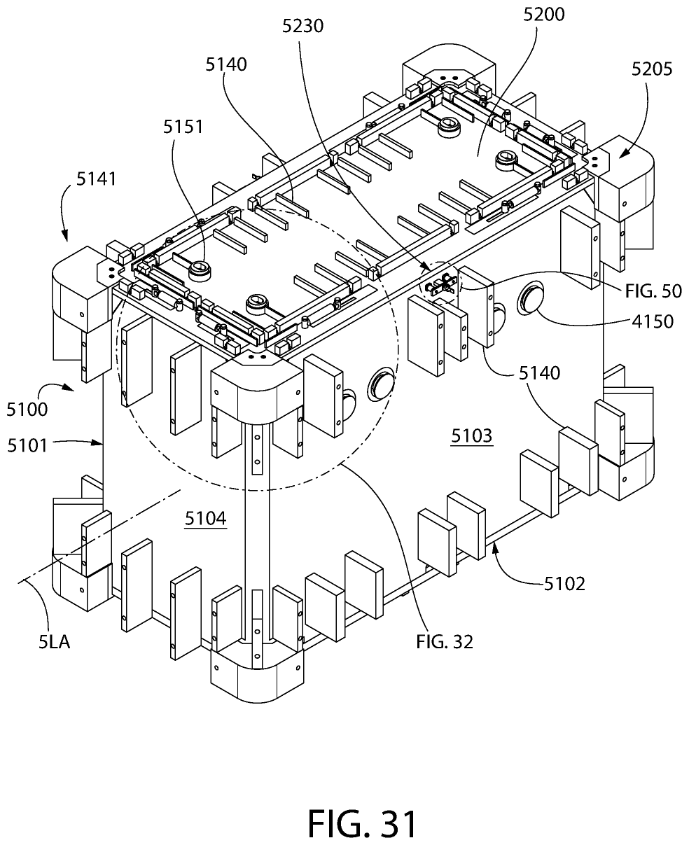

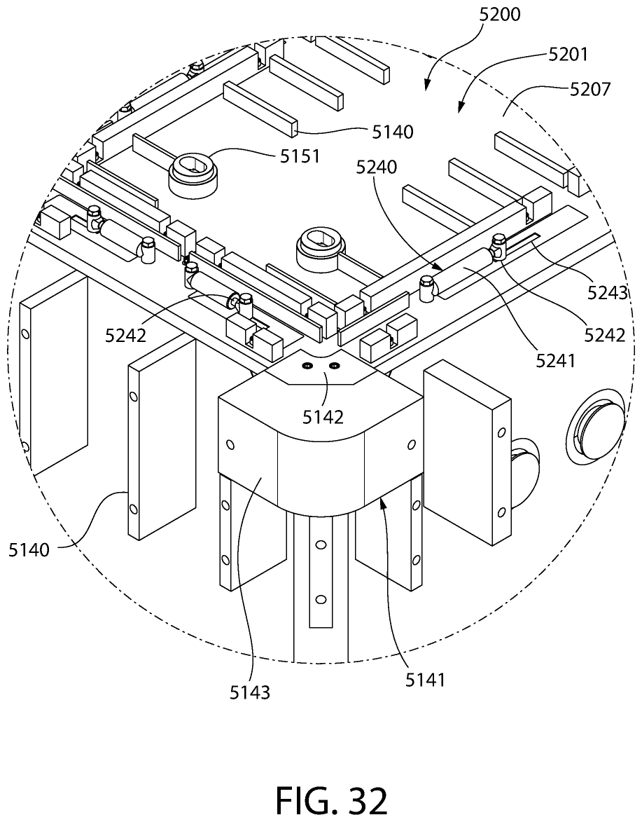

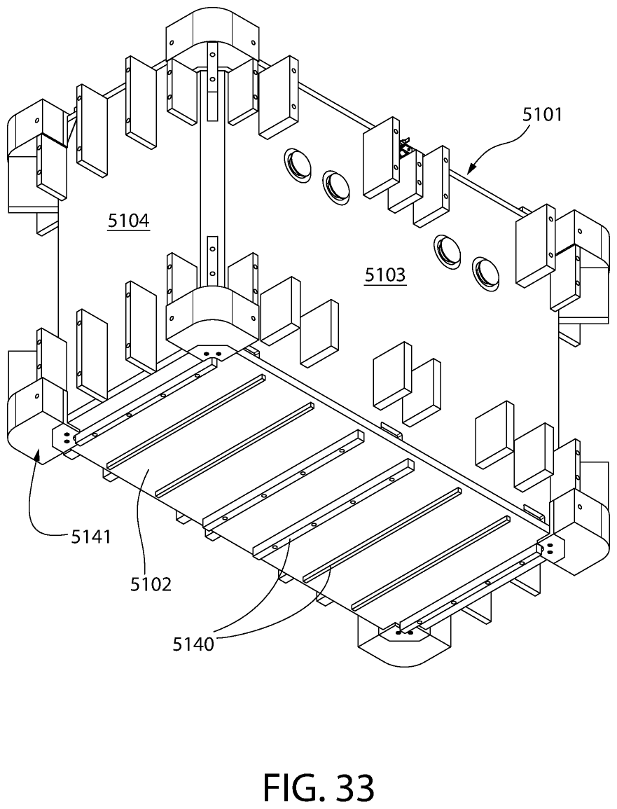

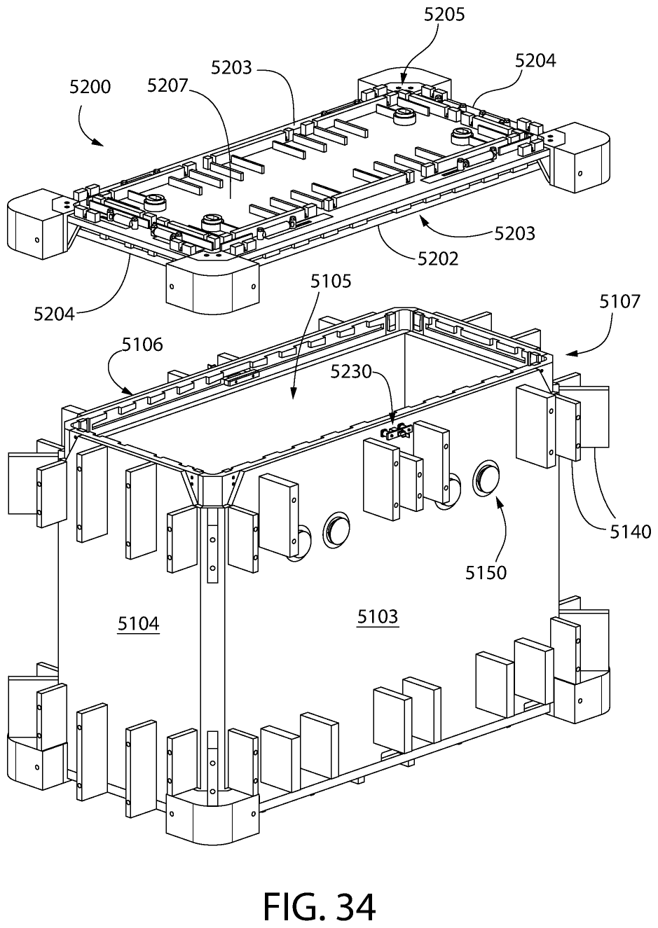

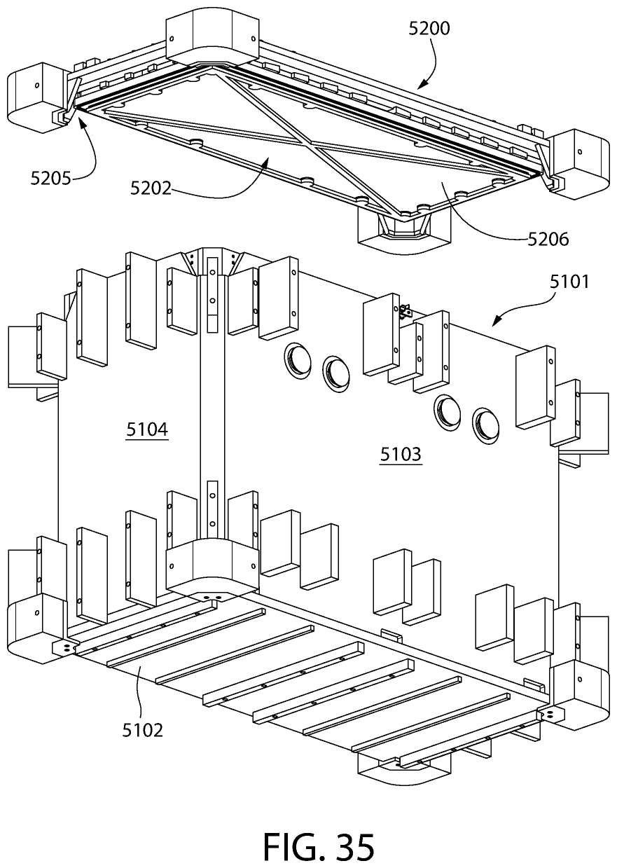

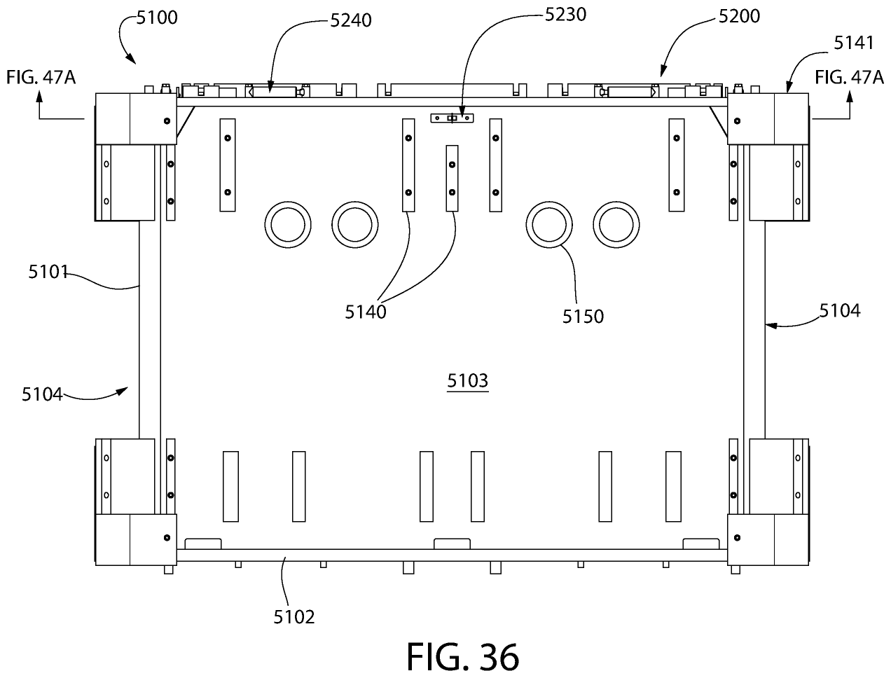

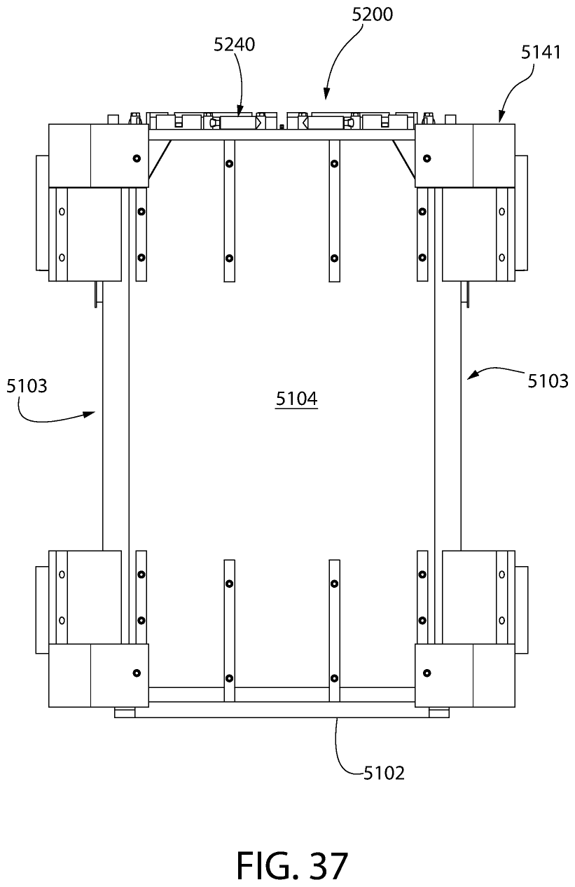

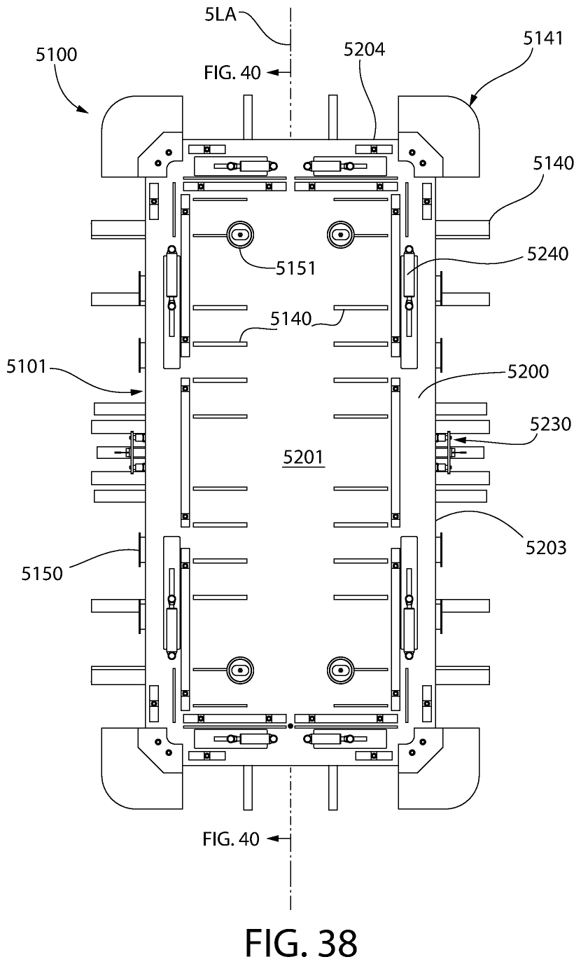

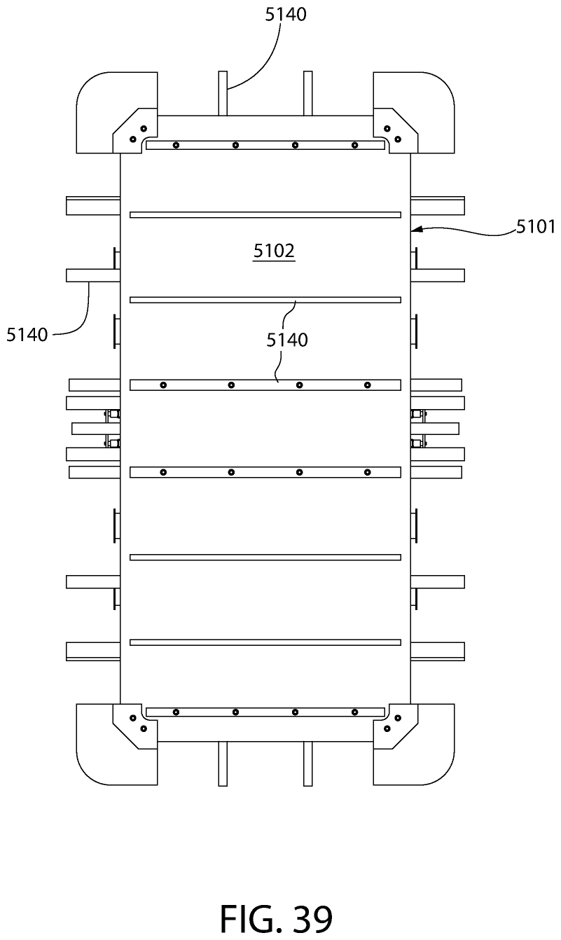

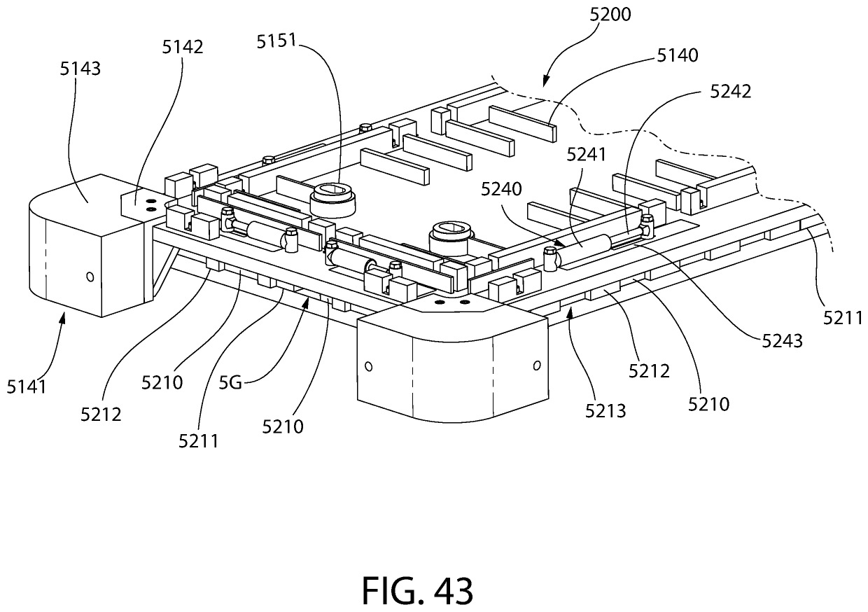

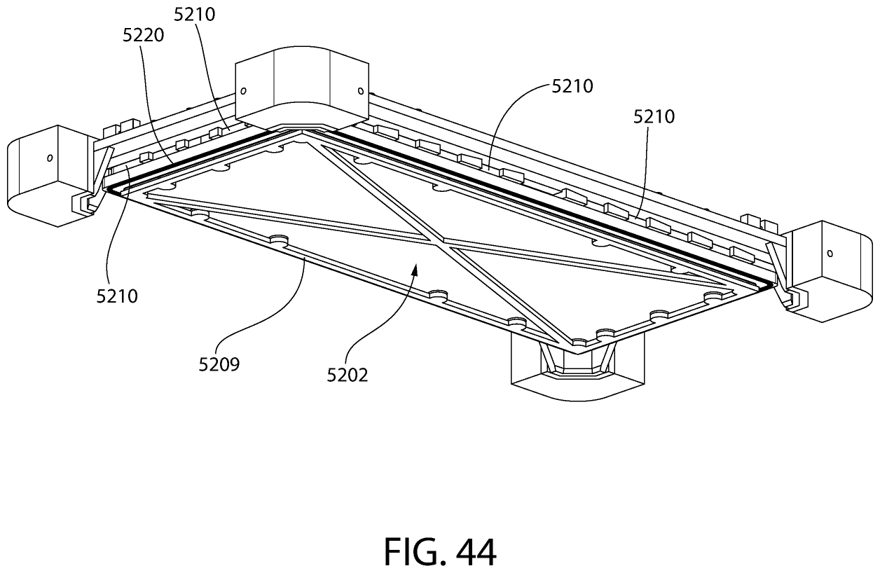

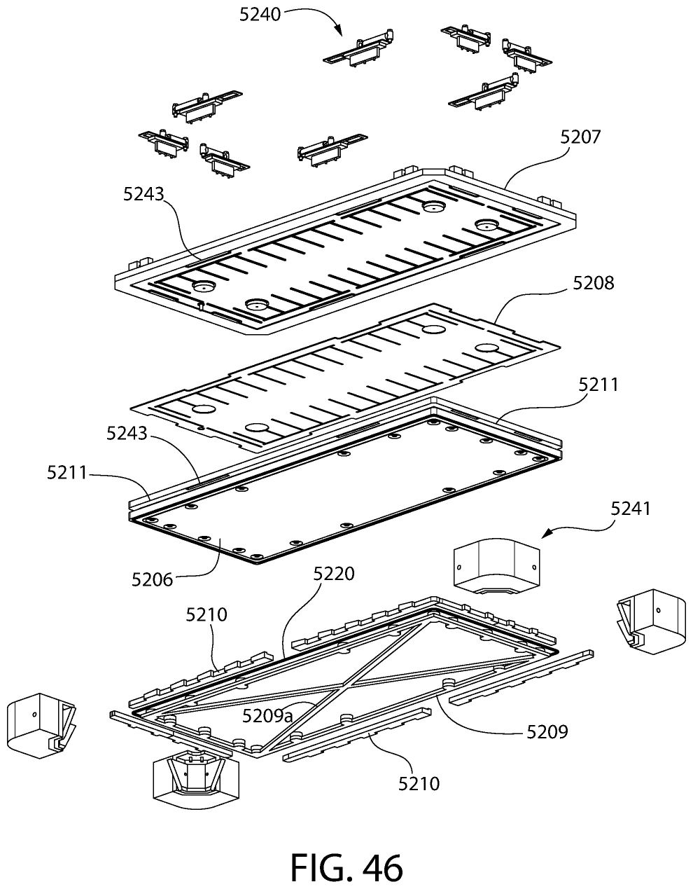

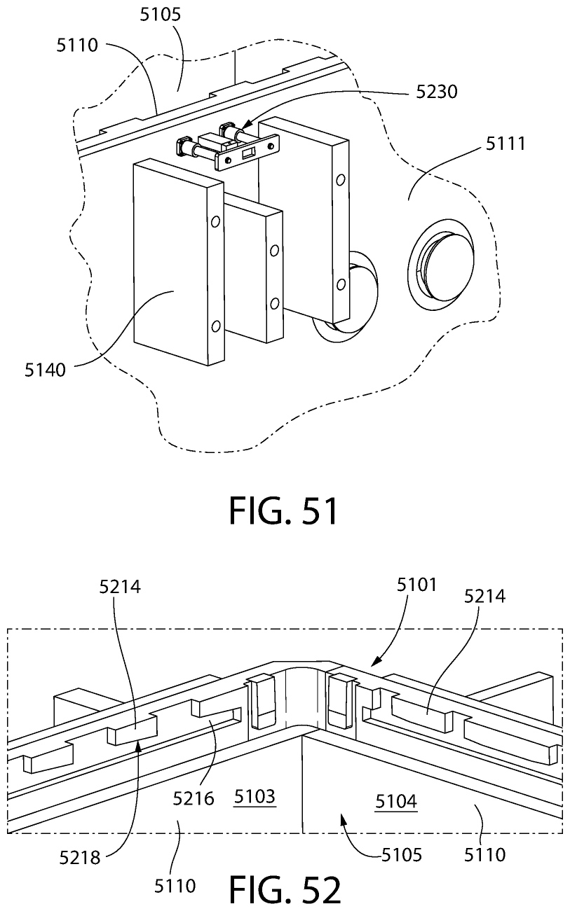

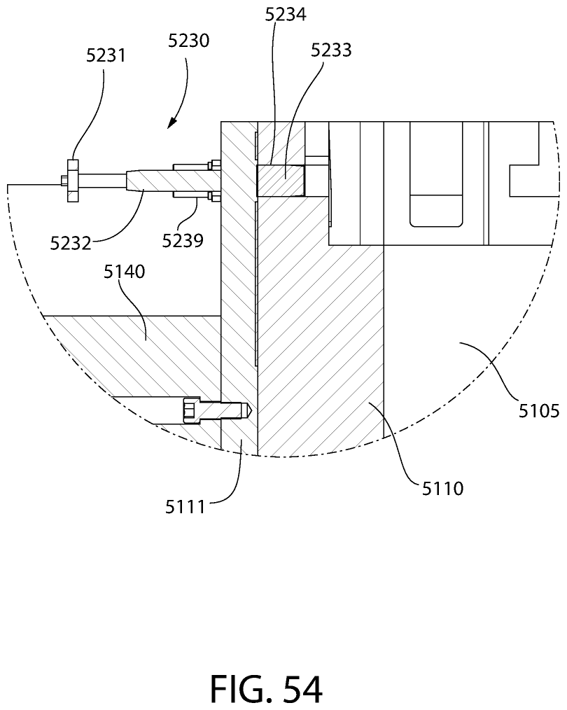

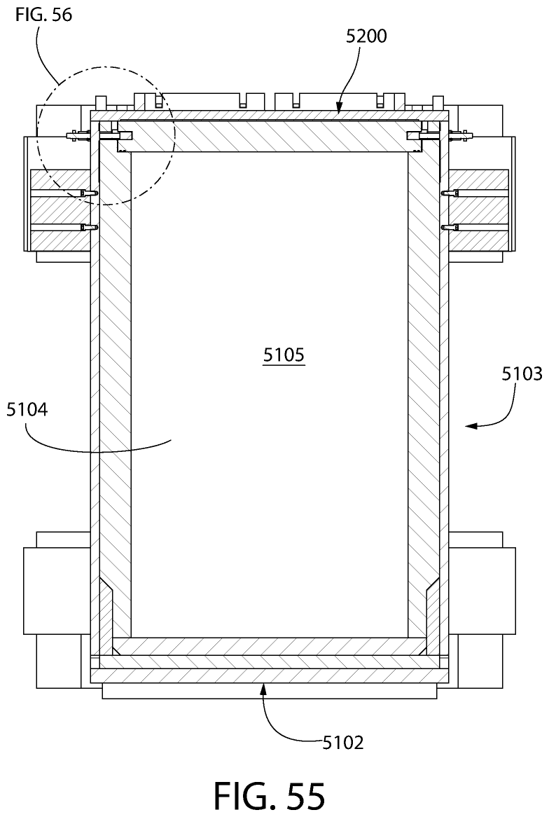

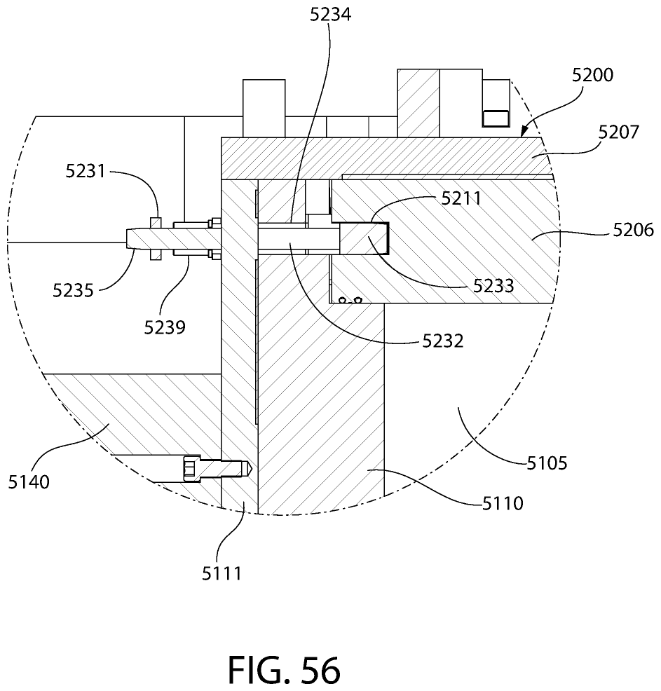

FIGS. 31-58 show various aspects of the nuclear waste transport and storage system. The system includes nuclear waste transfer and storage cask 5100 (hereafter nuclear waste cask for brevity) which is usable transport and/or store high level nuclear waste materials. Cask 5100 comprises an elongated rectilinear-shaped cask body 5101 defining a longitudinal axis 5LA and the lower part of the containment barrier for the nuclear waste. The body 5101 may have a rectangular cuboid configuration in one embodiment (as shown) comprising an axially elongated bottom wall 5102, a parallel pair of longitudinal sidewalls 5103 attached to the bottom wall, and a pair of lateral end walls 5104 attached to opposite ends of the bottom wall between the sidewalls. The longitudinal sidewalls are attached to the longitudinal sides or edges of the bottom wall. End walls 5104 are oriented transversely and perpendicularly to longitudinal axis 5LA and longitudinal sidewalls 5103, and the longitudinal sidewalls are oriented parallel to the axis to form the box-like structure shown. In one embodiment, the sidewalls and end walls may be welded to each other and in turn to the bottom wall to form a weldment. Four corners 5107 are formed at the intersection of the sidewalls 5103 and end walls 5104 which extend vertically along the height of the cask body 5101.

Bottom wall 5102 has a flat top surface 5102a and parallel opposing flat bottom surface 5102b. The bottom wall is configured to be seated on a horizontal support surface such as a concrete pad. The interior and exterior surfaces of each of the longitudinal sidewalls 5103 and end walls 5104 may be generally flat and parallel to each other as well.

Cask 5100 may be used in horizontal position as shown when transporting and storing nuclear waste. In this case, the vertical direction is defined for convenience of reference as being transverse and perpendicular to the longitudinal axis 5LA. A lateral direction is defined for convenience of reference in the horizontal direction as being transverse and perpendicular to the longitudinal axis.

The bottom wall 5102, longitudinal sidewalls 5103, and end walls 5104 collectively define an internal storage cavity 5105 configured for storing nuclear waste materials previously described herein. The bottom wall, longitudinal sidewalls, and end walls define and circumscribe an axially elongated top opening 5106 forming an entrance to the cavity for loading nuclear waste materials therein. The longitudinally-extending top opening 5106 extends for a substantial majority of the entire length of the cask body (less the thicknesses of the sidewalls and end walls). This provides a large opening which facilitates loading many different shapes and sizes nuclear waste materials into the cask 5100.

Longitudinal sidewalls 5103 and lateral end walls 5104 of the cask may each have a composite construction comprising a metallic inner containment plate 5110 adjacent to the storage cavity 5105 and a metallic outer radiation dose blocker plate 5111 abutted thereto. Bottom wall 5102 may similarly have a composite construction comprising a metallic inner containment plate 5112 adjacent to the storage; cavity and a metallic outer radiation dose blocker plate 5113. In some embodiments, as shown, an intermediate dose blocker plate 5114 may be sandwiched between the inner containment plate and outer dose blocker plate when needed to provide additional radiation shielding. In some non-limiting embodiments, the containment plates may be formed of steel alloy and the radiation dose blocker plates may be formed of a different steel material such as for example stainless steel for protection against corrosion by the exterior ambient environment. A suitable thickness of the containment and blocker plates may be used as needed to effectively reduce the radiation emitted from the cask to within regulatory compliant exterior levels for containment casks. As noted, the bottom wall and walls of cask 5100 may have an all metal construction without use of concrete. However, in other possible embodiments, concrete and additional or other radiation shielding materials including boron-containing materials for neutron attenuation and various combinations thereof may be provided if additional radiation blocking is needed. The bottom wall and wall construction materials used therefore do not limit the invention.

With continuing reference to FIGS. 31-58, cask 5100 further includes a longitudinally elongated closure lid 5200 which forms the upper containment barrier. Lid 5200 may be of rectangular shape in one embodiment to match the rectangular cuboid configuration of the cask body 5101 shown. Lid 5200 has a length and width sufficient to form a complete closure of the top opening of the cask in order to fully enclose and seal the internal storage cavity 5105 of the cask and nuclear waste materials. Lid 5200 includes an outward facing top surface 5201 and parallel bottom surface 5202 facing cavity 5105 of the cask body 5101 when positioned thereon, parallel longitudinal sides 5203 (i.e., long sides of the lid), parallel lateral ends 5204 short sides of the lid) extending between the longitudinal sides, and corners 5205 (four as shown) at the intersection of the longitudinal sides and lateral ends. Top and bottom surfaces 5201, 5202 are the major surfaces of the lid having a greater surface area than other surfaces on the lid.

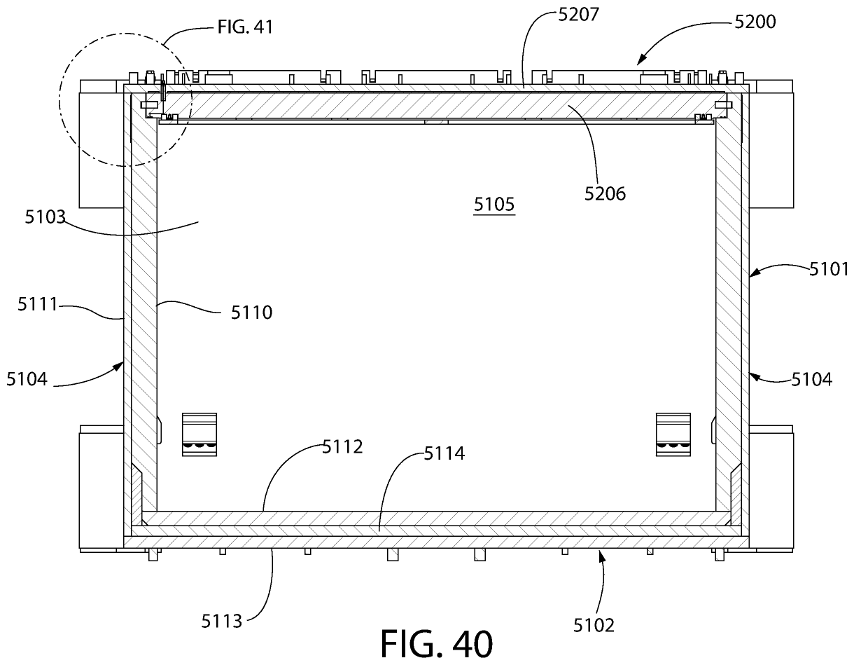

Referring additionally to FIGS. 40-47B, closure lid 5200 may have a composite construction comprising a metallic inner containment plate 5206 at bottom located adjacent to the storage cavity 5105 when the lid is position on the cask body 5101, and a top metallic outer radiation dose blocker plate 5207. Containment plate 5206 defines bottom surface 5202 of the lid and blocker plate 5207 defines top surface 5201. An insulation board 5208 may be sandwiched between plates 5206 and 5207 for protection against fire event.

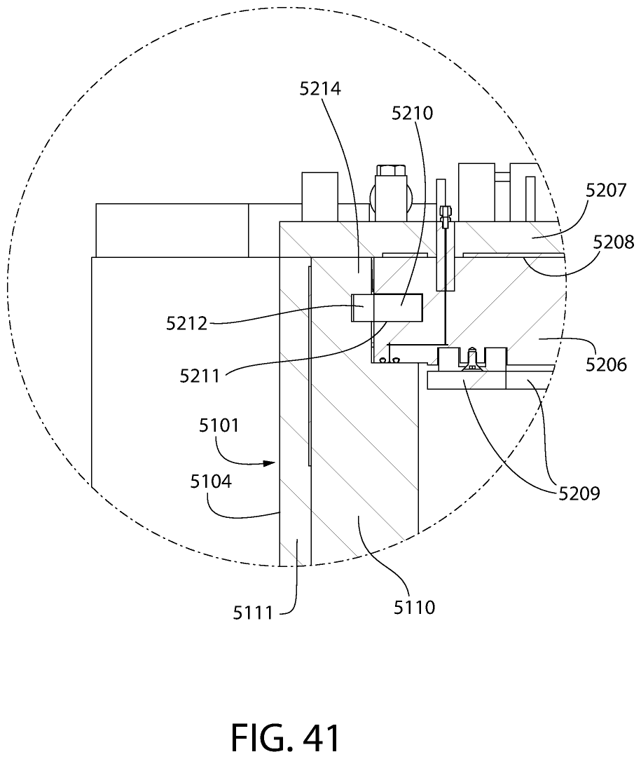

In one embodiment, a peripheral lid spacer frame 5209 may be attached to the bottom containment plate 5206 of lid 5200. Frame 5209 has an open space-frame structure which extends perimetrically around the bottom surface 5202 of the lid. The frame 5209 may include an X-brace 5209a extending through the interior space defined by the peripheral linear members of the frame to add structural reinforcement and bracing. When lid 5200 is positioned on cask body 5101, inner containment plate 5206 and frame 5209 are received completely into storage cavity 5105 of the cask (see, e.g., FIGS. 40 and 41).

A compressible gasket 5220 may be disposed on the bottom surface 5202 of the lid 5200 to form a gas-tight seal at the interface between the lid and cask body. Gasket 5220 has a continuous perimetrically extending shape which is complementary configured dimensionally to conform to and circumscribed the top end of the cask body 5101 on all sides. Gasket 5220 therefore extends perimetrically along the tops of the longitudinal sidewalls 5103 and lateral end walls 5104 of the cask to form an effective seal. Gasket 5220 may be formed of any suitable compressible material, such as elastomeric materials in some embodiments.

According to one aspect of the disclosure, a bolt-free cask locking mechanism provided to lock and seal lid 5200 to cask body 5101. FIGS. 40-48 and 52-58 in particular show various aspects of the bolt-free cask locking mechanism, which will now be further described in detail.

Lid 5200 and cask body 5101 include a plurality of locking features which cooperate to form the locking mechanism. The cask locking mechanism may comprise a plurality of first locking protrusions 5212 spaced apart on the lid which are selectively and mechanically interlockable with a plurality of second locking protrusions 5214 spaced apart on the cask body to lock the lid to the cask body. First locking protrusions 5212 are movable relative to the lid and cask body 5101, whereas second locking protrusions 5214 are fixed in position on and stationary with respect to the cask body.

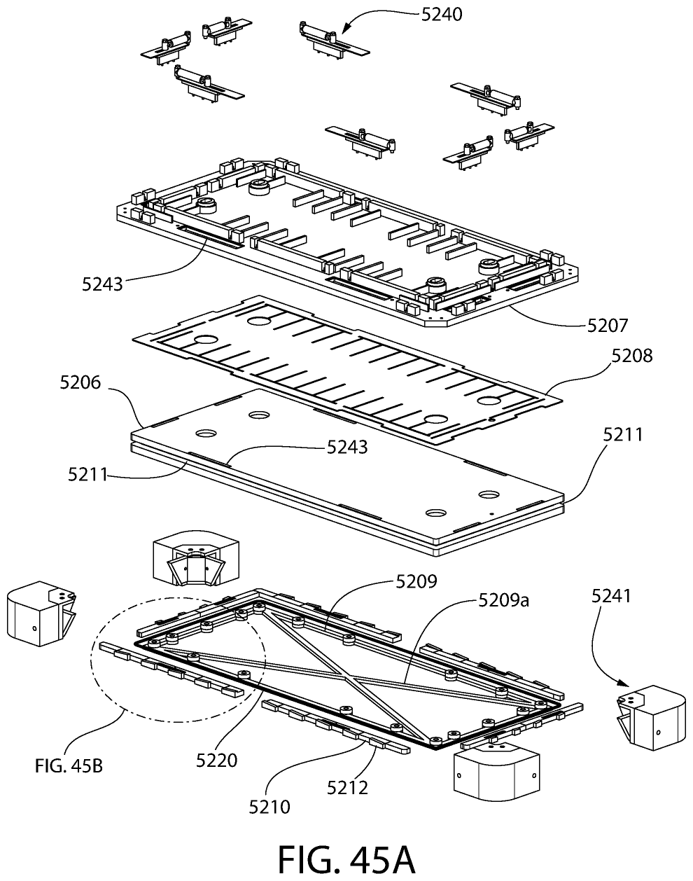

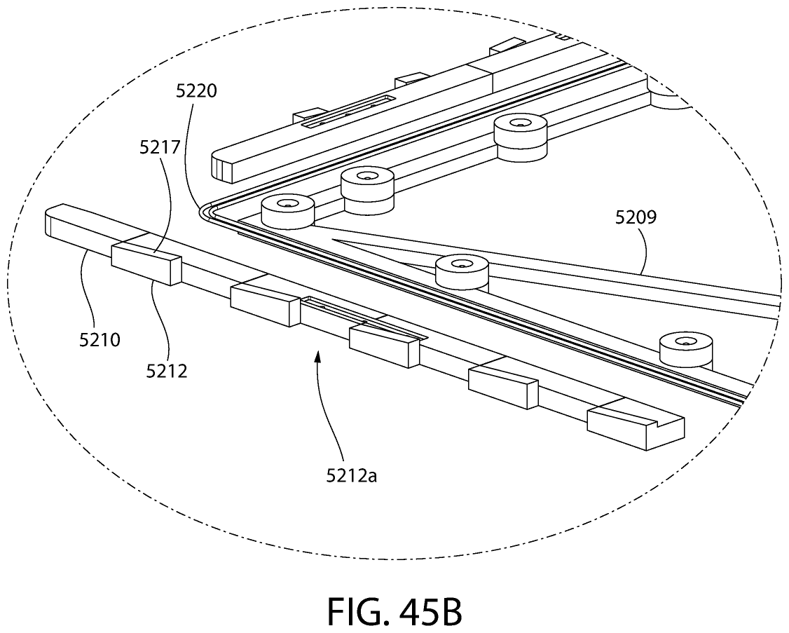

The locking features of the lid 5200 comprises at least one first locking member 5212a, which may be in the form of a linearly elongated locking bar 5210 for locking the lid to the cask body (see, e.g., FIGS. 45B and 59-62). 1n one embodiment, a plurality of elongated locking bars 5210 are arranged perimetrically around the outer peripheral portions of the lid on longitudinal sides 5203 and lateral ends 5204. First locking protrusions 5212 are formed on and may be an integral unitary structural part of the locking bars in one embodiment being formed of single monolithic piece of cast or forged metal. In other possible less preferred but satisfactory embodiments, locking protrusions 5212 may be discrete elements separately attached to the locking bars 5210 via mechanical fasteners or welding.

Locking bars 5210 are slideably disposed in corresponding outward facing elongated linear guide channels 5211 formed in the longitudinal sides and lateral ends of the lid 5200. The locking bars are movable back and forth in opposing directions within the guide channels relative to the lid. Each locking bar 5210 includes a plurality of the first locking protrusions 5212 which project outwardly from the bar beyond the outward facing surfaces of the longitudinal sides 5203 and lateral ends 5204 of the lid. The linear array of locking protrusions 5212 are spaced apart to form openings 5213 between adjacent locking protrusions for passing the second locking protrusions 5214 on the cask body 5101 therethrough, as further described herein.

The longitudinal sides 5203 and lateral ends 5204 of the lid 5200 may each include at least one locking bar 5210. In one preferred but non-limiting embodiment, as illustrated, the lateral ends 5204 of the lid may include a pair of the locking bars 5210 and the longitudinal sides 5203 of the lid may similarly include a pair of locking bars. This forms a unique arrangement and interaction between the locking bars to maintain a locked position, as further described herein.

The corresponding locking features of the bolt-free cask locking mechanism on cask body 5101 include at least one second locking member 5214a comprising the second locking protrusions 5214. Locking member 5214a may comprise upper portions of cask body 5101 in which the second locking protrusions 5214 and related features such as locking slot 5216 described below are integrally formed with the cask body inside storage cavity 5105. Locking protrusions 5214 are fixedly disposed in linear arrays on the cask body adjacent to top ends of the longitudinal sidewalls 5103 and lateral end walls 5104 of the body and cask body top opening 5106. The second locking protrusions 5214 are therefore stationary and not movable relative to the cask body. The second locking protrusions 5214 project inwardly into the nuclear waste storage cavity 5105 from the interior surfaces of the longitudinal sidewalls 5103 and lateral end walls 5104 of the cask body. Second locking protrusions 5214 therefore are arranged around the entire perimeter of the cask body to interface with the first locking protrusions 5212 of lid 5200.

The linear array of second locking protrusions 5214 are spaced apart to form openings 5215 between adjacent locking protrusions for passing the first locking protrusions 5212 on the lid therethrough. A linearly elongated locking slot 5216 is formed and recessed into the cask body 5101 immediately below the second locking protrusions 5214 on each of the longitudinal sidewalls 5103 and end walls 5104 of the cask body. The locking slots 5216 form continuous and uninterrupted inwardly open structures having a length which extends beneath at least all of the second locking protrusions on each of the longitudinal sidewalls 5103 and lateral end walls 5104 of the cask body as shown. Locking slots 5216 therefore extend for a majority of the lengths/widths of the cask body longitudinal sidewalls and end walls. Locking slots 5216 are in communication with the openings 5215 between the second locking protrusions 5214 to form an insertion pathway for the first locking protrusions 5212 of lid 5200 to enter the locking slots.

In one preferred but non-limiting construction, the openings 5215 between the second locking protrusions 5214 and the elongated locking slots 5216 may be formed as recesses machined into the cask body 5101 by removing material from longitudinal sidewalls 5103 and lateral end walls 5104. The material remaining therefore leaves the second locking protrusions 5214 in relief. Second locking protrusions 5214 therefore in this case are formed as integral unitary and monolithic parts of the cask body material. In other possible constructions, however, the second locking protrusions 5214 may be separate structures which are welded or otherwise fixedly attached to the cask body 5101. In this latter possible construction, no locking slot 5216 is formed but the cask locking mechanism may nonetheless still function satisfactorily to lock the lid to the cask body. In yet other possible constructions, the second locking protrusions 5214 and locking slots 5216 may be formed on linearly elongated closure bars of metal having the same composite construction as the longitudinal sidewalls 5103 and end walls 5104 previously described herein. The closure bars are in turn welded onto the tops of each longitudinal sidewalls and end walls to produce the same structure in the end as illustrated herein.

With continuing reference to FIGS. 40-48 and 52-58, the first and second locking protrusions 5212, 5214 may be generally block-shaped structures having a rectangular configuration. In one preferred but non-limiting embodiment, the first and second locking protrusions may each be wedge-shaped defining locking wedges having at least one tapered locking surface 5217 or 5218. The locking protrusions may be configured and arranged such that the tapered locking surfaces 5217 of the first locking protrusions 5212 on lid 5200 are each slideably engageable with one of the tapered locking surfaces 5218 of a corresponding second locking protrusion 5214 of the cask body 5101. In one embodiment, the tapered locking surfaces 5217 of the first locking protrusions 5212 on lid 5200 may be formed on a top surface thereof, and the tapered locking surfaces 5218 of the second locking protrusions 5214 on cask body 5101 may be formed on a bottom surface thereof. When the first and second locking protrusions are engaged to lock the lid to the cask body, the tapered locking surfaces 5217, 5218 become slideably engaged forming a generally flat-to-flat interface therebetween. This creates a wedging-action which draws the lid 5200 towards against the cask body 5101 to fully compress the gasket 5220 therebetween which forms a gas-tight seal of the cask internal storage cavity 5105 and its nuclear waste material content.

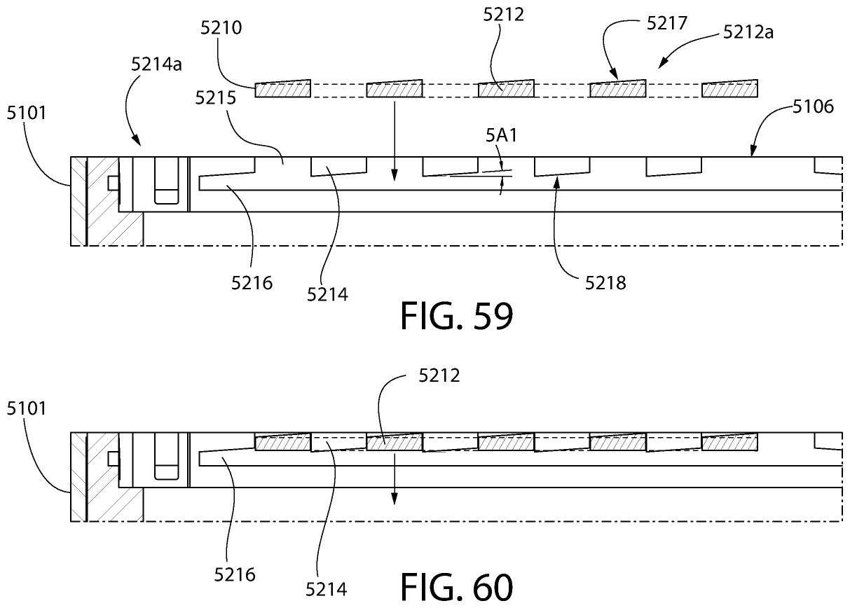

The tapered locking surfaces 5217 and 5218 preferably have the same taper angle 5A1 (see, e.g., FIG. 59) to form the generally flat-to-flat interface therebetween when mutually and frictionally engaged via the wedging action. Any suitable taper angle 5A1 may be used. In one representative but non-limiting examples, the taper angle 5A1 preferably may be between about 2 and 20 degrees. Other tapered angles may be used where appropriate.

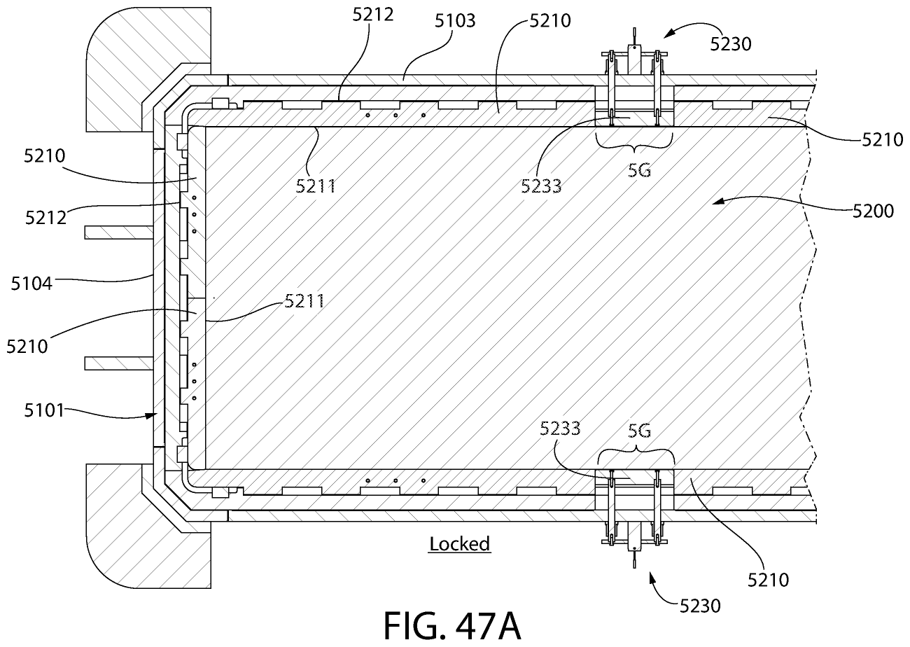

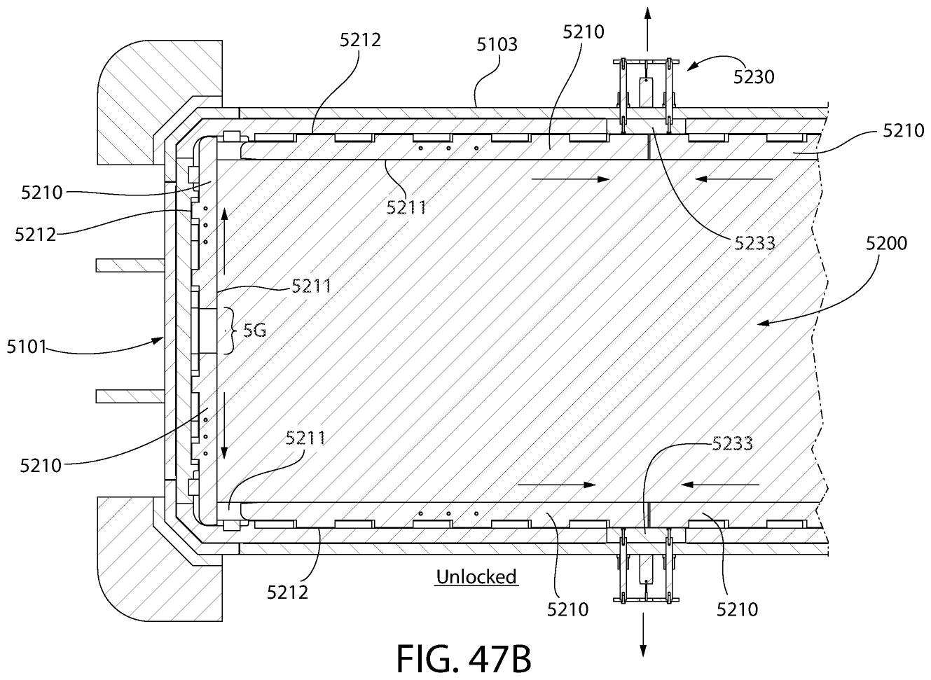

The locking bars 5210 with first locking protrusions 5212 on lid 5200 thereon are slideably movable between a locked position or state (see, e.g. FIG. 47A) in which the first and second protrusions 5212, 5214 are mutually engaged to prevent removal of the lid 5200 from the cask body 5101 (see, e.g. FIG. 41), and an unlocked position or state (see, e.g. FIG. 47B) in which the first and second protrusions are disengaged to allow removal of the lid from the cask body in a vertical direction transverse to longitudinal axis 5LA of the cask.

To move the locking bars 5210 with sufficient applied force to frictionally interlock the first and second locking protrusions 5212, 5214, and to concomitantly minimize radiation dosage to operating personnel, a remote lid operating system may be provided. This system is operably coupled to each of the locking bars 5210 and configured to advantageously move the locking bars 5210 between the locked and unlocked positions from a remote radiation safe distance and area. This obviates the need for operators to manually operate the locking bars directly at the cask during the lid-to-cask body closure and locking process.

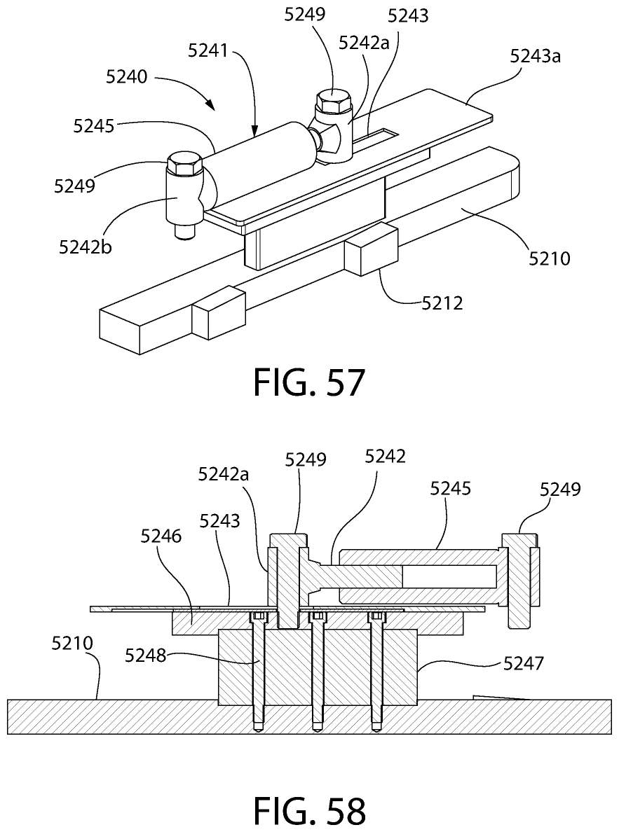

In one embodiment, the remotely-operated lid operating system comprises a local actuator 5240 mounted on the top surface 5201 of lid 5200 for and coupled to each of the locking bars 5210. FIGS. 57 and 58 show actuators 5240 in isolation and detail. Each actuator 5240 is an assembly which may generally comprise a cylinder-piston assembly 5241 including cylinder 5245 and an extendible/retractable piston rod 5242 slideably received inside the cylinder. The cylinder-piston assembly is fixedly attached to lid 5200. Cylinder 5245 may be fixedly mounted to the lid via a bolt 5249 passing through a tubular proximal mounting end 5242b as shown. Pistol rod 5242 has a tubular distal working end 5242a fixedly coupled to the locking bar 5210 through an elongated operating slot 5243 formed through the lid. The piston rod 5242 is therefore moves the locking bar 5210 in the manner described herein. In one embodiment, slot 5243 may be formed in a lid insert plate 5243a which in turn is mounted to the lid. A threaded bolt 5249 may be used to couple the piston rod to the locking bar 5210 via an intermediate block assembly comprising an upper mounting block 5246 and lower mounting block 5247. Upper block 5246 may be formed as integral part of lid insert plate 5243a in some embodiments. Piston rod 5242 is fixedly bolted to upper mounting block 5246. Upper mounting block 5246 is fixedly mounted to lower mounting block 5247 via a plurality of threaded fasteners 5248 which extend through the upper mounting block and are threadably engaged with the locking bar 5210 (see, e.g., FIG. 58). The mounting block assembly provides a robust coupling of the piston rods 5242 to the locking bars 5210 which can withstand the shear forces generated when the cylinder-piston assemblies 5241 are actuated to drive the locking protrusions 5212, 5214 of the lid 5200 and cask body 5101 into locking engagement.

The cylinder-piston assembly 5241 may be either (1) hydraulically operated wherein the working fluid is oil, or (2) pneumatically operated wherein the working fluid is compressed air. Oil or air hoses are fluidly coupled to the cylinder-piston assemblies (not shown) and operated from a remote hydraulic or pneumatic control unit in a conventional manner which comprises an air compressor or hydraulic pump with appropriate valving depending on the type of system provided. When actuated, the locking bar actuators 5240 function to slide the locking bars 5210 between the locked and unlocked positions (FIGS. 47A and 47) via extending or retracting the piston rod 5242. It bears noting that the use of hydraulic or pneumatic means to move the locking bars 5210 applies a greater force to the locking bars to form tight locking engagement via the wedging-action between the first and second locking protrusions of the lid and cask body than could be provided by manually actuating the locking bars 5210. This advantage, coupled with avoiding exposure of operating personnel or workers to radiation dosage are notable benefits of the present remote lid operating system.

Interaction between the locking protrusions 5212, 5214 and a related process/method for locking the nuclear waste cask 5100 (i.e., lid 5200 to cask body 5101) are described farther below. The movement and functioning of the locking bars 5210, however, is first further described.

FIGS. 47A and 47B show the locked and unlocked positions of the locking bars 5210 on lid 5200. Retention features are provided as a safety mechanism which lock and retain the locking bars in the locked position to prevent the lid 5200 from being unintentionally unlocked from the cask body 5101, such as could potentially result from substantial force impacts occurring during transporting and handling the cask (e.g., lifting, lowering, or loading the cask onto a transport vehicle/vessel), or during a regulatory postulated cask drop event.

In one embodiment, the locking bars 5210 on the longitudinal sides 5203 of lid 5200 are moveable towards each other to form the unlocked position shown, and away from each other to form the locked position shown. Conversely, the locking bars 5210 on the lateral ends 5204 of the lid are moveable towards each other to form the locked position, and away from each other to form the unlocked position. This apparent dichotomy serves a purpose. When locking bars 5210 on the lateral ends 5204 of the lid are therefore positioned and abutted together in the locked position, terminal end portions 5210a of the locking bars on the longitudinal sides 5203 of the lid are positioned to overlap and engage/block the locking bars on the lateral ends 5204 of the lid from being moved apart to the unlocked position (see, e.g., FIG. 47A). This forms a first locking bar retention feature which locks the lid lateral end locking bars 5210 in the locked position.

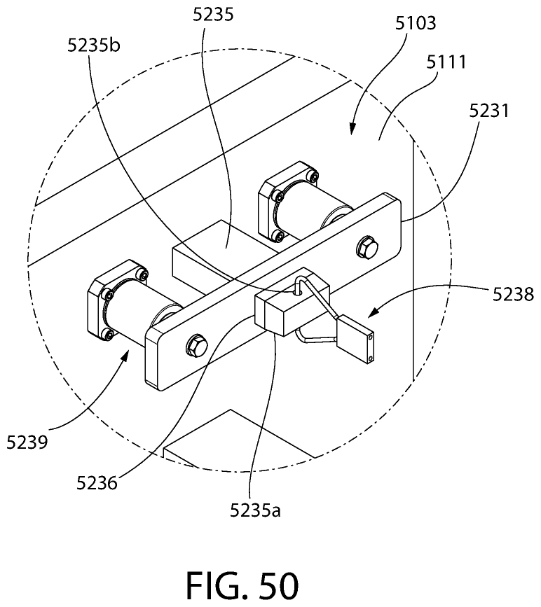

The second locking bar retention feature acts on the locking bars 5210 on the longitudinal sides 5203 of the lid 5200 to lock the lid longitudinal side locking bars in the locked position. This retention feature comprises a locking handle assembly 5230 slideably mounted on each of the longitudinal sidewalls 5103 of the cask body 5101 (see, e.g., FIGS. 47A, 47B, 49-51, and 53-56). Each locking handle assembly 5230 includes an elongated proximal handle 5231 configured for receiving an applied force generated by a user such as via grasping or a tool, a distal elongated locking block 5233, and a securement bar 5235. The locking block 5233 is coupled to the handle 5231 by one or more elongated coupling rods 5232 of any suitable polygonal or non-polygonal cross-sectional shape. Preferably a pair of coupling rods 5232 are provided. Securement bar 5235 is fixedly attached to the exterior surface of the cask body longitudinal sidewalls 5103 (e.g., welded) and has a proximal end 5235a which is insertable through an aperture 5236 in the handle 5231. End 5235a may project through aperture 5236 when the handle assembly is fully inward and can be secured in place (e.g., FIG. 50 further described herein).

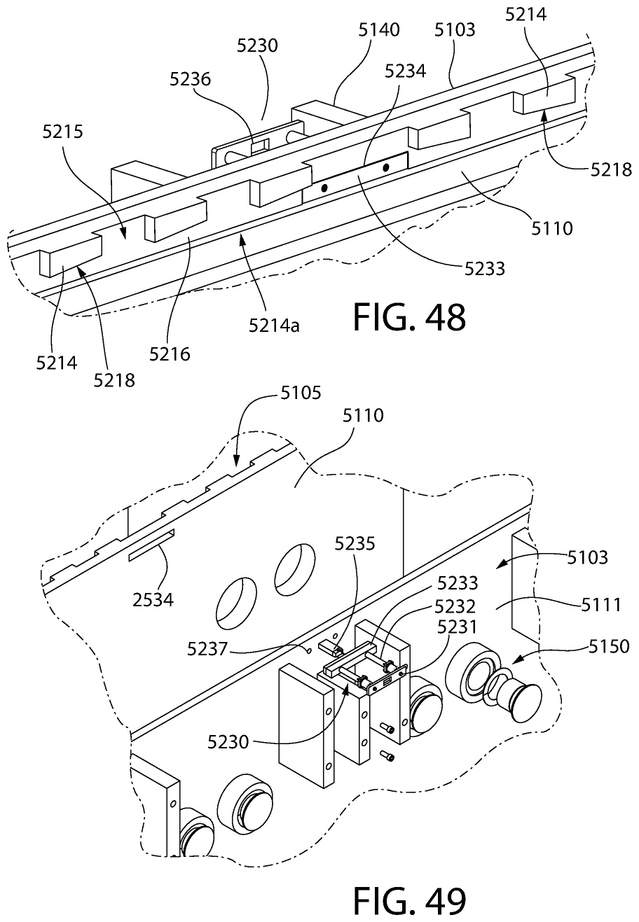

The locking handle assemblies 5230 are positioned on each longitudinal sidewall 5103 of the cask body 5101 to allow the locking block 5233 to be manually and selectively moved into and out of the locking slots 5216 on the cask body sidewalls. A windows 5234 formed in each longitudinal sidewall 5103 allows the locking block 5233 to access the guide channels 5216. More particularly, window 5234 is formed in and extends completely through inner containment plate 5110 of the longitudinal sidewalls 5103 of the cask body. Locking block 5233 is completely retractable from locking slot 5216 into the containment plate 5110 to allow insertion of first locking protrusions 5212 on locking bars 5210 into and slideably moved along the locking slot 5216 beneath second locking protrusions 5214 of the cask body. The outer radiation dose blocker plate 5111 comprises a pair of holes 5237 to permit the two coupling rods 5232 to be coupled to locking block 5233 located inside the blocker plate in window 5234 of the inner containment plate 5110 (see, e.g., FIG. 48). A pair of cylindrical mounting flange units 5239 may be used to fixedly mount each locking handle assembly 5230 to the dose blocker plate 5111 on the longitudinal sidewalls 5103 of cask body 5101 (see, e.g., FIG. 50). Flange units 5239 may be bolted/screwed or welded to the outer blocker plate 5111. The flange units 5239 further act as standoffs to limit the maximum inward projection of the locking block 5233 into the locking slot 5216 of the cask body. The coupling rods 5232 are slideably inward/outward through the flange units to change position of the locking handle assemblies 5230.

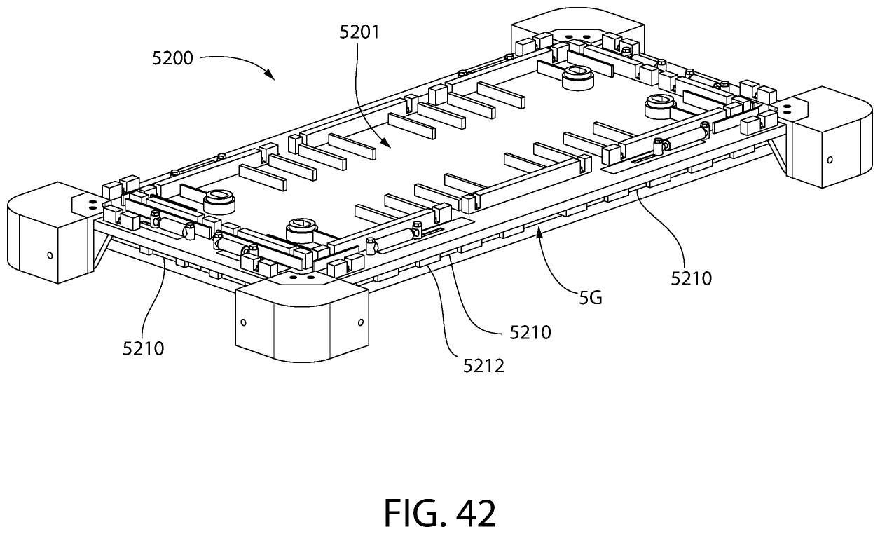

The locking handle assemblies 5230 are moveable via handles 5231 between (1) an inward blocking position in which the locking blocks 5233 project into the locking slots 5216 of the cask body 5101 beneath the second locking protrusions 5214, and (2) an outward non-blocking position in which the locking blocks 5233 are completely retracted from the locking slots. The non-blocking position allows locking bars 5210 with first locking protrusions 5212 thereon to enter and slide back and forth in the locking slots 5216 between the locked and unlocked positions (both previously described herein) when the lid 5200 is positioned on cask body 5101. Once the locking bars are in the locked position, a gap 5G is formed between each pair of locking bars on the longitudinal sides 5203 of the lid (see, e.g., FIGS. 42 and 47A). Moving the locking handle assemblies 5230 to the inward blocking position locates the locking blocks 5233 in and fills the gaps 5G on each longitudinal sidewall 5103 of the cask body (within guide channels 5211 of lid 5200). The locking bars 5210 therefore cannot be drawn back together to their unlocked position, thereby locking the locking bars in the locked position due to interference between the locking blocks 5233 and locking bars. To move the locking bars 5210 on longitudinal sidewalk 5103 to the unlocked position, the locking blocks 5233 are first withdrawn via handles 5231 of the locking handle assemblies 5230 to re-open gap 5G, thereby allowing the longitudinal sidewall locking bars to slide together again to the unlocked position.

When each handle assembly 5230 is in the inward blocking position, the securement end 5235a of securement bar 5235 is projected through apertures 5236 in handles 5231. Any suitable commercially-available cable-lock security tag or seal tag 5238 as shown may be coupled through hole 5235b in securement bar 5235 to lock the handle assemblies in the inward blocking position. Should the cask 5100 be impacted or dropped during handled, the lid 5200 will remain locked to the cask body 5101 since the handle assemblies 5230 cannot be moved outward to unlock the lid. The security tag also provides visual indication that the lid is in the locked position to operating personnel. This is especially helpful in situations where the cask lid 5200 may be loaded with radioactive materials and locked to the cask body 5101 at one location, and then the cask is transported to a more remote receiving location. The crew at the receiving location can readily confirm the lid is in the locked position or state.

A process or method for locking the nuclear waste storage cask 5100 using the foregoing features will now be briefly described. FIGS. 59-62 are sequential views showing the relationship between the first and second locking protrusions 5212, 5214 during the lid mounting and cask locking process.

The process or method generally includes first placing the locking bars 5210 on longitudinal sidewalls 5103 and lateral end walls 5104 of lid 5200 in their unlocked position and the locking blocks 5233 on locking handle assemblies 5230 in their non-blocking positions which retracts the locking blocks 5233 from the locking slots 5216 on the longitudinal sidewalls 5103 of the cask body 5101 (FIG. 47B). The locking bar actuators 5240 or manual means may be used to perform the foregoing step. The locking bars 5210 on longitudinal sides 5203 of lid 5200 are together, and locking bars on lateral ends 5204 of the lid are spaced apart forming gap 5G therebetween as shown. The lid is positioned over and align with the cask body 5101 wherein the lid first locking protrusions 5212 are vertically aligned with the openings 5215 between second locking protrusions 5214 on the cask body (FIG. 59).

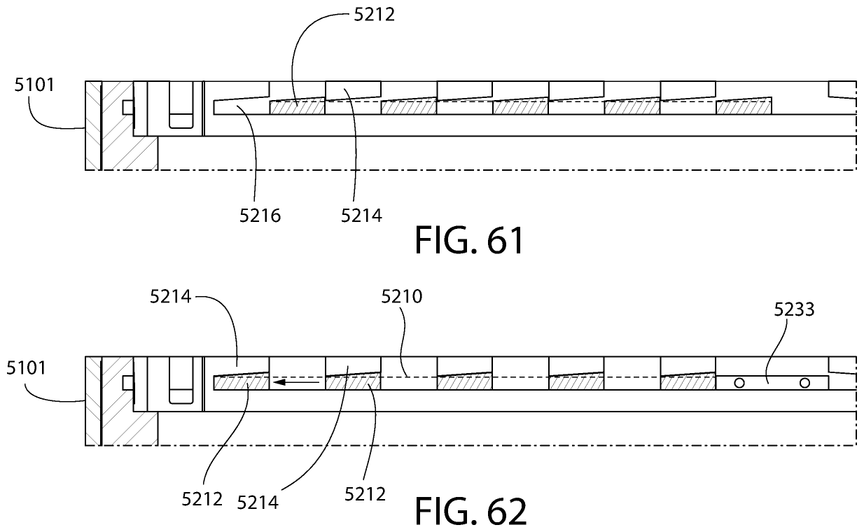

Next, the closure lid 5200 is lowered and positioned on top of the cask body 5101 over the top opening 5106. This step first vertically inserts the peripheral array of first locking protrusions 5212 on locking bars 5201 of lid 5200 between the peripheral array of second locking protrusions 5214 disposed on the cask body 5101 around the top opening (FIG. 60). As the lid engages the top of the cask body 5101, the first locking protrusions pass completely through the openings 5215 between the second locking protrusions 5214 and enter the horizontally elongated locking slots 5216 in a position below the second locking protrusions (FIG. 61). In turn, the second locking protrusions 5214 pass through openings 5213 between the first locking protrusions 5212 and become positioned above the first locking protrusions.

The process or method continues with then sliding the locking bars 5210 to their locked positions (FIGS. 47A and 61), which moves the first locking protrusions 5212 beneath the second locking protrusions 5214 in a horizontal locking plane oriented parallel to the bottom wall 5102 and passing through the locking slots 5216. This step may be performed by actuating the hydraulic or pneumatic cylinder-piston assembles 5241 of the locking bar actuators 5240 from a location remote from the cask to minimize radiation exposure of operating personnel. Sliding the locking bars 5210 slideably and frictionally engages the first locking protrusions 5212 of the lid with bottom surfaces of the second locking protrusions 5214 of the cask body 5101. Specifically, the tapered locking surfaces 5217, 5218 of the wedge-shaped locking protrusions 5212, 5214 become mutually locked in increasingly tightening frictional engagement via the wedging-action produced. This draws lid 5200 downward with added force beyond the weight of the lid alone onto and against the cask body 5101 to fully compress gasket 5220 and seal the cask cavity 5105. The gasket is now compressed further than when the lid 5200 first engages the cask body before the cask locking mechanism is actuated to draw the lid farther downward.

Now that the lid 5200 is fully coupled to the cask body 5101, the locking handle assemblies 5230 may be moved to their inward blocking positions to insert the locking blocks 5233 between each pair of locking bars 5210 on the longitudinal sides 5103 of the lid, thereby preventing sliding and unlocking of the longitudinal side locking bars (FIG. 47A). The handle assemblies therefore retain the locked positions of the locking bars on the cask longitudinal sidewalls 5103, which in turn retains the locking bars on the cask end walls in the locked position as previously described herein.

It bears noting that although the locking bars 5210 with locking protrusions 5212 are shown and described herein as being slideably mounted to the lid 5200 and locking protrusions 5214 are shown and described as being fixedly mounted to the cask body 5101 in one embodiment, in other embodiment the arrangement may be reversed. Accordingly, the locking bars 5210 may be slideably mounted to guide channels 5211 formed in the cask body while the fixed locking protrusions 5214 may instead be fixedly mounted to the closure lid. This alternate arrangement provides the same benefits and is operated in the same manner previously described herein. The locking bar hydraulic or pneumatic actuators 5240 in turn would be mounted to the cask body for operating the locking bars 5210.

Although the cask locking mechanism with locking bars 5210 and locking protrusions 5212, 5214 are shown and described herein as being applied to a box-shaped rectangular cuboid cask body and rectangular lid, the locking mechanism may be applied with equal benefit to a conventional cylindrical cask body and circular lid. The fixed second locking protrusions 5214 may be arranged on either the cylindrical cask body or lid, and the locking bars 5210 may be mounted on the other one of the cask body or lid. The locking bars and guide channels for the cylindrical cask application may be arcuately curved and operated via the hydraulic or pneumatic locking bar actuators 5240 previously described herein if mounted on either the cask body or circular lid. Alternatively, both the locking protrusions 5212, 5214 may be fixedly mounted to the cylindrical cask body and lid, and the slideable locking bars may be omitted. In this case, the lid may simply be rotated relative to the cylindrical cask body to slideably and frictionally engage the wedge-shaped locking protrusions to form a breech lock type closure. The lid may be rotated via assistance form the hydraulic/pneumatic actuators. Based on the foregoing alternative embodiments of the cask locking mechanism and description already provided herein, it is well within the ambit of those skilled in the art to implement any of these options without undue experimentation.

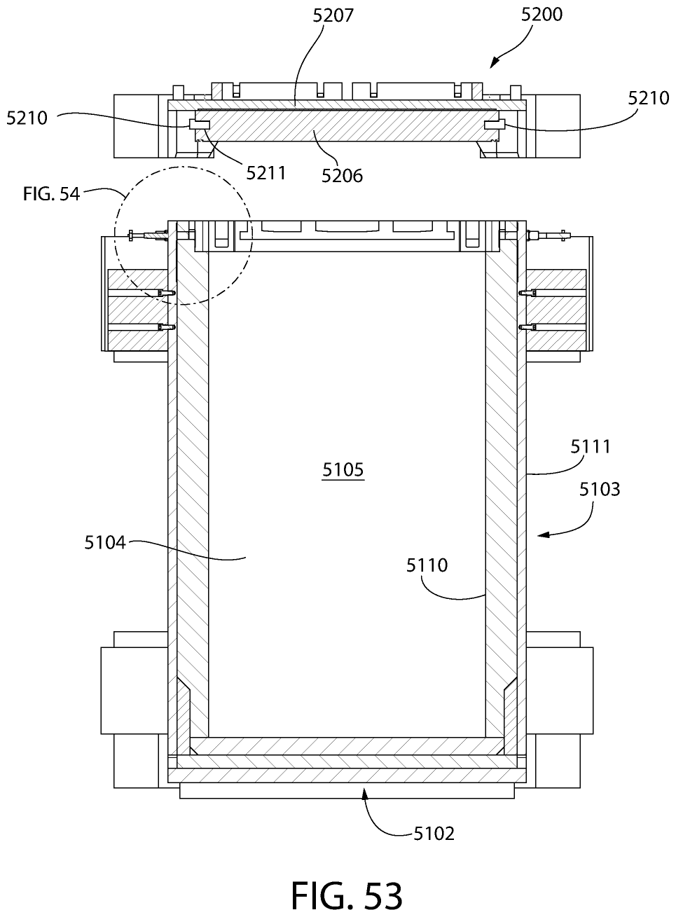

With general reference to FIGS. 31-40 and 51-53, an impact absorption system is provided to protect the cask 5100 and containment barrier from undue damage should the cask be forcibly impacted or dropped during transport and handling. In one embodiment, each of the longitudinal sidewalls 5103 and lateral end walls 5104 of the cask body 5101 comprises a plurality of outwardly protruding impact absorber bars 5140 fixedly coupled thereto. The closure lid 5200 and bottom surface 5102 of the cask body may also include multiple impact absorber bars 5140 fixedly coupled thereto. The bars 5140 may be each configured and arranged in appropriate locations on and in a pattern appropriate to meet regulatory requirements (e.g., Nuclear Regulator Commission or NRC) for surviving a postulated cask impact/drop event. In one embodiment, the impact absorber bars 5140 may be configured as rectangular blocks of suitable thickness and dimension for the intended purpose. The locking handle assemblies 5230 on longitudinal sidewalls 5103 of cask body 5101 may each be protected between at least a pair of absorber bars 5140 located proximately to the assembly on each side. These protective impact absorber bars have depth measured perpendicularly to the exterior surface of the cask body longitudinal sidewalls 5103 such that the handle assemblies 5230 do not protrude outwards beyond the bars. In one embodiment, the impact absorber bars 5140 may be bolted to the cask body and lid (see, e.g., FIGS. 53-56). This allows the bars to be readily replaced if damaged during a cask drop/impact event. In other embodiments, the bars 5140 maybe welded thereto.

Each corner 5107 of the cask body 5101 and corners 5205 of lid 5200 may be protected by corner impact absorbers 5141 fixedly coupled to corner regions. Sets of upper and lower corner impact absorber are provided to cover and shield the lid and adjacent upper corner regions of the cask body, and the bottom wall 5102 and adjacent lower corner regions of the cask body, respectively. In one embodiment, the corner impact absorbers 5141 may be assemblies comprising an inner corner bracket 5142 and outer corner blocks 5143 fixedly coupled thereto. Inner corner brackets 5142 may be fixedly coupled to the cask body 5101 at the lower corners of the body, and the lid and/or cask body at the upper corners. In one embodiment, the inner corner brackets 5142 and corner blocks 5143 may be fixedly coupled to and movable with lid 5200 as shown herein. The inner corner brackets 5142 have inward facing concave recesses configured to conform to the perpendicular and squared off corners of the cask body and lid. The outer corner blocks 5143 have concave recesses configured to conform to the exterior shape of the inner corner brackets 5142. The upper corner impact absorbers 5141 extend vertically downwards from the lid over the upper corners of the cask body, and horizontally wrap longitudinally and laterally around the side regions of the corners on both the cask body 5101 and lid 5200. The upper corner impact absorbers also extend partially over the top of the lid at the corners. The lower corner impact absorbers 5141 horizontally wrap longitudinal and laterally around the side regions of the corners on the cask body 5101 and bottom wall 5102, and partially underneath the bottom wall. In one embodiment, the inner corner brackets 5142 and outer corner blocks 5143 may be bolted or screwed together via threaded fasteners. The inner corner brackets 5142 may in turn be bolted or screws to the cask body 5101 and cask body and/or lid 5200 via threaded fasteners as applicable.

To facilitate handling the cask 5100, each of the longitudinal sidewalls 5103 of cask body 5101 may include a plurality of outwardly protruding lifting trunnions 5150 fixedly attached thereto. Lifting trunnions 5150 may be generally cylindrical in configuration and of the retractable type in one embodiment which are known in the art. The lid 5200 in turn may include a plurality of lifting lugs 5151 for handling the lid. Lugs 5151 are fixedly attached to the lid. Lifting lugs may be generally cylindrical in configuration in one embodiment. Any suitable number of lifting trunnions and lugs may be provided as needed to safely lift and maneuver the cask body and lid. Other configurations and constructions of the lifting trunnions and lugs may be provided which are suitable for lifting and maneuvering the weight of cask body and lid in a stable manner.

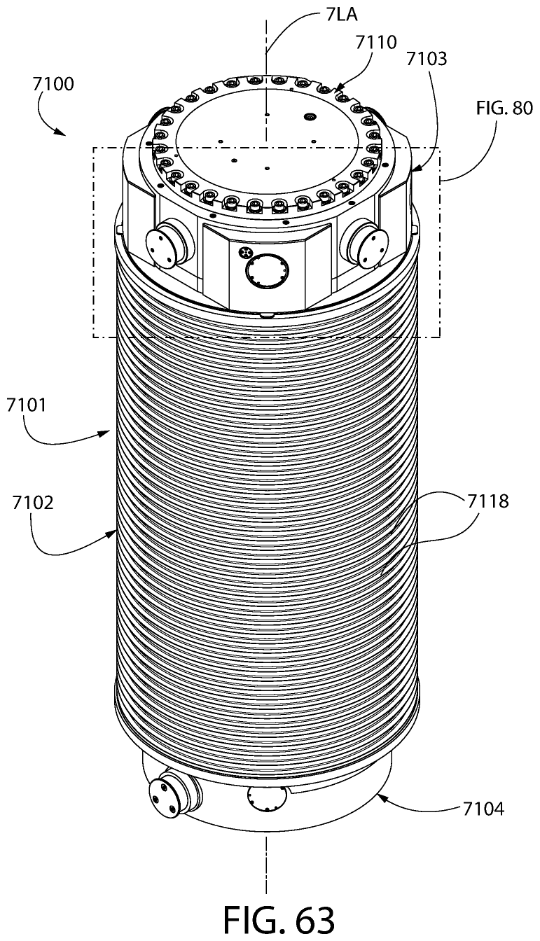

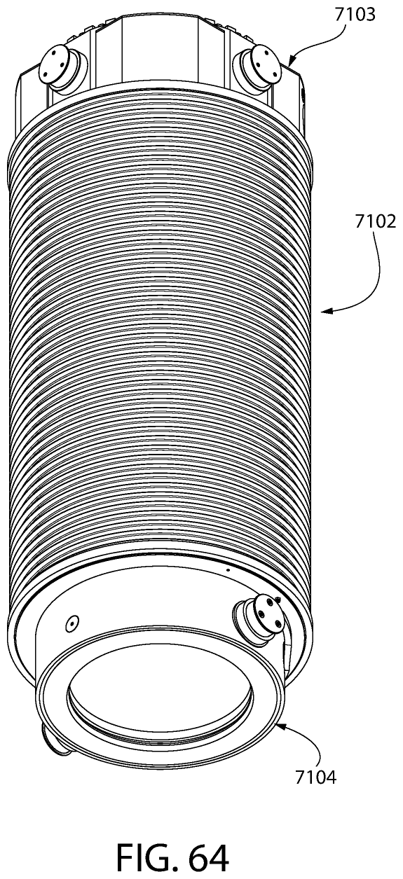

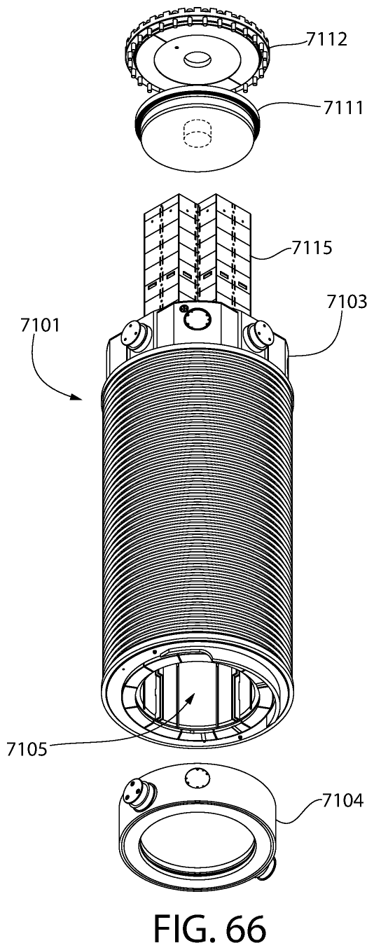

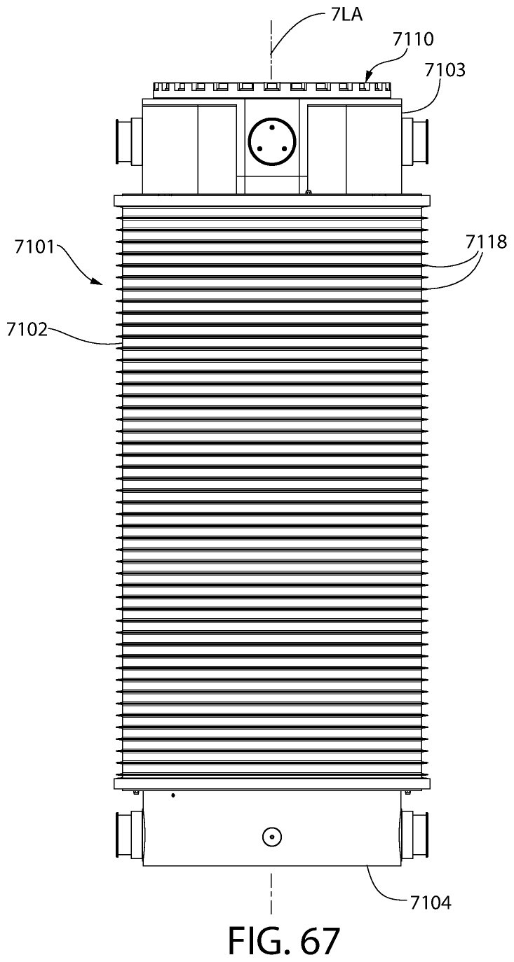

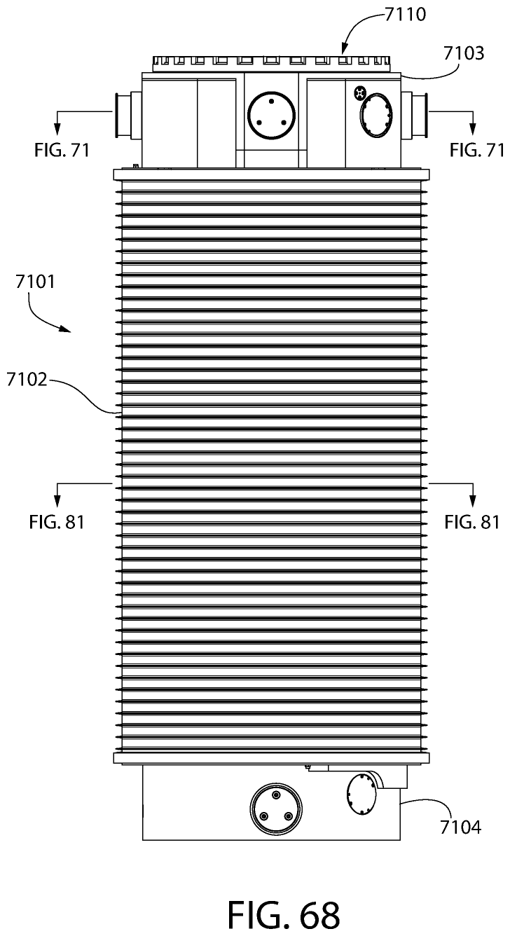

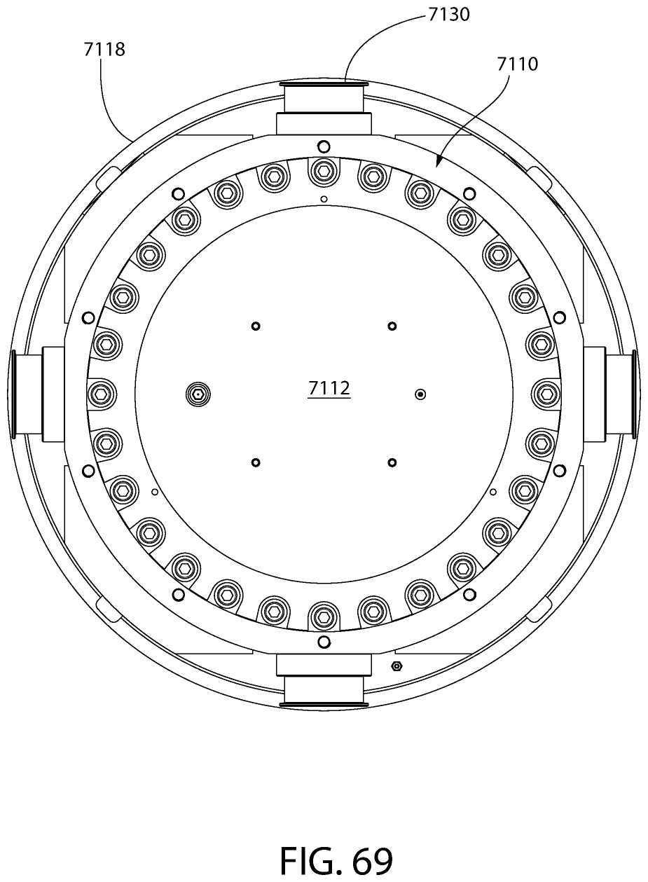

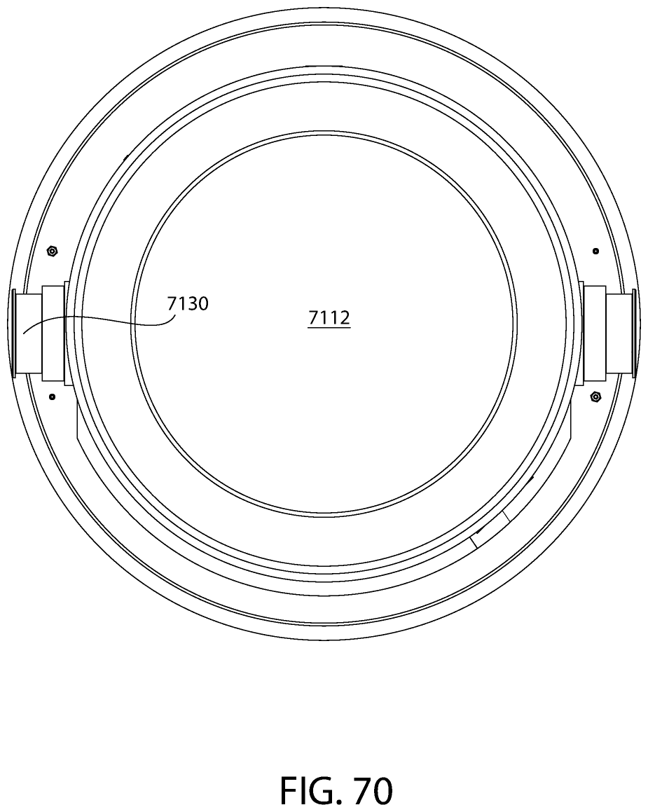

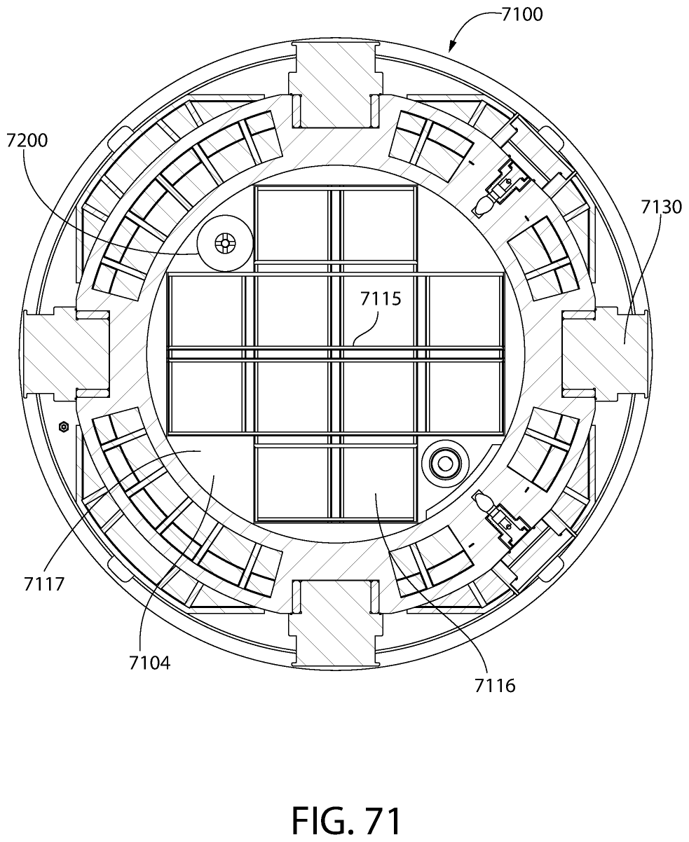

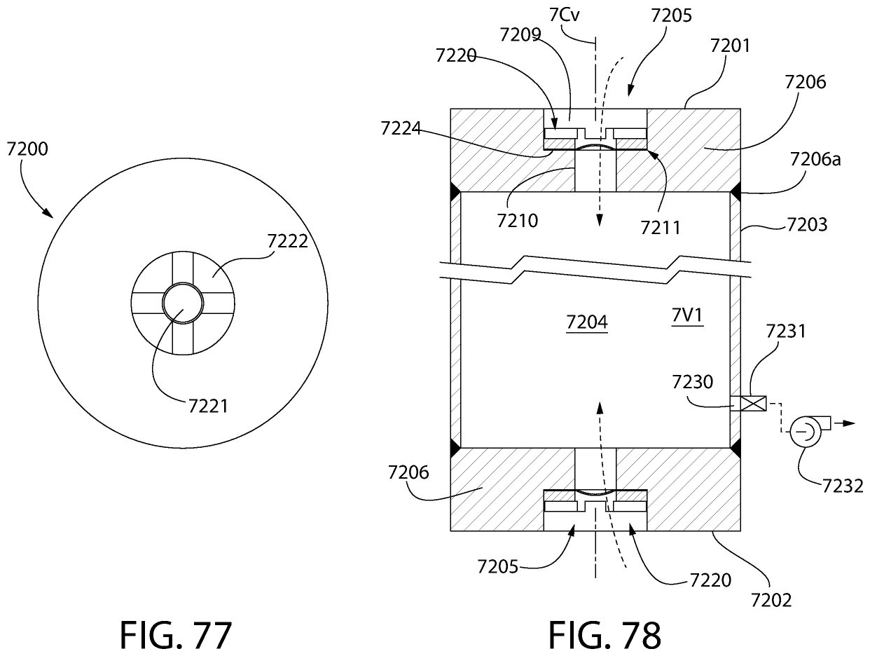

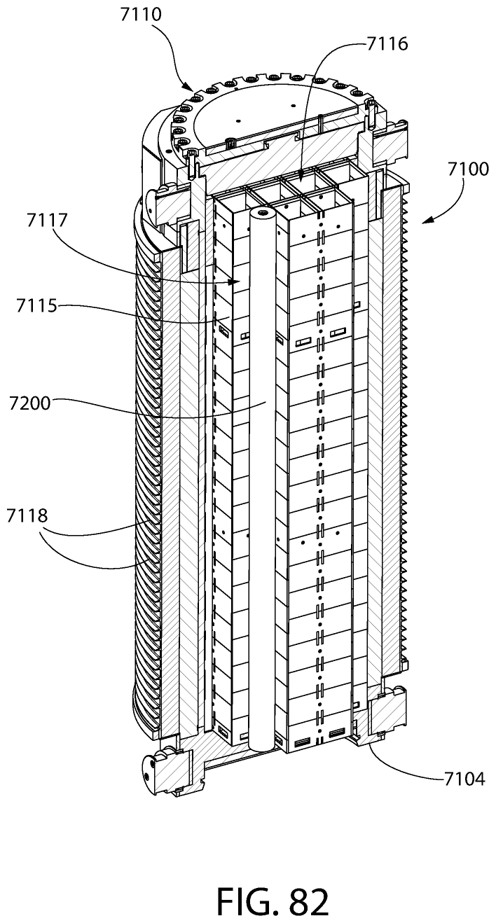

FIGS. 63-84 show various aspects and features of the wet cask system for storing and transporting radioactive nuclear waste such as spent nuclear fuel (SNF) according to the present disclosure. The wet cask system advantageously overcomes the shortcomings of insert gas “dry casks” previously described herein. The relatively high conductivity of water keeps the fuel much cooler than does the inert gas medium in the dry cask; an advantage that is highly desirable from the standpoint of maintaining a low pressure inside the nuclear fuel rods. The fuel rods are elongated and thin-walled zirconium metal tubes (also called fuel cladding) containing the fuel pellets of fissionable material (e.g. uranium ceramic pellets) and an inert fill gas mixed with the radioactive gases in the tubes produced in the reactor core. The high-pressure attendant to high temperature (pursuant to the classical Gas law) causes a high membrane stress in the fuel cladding which is known to cause cladding's failure and release of its gaseous contents into the cask's fuel storage cavity. Preventing these harmful gases from escaping into the environment is a key mission of a cask. The cask is therefore designed to withstand a rise in its internal pressure caused by failure of the fuel cladding. Assuming that a significant quantity of gas release could occur during a cask's operation, designing its pressure retention capability with ample structural margin is accordingly a mandatory requirement in virtually all regulatory jurisdictions.

In a wet cask in which the spent nuclear fuel (SNF) assemblies are immersed in water, the small free volume above the water and SNF (e.g. headspace) is occupied by water vapor. In case of a regulatory postulated fire event, heating the captive volume of water in the wet cask can raise the vapor pressure in the headspace or an accident leading to massive fuel rod failures inside the cask can release large quantities of the fuel rod gas into the cask cavity. Generation of hydrogen and oxygen by radiolysis of water is another source of pressure build up, although this problem is largely overcome by the use of passively acting hydrogen recombiners or hydrogen “getters” placed inside the cask. The vulnerability of the wet cask to rapid pressure rise is further aggravated by the fact that, at high pressures, even a small increase in the temperature causes a large bump in the saturation pressure.

To make wet casks safe and viable for storage/transport of high heat load used or spent nuclear waste fuel, a pressure control sub-system is disclosed herein to protect the cask from a high internal pressure surge under the foregoing accident conditions.

With continuing reference in general to FIGS. 63-84, the present wet cask system with integrated pressure control sub-system generally includes a leak-tight sealable cask 7100 and at least one pressure surge capacitor 7200 operable to absorb a high pressure excursion occurring internally within the cask. There are no provisions for circulating ambient cooling air through cask 7100, which is distinguishable from vertical ventilated type overpacks or casks well known in the industry.

Cask 7100 may be a hermetically sealed, leak-tight pressure vessel comprising a vertically elongated metallic cylindrical body 7101 defining a vertical longitudinal axis 7LA passing through the vertical centerline and geometric center of the body. The cask body generally includes (in progression from top to bottom) lid assembly 7110, annular top flange 7103, cylindrical circumferential wall 7102, and circular base 7104 at bottom. Circumferential wall 7102 defines a circumferentially-extending sidewall extending vertically between top flange 7103 and base 7104. The top and bottom ends of wall 7102 may be fixedly coupled to the top flange and bottom base via welded connections such as one or more circumferentially continuous seal welds for each to permanently join the components together. Top flange 7103 and base 7104 may be forged steel structures in one embodiment for added mechanical strength in one embodiment.

In some embodiments, the external surface of the cask circumferential wall 7102 may optionally comprise a plurality of annular heat transfer fins 7118 extending circumferentially around the cask 7100. The fins may be arranged in longitudinally spaced apart manner on the cask and extend in a vertical array between top flange 7103 and bottom base 7104 as shown. Since the sealed cask is not cooled by introducing and flowing ambient cooling air internally through the cask, the fins help remove heat emitted by the decaying fuel in the SNF assemblies in the cask. In other embodiments, the fins may be omitted.

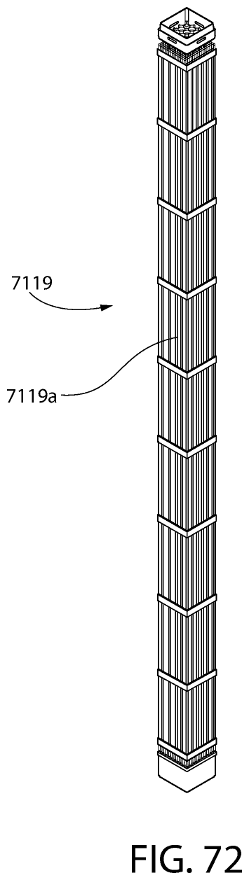

The cask body 7101 defines an internal cavity 7105 which extends longitudinally for a full height of the cask from base 7104 at bottom to the top end of circumferential wall 7102. The cavity 7105 is configured in dimensioned to hold a plurality of spent nuclear fuel (SNF) assemblies 7119 (see, e.g., FIG. 72). Cavity 7105 is hermetically sealed when lid assembly 7110 is removably coupled to the cask body. The fuel assemblies may be insertably contained in a fuel basket 7115 is disposed in cavity 7105 and seated on the bottom base 7104. This design obviates the need for a typical unshielded fuel canister used with some casks. The present cask 7100 may instead be completely submerged directly into the spent fuel pool associated with the reactor for loading individual fuel assemblies into the basket while the assemblies remain immersed under water for radiation containment.

The fuel basket 7115 is a honeycomb prismatic structure comprising an array of vertically-extending openings forming a plurality of vertical longitudinally-extending fuel assembly storage cells 7116. Each cell is configured in cross-sectional area and shape to hold a single U.S. style nuclear fuel assembly 7119 (see, e.g., FIG. 72) having a rectangular cuboid configuration, which in turn contains a multitude of spent nuclear fuel rods 7119a previously described herein (or other radioactive nuclear waste). The cells 7116 may each have generally square cross-sectional shape as shown which is complementary configured to the cross sectional shape of the fuel assembly. Such fuel assemblies and the foregoing fuel basket structure are well known in the industry. The fuel basket may be formed in various embodiments by a plurality of interlocked and orthogonally arranged slotted plates built up to a selected height in vertically stacked tiers of plates. Examples of slotted plate basket constructions are disclosed in commonly-owned U.S. patent application Ser. No. 17/115,005, which is incorporated herein by reference. Other constructions of fuel baskets such as multiple laterally adjacent vertically extending tubes or other structures to the canister baseplate may be used and others used in the art may be used. In addition, the fuel assembly cells 7116 in some constructions may have a hexagonal cross-sectional shape to accommodate hexagonal fuel assemblies commonly used in Russia. The fuel basket construction however is not limiting of the present invention.

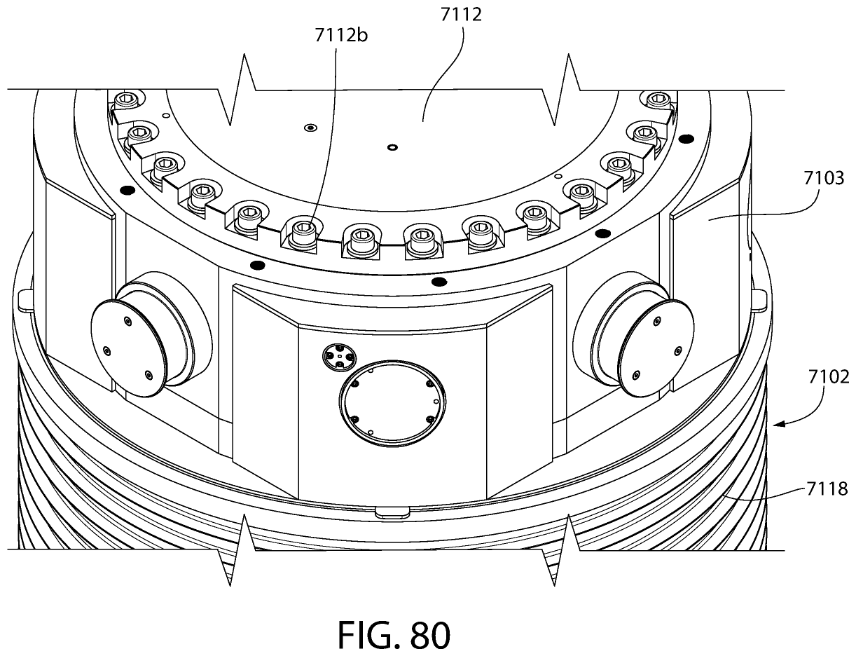

As best shown in FIG. 80 to FIG. 84, the polygonal shaped structure of the complete fuel basket 7115 structure fitted inside the cylindrical internal cavity 7105 of cask 7100 leaves a plurality of unused peripheral areas or regions 7117 between the cask circumferential wall 7102 and basket. These regions have a par-polygonal shape comprising one outer non-polygonal side formed by an arcuate portion of the cask wall 7102 and remaining polygonal inner sides of linear shape formed by parts of the fuel basket 7115. Peripheral regions 7117 are dead zones serving typically no function and considered wasted space. Accordingly, such peripheral regions are generally kept to a minimum as much as practical. The present cask pressure control sub-system however advantageously makes use of these dead zones, as further described herein.

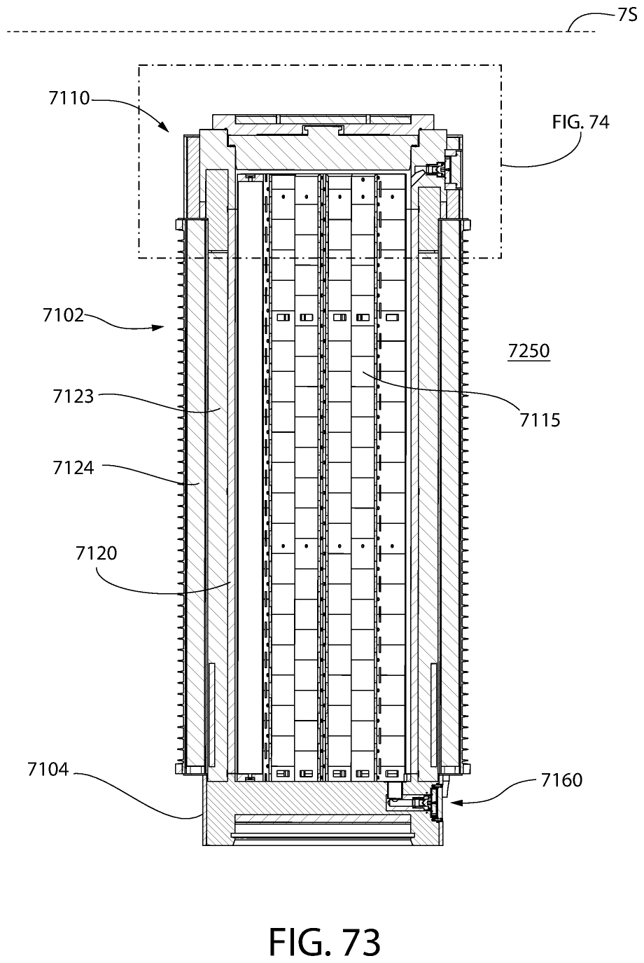

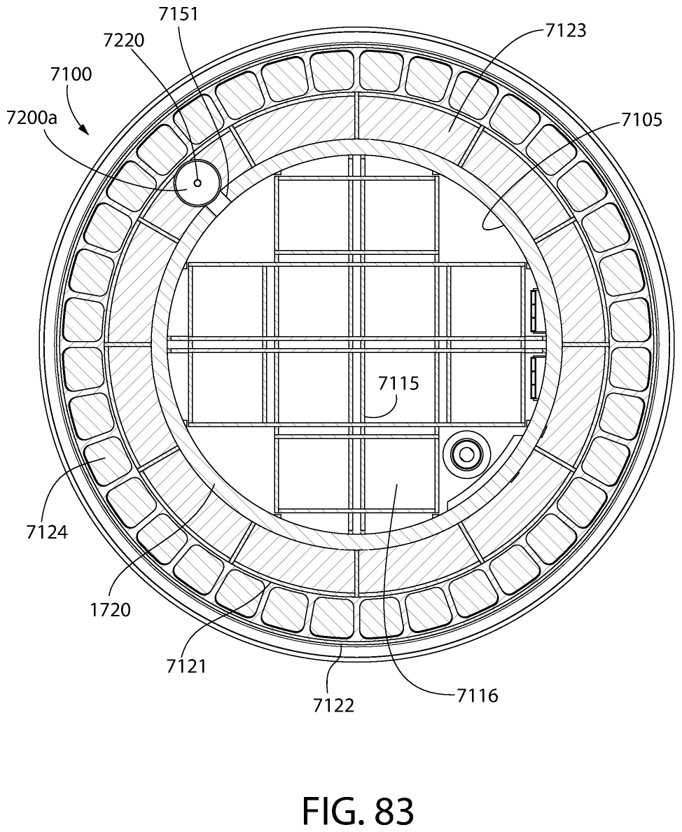

Referring initially in general to FIGS. 63-76 and 82-84, wet cask 7100 is a heavy radiation shielded nuclear waste fuel storage and transport vessel having a composite wall construction operable to ameliorate the gamma and neutron radiation emitted by the SNF fuel assemblies contained therein to safe levels outside the cask. Circumferential wall 7102 of the cask comprises in progression from inside to outside inner shell 7120 adjacent to cask cavity 7105, intermediate shell 7121, and outer shell 7122 (see, e.g. FIGS. 73, 74, and 83). Inner shell 7120 may be formed of thick steel. Shells 7120-7122 are coaxially aligned around longitudinal axis 7LA and radially spaced apart to permit radiation shielding materials to be located in the annular gaps or spaces formed between the shells. Gamma shielding material 7123 is disposed in inner annular space 7125 between inner shell 7120 and intermediate shell 7121. Any suitable gamma shielding material may be used, including lead as shown, concrete, or others. In one embodiment, gamma shielding material 7123 may be provided in the form of longitudinally-elongated arcuately curved blocks each extending for a majority of the height of the cask 7100 at least covering a portion of the height of the fuel basket which contains the SNF fuel assemblies 7119. A plurality of such blocks are arranged circumferentially around the cask encircling internal cavity 7105. The gamma shielding blocks may be separated by conductive inner radial ribs 7127 welded between and to inner shell 7120 and intermediate shell 7121 (see, e.g. FIG. 83). Ribs 7127 may be made of steel in one embodiment. A plurality or array of circumferentially spaced apart ribs 7127 encircle the inner shell 7120. The ribs 7127 form longitudinally-extending pockets which receive and organize the blocks of the gamma shielding material. Notably, ribs 7127 further act as thermally conductive elements which draw the heat emitted by the SNF assemblies 7119 outwards towards the outer shell 7122 and heat transfer fins 7118 since there is no ambient ventilation air circulated through this unventilated cask. Ribs 7127 further provide structural reinforcement for the cask and maintain the annular space 7125 between the shells 7120, 7121.

Boron-containing neutron shielding material 7124 is disposed in outer annular space 7126 between outer shell 7122 and intermediate shell 7121. Any suitable neutron shielding material containing boron may be used, such as for example without limitation Holtite™ from Holtec International of Camden, Jersey. Other boron-containing materials however may be used. In one embodiment, neutron shielding material 7124 may be provided in the form of longitudinally-elongated bars each extending for a majority of the height of the cask 7100 at least covering a portion of the height of the fuel basket which contains the SNF fuel assemblies. A plurality of such bars are arranged circumferentially around the cask encircling internal cavity 7105 which holds the SNF fuel assemblies 7119. The neutron shielding bars may be similarly separated by an outer second plurality or array of conductive outer radial ribs 7128 welded between and to outer shell 7122 and intermediate shell 7121 (see, e.g., FIG. 83). The ribs form longitudinally-extending pockets which receive and organize the bars of the neutron shielding material (e.g. Holtite™), as well as providing the same heat transfer function and structural reinforcement for the cask as ribs 7127 described above in addition to maintaining the annular space 7126 between the shells 7121, 7122. Outer radial ribs 7128 may be formed of copper in one embodiment to maximize heat transfer between the intermediate shell 7121 and outer shell 7122.

In some embodiments, the forgoing inner radial ribs 7127 and/or the outer radial ribs 7128 may each be formed as integral parts of an annular or ring-shaped monolithic casting. Each of the castings may then be fitted between the shells 7120-7122 in the circumferential wall 7102 of the cask 7100 in their respective positions described above. In one embodiment, the outer radial rib 7128 casting may be made of copper to maximize heat transfer. Inner radial rib 7127 casting may be formed of steel in some embodiments if used. Alternatively, either of the inner or outer radial ribs 7127, 7128 may be welded directly to their respective shells which they bridge.

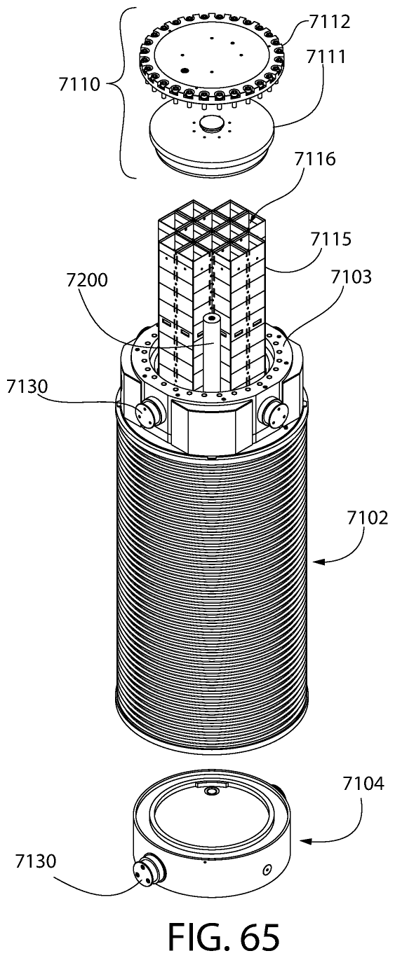

Lid assembly 7110 may comprise a lower inner lid 7111 and upper outer lid 7112 stacked thereon (best shown in FIGS. 65-66 and 74). Inner lid 7111 is configured for partial insertion into cask cavity 7105 and terminates proximate to the top of the fuel basket 7115. A lower portion of the lid 7111 therefore has a smaller diameter than the inside diameter of the cask defined by inner shell 7120. An upper portion of inner lid 7111 has a larger diameter radially protruding annular flange 7111a seated on a mating step-shaped annular shoulder 7113a on the top of the cask defined by cask top flange 7103. Lid 7111 may include a centrally located lifting lug 7113 on top configured to be grasped by a grappling assembly of a hoist or crane for lifting the lid into place on the cask 7100. Lifting lug 7113 may be disk-shaped in one embodiment. Lug 7113 is received and nested in a downwardly open complementary configured circular recess 7114 formed on the bottom of the outer lid 7112. Outer lid 7112 has a larger diameter than the inner lid and comprises a radially protruding annular flange 7112a seated on a mating step-shaped annular shoulder 7114a on the top of the cask also defined by cask top flange 7103. Outer lid 7112 is bolted to top flange 7103 of cask 7100 by a circular array of closure bolts 7112b, thereby trapping the inner lid 7111 onto the cask.

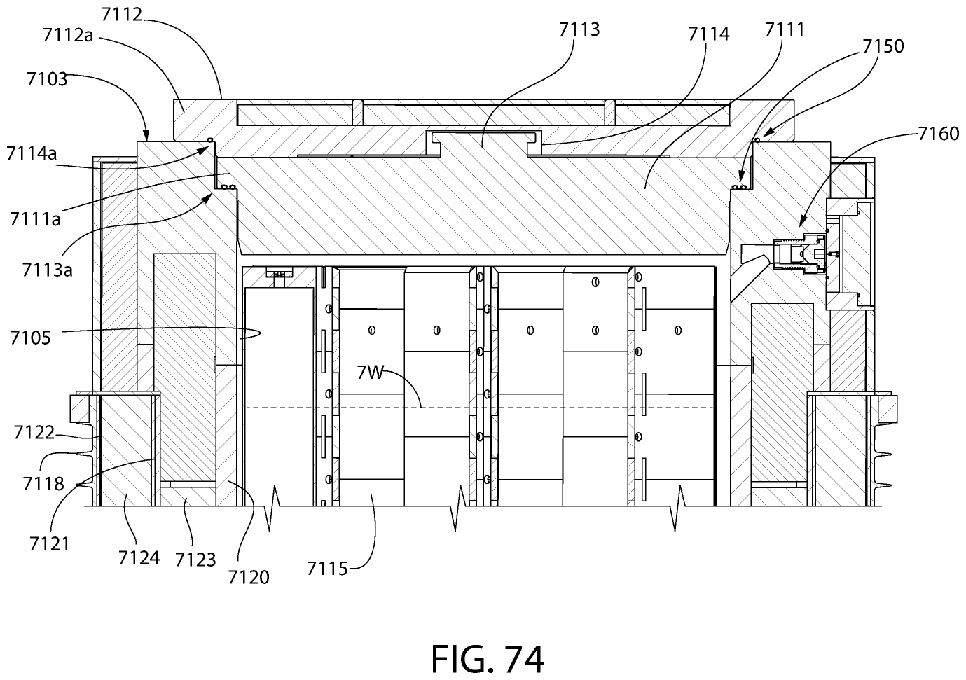

Lid assembly 7110 further comprises a plurality of annular seals 7150 compressed between the cask body (e.g., top flange 7103) and each of the inner and outer lids 7111, 7112 (best shown in FIG. 74). When lid assembly 7110 is coupled to cask 7100 (e.g., bolted), a hermetically sealed leak-tight cask internal cavity 7105 and pressure vessel is created which is fluidly isolated from the ambient environment.

Cask 7100 may further include a plurality of radially protruding lifting lugs 7130 for maneuvering the cask such as lifting into and out of the spent fuel pool during the process of loading SNF assemblies 7119 into the cask fuel basket 7115. At least one bottom drain assembly 7160 may be provided which is openable/sealable to drain the inventory of water in the cask in which the fuel assemblies are submerged (FIG. 73). Drain assembly 7160 may be formed in base 7104 in some embodiments. A top openable/sealable port 7161 which is fluidly coupled to cask internal cavity 7105 via a duct as shown in FIG. 74. Port 7161 may be used for various purposes, including for example without limitation for testing the conditions inside the cask, or optionally to convert the cask 7100 to long dry storage by circulating an inert gas (e.g., helium) through the cask to dry cavity 7105 in conjunction with the bottom drain assembly 7160 for establishing a gas flow path therethrough. Inert gas cask drying systems are well known in the art without further elaboration. Top port 7161 may be a gas inlet and bottom drain assembly 7160 may be a gas outlet, or vice versa. Top port 7161 may be formed in top flange 7103 in some embodiments.

As previously described herein, wet cask 7100 is a water-impounded cask in which the fuel assemblies 7119 are immersed under water. The water 7W has a surface level sufficient to at least fully cover the fuel assemblies. An exemplary surface level of water 7W is represented in FIG. 74 by the dashed line.

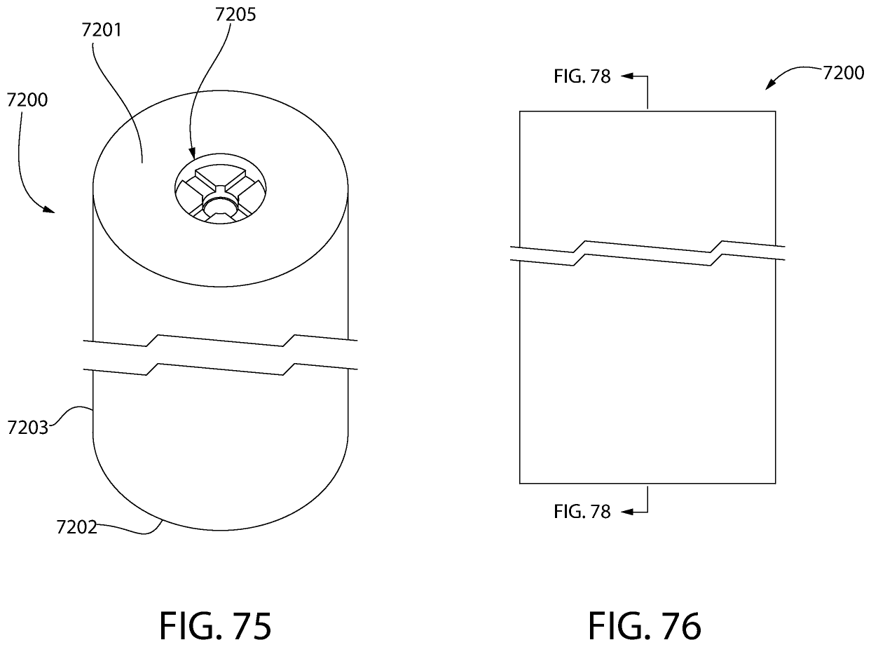

The pressure control sub-system comprising pressure surge capacitor 7200 operable to absorb a high pressure excursion occurring internally within the cask will now be further described. FIGS. 75-79 show the pressure surge capacitor in isolation.

Referring initially to FIGS. 75-79 and 83-84, pressure surge capacitor 7200 has a longitudinally elongated cylindrical tubular body defining a vertical centerline and comprising a top end 7201, bottom end 7202, and cylindrical sidewall shell 7203 extending therebetween and defining an internal pressurizable vacuum space or chamber 7204 having a volume 7V1. The terminal end portions of the capacitor 7200 define end caps 7206 having a thickness measured parallel to the vertical centerline 7Vc which is substantially greater (e.g. 3 times or more) than the wall thickness of the sidewall shell 7203 (measured transversely to centerline 7Vc).

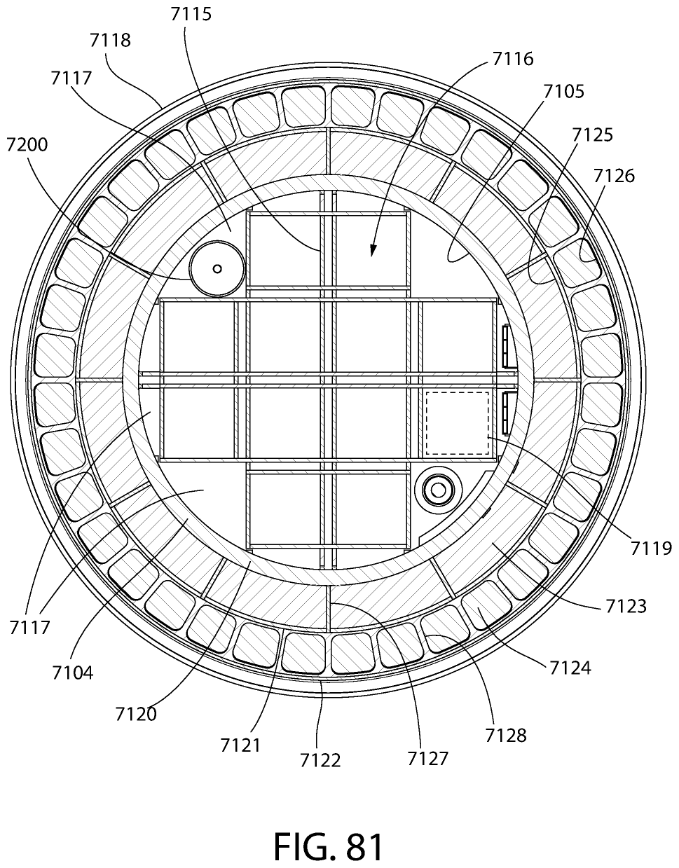

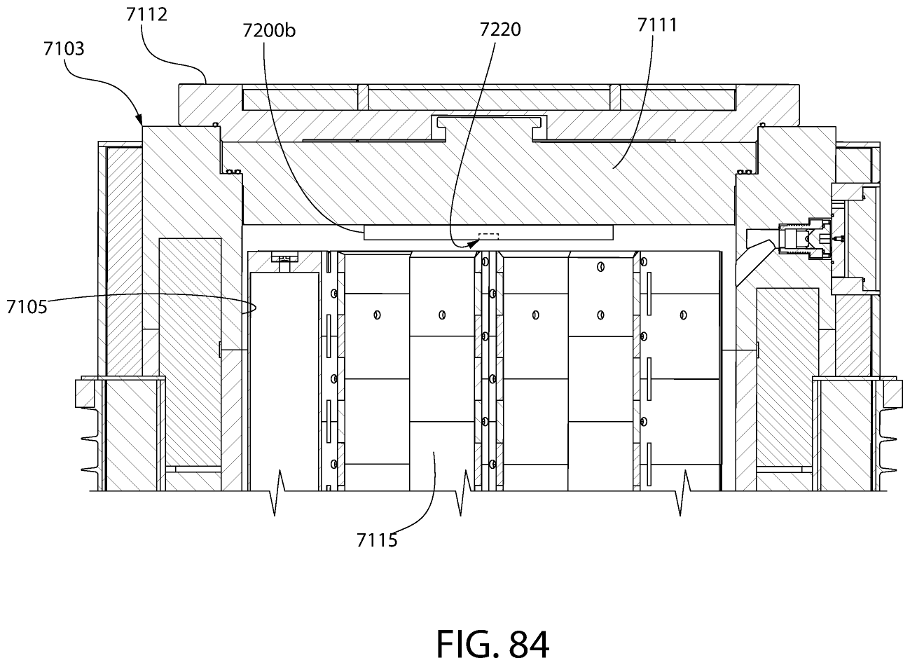

As shown in FIGS. 73 and 84, the pressure surge capacitor 7200 is a longitudinally elongated pressure vessel having a greater longitudinally length than its diameter. Capacitor may have a height at least coextensive with the height of the fuel basket 7115 in some embodiments. Capacitor 7200 therefore has a height which extends for a substantial majority of the height of the internal cavity 7105 of cask 7100 from proximate to the bottom of lid assembly 7110 to base 7104 of the cask. In one embodiment, pressure surge capacitor 7200 is positioned and located adjacent to inner shell 7120 of the cask in its internal cavity 7105, such as in one of the larger peripheral regions 7117 inside cask 7100 lying between the fuel basket 7115 and inner shell 7120 (see also FIG. 81). This otherwise dead space too small to accommodate a full rectangular SNF fuel assembly is advantageously not wasted and advantageously used in a cask overpressurization function. Although one pressure surge capacitor 7200 is shown, other embodiments may place multiple capacitors 7200 in a similar manner in peripheral regions 7117 for added cask pressure surge protection as needed.

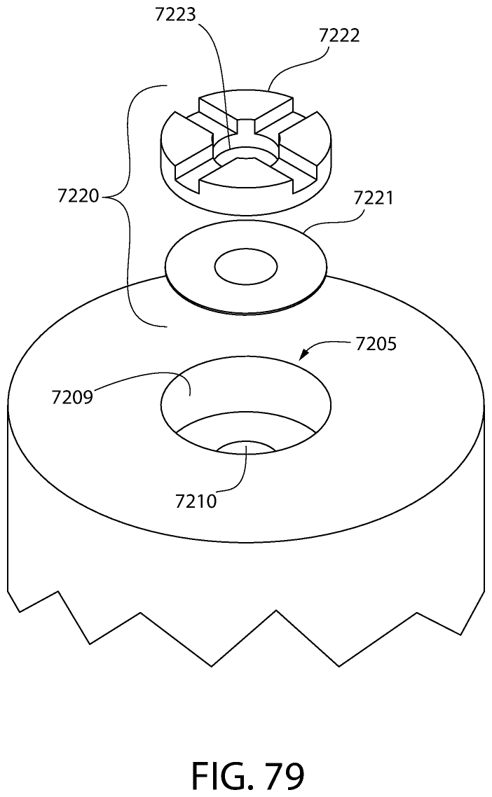

A flow inlet opening 7205 is formed through at least one end 7201 or 7202 of pressure surge capacitor 7200 (e.g., end caps 7206), and in some embodiments through both ends at top and bottom as shown. Inlet opening 7205 is in fluid communication with vacuum chamber 7204 of pressure surge capacitor 7200 for selectively admitting high pressure water held inside cask cavity 7105 during a cask n internal pressure excursion (increase). In one embodiment, inlet opening 7205 may be circular in transverse cross section and comprises a larger diameter outer portion 7209 and small diameter inner portion 7210. A step-shaped annular shoulder 7211 is formed therebetween (best shown in FIGS. 78 and 79).

Each inlet opening 7205 is fitted with a pressure relief device 7220 comprising a circular metallic rupture disk 7221 and annular disk retaining ring 7222. Retainer ring 7222 includes a central opening 7223 which allows pressurized water to flow through the inlet opening 7205 into the pressurizable vacuum chamber 7204 of the tubular pressure surge capacitor when the rupture disk bursts. Rupture disk 7221 is designed and constructed with predetermined burst pressure selected to protect the cask 7100 and fuel assemblies 7119 therein from a potentially damaging high pressure condition previously described herein internal to the cask caused by degradation and/or failure of the fuel rod cladding. The predetermined burst level is set taking into consideration the differential between the sub-atmospheric vacuum condition inside the pressure surge capacitor 7200 and the pressure outside the capacitor inside the cask cavity 7105. Any suitable type of metal rupture disk may be used, including without limitation a reverse buckling design as shown herein (in which the convex side of the rupture disk faces the high pressure source) or a forward-acting disk design (in which the concave side of the disks faces the high pressure source).

During assembly of each pressure relief device 7220, one rupture disk 7221 is positioned and seated on an outward facing disk seating surface 7224 formed at the innermost end of outer portion 7209 of flow inlet opening 7205. One retaining ring 7222 is then positioned over the rupture disk and coupled to the end cap 7206 of pressure surge capacitor 7200 such as via welding, threaded connection, or other. This traps the rupture disk 7221 between the retaining ring and seating surface 7224. The dome shaped central portion of the rupture disk protrudes outwards into and partially enters the central opening 7223 of retaining ring 7222 where it is exposed to the internal pressure of cask 7100 inside cavity 7105.

Each pressure surge capacitor 7200 is then evacuated to as deep a vacuum (negative pressure) as practicable. A vacuum port 7230 may be formed in sidewall shell (or alternatively the end caps 7206) for evacuating the vacuum chamber 7204 of the capacitor. A valve 7231 may be removably coupled to the port 7230 for drawing the vacuum via an external vacuum pump 7232 (valve and pump shown schematically in FIG. 80). Any suitable type of valve may be used which is configured with a suitable end fitting configuration for detachable coupling to a hose or other flow conduit line fluidly connected to the vacuum pump.

The evacuated pressure surge capacitor(s) 7200 are now ready for deployment and operation. Each pressure surge capacitor 7200 provided (e.g., one or more) may be positioned inside cask cavity 7105 in an available empty space such as open peripheral regions 7117 (see, e.g., FIG. 81). Capacitors 7200 may be loosely positioned in the cask, or alternatively may be fixedly attached to the outside walls of the fuel basket 7115 (such as via welding) before the fuel basket is installed in cask 7100. In the latter case, the capacitors may be evacuated before or after welding to the fuel basket. Capacitors 7200 are constructed via selection of the type of metal used for the body and end caps (i.e., mechanical strength and other material properties), and associated thicknesses to withstand the external pressure which the cask cavity will exert from the elevated hydraulic pressure that would result under a condition of elevated temperature of the body of water inside cask 7100. The pressure surge capacitors are fully exposed to the temperature and pressure conditions inside the cask cavity 7105.

In operation, if an overpressurization condition should occur in cask cavity 7105 which exceeds the pre-designed and predetermined burst pressure of the rupture disk 7221, the disk will burst allowing the excess pressure to bleed into the evacuated vacuum chamber 7204 of the capacitors 7200 (see dashed water inflow arrows in FIGS. 80-81). The internal cask pressure will attempt to equilibrate inside and outside the pressure surge capacitors in the cask cavity 7105 to thereby lower the internal cask pressure to a stable acceptable pressure level, thereby ameliorating the high pressure excursion condition. Although only a single pressure surge capacitor 7200 is shown for clarity of depiction in the figures, it will be appreciated that other embodiments will include any suitable number of pressure surge capacitors as needed to provide the surge capacity necessary to compensate for and ameliorate the postulated cask overpressurization conditions that could possibly occur during storage of the SNF in sealed wet cask 7100.

A method for controlling pressure in a sealed cask 7100 using pressure surge capacitors 7200 will now be briefly summarized. The method generally comprises providing an unventilated cask 7100 comprising a sealable internal cavity 7105 configured for storing nuclear waste such as spent nuclear fuel assemblies 7119; positioning a pressure surge capacitor 7200 in the cask, the pressure surge capacitor comprising a vacuum cavity 7204 evacuated to sub-atmospheric conditions and in fluid communication with the internal cavity; filling the cask with water; submerging the nuclear waste in the water; and sealing a lid assembly 7110 to the cask to hermetically seal the internal cavity; wherein the pressure surge capacitor is configured to suppress a pressure surge in the internal cavity of the cask. The method may further include after the sealing step, steps of: increasing the pressure inside the cask to exceed a predetermined burst pressure of a rupture disk 7221 of the pressure surge capacitor 7200; and admitting a portion of the water into the pressure surge capacitor which reduces the pressure inside the cask. The pressure surge capacitor therefore advantageously operates to relieve the cask pressure and ameliorate the high pressure increase excursion.

In some embodiments, the filling step includes lowering the cask 7100 into a first spent fuel pool 7250 below a water surface 7S thereof (schematically shown in FIG. 73). The method may further include after the sealing step, steps of: lifting the cask out of the first spent fuel pool; and transporting the cask to a second spent fuel pool. The cask may be lowered into the second fuel pool for either loading additional SNF assemblies 7119 into the cask, or unloading the spent fuel assemblies into the second fuel pool such as into cavities of a SNF storage rack such as those disclosed in commonly-owned U.S. Pat. No. 10,847,274, which is incorporated herein by reference in its entirety.

Variations in the foregoing steps of the method, and additional steps, may be used.

It bears noting pressure surge capacitor 7200 is shown having a cylindrical configuration, in other embodiments the capacitor may have a body shaped other than cylindrical with circular transverse cross section, such as any suitable non-polygonal or polygonal configuration. The shape of the pressure surge capacitor does not limit the invention.

FIG. 83 shows an alternative embodiment of the pressure control sub-system of the cask 7100 in which one or more pressure surge capacitors 7200a are incorporated and embedded in the circumferential walls 7102 of the main cylindrical body of the cask. Inner shell 7120 includes one or more separate flow apertures 7151 fluidly coupled between each rupture disk 7221 provided for the capacitor 7200a and the internal cavity 7105 of the cask 7100. The vacuum chamber 7204 of the capacitor is therefore fluidly connected to the cavity 7105 through the rupture disk(s) 7221 previously described herein and function in the same manner to protect the cask from internal high pressure surges/excursions. A plurality of embedded pressure surge capacitors 7200a may be provided.

FIG. 84 shows a second alternative embodiment of the pressure control sub-system of the cask 7100 in which one or more pressure surge capacitors 7200b are incorporated in the lid assembly 7110 of the cask 7100. In this illustrated embodiment, a centrally located pressure surge capacitor 7200b is fixedly coupled to the bottom surface of inner lid 7111 (such as via welding). This locates capacitor 7200b in the headspace between the bottom surface of inner lid 7111 and the top edges of the fuel basket within the internal cavity 7105 of the cask 7100. Capacitor 7200b may have a cylindrical body similar to capacitor 7200 previously described herein and includes at least one pressure relief device 7220 (i.e., rupture disk 7221 and retaining ring 7222) in a bottom surface of the lid-mounted capacitor 7200b. In this embodiment, the diameter of capacitor 7200b may be larger than its longitudinal height. In some embodiments, an array comprised of multiple lid-mounted pressure surge capacitors 7200b may instead be provided.

It bears noting that alternative pressure surge capacitors 7200a and 7200b may be provided instead of pressure surge capacitors 7200 previously described herein which are located directly in the cask fuel storage internal cavity 7105, or alternatively in addition thereto if added pressure surge amelioration capacity is needed.

Above Grade Ventilated Nuclear Fuel Storage Cask

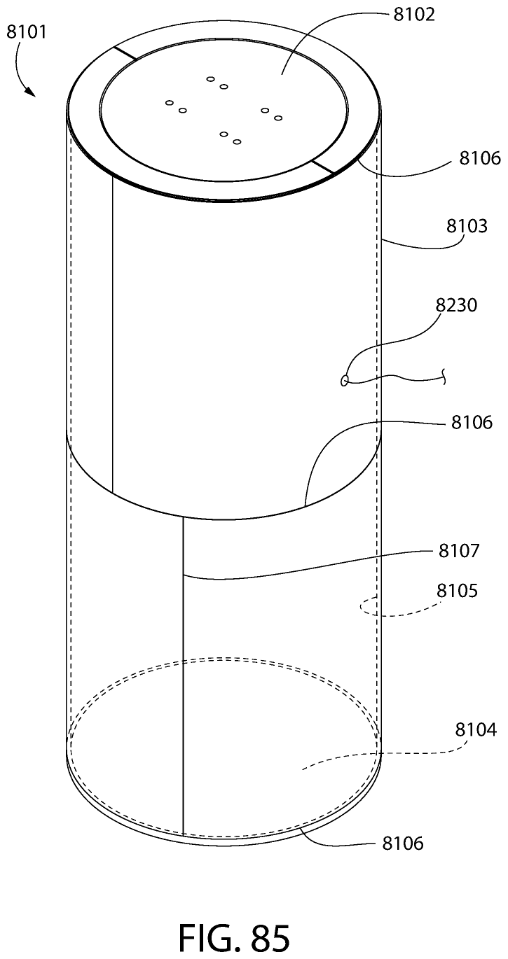

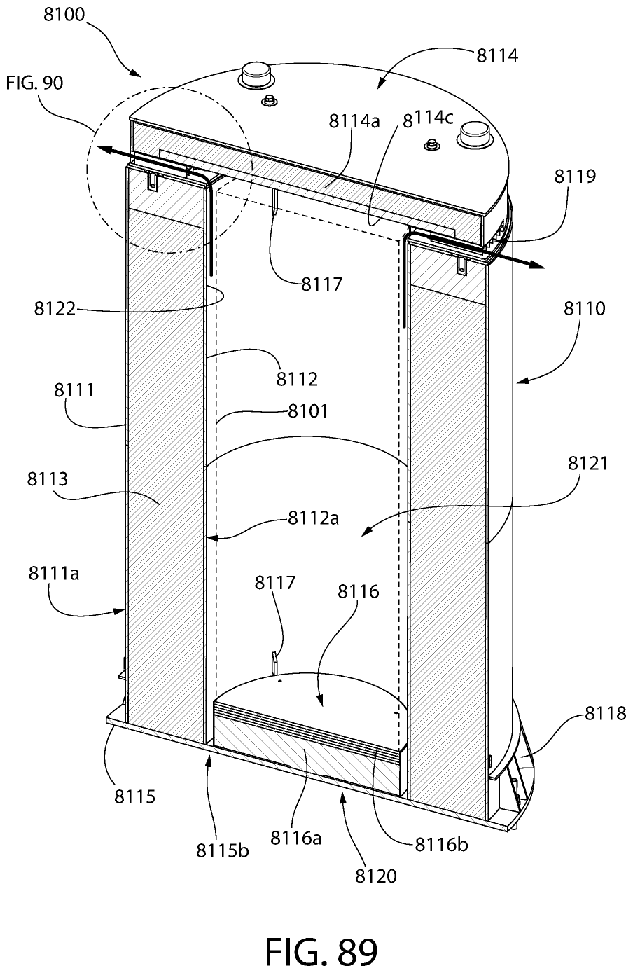

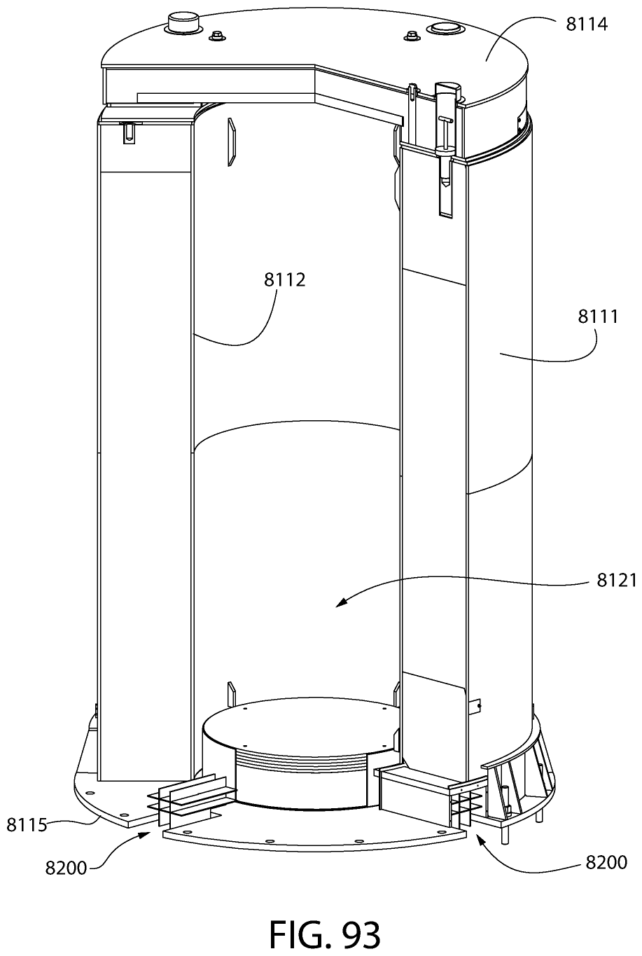

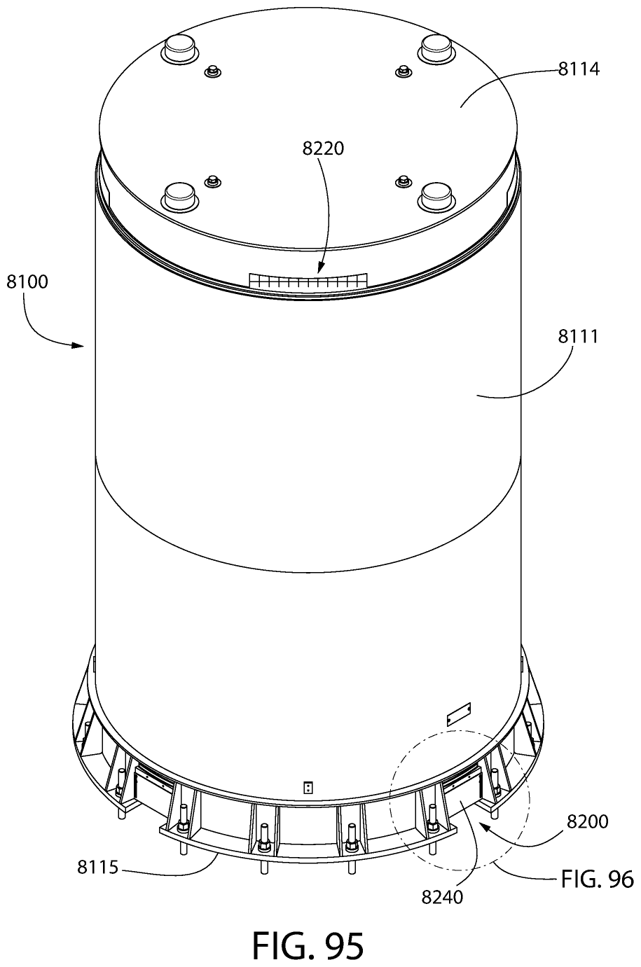

FIGS. 85-99 depict various aspects of a nuclear fuel storage system generally comprising a first embodiment of a passively cooled and naturally ventilated outer storage module or cask 8100. Cask 8100 is constructed for above grade placement such as on a concrete slab. The cask has an internal cross-sectional area configured to hold only a single spent nuclear fuel (SNF) canister 8101 loaded with SNF assemblies (not shown) emitting radiation and substantial amounts of decay heat.

Canister 8101 is a vertically elongated and hermetically sealed (i.e., gas tight) vessel in one embodiment comprising cylindrical shell 8103, bottom closure plate 8104 affixed to a bottom end of the shell, and a lid coupled to a top end of the shell. The lid and bottom closure plate may be hermetically seal welded to the shell via circumferentially continuous girth seal welds 8106 at the weld seams. Shell 8103 may be formed one or more rolled metal plate segments 8103a joined by longitudinal seal welds 8107 at the weld seams. A continuous circumferential girth seal weld 8106 may be used to hermetically join adjacent vertically stacked shell segments together. An interior cavity 8105 is defined within the shell which is configured for holding the SNF fuel assemblies. The canister (shell(s)), lid, and bottom closure plate) may be made of stainless steel in one embodiment.

Cask 8100 may be a heavily radiation-shielded double-walled vessel in one embodiment including an elongated cask body 8110 formed by a cylindrical outer shell 8111 and inner shell 8112, and radiation shielding material 8113 disposed in annular space formed therebetween. The shells 8111, 8112 and shielding material collectively define the sidewall of the cask. The inner and outer shells are concentrically arranged relative to each other as shown. In one embodiment, the shielding material 8113 may comprise a concrete mass or liner for neutron and gamma radiation blocking. Other radiation shielding materials may be used in addition to or instead of concrete including lead for gamma radiation shielding, boron containing materials for neutron blocking (e.g. Metamic® or others), steel, and/or others shielding material typically used for such purposes in the art. Inner shell 8112 defines an interior or internal surface 8112a and outer shell 8111 defines an exterior or external surface 8111a of the cask. Surfaces 8111a, 8112a formed by the shells may correspondingly be cylindrical and arcuately curved in one embodiment. The cask further includes a top end 8119 defines by the upper end of the cask body 8110 and bottom end 8120.

The passively cooled storage cask 8100 may be vertically elongated and oriented as shown in the illustrated embodiment; however, other orientations such as horizontal may be used which include the features described herein. The inner and outer shells 8112, 8111 may be formed of a suitable metallic material, such as without limitation steel (e.g. carbon or stainless steel). If carbon steel is used at least the exterior surface 8111a of the cask may be epoxy painted/coated for corrosion protection. The metal shells 8111, 8112 may each have representative thickness of about ¾ inches as one non-limiting example; however, other suitable thicknesses may be used.

Cask 8100 comprises a vertically-extending internal cavity 8121 which extends along a centerline or longitudinal axis 8LA defined by the vertically elongated cask. Cavity 8121 may be of cylindrical configuration in one embodiment with a circular cross-sectional shape; however, other shaped cavities with corresponding cross-sectional shapes may be used including polygonal shapes and other non-polygonal shapes (e.g. rectilinear, hexagon, octagonal, etc.).

A metal baseplate 8115 may be seal welded to the inner and outer shells 8112, 8111 at the bottom end 8120 of cask 8100 to close cavity 8121 which opposes the ingress of water. Structurally, this forms a rigid self-supporting assemblage or structure which can be fabricated in the shop, and then transported to the desired SNF storage site and handled by hoists/cranes and/or cask crawlers for loading the SNF canister into the cask. Baseplate 8115 may have a flat and circular in one non-limiting configuration as shown. Baseplate 8115 may be structurally reinforced and stiffened by a plurality of circumferentially spaced apart angled gusset plates 8115b welded to the top surface of the baseplate and lower exterior surface 8111a of outer shell 8111.

Baseplate 8121 is configured for placement on a flat support surface 8S and rigidly anchoring the cask thereto. In one embodiment, the support surface 8S may preferably be defined by the flat top surface of a concrete support pad 8S1 which provides additional radiation shielding in the vertical downwards direction. A plurality of circumferentially spaced apart fasteners 8124 embedded in concrete support pad 8S1 and arranged in a bolt circle may be used to anchor the baseplate and cask in place.

Baseplate 8120 may be made of a similar metallic material as the shells 8111, 8112 (e.g., steel or stainless steel). In one embodiment, baseplate 8115 may be about 3 inches thick. The bottom surface of baseplate 8115 in one embodiment defines the bottom end 8120 of the cask 8100.

In one embodiment, a cylindrical support pedestal 8116 may be rigidly affixed such as via welding to the top surface 8115a of baseplate 8115. Pedestal 8116 is configured to support and elevate the canister 8101 above the baseplate in some aspects. In another aspect, pedestal 8116 is designed to provide radiation shielding for the bottom of the cask 8100 at the lower of the internal cavity 8121 when the radiation emitting canister 8101 is loaded in the cask. Accordingly, pedestal 8116 may be a thick and composite structure comprised of radiation shielding material including concrete fill 8116a and a vertical stack of steel plates 8116b thereon. The shielding is particularly important when the combination cask and canister are transported at the nuclear facility site before final placement at the storage location on the concrete support pad 8S1.

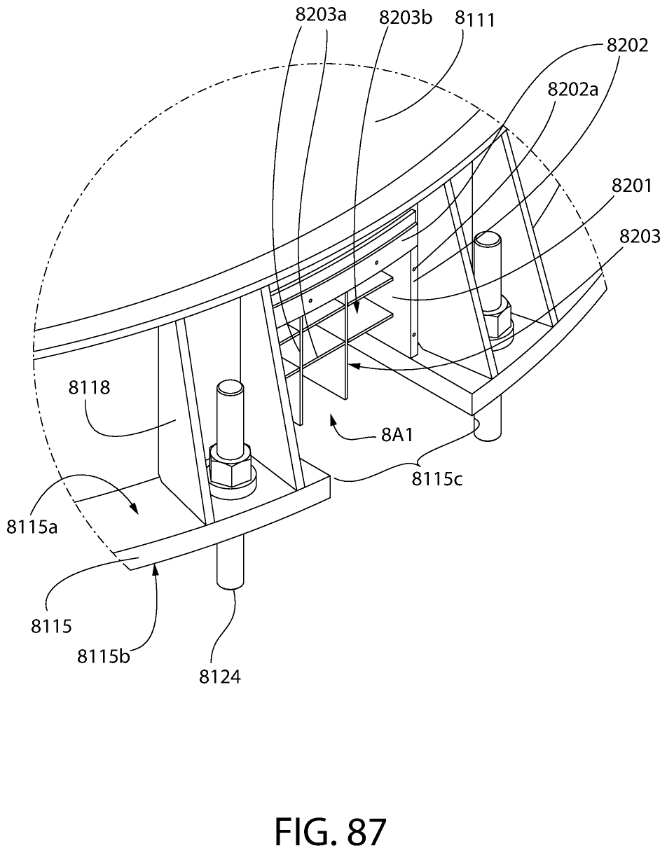

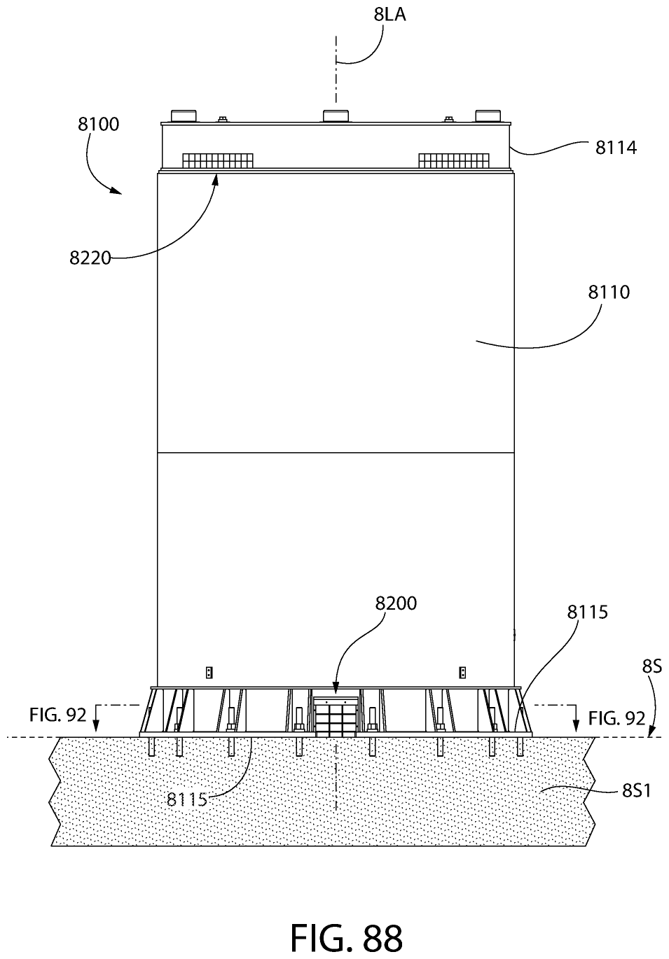

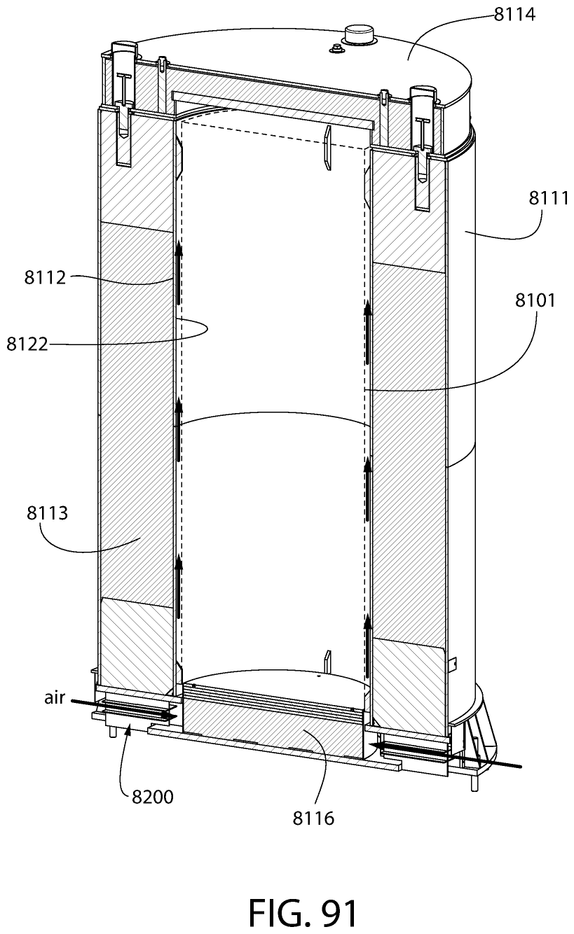

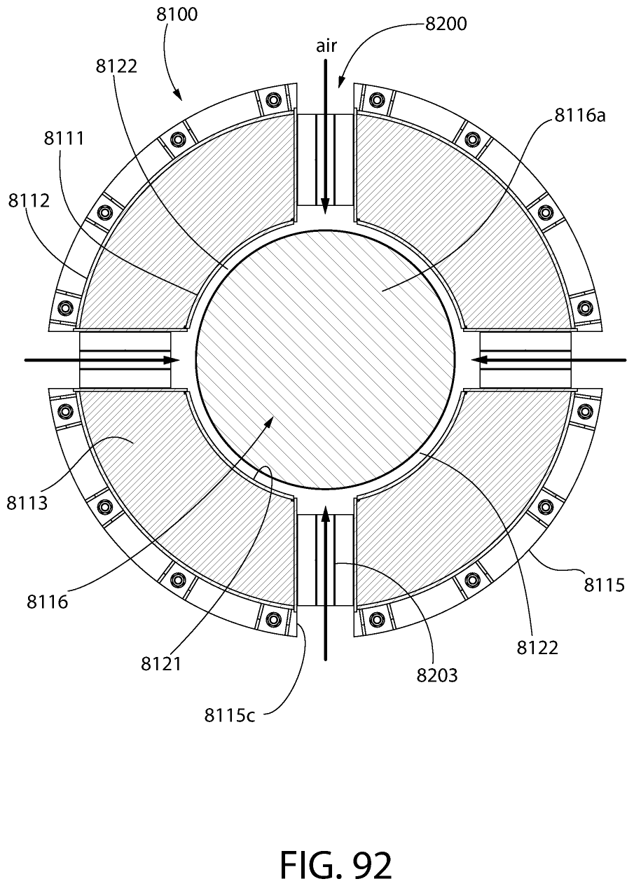

Cavity 8120 of cask 8100 has a configuration and height suitable for holding a single SNF canister 8101 therein (represented by dashed lines in FIG. 87). The diameter of cavity 8120 is intentionally larger than the diameter of the fuel canister 8100 by a smaller amount to form a ventilation annulus 8122 between the canister 8101 and inner shell 8112 within the internal cavity 8121 of the cask (see, e.g., FIG. 91). The radial width of annulus 8122 preferably is sufficient to draw heat generated by the SNF within the canister away from the canister as the cooling air flows upwards alongside the canister as it is heated via a natural convective thermo-siphon effect. A typical airflow annulus may be in the range of about and including 2-6 inches in width as a non-limiting example depending on the estimated heat load of the fuel canister 8100. The annulus 8122 extends vertically for the full height of the canister which may terminate at top adjacent to the top ends of the upper guide lugs 8117 discussed below. Accordingly, the canister 8101 has a height approaching the full height of the cask cavity 8121, and at least greater than ¾th the height of the cavity. Annulus 8122 further extends all the way down to the baseplate 8115 alongside the pedestal 8116 which may have a diameter commensurate with the diameter of the canister (see, e.g., FIG. 92). This lower portion of ventilation annulus 8122 places the air inlet ducts 8200 in fluid communication with the annulus (see, e.g., FIG. 91)

A plurality of radially and vertically extending guide lugs 8117 are disposed at the upper and lower portions of the cask cavity 8121. The array of upper and lower guide lugs 8117 are circumferentially spaced apart and rigidly attached to the interior/internal surface 8112a of the inner shell 8112 such as via welding. Guide lugs 8117 may be formed of steel plates and are provided around the entire inner shell at least at the upper and lower portions thereof for full 360 degree coverage. The inward vertical sides or edges of the guide tubes are configured to abuttingly engage and prevent the canister 8101 from excessively moving laterally or rattling if vibrated during a seismic event or when being lifted and lowered by a crane or hoist from or into the cask internal cavity 8121. Notably, the guide lugs 8117 further act to maintain the ventilation annulus 8122 between canister 8100 and inner shell 8112 of the cask to preserve this airflow passage for removing heat emitted by the canister. This allows a continuous flow of ambient cooling air to circulate around and flow upwards along the sides of the canister.

A radiation-shielded lid 8114 is detachably coupled to the cask top end 8119 which closes the normally upwardly open cavity 8121 of cask 8100 when in place. Lid 8114 may be a circular cylindrical structure comprising a hollow metal outer housing 8114b defining an interior space filled with a radiation shielding material 8114a such as a concrete plug or liner encased by the outer housing. Other shielding materials may be used in addition to or instead of concrete. Lid 8114 provides radiation shielding in the vertical upward direction, whereas the concrete liner 8113 disposed between the inner and outer shells 8112, 8111 provides radiation shielding in the lateral or horizontal direction. With exception of the concrete liner, the foregoing lid-related components are preferably all formed of a metal such as without limitation steel (e.g., carbon or stainless).

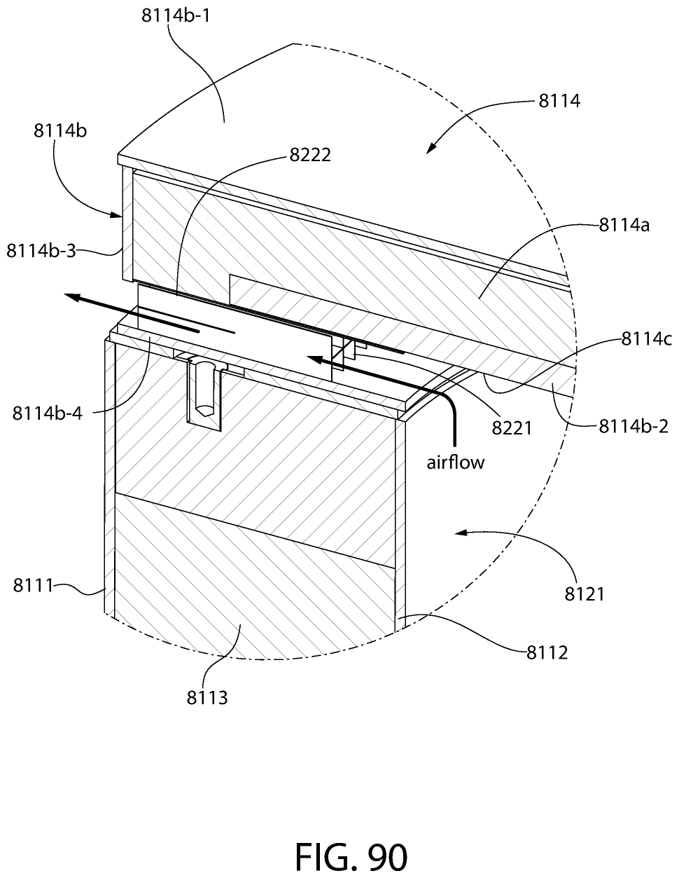

Housing 8114b of lid 8114 may include top cover plate 8114b-1, bottom cover plate 8114b-2, bottom peripheral ring plate 8114b-4, and a circumferentially-extending peripheral ring wall or shell or 8114b-3 extending vertically between the ring plate and top plate (see, e.g. FIG. 90). All plates may be flat and the ring shell may be cylindrical in shape in a certain embodiment. Ring shell 8114b-3 extends downwards farther than bottom cover plate 8114b-2 forming a central air collection recess 8114c on the underside of the lid above the peripheral ring plate 8114b-4. Central air collection recess 8114c is downwardly open to internal cavity 8121 of cask 8100 to receive the rising ventilation air form the ventilation annulus 8122 which is heated by the canister. The central recess collects the heated ventilation air and directs the air through the radial air outlet ducts 8220 in lid 8114 for discharge to atmosphere, as further described herein.

According to one aspect of the nuclear waste fuel storage system, the vertical ventilated nuclear fuel storage cask 8100 includes a natural circulation cooling air ventilation system (i.e. unpowered by fans/blowers) for removing decay heat emitted from the canister 8101 which holds the SNF. The cooling airflow provided by ambient air surrounding the cask is driven by natural convective thermo-siphon effect in which air within the ventilation annulus 8122 is heated by the canister 8101 which emits the heat generated by the decaying SNF inside causing an upflow.

Referring generally to FIGS. 85-99 as applicable, the cask ventilation provisions include a plurality of circumferentially spaced apart cooling air inlet ducts 8200 to draw and introduce ambient cooling air into the internal cavity 8121 of cask 8100, and a plurality of circumferentially spaced apart cooling air outlet ducts 8220 to expel the air heated by canister 8100 from the cavity back to atmosphere. Both the air inlet and outlet ducts may generally be radially oriented and communicate with cask cavity 8121, and particularly ventilation annulus 8122 formed in the cavity between canister 8101 and inner shell 8112 of the cask body 8110. In a one non-limiting preferred embodiment, the air inlet ducts 8200 are disposed in and formed through the lower portion of cask body proximate to the bottom end 8120 of the cask and cavity. Conversely, the air outlet ducts 8220 are disposed proximate to the top end 8119 of the cask 8100.

Each air inlet duct 8200 extends horizontally/laterally completely through the sidewall formed by the cask body 8110 from outer shell 8111 to inner shell 8112. The radially oriented ducts 8200 define air inlet passageways which place the lower portion of the cask cavity 8121 and ventilation annulus 8122 in fluid communication with ambient atmosphere and cooling air. Inlet ducts 8200 may be horizontally oriented and linearly straight in configuration in one non-limiting preferred embodiment as shown. The inlet ducts may be circumferentially spaced apart around the circumference of the cask. In one embodiment, inlet ducts 8200 may be equally spaced apart and may include at least four ducts to uniformly deliver ambient cooling air to each quadrant of the SNF canister 8101 (see, e.g., FIG. 92).

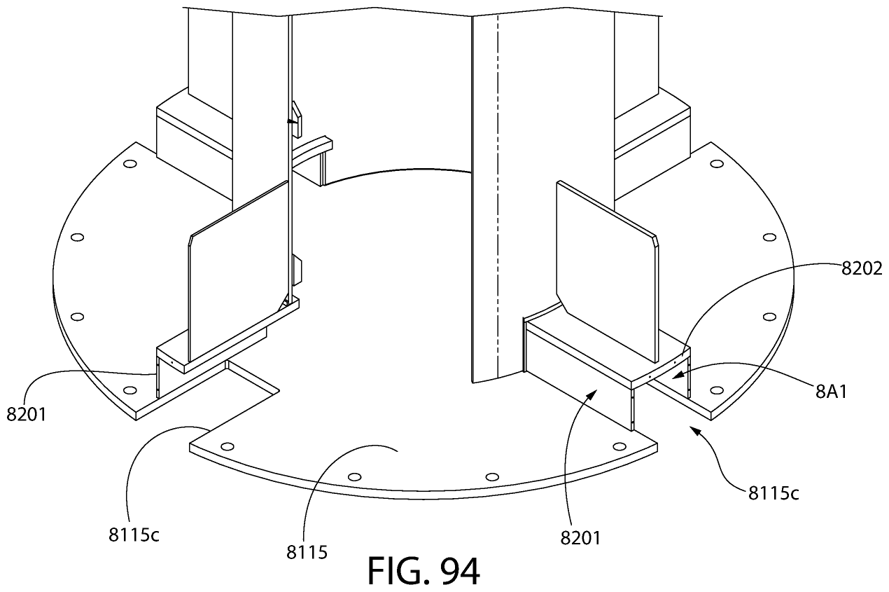

In one embodiment, the air inlet ducts 8200 may be located directly adjacent to top surface 8115a of baseplate 8115 (see, e.g., FIGS. 87 and 94). Each air inlet duct 8200 includes an outer portion which penetrates outer shell 8111, and an inner portion which penetrates inner shell 8112. The ducts 8200 are configured and arranged to introduce ambient cooling air directly into the bottom of the ventilation annulus 8122 between the canister 8101 and inner shell 8112, and preferably adjacent to the top surface of the baseplate 8115.

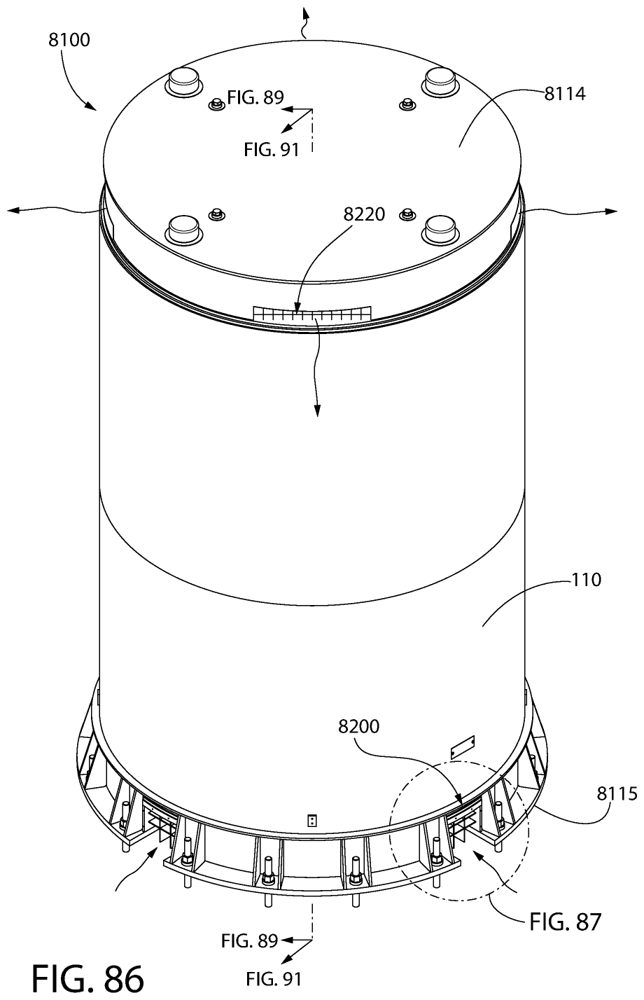

Referring initially to FIGS. 86-87 and 91-94, each air inlet duct 8200 may comprise a generally rectangular inlet flow box 8201 extending radially through the sidewall of the cask body (i.e. shells 8111, 8112 and radiation shielding material 8113 therebetween) to fluidly connect ambient air to the internal cavity 8121 and ventilation annulus 8122 of the cask 8100. In one embodiment, the flow box may be a three-sided inverted U-shaped orthogonal structure formed of steel plates welded together and in turn is welded to the baseplate 8115 (best shown in FIG. 94). The interior outlet of the flow box 201 penetrates the inner shell 8112 within the ventilation annulus 8122 (visible in FIG. 94). The external portion or entrance of the inlet flow box 8201 may be terminated with an outward facing flat face frame 8202 to which a shutter plate 8240 (further described elsewhere herein) may be coupled to regulate the inflow of ambient cooling air into the cask 8100. Advantageously, this simpler construction allows the shutter plate 8240 to be formed of a flat piece of steel or other metallic plate thereby obviating the need and additional expense of forming curved shutter plates to match the arcuately curved external surface 8111a of the cask outer shell 8111.

To prevent radiation streaming from the SNF inside the canister 8101 when disposed in cask 8100 to the ambient environment through the inlet ducts 8200, each inlet duct 8200 may be fitted with a gamma shield 8203 formed by an orthogonal grid array of shielding plates 8203a. The shielding plates 8203a extending radially from the external surface to the internal surface of the cask sidewall inside the inlet flow box 8201. The shield 8203 defines an array of radial airflow openings 8203b through which cooling air may enter the internal cavity 8121 of cask 8100 from atmosphere.

The radial cooling air outlet ducts 8220 may be formed in housing 8114b of the lid. FIG. 90 is a close-up view of one of the outlet ducts. Each air outlet duct 8220 extends horizontally/laterally completely through the lid 8114 and may be disposed adjacent to the bottom of the lid. The ducts 8220 may be formed above and adjacent to peripheral ring plate 8114b-4. Each duct 8220 is defined by an inverted U-shaped outlet flow box 8222 formed of metal plates which extends horizontally/laterally through peripheral shell 8114b-3 of the lid housing 8114 at the outer end, and opens inwardly to the central air-collection recess 8114c of the lid to receive the rising heating air from the ventilation annulus 8122. Each air outlet duct 8220 may be fitted with a gamma shield 8221 having a similar construction to and for the same purpose as gamma shield 8203 of the air inlet ducts 8200 previously described herein.

The radially oriented air outlet ducts 8220 define air outlet passageways which place the upper portion of the cask cavity 8121 and ventilation annulus 8122 in fluid communication with ambient atmosphere to discharge the rising cooling or ventilation air heated by the canister 8100 back to the external environment surrounding the cask 8100. Outlet ducts 8220 may be horizontally oriented and linearly straight in configuration in one non-limiting preferred embodiment as shown. The outlet ducts may be circumferentially spaced apart around the circumference of the lid 8114. In one embodiment, outlet ducts 8220 may be equally spaced apart and may include at least four ducts to uniformly extract and expel the rising ventilation or cooling air heated by each quadrant of the SNF canister 8101 for efficient canister cooling. In one embodiment, at least four outlet ducts may be provided. In other embodiments, more or fewer outlet ducts (including only a single outlet duct) may be provided.

In operation, air inside the ventilation annulus 8122 of the cask 8100 between the canister 8101 and inner shell 8112 is heated by the canister. The heated air rises, enters the central air collection recess 8114c on the underside of the lid contiguous with the cask internal cavity 8121, and is discharged to atmosphere through air outlet ducts 8220. Concomitantly, the rising heating air draws available ambient cooling air surrounding the cask through the air inlet ducts 8200 at the bottom of the cask via natural convective thermo-siphon effect. This ventilation air circulation pattern continues indefinitely as long as the canister emits some degree of heat.

As the SNF stored in canister 8101 decays over time, the heat emission rate will drop and correspondingly the air in the ventilation annulus 8122 will decrease. The air temperature surrounding particularly the lower portion of the canister may drop to a value or level which is conducive to the onset of stress corrosions cracking (SCC) particularly when the cask is located in a marine or similar high humidity environment in the presence of halides, as previously described herein. It is therefore desirable to have the ability to reduce the airflow rate through the cask to maintain the canister maximum temperature limit previously described herein which can also minimize the chance of the onset of SCC at the exposed canister weld seams.

According to another aspect of the present natural convective circulation cooling air ventilation system, the system includes provisions and features for regulating the airflow rate through the internal cavity 8121 of cask 8100 which houses the SNF canister 8101. The ventilation system is the primary mechanism in a ventilated cask nuclear fuel storage system by which heat is extracted from the canister 8101 and rejected to the surrounding environment.

Accordingly, the present cask ventilation system provides user-controllable and adjustable throttling of the natural convective airflow by opening or partially closing the ventilation air passageways formed by the inlet or outlet ducts 8200, 8220. This airflow regulation may be used to maintain the temperature of air surrounding the canister 8101 inside the cask cavity 8121 at or near the predetermined canister maximum temperature limit which is detrimental to the onset of stress corrosion cracking (SCC) at the canister welds as previously described herein.

In one embodiment, the airflow throttling mechanism comprises a vertically adjustable shutter plate 8240 coupled to the outer end of preferably each the air inlet ducts 8200. The movable shutter plate acts as a variable orifice and defines a variable flow opening area 8A1 for each duct which is configured and operable to throttle or adjust an inflow of cooling air drawn into and through the internal cavity 8121 of the cask 8100 and ventilation annulus 8122 adjacent the canister 8101. Accordingly, the shutter plates 8240 are vertically adjustable in position on the cask to vary the flow opening area 8A1 to increase or decrease the inflow of cooling air to maintain the desired canister 8101 temperature at or near the predetermined canister maximum temperature limit. The peripheral outer edge of the baseplate 8115 in preferred non-limiting embodiments may comprises a cutout 8115c at each of the cooling air inlet duct 8200 locations on the cask 8100. This forms a discontinuous and interrupted outer circumference and edge of the baseplate forming a castellated baseplate configuration (see, e.g., FIGS. 94-99). The cutouts 8115c contribute to and are contiguous with the flow opening area 8A1.

When the SNF (spent nuclear fuel) inside the canister 8101 is newer (i.e. recently removed from the reactor), the heat emitted through the canister walls will be greater. Accordingly, a higher airflow rate (e.g., CFM—cubic feet per minute) is desirable to prevent overheating and damage the SNF fuel assemblies in the canister. As the SNF ages, the heat emitted will decrease.

Accordingly, it then becomes desirable to reduce the airflow rate to prevent the onset of SCC while balancing the need to keep the SNF from overheating. The present shutter plates 8240 allow such adjustment to be readily made over time by monitoring the temperature of the heated ventilation air discharged from the cask and/or the canister 8101 external wall temperature such as via temperature sensors 8230 (shown in FIG. 85) such as thermistors or thermocouples.

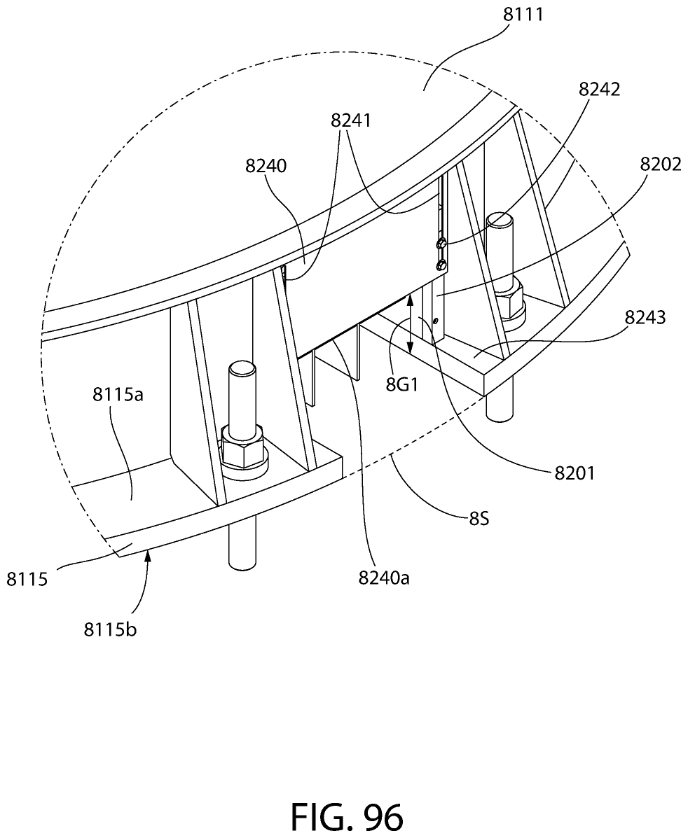

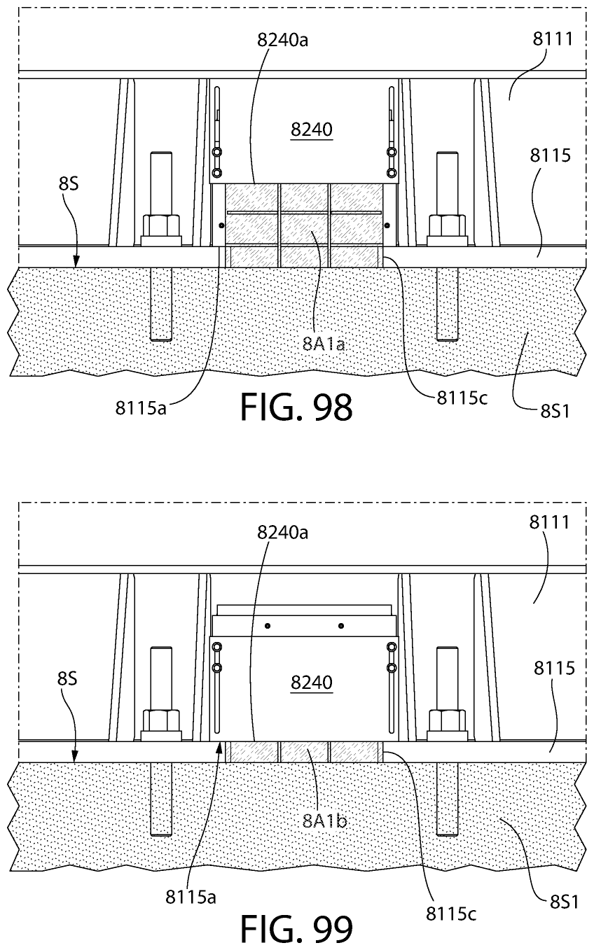

Shutter plates 8240 are vertically movable between a first upper position associated with a first flow opening area 8A1a, and a second lower position associated with a second flow opening area 8A1b which may be smaller than the first flow opening area. These positions and flow opening areas are represented in FIGS. 96-99. The flow opening areas 8A1a, 8A1b for inlet ducts 8200 are each measured and defined between bottom edge 8240a of the shutter plate 8240 and the bottom surface 8115b of baseplate 8115, which also happens to coincide with the top support surface 8S of concrete support slab 8S1 on which the baseplate rests. Gap 8G1 is formed between bottom edge 8240a and baseplate bottom surface 8115b/support surface 8S when shutter plate 8240 is in the upper position. This sets the extent of the flow opening area 8A1a denoted by the dashed hatching in FIG. 98, which may be a maximum flow opening area (and open position of shutter plate 8240) and maximum gap 8G1 allowing the greatest inflow of induced ambient cooling air into the cavity 8121 of cask 8100. This position of shutter plate 8240 may be used for example when the SNF is initially removed from the reactor and loaded into the canister 8101 and cask 8100 to maximize cooling of the canister.

When shutter plate 8240 is in the lower position, gap 8G2 is formed between bottom edge 8240a and baseplate bottom surface 8115b/support surface 8S when shutter plate 8240. Gap 8G2 is smaller than gap 8G1. This sets the extent of the smaller flow opening area 8A1b denoted by the dashed hatching in FIG. 99, which may be a minimum flow opening area and gap 8G2 allowing the least inflow of induced ambient cooling air into the cavity 8121 of cask 8100. This position of shutter plate 8240 may be used for example after a prolonged period of time when the decay heat emitted by the SNF in canister 8101 has decreased significantly. The smaller flow opening area 8A1b may be set to maintain the canister 8101 at or near the predetermined canister maximum temperature limit associated with both preventing overheating and damaging the fuel cladding (fuel rods) stored in the canister, which in turn prevents the onset of stress corrosion cracking (SCC) at the canister weld seams.

To leverage the variable airflow control technique, a benchmarked thermal model of the cask may be prepared using a commercially-available computational fluid dynamics (CFD) code or software such as FLUENT to ascertain the predetermined canister maximum temperature limit. The model may be benchmarked by measuring the temperature of reference points on the top lid and comparing the measured values with the predicted temperature from the CFD analysis. The “normalized” thermal model can then be used to inform the appropriate extent of inlet vent or duct flow opening reduction required to keep the outer wall of the canister 8101 as hot as possible without exceeding the regulatory limit on the fuel cladding temperature with sufficient safety margin. This predetermined canister maximum temperature limit based on the CFD results will concomitantly maintain the air temperature within the cask internal cavity as high as possible to provide conditions which are not conducive to the onset of stress corrosion cracking (SCC) at the exposed canister welds. For a typical canister, calculations show that the heat rejection demand drops sufficiently within the first 20 years of canister storage to warrant reducing the vent openings by as much as 90% in order to keep the canister at or near the canister maximum temperature limit and as warm as it was at the time it was first placed in service. For certain waste fuel loading scenarios, almost or complete closure of the vents may be advisable at coastal or other sites with non-negligible halide concentrations in the ambient environment within as little as 10 years from placement into service

It bears noting that the shutter plates 8240 may be adjusted in position anywhere between the upper maximum and lower minimum positions described above and shown to throttle the airflow between maximum and minimum as needed by the user or operator to maintain the cask minimum internal air temperature threshold or limit. Accordingly, the airflow rate is adjustably variable between maximum and minimum.

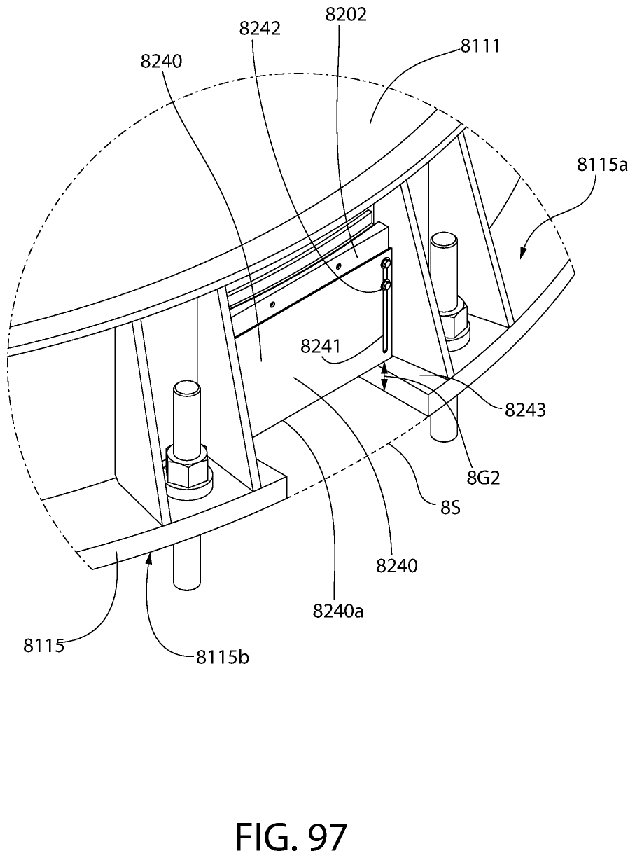

A failsafe measure may be provided to ensure some amount or degree of ambient cooling air can always flow into internal cavity 8121 of cask 8100 and reach the canister 8101 via the natural convection to prevent overheating the SNF stored therein. In one embodiment, the baseplate 8115 may be configured such that the bottom edge 8240a of each shutter plate 8240 abuttingly engages the top surface 8115a of the baseplate adjacent to cutouts 8115c. Top surface 8115a of the baseplate therefore forms a travel stop 8243 which limits the minimum closed position of shutter plate as shown in FIGS. 97 and 99, which is not a fully closed position. The minimum flow opening area 8A1b is maintained at all times between the bottom edge of the shutter plate 8240 and top support surface 8S of concrete support pad 8S1. Accordingly, bottom edge 8240a of shutter plate 8240 can never engage support surface 8S in this embodiment to fully close off the inlet ducts 8200. The baseplate cutouts 8115c advantageously ensure some degree of ambient cooling air can enter the cask cavity 8121. In other embodiments contemplated however where it might be desirable to be able to fully close the inlet ducts, the baseplate 8115 and shutter plates 8240 may be designed to engage the top support surface 8S.

Shutter plates 8240 may be slideably coupled to the outer part of each ambient cooling air inlet duct for vertical movement and adjustment to vary the ventilation air inflow into cask 8100. In one embodiment, each shutter plate 8240 may be slideably coupled to the flat outer face frame 8202 formed by the inlet flow boxes 8201 associated with each air inlet duct 8200 (see, e.g., FIGS. 94-99). In other possible embodiments, however, the shutter plates 8240 may be slideably mounted directly to the external surface 8111a of the outer shell 8111 near the bottom end of the cask.

Each shutter plate 8240 in the illustrated embodiment includes at least one vertically elongated adjustment slot 8241 through which at least one threaded locking fastener 8242 is inserted to threadably engage the inlet flow box face frame 8202. In one embodiment, a pair of slots 8241 may be provided at opposite sides of the shutter plate (see, e.g., FIG. 96) for added securement. Threaded fastener holes 8202a (see, e.g., FIG. 87) may be pre-formed in the face frame to receive each of the locking fasteners. The fasteners 8242 are tightened to fix the position of shutter plates 8240 to set the desired gap and flow opening area of the air inlets 8200. To vertically adjust the position of the shutter plates and corresponding flow areas, the locking fastener 8242 may be loosened. This allows the plate 8240 to be slid up or down to the desired location. The fastener is then tightened to lock the shutter plate 8240 in position.

In operation, once the shutter plates 8240 are vertically adjusted and fixed in position via tightening the locking fasteners 8242 to set the desire airflow rate through inlet ducts 8200, ambient cooling air is drawn inwards through the ducts beneath each shutter plate which forms a variable orifice of sorts. The air flows radially inwards through the openings 8203b in the gridded gamma shield 8203 and enters the bottom of the ventilation annulus 8122 adjacent to the top surface of baseplate 8115 and sides of the cylindrical pedestal 8116 (see, e.g., FIG. 91). The air heated by the canister rises inside the annulus 8122 and exits the top of the cask internal cavity 8121 via the outlet ducts 8220 in the lid 8114.

Although shutter plates 8240 are described above and shown as being mounted to the air inlet ducts 8200, in other possible embodiments the shutter plates may instead be mounted to the air outlet ducts 8220 in lid 8114 to regulate the inflow of ambient cooling air into the cask 8100. The shutter plates may be similarly configured and mounted to the air outlet ducts in the same manner disclosed for the inlet duct arrangement without further undue elaboration.

Although flat shutter plates 8240 are shown, in other embodiments arcuately curved shutter plates may instead be used as needed while maintaining the vertical adjustment features previously described herein.

Below Grade Ventilated Nuclear Fuel Storage Cask

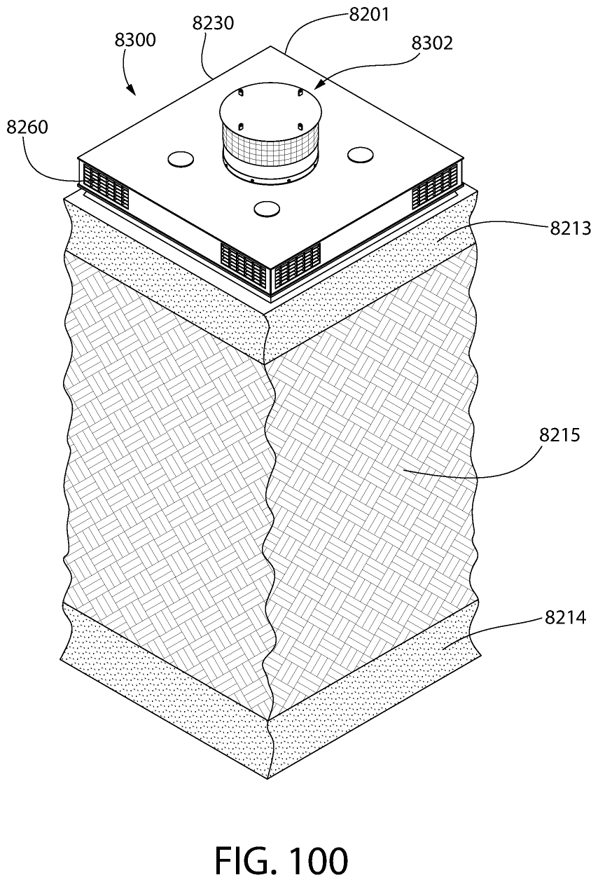

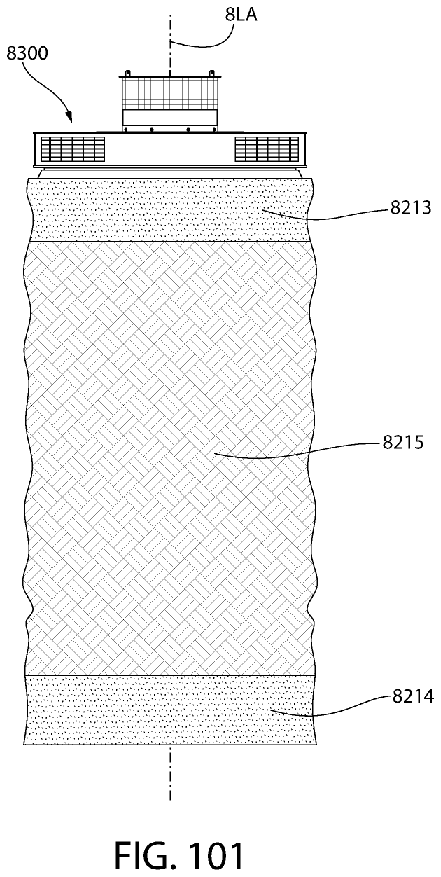

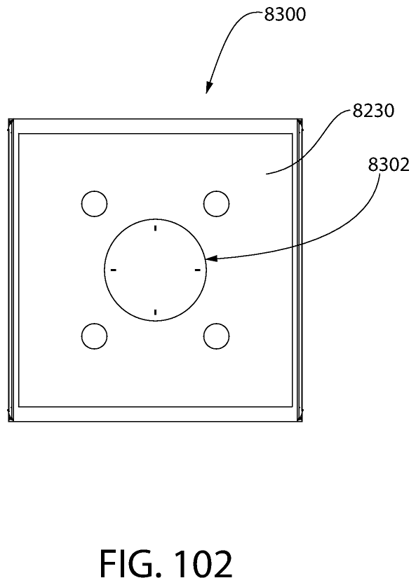

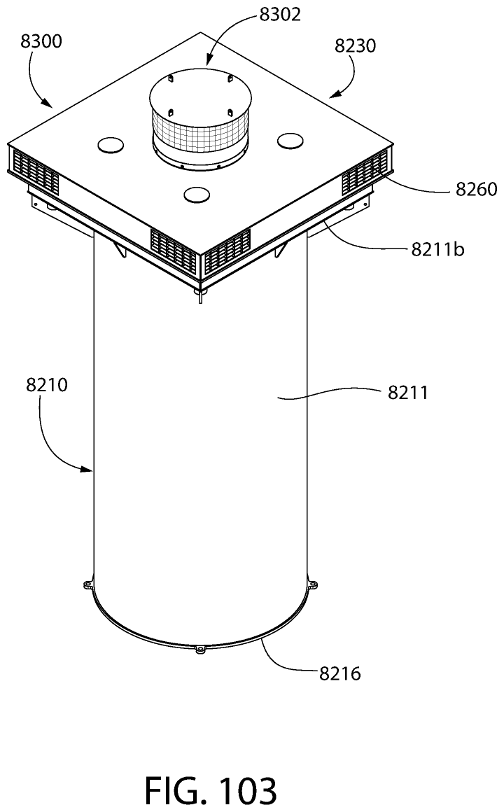

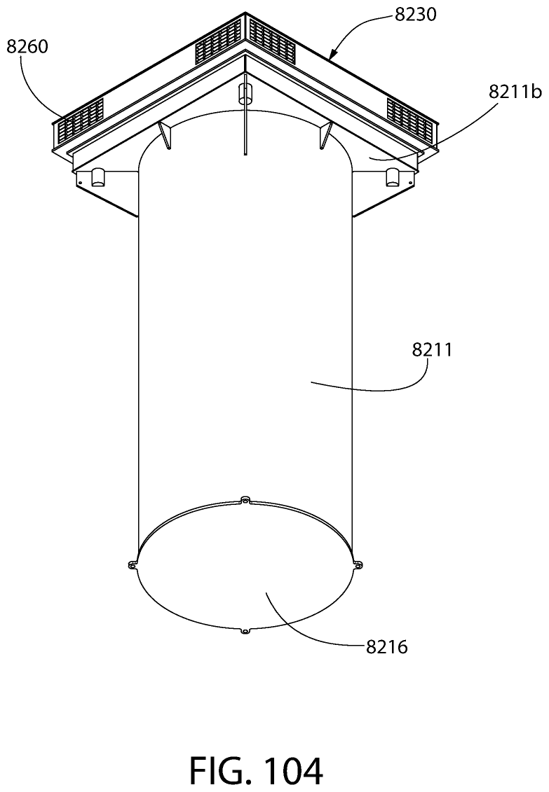

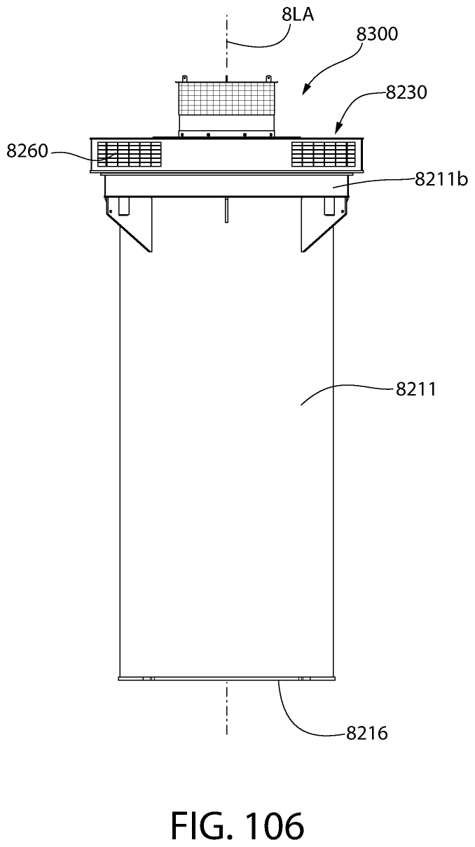

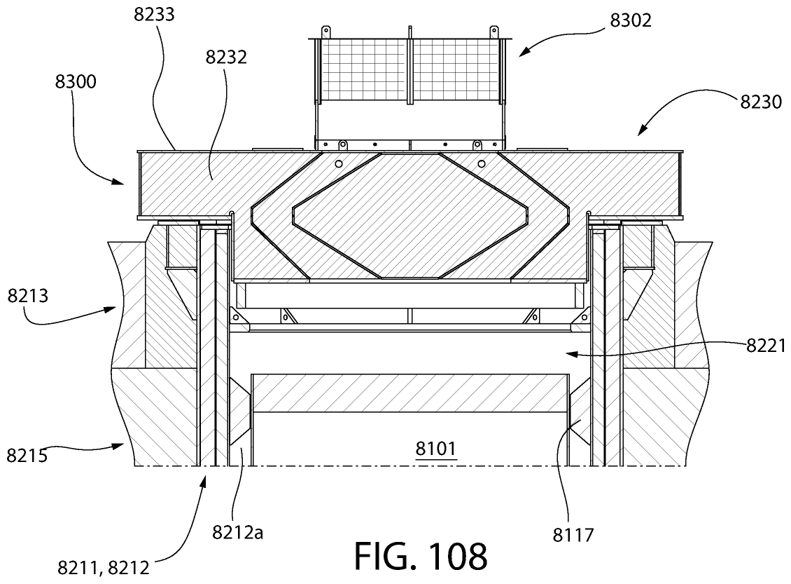

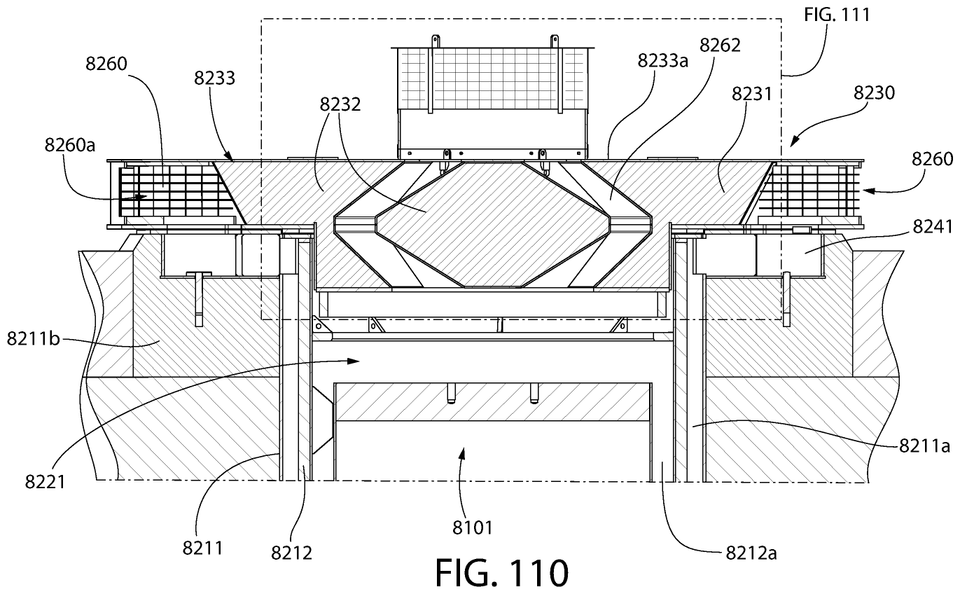

FIGS. 100-115 depict various aspects of a nuclear fuel storage system generally comprising a second embodiment of a passively cooled and naturally ventilated outer storage module or cask 8300. Cask 8300 is constructed for partial and substantial underground/below grade placement wherein a majority of the height of the cask is located below grade and the entirety of the SNF canister 8101 is below grade for radiation shielding provided by the surround embedment. Whereas above grade storage cask 8100 previously described herein is heavily radiation shielded, storage cask 8300 conversely is unshielded. Instead, cask 8300 utilizes the surrounding at grade and below grade embedment materials such as concrete and engineered fill (e.g., compacted soil, crushed stone, masonry waste material, etc. and combinations thereof) to block and absorb the radiation emitted by the SNF inside the nuclear waste fuel canister 8101. Cask 8300 is compatible for use in underground nuclear waste fuel and high level waste storage systems forming part of an Independent Spent Fuel Storage Installation (ISFSI) such as the HI-STORM UMAX Dry Storage System available from Holtec International of Camden, N.J.

The naturally ventilated below grade storage cask 8300 may be double-walled vessel in one embodiment including an elongated cask body 8210 formed by a cylindrical outer shell 8211 and concentrically arranged cylindrical inner shell 8212 nested inside the outer shell. The shells 8111, 8112 collectively define the sidewall of the cask. The shells of cask 8300 are embedded in radiation shielding materials such as a reinforced concrete top pad 8213 surrounding the upper portion of the cask and layer of intermediate embedment material 8215 extending from the top pad to the bottom of the cask body (inner and outer shells). Intermediate embedment material 8215 may be concrete or engineered fill. The upward facing exposed top surface of top pad 8213 defined grade. The cask 8300 further includes circular baseplate 8216 which is seated on and fixedly coupled to a reinforced concrete base pad 8214 such as via bolting. The top pad and intermediate layer of embedment material directly contacts outer shell 8211.

Inner shell 8212 of cask 8300 comprises a vertically-extending internal cavity 8221 which extends along a centerline or longitudinal axis 8LA defined by the vertically elongated cask. The cavity 8221 has a cross-sectional area configured to hold a single SNF canister 8101. Cavity 8221 may be of cylindrical configuration in one embodiment with a circular cross-sectional shape; however, other shaped cavities with corresponding cross-sectional shapes may be used. The metal baseplate 8216 may be seal welded to the bottom ends of inner and outer shells 8212, 8211 at the bottom end of cask 8300 prevent the ingress of water. The metallic inner and outer shells 8212, 8211 may be formed of the same metals as inner and outer shells 8112, 8111 of cask 8100 (e.g., carbon or stainless steel).

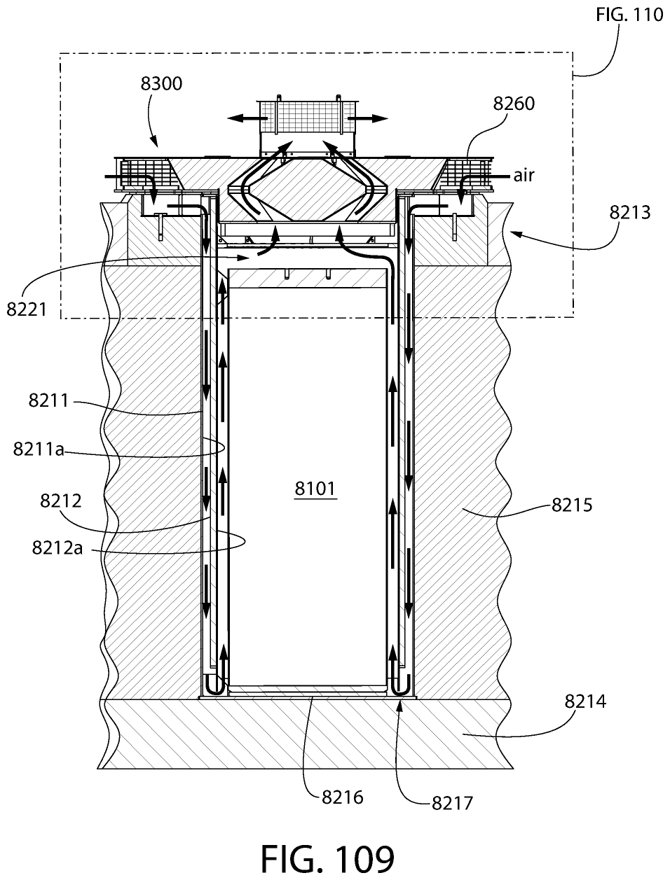

Outer shell 8211 is radially spaced apart from inner shell 8212 defining an annular ventilation downcomer 8211a therebetween. An annular ventilation riser 8212a is formed between canister 8101 and inner shell 8212. At the bottom, downcomer 8211a is in fluid communication with the lower portions of cavity 8221 of the cask and ventilation riser 8212a via a plurality of circumferentially spaced apart flow openings 8217 formed by and between downwardly protruding legs 8218 on the bottom end of inner shell 8212. The bottom end of outer shell 8211 and legs 8218 of inner shell 8212 rest on the flat top surface of base pad 8214 (see, e.g., FIG. 109). The upper portion of ventilation downcomer 8211a is in fluid communication with ambient atmosphere through lid 8230 for drawing in cooling ventilation air, as further described herein.

Inner shell 8212 may include a plurality of circumferentially spaced upper and lower upper guide lugs 8117 similar to cask 8100 previously described herein to center the SNF canister 8101 and maintain an open ventilation riser 8212a all around the canister.

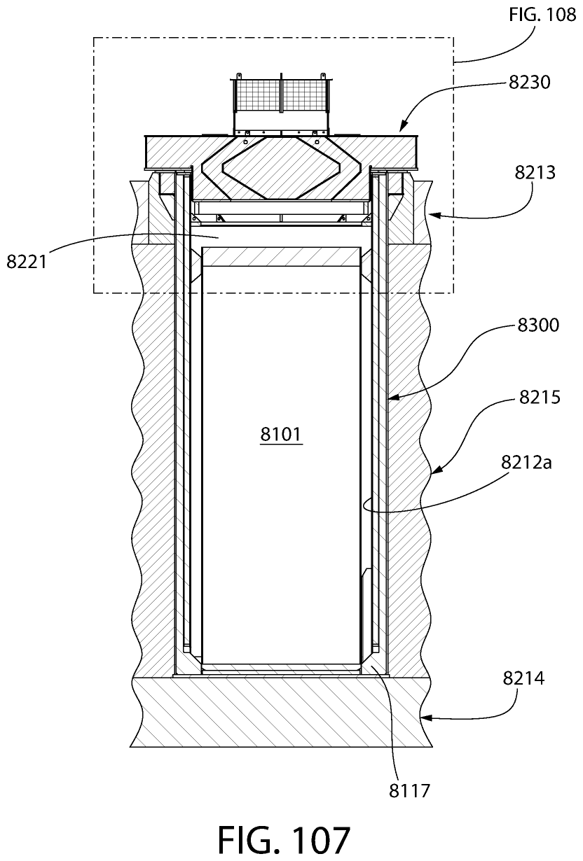

As shown in FIGS. 100-101 and 109 for example, the cask body 8210 comprising outer and inner shells 8211, 8213 is configured for mounting a majority of the cask body and its vertical length/height below grade to take advantage of the radiation shielding effect of the embedment materials 8213-8215 previously described herein. This also advantageously creates a low profile below grade nuclear fuel storage system where only primarily the lid 8230 is exposed. The below grade placement makes the storage system offers greater protection of the spent nuclear fuel canister 8101 less susceptible to projectile impact scenarios. In all embodiments, at least the SNF canister 8101 is located below grade when positioned in cask 8300 (see, e.g., FIGS. 107 and 109).

Lid 8230 is configured for mounting on top of inner shell 8212 which may extend vertically upwards farther than outer shell 8211 (see, e.g., FIGS. 109-111). Referring generally as applicable to FIGS. 100-115, lid 8230 is a radiation shielded component comprising a metallic outer housing 8233 (e.g., steel or other) comprising a top housing plate 8233a, bottom housing plate 8233c, and housing sidewall plate 8233b extending perimetrically around the lid between the top and bottom housing plates. A concrete or fill liner 8233 is formed inside the lid housing.

In one embodiment, the lid housing 8233 may have a polygonal configuration such as rectangular (e.g., rectangular cuboid which by definition includes sides of equal or unequal length) as shown. In other embodiments, non-polygonal shapes such as cylindrical may be used. Lid 8230 preferably projects laterally/horizontally farther outwards beyond outer shell 8211 by a substantial distance (e.g., at least 20% of the diameter of the outer shell) on all sides of the lid. The projected distance allows air inlet ductwork to be incorporated directly into the lid without compromising the lateral extent and depth of radiation shielding material in the lid. The projection further provides space for incorporating the air outlet ducts directly into the lid. Accordingly, the ambient cooling ventilation air both enters and exits the cask 8300 through lid 8230.

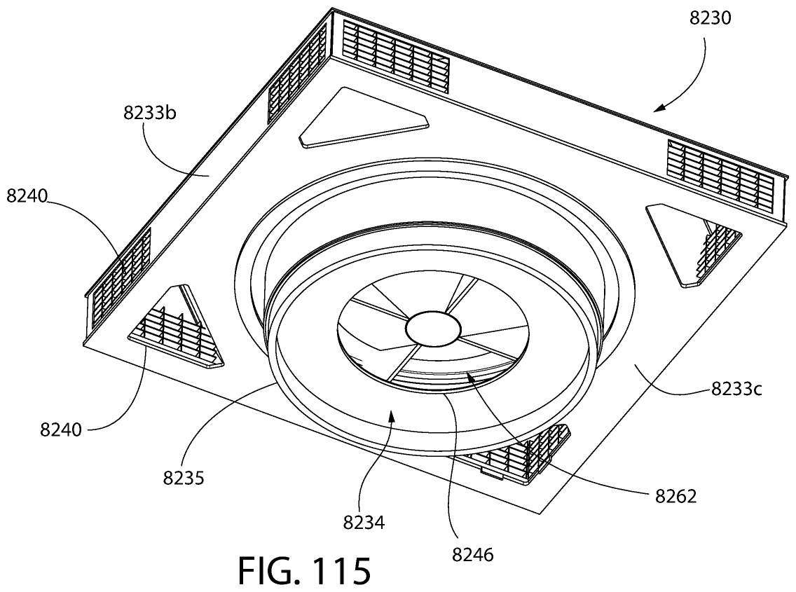

Accordingly, lid 8230 includes an array and plurality of air inlet ducts 8260 for drawing ambient cooling air directly through the lid to the cask 8300. In one embodiment, an inlet duct 8260 may be formed at each of four corner regions of the lid and open laterally/horizontal outwards through housing sidewall plate 8233b (see, e.g., FIG. 115). The lateral outward entrance openings of the inlet ducts are located horizontally outwards beyond outer shell 8211 of cask 8300 as shown. The entrance openings are shown fitted with perforated screens 8260a to prevent foreign objects and debris from entering and obscuring the inlet ducts.

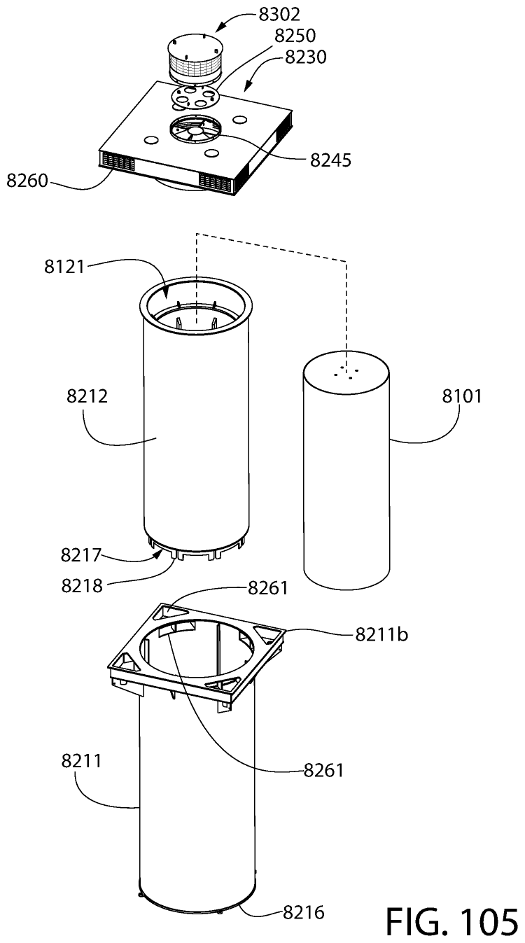

Inlet ducts 8260 are downwardly open through openings formed in housing bottom plate 8233c. Housing 8233 is mated to complementary configured lid mounting flange 8211b fixedly disposed on the top end of cask outer shell 8211 (see, e.g., FIGS. 105 and 109-111). In the non-limiting illustrated embodiment, both lid housing 8233 and mounting flange 8211b may have a rectangular configuration (e.g., rectangular cuboid). Mounting flange 8211b protrudes laterally/horizontal outwards beyond the outer surface of outer shell 8211 as shown in a cantilevered manner.

The lid mounting flange 8211b of outer shell 8211 includes a plurality of air inlet passageways 8261 which coincide in location and general shape to the air inlet ducts 8260 of lid 8230 (e.g., one each in the four corner regions of the lid and mounting flange). The passageways 8261 are upwardly open at top and radially inwards opens through the upper portion of outer shell 8211 for introducing ambient cooling air into the ventilation downcomer 8211a. Each passageway 8261 is in fluid communication at top with one of the air inlet ducts 8260 of the lid, and at bottom with the downcomer.

Lid 8230 further includes an air outlet duct 8262 extending vertically through the concrete liner 8232 between the housing top and bottom plates 8233a and 8233c. In one embodiment, the outlet duct extends vertically through a central portion of the lid as shown. Air outlet duct has a non-linear and curved shaped configured to eliminate any straight line of sight vertically through the lid to prevent radiation streaming. Air outlet duct 8262 may comprise a plurality of curved branches of similar shape extending vertically through the lid and being configured such that there is no straight line of sight from the internal cavity of the cask to ambient atmosphere through the air outlet duct. The branches thus configured may be recurvant in shape.

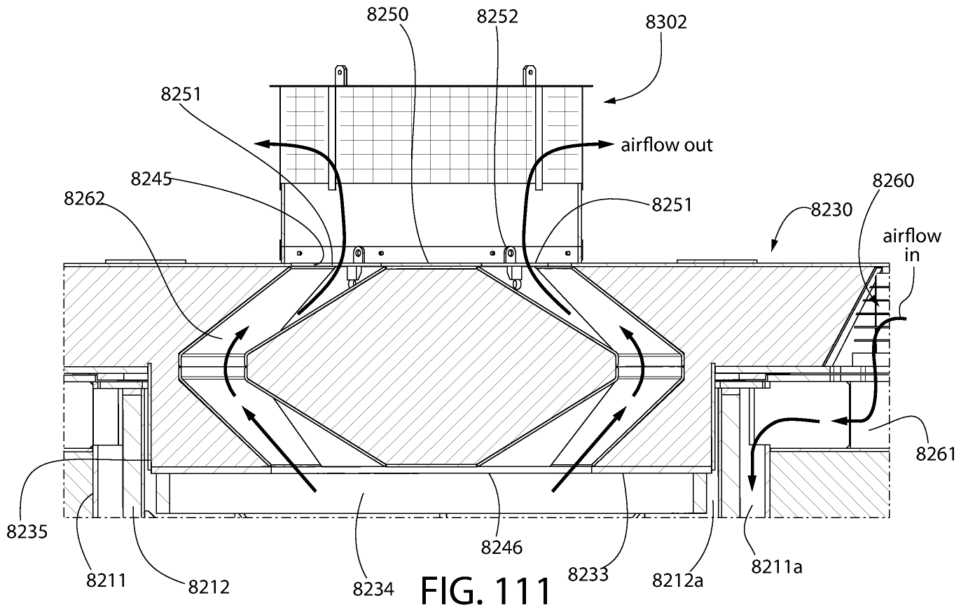

In one embodiment, lid 8230 comprises a cylindrical central plug extension 8235 which projects vertically downwards from housing bottom plate 8233a best shown in FIGS. 109-111 and 114. Plug extension 8235 has a diameter sized to be received inside the top opening of cask inner shell 8212. A large circular downwardly open recess 8234 is defined by plug extension 8235 which is in fluid communication with the upper portion of cask cavity 8221 at bottom and the air outlet duct 8262 at top via lower circular air inlet opening 8246 in the bottom of the lid 8230 (see, e.g., FIGS. 111 and 115). Opening 8246 may be formed in the center of plug extension 8235 in some embodiments.

An upper circular air outlet opening 8245 in lid 8230 is formed in the center of housing top plate 8233a. Opening 8245 is in fluid communication with the top of air outlet duct 8262 in lid 8230. Outlet opening 8245 is covered and protected from the elements and environment by a hollow/tubular top weather protection cap structure 8302 which forms an outlet vent extension. Cap structure 8302 may comprise a vertical cylindrical sidewall 8303 fitted with a perforated vent screen 8306 and preferably solid top cover plate 8304 to prevent the direct ingress of rain. Vent screen 8306 may have an open area of approximately 50% in one non-limiting embodiment. An open interior 8305 is defined inside cap structure 8302 which is in fluid communication at bottom with the air outlet opening 8245 in the lid and laterally to ambient atmosphere through the vent screen 8306.

In one embodiment, the circular air outlet opening 8245 is fitted with a circular metallic flow restrictor which may comprises an orifice plate 8250 to control the amount of ambient cooling air which can be drawn into below grade cask 8300 via air inlet ducts 8260 by the natural convective thermo-siphon effect previously described herein when the air in cask cavity 8221 is heated by the SNF canister 8101. By restricting the outflow of heated cooling air from the cask internal cavity 8221 at top, the amount of cooling air entering the air inlet ducts 8260 is concomitantly restricted to maintain the desired air temperature inside the cask to prevent the onset of stress corrosion cracking (SCC) of the SNF canister welds as previously described herein.

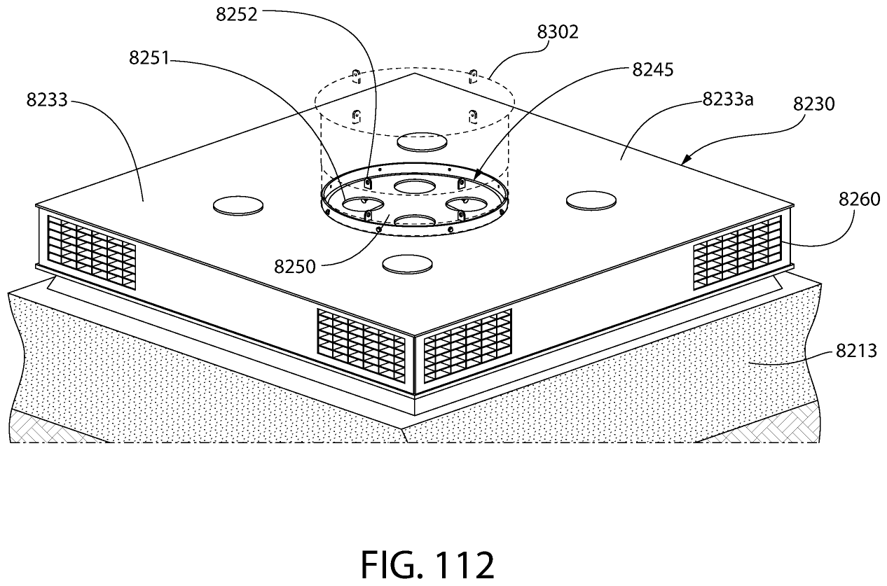

Orifice plate 8250 may be fixedly attached to the lid top cover plate 8233a at the annular edge of air outlet opening 8245 of outlet duct 8262 via welding. In other possible constructions, orifice plate 8250 may be detachably bolted to housing top plate 8233a via threaded fasteners. Orifice plate 8250 may include a plurality of lifting lugs on its top surface to facilitate maneuvering the plate into position on lid 8230. Orifice plate 8250 may have a representative diameter of about 45 inches in one non-limiting example and thickness of about 1½ inches or less, and preferably 1 inch or less. Plate 8250 preferably may be made of a corrosion resistant metal such as stainless steel or another suitable metal. A plurality of lifting lugs 8252 configured for rigging may be welded to the top surface of orifice plate 8250 (FIGS. 111-112).

In one embodiment, orifice plate 8250 may comprise an array or plurality of orifice holes 8251 which may be of circular configuration in one design. Four large spaced apart orifice holes may be provided in one non-limiting embodiment, recognizing that more or less holes and different diameter holes than shown may be used. The orifice holes 8251 may each have the same diameter or have different diameters. In some embodiments, contemplated, a mix of small diameter and larger diameter holes may be used.

Orifice holes 8251 of orifice plate 8250 are configured in number, size, and shape to provide a cumulative open area which leaves solid material or ligaments between holes that provides the desired resistance to the flow of ventilation air from the outlet duct 8262 of cask 8300. This regulates the flowrate (CFM) of air through the cask necessary to balance cooling the SNF canister 8101 while retaining enough heat in the internal cask cavity 8121 to prevent the onset of stress corrosion cracking (SCC) of the canister welds. In operation, orifice plate 8250 is thus configured to create a resistance to air flow through the air outlet duct 8262 of the lid 8230, which in turn creates backpressure on the cask cavity 8221 and in turn the air inlet ducts 8260 via intervening annular downcomer 8211a to reduce the amount of ambient air which can be drawn through the internal cavity of the cask via natural convective circulation when the cavity is heated by the SNF canister 8101.

In one example arrangement shown in FIG. 114, an array of circular orifice holes 8251 is provided around center 8C of the orifice plate 8250 such that no holes are located at the center. In other possible embodiments, one hole may be provided at the center. In other possible embodiments, a single large orifice hole may be provided. In yet other possible embodiments, the orifice plate comprises a plurality of perforations with ligaments between adjacent holes which are shorter than a diameter of the holes and which perforations substantially cover an entire surface area of the plate in a uniform pattern. The term “substantially” as used here means that a narrow annular band of solid material may be provided at periphery of the plate for welding to the lid 8230.

In order to maintain the foregoing balance during the service life of cask 8300, as previously described, the cooling ventilation air flowrate will need to be changed over time as the heat emitted from the canister decreases as the SNF decays.

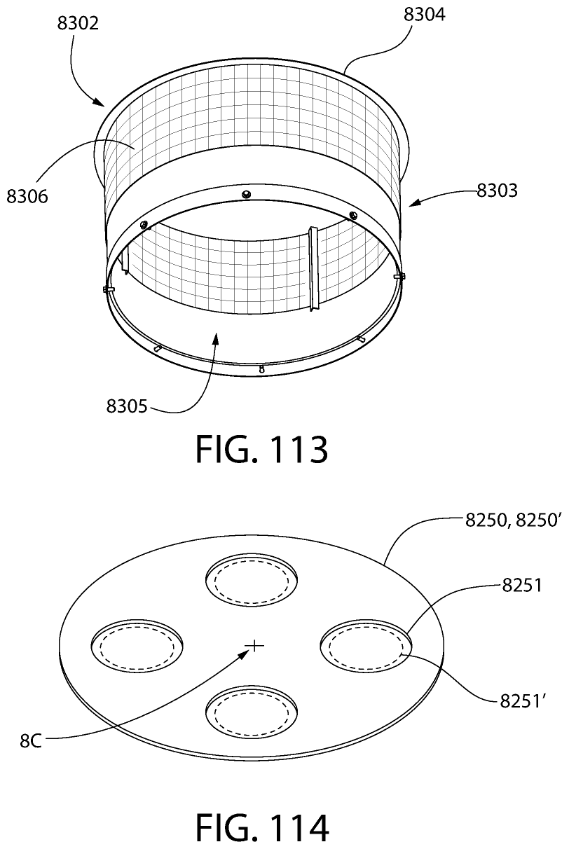

Accordingly, an ambient cooling air cask ventilation system in one embodiment comprises a plurality of orifice plates 8250 each configured to provide a different resistance to airflow. As an example, a first orifice plate may have orifice holes 8251 configured and sized to provide a cumulative open area which is greater a cumulative open area provided by a second orifice plate having the same number but smaller orifice holes 8251′ (illustrated in FIG. 113). The second orifice plate is interchangeably mountable to lid 8230 with the first orifice plate such that one orifice plate may be swapped out for another.

Due to the greater amount of heat emitted by the SNF canister 8101 when first loaded with spent nuclear fuel assemblies removed from the reactor or short term interim storage in the spent fuel pool, the first orifice plate 8250 may be used for an initial period of time. At some point in time as the canister heat emission rate decreases with age, the first orifice plate may be replaced with the second orifice plate 8250′ (FIG. 113) having a smaller cumulative open area for subsequent second period of time to maintain a desired minimum air temperature inside the cask 8300. Because the relative humidity of air decreases with increasing temperature, maintaining the minimum cooling air temperature in cask cavity 8221 which is associated with lower relative humidity advantageously is detrimental to the onset of SCC which occurs in high humidity environments in the presence of halides (salts) such as in marine nuclear fuel storage sites.

A method for operating a passively ventilated below grade nuclear fuel storage system may be summarized as comprising: inserting a canister 8101 containing spent nuclear fuel in an internal cavity 8221 of a cask 8300; attaching a lid 8230 on the cask, the lid comprising an air outlet duct 8262 including a first orifice plate 8250 having a first open area, the outlet duct in fluid communication with the internal cavity of the cask; storing the canister in the cask for a first period of time; removing the first orifice plate from the lid; and installing a second orifice plate 8250′ in the lid for a second period of time, the second orifice plate having a second open area different than the first open area.

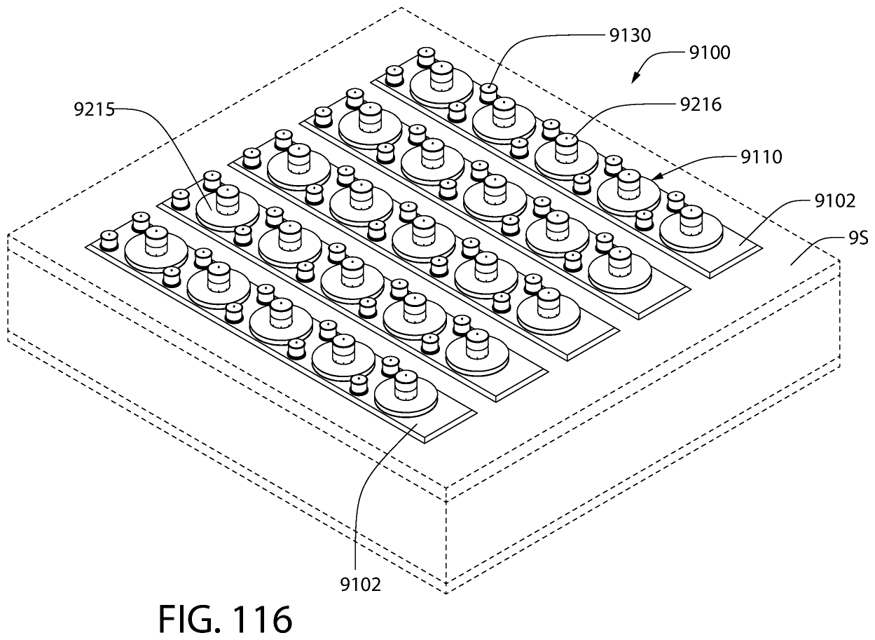

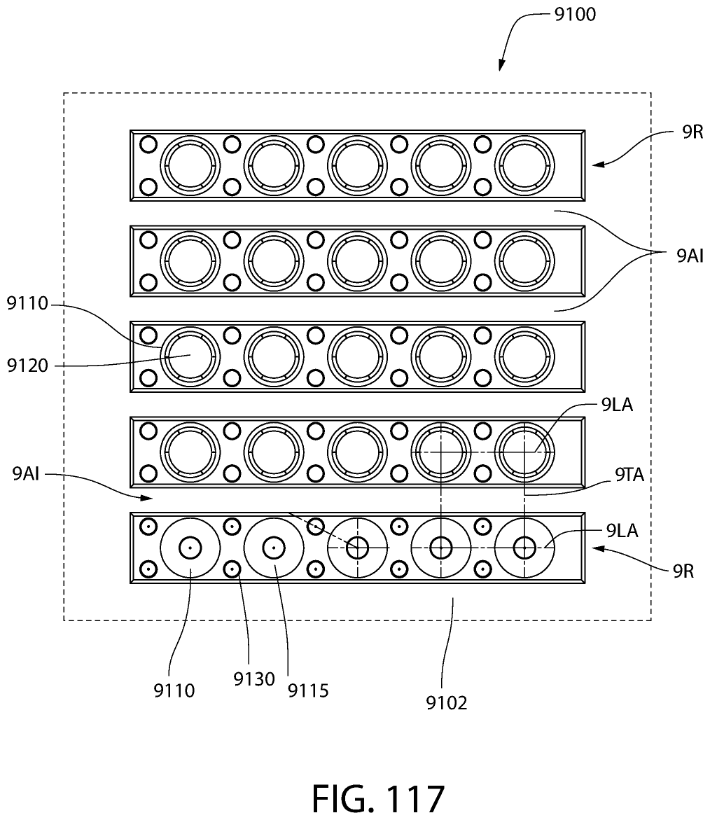

FIGS. 116 and 117 depict a top views of an ISFSI facility comprising a passively cooled subterranean consolidated interim storage (CIS) system 9100 according to the present disclosure. System 9100 comprises an array of underground vertical ventilated cavity enclosure containers (CECs) 9110 each holding a single nuclear waste canister 9150 containing the radioactive nuclear waste, and vertically elongated cooling air feeder shells 9130 interspersed between and fluidly coupled to the CECs according to the present disclosure. The CECs and air feeder shells are configured to form integral parts of an unpowered natural convective ventilation system which operates via the thermo-siphon effect to cool the nuclear waste fuel stored in each CEC, as further described herein.

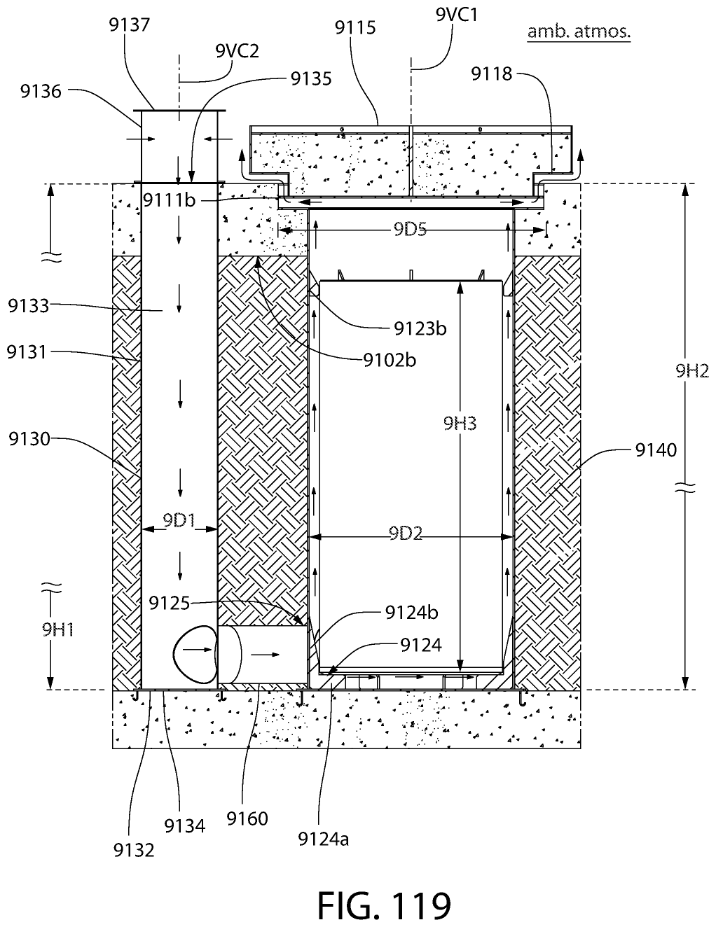

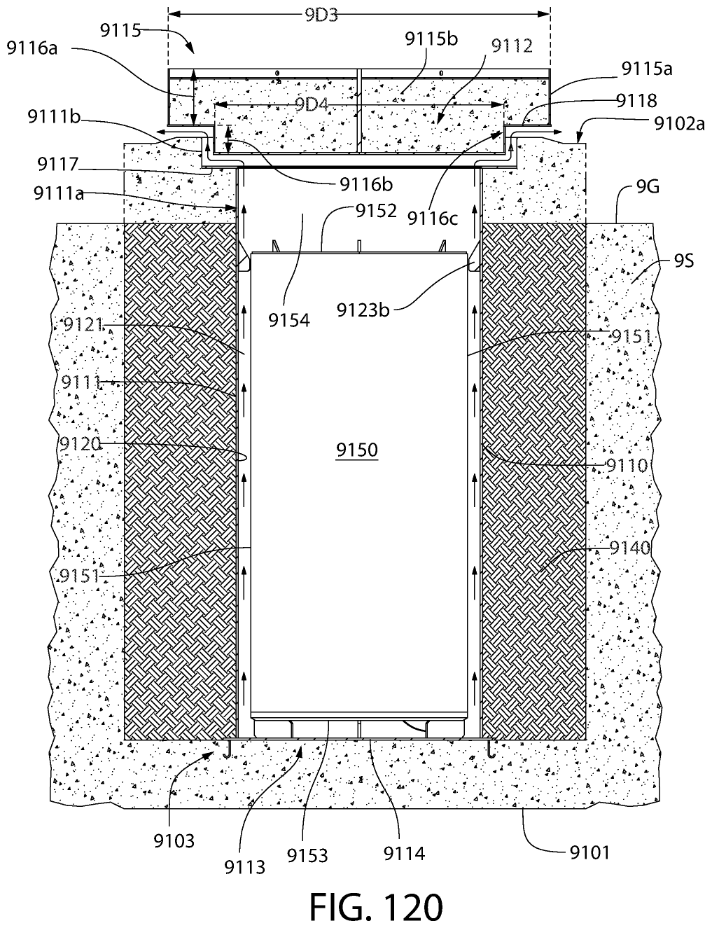

FIGS. 119 and 120 depict one embodiment of a CEC 9110 and cooling air feeder shell 9110 of a nuclear waste storage system according to the present disclosure in greater detail. The CECs 9110 and cooling air feeder shells 9130 are founded on and supported by a thick and horizontally extending subterranean bottom base pad 9101 located below a cleared top surface or grade “9G” of the native soil “9S” at the CIS system site. Base pad 9101 may be made of reinforced concrete in one embodiment; however, in other embodiments other materials may be used such as compacted gravel so long a stable and firm base is provided to support the CECs and air feeder shells. In the case of concrete as shown in the illustrated embodiment, the CECs and air feeder shells may be rigidly anchored to the base pad via multiple anchor members 9103 such as robust J-shaped fasteners (threaded or otherwise), or other suitable types of anchors commonly used for fastening structural objects to concrete. Preferably, base pad 9101 has a suitable thickness and construction robust enough to withstand postulated seismic events and maintain safe support the CECs 9110 and containment of their nuclear waste contents.

A horizontally and longitudinally extending concrete top pad 9102 is formed on top of the engineered fill 9140 described below which is placed after pouring base pad 9101. Top pad 9102 therefore protrudes upwards from and is raised above the cleared grade 9G of the surrounding native soil 9S. The top pad is vertically spaced apart from the below grade base pad 9101. The top pad defines an upward facing top surface 9102a elevated above grade to prevent the ingress of standing water from the surrounding native soil 9S into the CECs 9110 originating from rain events. Top surface 9102a is substantially parallel to an upward facing top surface 9101a of base pad 9101 (the term “substantially” accounting for small variations in the level of surfaces 9101a, 9102a and recesses and/or contours formed therein for various purposes). The top pad 9102 preferably extends at least one CEC outer diameter beyond the peripheral CECs 9110. A gradually sloping terrain of native soil 9S around the top pad is preferred to facilitate rainwater drainage away from the CECs.

The vertical gap or space formed between base and top pads 9101, 9102 including the open horizontal/lateral space between adjacent CECs 9110 and cooling air feeder shells 9130 is filled with a suitable “engineered fill” 9104 to provide both lateral radiation shielding for the nuclear waste stored inside the CECs 9110, and full lateral structural support to the CECs and the cooling air feeder shells 9130. Any suitable engineered fill may be used, such as without limitation flowable CLSM (controlled low-strength material) which is a self-compacting cementitious fill material often used in the industry as a backfill in lieu of ordinary compacted soil fill. Plain concrete may also be used as the inter-CEC and base pad to top pad gap filler material if it is desired to further increase the CIS system's radiation dose blockage capabilities. Other types of fill material which can provide radiation shielding and lateral support of the CECs and air feeder shells may be used.

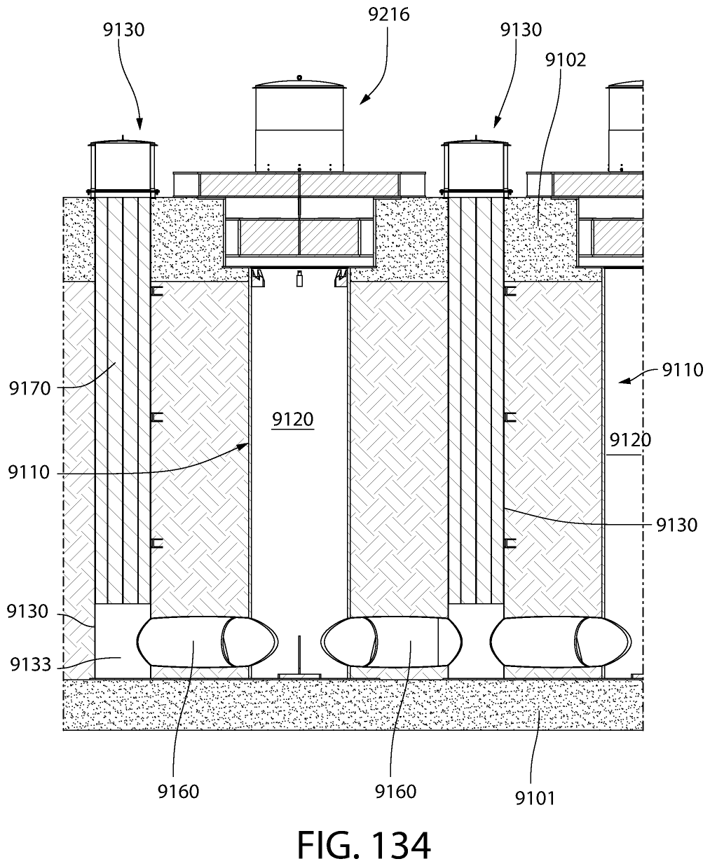

With continuing general reference to FIGS. 119 and 120, each CEC 9110 comprises a vertically elongated metallic shell body 9111 defining a vertical centerline axis 9VC1 and which extends between a top end 9112 and bottom end 9113 of the body. The upper portion 9111a of the shell body which defines top end 9112 may be embedded in in concrete top pad 9102 including between the top surface 9102a and bottom surface 9102b of the top pad 9102 as shown. In some embodiments shown in FIGS. 119-120 and 132-134. The top end 9112 of the CEC shell body 9111 may terminate at the top surface 9102a of the top pad. In either case, body 9111 of CEC 9110 may be cylindrical with a circular transverse cross-sectional shape in preferred non-limiting embodiments; however, other non-polygonal and polygonal shaped bodies may be used in certain other acceptable embodiments. The shell body 9111 of each CEC 9110 defines a vertically extending internal cavity 9120 extending between ends 9112, 9113 which is configured for holding a cylindrical nuclear waste canister 9150. As previously described herein, the waste canister 9150 defines an interior space which holds spent fuel assemblies and/or other high level radioactive waste from the nuclear reactor.

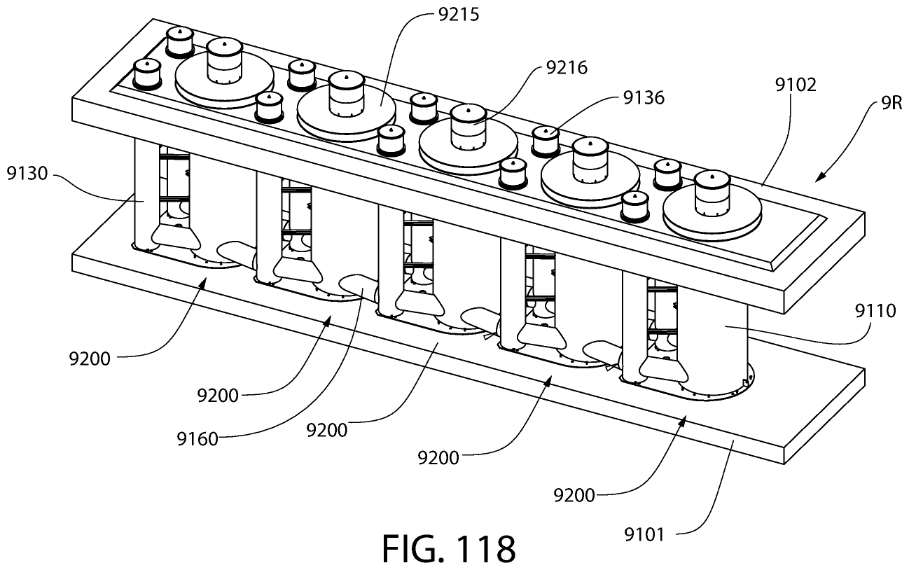

The nuclear waste canister 9150 stored in CEC 9110 includes a vertically-elongated hollow cylindrical shell 9151, top closure plate 9152, and bottom closure plate 9153. The top and bottom closure plates are hermetically seal welded to the top and bottom ends of shell 9151 to form a gas-tight containment boundary for the nuclear waste stored in the canister. Canister 9150 (i.e. shell and closure plates) may be formed of stainless steel in preferred embodiments for corrosion resistance. Canister 9150 has a height 9H3 smaller than the height 9H2 of the CEC shell body 9111 such that the top of the canister is spaced vertically apart and downwards from the bottom of the concrete top pad 9102 (see, e.g., FIG. 118). This helps to both ensure that there is no lateral radiation streaming outwards from the CEC 9110 at the top, and provides impact protection from incident projectiles (e.g., missiles, etc.). Canister 9150 may be any type of nuclear waste/SNF canister, including without limitation Multi-Purpose Canisters (MPCs) available from Holtec International of Camden, N.J.

CEC 9110 further includes a baseplate 9114 hermetically seal welded to the bottom end 9113 of shell body 9111. A plurality of metallic radial support lugs 9124 are welded to baseplate 9114 and/or inside surface of the CEC shell body 9111 in a circumferentially spaced apart manner at the bottom of cavity 9120. The lugs are formed of suitable metal (e.g., stainless steel or other) and act to support and elevate the canister 9150 above the baseplate. This creates open space between the top of the baseplate 9114 and bottom closure plate 9153 of the canister 9150 to allow cooling ventilation air to circulate beneath the canister for removing heat emitted from the bottom of the canister by the nuclear waste material stored therein.

In one embodiment, the support lugs 9124 may be generally L-shaped having a horizontal portion 9124a welded to baseplate 9114 and an integral adjoining vertical portion 9124b welded to the inner surface of the CEC shell body 9111. Vertical portions 9124b each define radially-extending lower seismic restraint members which engage the sides of the canister 9150 to keep it centered in the cavity 9120 of the CEC 9110 particularly during a seismic event (e.g., earthquake). A plurality of radially-extending upper seismic restraint members 9123b project inwards from the shell body 9111 in cavity 9120 to keep the upper portion of the canister 9150 centered. Restraint members 9123b may be formed by circumferentially spaced apart metal plates or lugs welded to the inner surface of the CEC shell body 9111.

When the canister 9150 is positioned in the cavity 9120 of the CEC 9110, a ventilation annulus 9121 is formed therebetween which extends for the full height of the canister. The ventilation annulus is fluid communication with the cooling air feeder shells 9130 at the bottom via flow conduits 9160 and an air outlet plenum 9152 formed inside the CEC cavity 9120 above the canister.

The shell body 9111 and baseplate 9114 of each CEC 9110 may be formed of a suitable metal such as stainless steel for corrosion resistance.

The top end 9112 of CEC 9110 is enclosed by a removable thick radiation shielded lid 9115 detachably mounted on top of the CEC shell body 9111. The lid may have a composite metal and concrete construction including an outer shell 9115a formed of steel such as stainless steel, and interior concrete lining 9115b. This robust construction not only provides radiation shielding, but also offers added protection against projectile impacts. In one configuration, lid 9115 includes a cylindrical circular upper portion 9116a and adjoining cylindrical circular lower portion 9116b having an outer diameter 9D4 smaller than an outer diameter 9D3 of the upper portion. An annular stepped shoulder 9116c is formed between the upper and lower portions of the lid. Diameters 9D3 and/or 9D4 in some embodiments may be larger than an outer diameter 9D2 of the CEC shell body 9111.

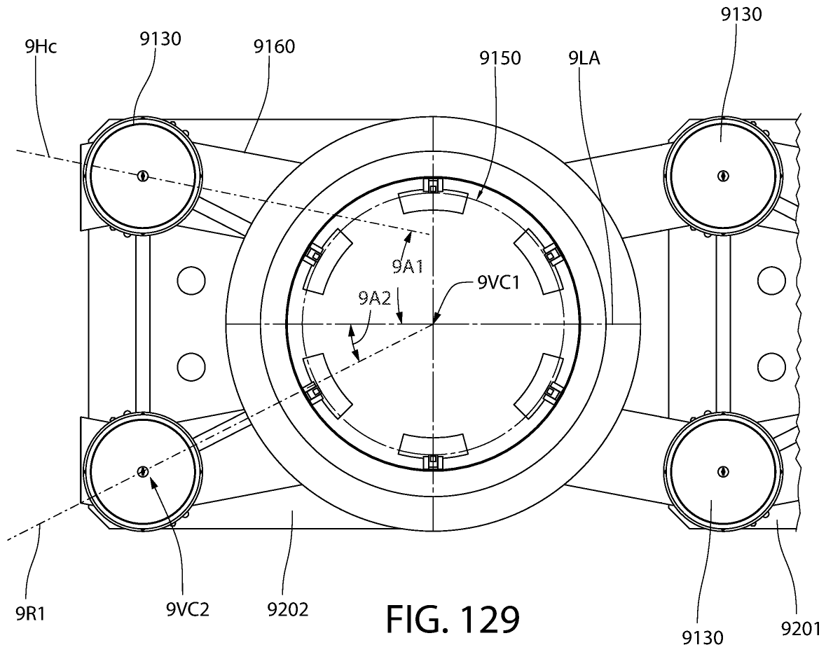

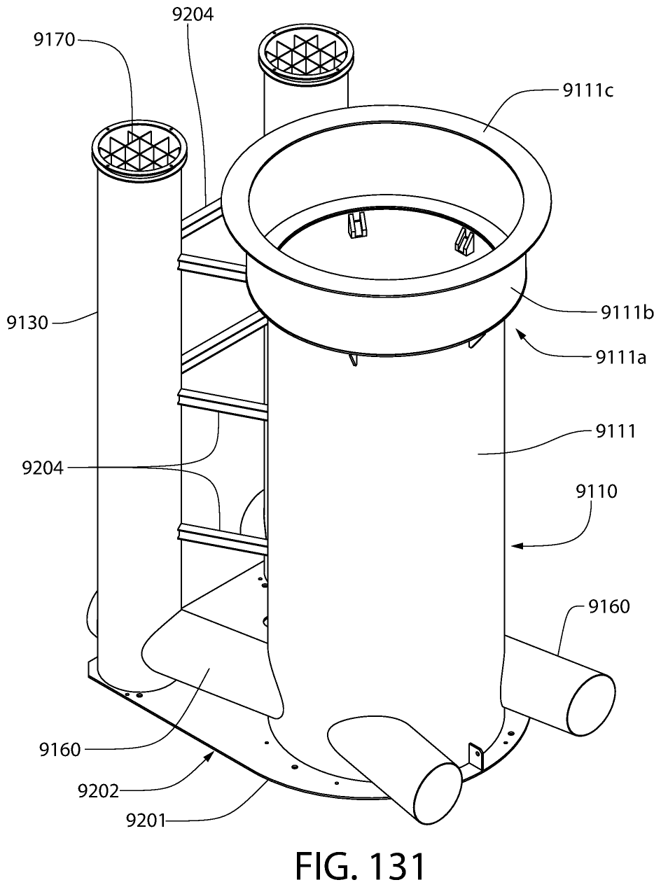

Lower portion of 9116b of lid 9115 is insertably positioned inside a corresponding upwardly open circular recess 9117 formed into the top surface 9102a of the top pad 9102 around the top end 9112 of each CEC 9110 as shown (see, e.g., FIGS. 119-120). Recess 9117 is larger in diameter 9D5 that the outer diameter 9D2 of the CEC shell body 9111. In one embodiment, the upper portion 9111a of CEC 9110 (i.e. shell body 9111) may include a diametrically enlarged top cylindrical section 9111b which has the same diameter 9D5 as recess 9117 and in fact defines the recess in this embodiment shown in FIGS. 129 and 131. The lid is slightly elevated and ajar from top pad 9102 in its recess to create an air outlet 9118 thereby forming an exit pathway between the lid and CEC 9110 for the rising ventilation air from the cavity 9120 of the CEC to return to ambient atmosphere. The air outlet 9118 is configured to form a circuitous multi-angled pathway such that there is no direct line of sight from cavity 9120 to atmosphere for radiation to escape (i.e. radiation streaming). Outlet 9118 may have a double L-shaped configuration in one embodiment for this purpose as shown in FIG. 117; however other circuitous shaped pathways may be used.

In some embodiments as shown in FIGS. 131-133, the top section 9111b of the CEC shell body 9111 may further include a flat radially projecting annular seating flange 9111c. The seating flange is configured for engaging and resting on top surface 9102a of the concrete top pad 9102.

Each cooling air feeder shell 9130 is a tubular hollow structure comprising a metallic vertically-elongated body 9131 defining a vertical centerline axis 9VC2 and bottom closure plate 9132 welded to the bottom end 9134 of the shell. The vertical centerlines 9VC2 and 9VC1 of the CECs 9110 are parallel to each other. The body 9131 may be cylindrical with a circular transverse cross-sectional shape in preferred non-limiting embodiments; however, other non-polygonal and polygonal shaped bodies may be used in certain other acceptable embodiments. The body 9131 of each feeder shell defines an open vertical air passage 9133 extending between the bottom end 9134 and top end 9135 of the shell 9130 for drawing ambient cooling air downwards through the shell. The top end of shell 9130 may terminate at the top surface 9102a of the concrete top pad 9102 in some embodiments. A perforated air intake housing 9136 is coupled to the top end 9135 of the shell 9130 which projects vertically upwards from the top pad 9102 as shown. In one embodiment, housing 9136 may be formed of a cylindrical shell which is perforated to form a plurality of lateral openings extending 360 degrees circumferentially around for drawing air laterally into the feeder shell 9130. A circular cap 9137 encloses the top of the air inlet housing 9136 to prevent the ingress of rain. The air feeder shell 9130, bottom closure plate 9132, air intake housing 9136, and cap 9137 may be formed of metal such as stainless steel for corrosion protection. Other shaped caps and intake housings may be used in other embodiments.

To minimize rising air leaving the top of the cavities 9120 of the CECs 9110 which has been heated by the canisters 9150 from being drawn back into the intake housings 9136 of the cooling air feeder shells 9130, each feeder shell is preferably spaced apart from the shell bodies 9101 of adjacent CECs by a sufficient lateral/horizontal distance such as at least one outer diameter 9D1 of feeder shell in some embodiments.

With continuing reference to FIGS. 119 and 120, cooling air feeder shells 9130 have a height 9H1 which is at least coextensive as height 9H2 of CEC shell bodies 9111. As one non-limiting example, 9H2 and 9H1 may be about 9227 inches (576.6 cm). In one embodiment, shells 9130 may have a slightly greater height 9H1 (measured between bottom and top ends 9134, 9135) than height 9H2 of the CEC shell bodies 9111 (measured between bottom and top ends 9113, 9112 of the bodies in including upper portion 9111a).

The canister 9150 has a total height 9H3 (inclusive of the top and bottom closure plates 9152, 9153) less than height 9H2 of the CEC shell bodies 9111 so that an air outlet plenum 9154 is formed between the bottom of CEC lid 9115 and the top closure plate 9152 of the canister. The top of the canister defined by top closure plate 9152 terminates beneath the concrete top pad 9102 of the CIS system at an elevation that may fall within the vertical extent of the engineered fill 9140. This helps prevent “sky shine” radiation streaming to the ambient environment.

Referring to FIGS. 116 and 117, the cavity enclosure containers 9110 and cooling air feeder shells 9130 in one embodiment may be arranged in a tightly packed array to minimize spatial site requirements at the CIS facility. The array comprises a plurality of longitudinally-extending and parallel linear nuclear waste storage rows 9R each including a plurality of CECs 9110 and cooling air feeder shells 9130. For convenience of illustration, the array in FIGS. 116-117 shows only five rows 9R; however, it is recognized that more or less rows of CECs and air feeder shells may of course be provided as needed. Each row defines a respective horizontally-extending longitudinal axis 9LA. The geometric centers of each CEC which intersect their vertical centerline axes 9VC1 intersect the respective longitudinal axis 9LA in each row such that the CECs 9110 may be considered to be located on the longitudinal axis. For convenience of reference, a transverse axis 9TA may be defined as oriented perpendicularly to the longitudinal axis 9LA in each row extending front to back between rows 9R in the array (see, e.g., FIG. 117).

The nuclear waste storage rows 9R of CECs 9110 are spaced apart and parallel to each other to form longitudinally-extending access aisles 9AI which provide access for commercially-available motorized wheeled or track driven lifting equipment such as without limitation cask crawlers or other equipment which transport, maneuver, and raise/lower the canisters 9150 for insertion into and removal from the CECs 9110. The equipment may straddle the row of CECs 9110 and the wheels or tracks run in aisles 9AI on each side of the row. Such equipment is well known to those skilled in the art without further elaboration. The low exposed vertical profile of the CECs 9110 (as further described herein) allows the equipment to move over the CECs modules in a single row to the desired CEC for inserting or removing canisters.

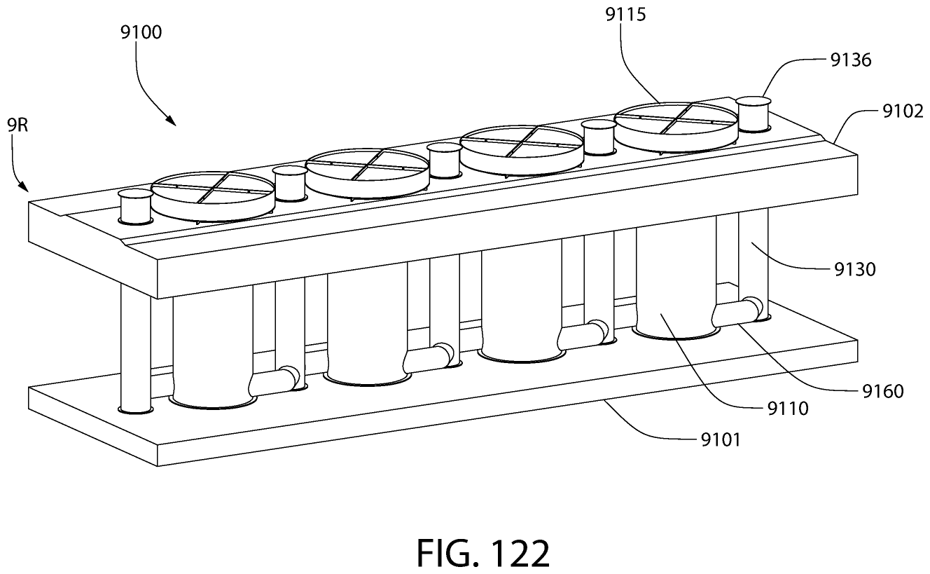

FIGS. 119-122 show a possible first embodiment and arrangement of CECs 9110 and cooling air feeder shells 9130. In this embodiment, each CEC 9110 in each row 9R is fluidly coupled directly to a pair of cooling air feeder shells 9130 by horizontally/laterally extending flow conduits 9160; one each of feeder shells 9130 being on opposite lateral sides of the CECs along the longitudinal axis 9LA as shown. Viewed the other way, each air feeder shell 9130 may be considered centrally located between a pair of CECs. Each CEC therefore comprises a pair of air inlets 9125 on opposite sides forming openings which extend through the shell body 9111 of the CEC 9110 to the internal cavity 9120. The air inlets 9125 are therefore formed in and through the lower portion 9111d of the CECs (i.e. shell body 9111) to introduce cooling air into the bottom of the CEC cavity 9120 and ventilation annulus 9121. In a preferred but non-limiting embodiment, the air inlets 9125 are each configured and arranged to introduce cooling ventilation air tangentially into the cavity 9120 of each CEC 9110 as shown. Introduction of cooling air in this tangential manner which flows circumferentially around the inner surface of the CEC to quickly fill the CEC cavity and ventilation advantageously results in less pressure drop than introducing the air radially and perpendicularly at the canister shell 9151.

The flow conduits 9160 comprise sections of horizontally-extending metal piping spanning between the cooling air feeder shells 9130 and their respective CECs 9110. The flow conduits fluidly couple each CEC air inlet 9125 “directly” to a respective air feeder shell 9130 meaning that the cooling air passes from the feeder shell to the respective CEC without passing through any other CEC or feeder shell on the way. As previously described herein, this arrangement advantageously maximizes the amount of cooing air received by each CEC 9110 commensurate with the level of heat emitted by the canisters in each CEC which may differ. Accordingly, no CEC is starved of its required cooling air flow by any upstream CEC. Because the CECs and their nuclear waste material contents are passively and convectively cooled via the natural thermo-siphon effect as previously described herein, pressure imbalances in the cooling air ventilation system which can adversely affect proper cooling of each CEC are avoided by the present cooling equipment arrangement. The provision of two air inlets 9125 for each CEC 9110 and separate sources of cooling air (i.e. feeder shells 9130) for each inlet further ensures each CEC is cooled to remove the heat generated in its cavity to the maximum extent possible.

For the same foregoing reasons to ensure each CEC 9110 receives the needed amount of cooling air based on its particular heat load generated by the nuclear waste canister 9150 therein, it further bears noting that there is no interconnecting flow conduits between any CECs or cooling air feeder shells 9130 in one row and any other rows 9R. Accordingly, each nuclear waste storage row 9R is fluidly isolated from every other row.

Although perhaps not readily apparent from the figures, it also bears noting that each CEC 9110 in a single row 9R is fluidly isolated from adjacent CECs and every other CEC in the same row when the ambient air cooling ventilation system is in operation (i.e. nuclear waste canisters 9150 disposed in the CECs thereby creating active air flow through the ventilation system via the thermo-siphon effect previously described herein). For example, referring to FIG. 119, ambient cooling air will be drawn downwards in the centrally located air feeder shell 9130 and then flow laterally outwards to each of the two CECs 9110 pictured via flow conduits 9160 (see directional air flow arrows). The cool air enters the bottoms of the CECs and flows vertically upwards as the air in the CEC cavities 9120 is heated by the canisters 9150 (see, e.g., FIG. 117). Accordingly, given the direction of flow through these nuclear waste storage system components, air cannot possibly flow from one CEC 9110 backwards through the centrally located air feeder shell 9130 and into the remaining CEC. The CECs are therefore effectively fluidly isolated from each other.

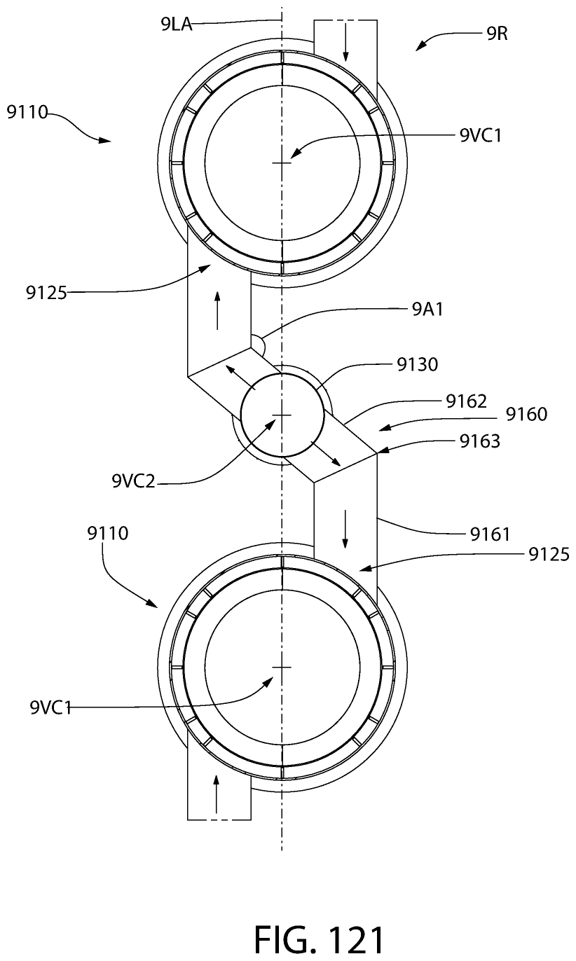

As previously noted, the flow conduits 9160 may comprise sections of metal piping such as stainless steel of suitable diameter. In preferred but non-limiting embodiments, the flow conduits are configured such that there is no straight line of sight between each cooling air feeder shell 9130 and either of its respective pair of cavity enclosure containers 9110 fluidly coupled thereto to prevent radiation streaming. This concomitantly also ensures there is no straight line of sight between any of the CECs 9110 in the row 9R through the feeder shells 9130. In one configuration, flow conduits 9160 may each comprise an angled transverse section 9162 oriented transversely to the longitudinal axis 9LA, and an adjoining longitudinal section 9161 oriented parallel to the longitudinal axis. A welded mitered joint 9163 may be formed between the transverse and longitudinal sections (see, e.g., FIG. 121). An oblique angle is formed between these two sections of the flow conduit. In other possible embodiments, curved piping elbows may be used instead of mitered sections of straight piping to prevent the straight line of sight.

Because each cooling air feeder shell 9130 need only be sized in diameter to supply cooling air to a pair of CECs 9110, the diameter of the feeder shells can be minimized to allow CECs in each row to be closely spaced. This advantageously allows more CECs and nuclear waste to be packed into each row 9R. Accordingly, in preferred but non-limiting embodiments, the outer diameter 9D1 of the feeder shells 9130 may be smaller than the outer diameter 9D2 of the CECs 9110. As one non-limiting example, 9D1 may be about 30 inches (76.2 cm) and 9D2 may be about 84 inches (213.4 cm). For size comparison, the flow conduits 60 may have a smaller diameter than 9D1 or 9D2; such as for example without limitation about 24 inches (61 cm) in one embodiment. Other diametrical sizes may be used in other embodiments and does not limit the invention.

To summarize operation of the nuclear waste storage system and ambient cooling air ventilation system, nuclear waste canisters 9150 containing radioactive waste materials (e.g. SNF fuel assembly and/or other high level radioactive waste materials removed from the reactor) are loaded into the CECs 9110. The lids 9115 are then placed onto the CECs to enclose the CECs and their internal cavities.

With the canisters positioned inside the CECs and lids in place, air in the ventilation annulus 9121 between the canister and shell body 9111 of each CEC 9110 becomes heated by the canister. The heated air rises, collects in the air outlet plenum 9154 above the canister in cavity 9120 of the CEC, and exits the CEC back to atmosphere through the air outlet 9118 formed through the lid 9115 of the CEC (see directional air flow arrows in FIGS. 119-120 and 133).

The upward convective flow of air inside cavity 9120 of each CEC 9110 creates a negative pressure which draws ambient air down into the cooling air feeder shell 9130 via the known thermo-siphon effect or mechanism. The CEC draws the air from the bottom of the air feeder shell into the lower portion of its internal cavity 9120 and ventilation annulus 9121 through the flow conduits 9160 to complete the ventilation air flow circuit. It bears noting that this natural air flow is unassisted by powered fans or blowers, thereby avoiding operating costs associated with electric power consumption, but importantly ensuring continued cooling of the CECs 9110 in the event of power disruption to prevent overheating the CECs and protect the containment of the nuclear waste materials.

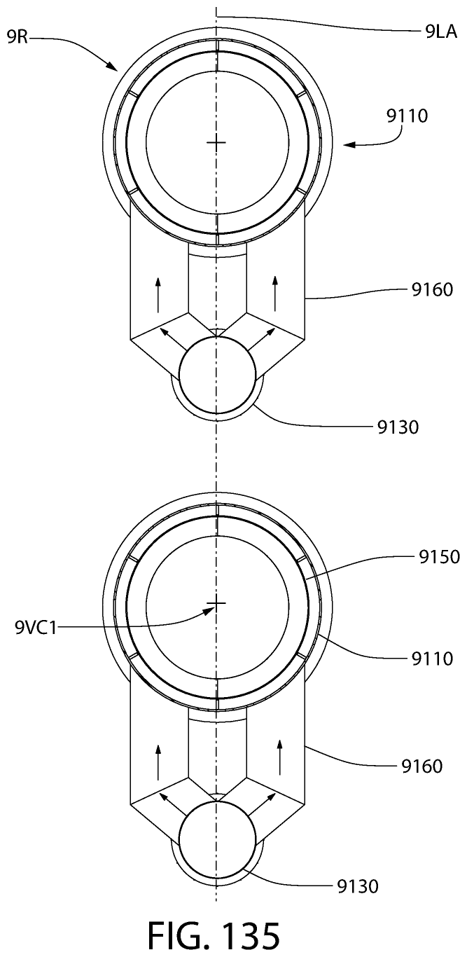

FIG. 135 depicts an alternative second embodiment and arrangement of a nuclear waste storage system and corresponding air ventilation system. In this embodiment, each CEC 9110 is fluidly coupled to only a single cooling air feeder shell 9130 by a pair of angled/curved flow conduits 9160 to prevent radiation streaming as previously described herein. The CEC includes two air inlets 9125 also arranged to introduce ventilation air tangentially into the internal cavity of the CEC. The bifurcated ventilation air supply effectively creates a curtain of cooling air around the nuclear waste canister 9150 inside the CEC with minimal flow resistance to maximize the air flow for cooling the radioactive waste material. This alternative embodiment may be appropriate where certain canisters 9150 are still emitting extremely high levels of thermal energy (heat) which must be dissipated in order to protect the structural integrity of the canister and nuclear waste therein. Multiple pairs of the fluidly isolated CECs 9110 and cooling air feeder shells 9130 in FIG. 135 may be arranged in a row 9R of the CIS facility. The CECs 9110 and air feeder shells 9130 are arranged on the longitudinal axis 9LA of each row 9R that may be provided in the array of CECs.

It bears noting that certain CIS facilities may combine some rows of CECs 9110 and air feeder shells 9130 according to the arrangement shown in FIG. 135 for high thermal energy emitting nuclear waste canisters, and some other rows of CECs and air feeder shells according to the arrangement shown in FIGS. 119-122 for lower thermal energy emitting nuclear waste canisters. In yet other embodiments, the two different arrangements of CECs and air feeder shells may be mixed in a single row 9R. Accordingly, numerous variations are possible depending on particular nuclear waste material storage needs and level of thermal energy emitted by the canisters 9150.

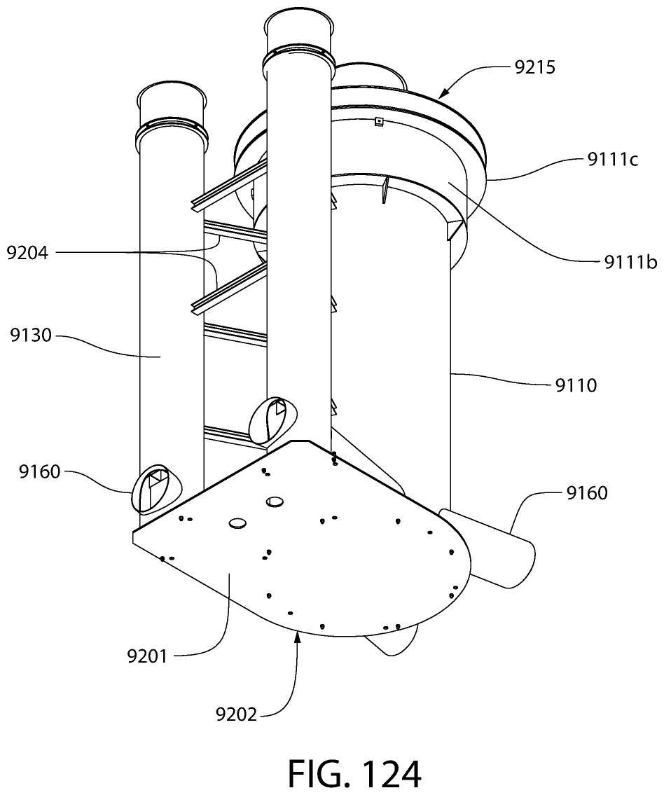

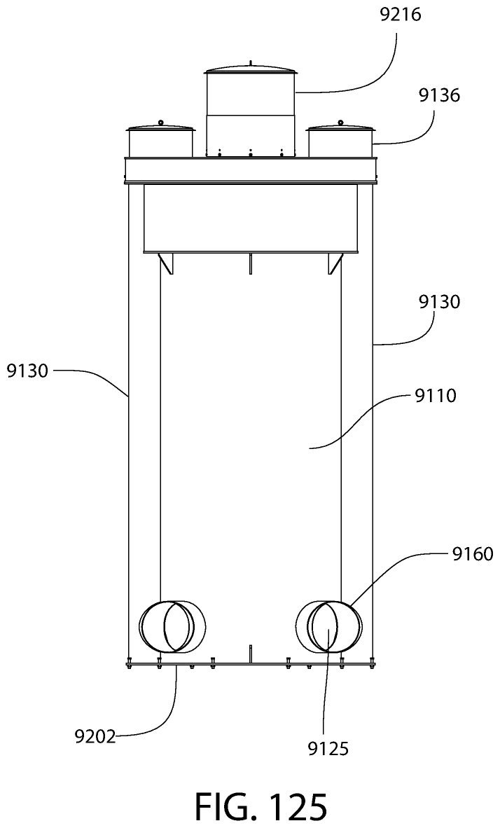

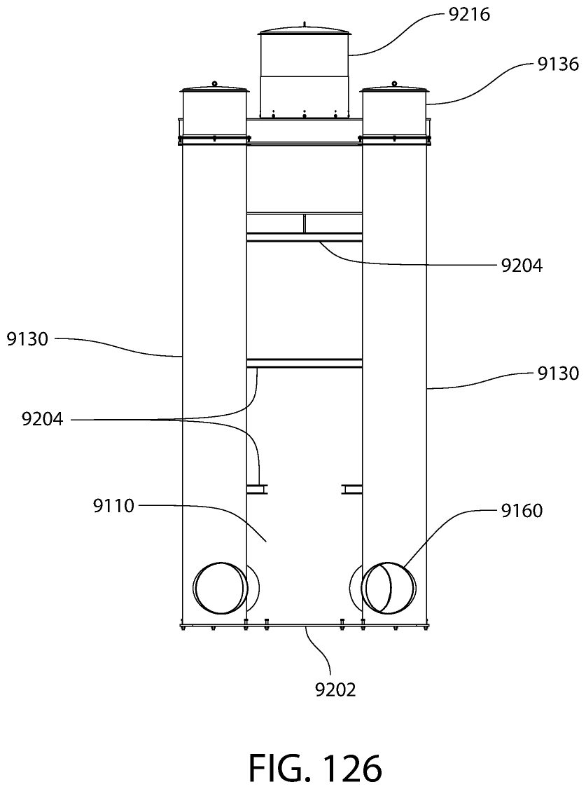

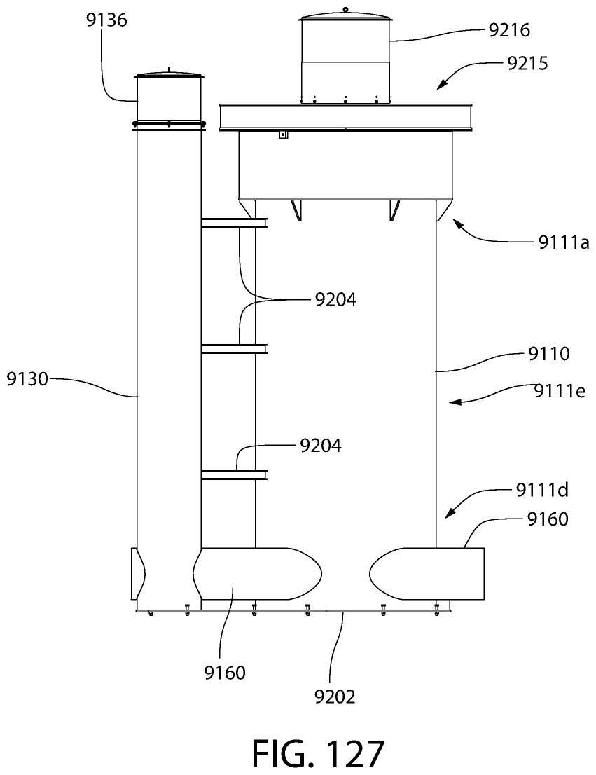

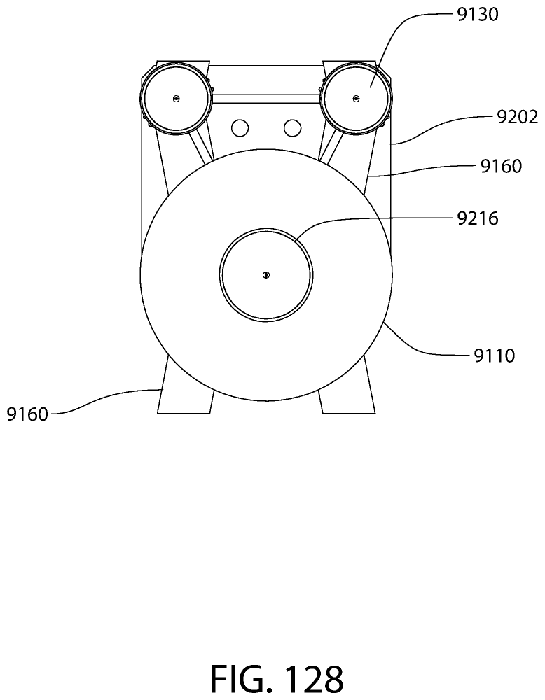

FIGS. 116-118 and 123-134 depict yet another third alternative embodiment and arrangement of a nuclear waste storage system and corresponding air ventilation system. This a high airflow capacity configuration of the passively cooled nuclear waste storage system with thermo-siphon driven ventilation system suitable for radioactive nuclear waste emitting extremely high levels of heat that must be dissipated by ambient cooling air to protect the radioactive waste (e.g., SNF fuel assemblies, etc.) inside the nuclear waste canisters 9150. The cooling air requirements of these high heat load CECs may exceed even the higher airflow capacity provided by the CECs in FIG. 135 with a dedicated separate pair of cooling air feeder shells 9130 as shown.

Accordingly, CECs 9110 in this high airflow capacity third embodiment may each be fluidly coupled to two pairs (i.e. four) cooling air feeder shells 9130 by air flow conduits 9160 (see, e.g., FIGS. 116-118 and 129). With continuing reference to FIGS. 116-118 and 123-134 generally, one pair of feeder shells 9130 may be located on one lateral side of the CEC, and the remaining pair of feeder shells may be located on the opposite other lateral side as shown. The CEC includes four air inlets 9125; each of which is fluidly coupled by a flow conduit 9160 to one of the four cooling air feeder shells 9130. The flow conduits 9160 may be similarly configured and arranged to the prior embodiments of the ambient air ventilation system previously described herein to introduce ventilation air tangentially into the lower/bottom portion of internal cavity 9120 of the CEC 9110 in order to achieve the same airflow benefits noted above.

It bears noting that each CEC 9110 in a single row 9R need not necessarily be coupled to four cooling air feeder shells 9130 as seen in FIGS. 116-118. For example, one CEC 9110 located at one end of row 9R is shown fluidly coupled to only a pair of cooling air feeder shells 9130 as this CEC may not have a heat load as high as the heat loads of the remaining other CECs in the depicted row which require a higher ambient ventilation air flow volume or rate (e.g. CFM—cubic feet per minute) to dissipate the higher heat emissions from the canisters 9150 stored therein. Accordingly, the present passively cooled nuclear waste storage and ventilation system offers considerable flexibility in configuration which can be customized in order to accommodate the particular heat load dissipation needs of the CECs which may differ.

With continuing general reference to FIGS. 116-118 and 123-134, the construction and structural details of the CECs 9110 in this third embodiment and arrangement of passively-cooled nuclear waste storage system may be similar to the previously described embodiments with exception of the additional cooling air inlets 9125 to accommodate the two pairs of cooling air feeder shells 9130. The description of the CEC structure including lid 9115 will therefore not be repeated here for sake of brevity. The features or parts of the CEC in the presently illustrated third embodiment of the nuclear waste storage system are therefore numbered the same as in the figures for the first and second embodiments.

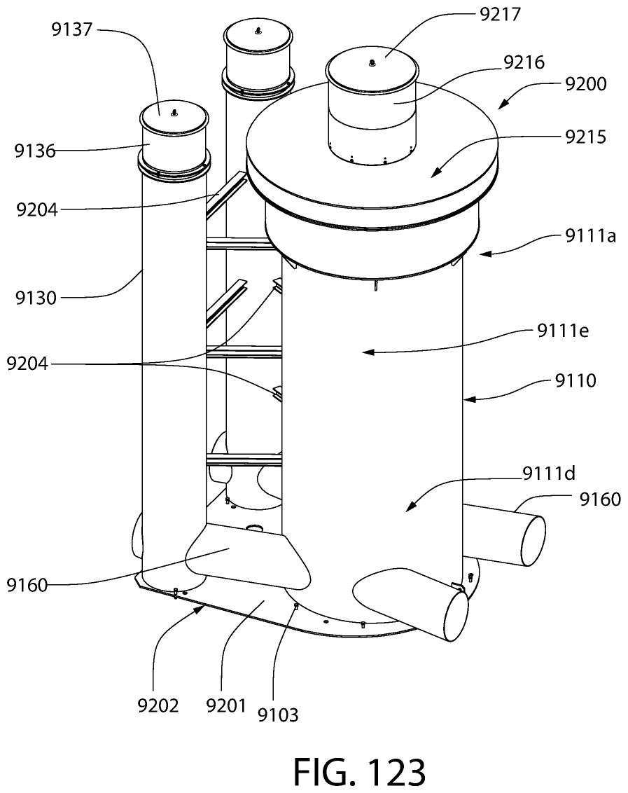

In the present high air flow embodiment shown in FIGS. 116-118 and 123-134, the CECs 9110 and cooling air feeder shells 9130 however have been structurally integrated into a readily transportable and mountable modular nuclear waste storage unit 9200 (best seen in FIGS. 123-131). The modular unit 9200 is a self-supported and transportable assemblage or structure which includes a common or shared support plate 9202 formed of a suitably strong and appropriate metallic material (e.g., stainless steel or other). The support plate 9202 has a horizontally broadened and flat body 9201 configured for mounting and anchoring onto the top surface of the subterranean concrete base pad 9101 such as via anchors 9103 which may be threaded fasteners or other type anchoring/mounting devices. One CEC 9110 and a single pair of cooling air feeder shells 9130 on one lateral side of the CEC are fixedly attached to the common or shared support plate 9202 such as via welding. The support plate 9202 may have any suitable configuration, such as a U-shaped mixed polygonal-non-polygonal configuration in one non-limiting embodiment as shown.

To ensure that the vertically tall shell body 9111 of the CEC 9110 and pair of cooling air feeder shells 9130 are structurally stabilized and braced for lifting and transport as a single self-supporting unit, a plurality of horizontally-extending cross-support members 9204 (e.g., structural beams of suitable shape) are provided which structurally ties the CEC shell body and feeder shells together in a rigid manner. In one embodiment (as variously appearing in FIGS. 123-131), the CEC 9110 in each modular nuclear waste storage unit 9200 is structurally tied and laterally braced to each of the pair of cooling air feeder shells 9130 by a plurality of vertically spaced apart cross-support members 9204. In the non-limiting illustrated embodiment, three cross-support members are shown to tie each of the lower portion 9111d, middle portion 9111e, and upper portion 9111a of the CEC to each of the two feeder shells 9130. More or less cross-support members 9204 may be used. The pair of cooling air feeder shells 9130 are similarly structurally tied together and laterally braced by vertically spaced apart cross-support members 9204 which may be of the same type or different than the cross-support structural members tying the CEC 9110 to each of the cooling air feeder shells 9130. In one non-limiting embodiment, a W-beam may be used for cross-support structural members 9204; however, other suitable type/shape structural members may be used.

The modular nuclear waste storage unit 9200 advantageously allows the units to be fabricated under controlled shop conditions in the fabrication facility, and then shipped to the installation site (e.g., Consolidated Interim Storage facility). Since the CEC 9110 and pair of cooling air feeder shells 9130 are already palletized so to speak on the common support plate 9201, installation requires only making the piping connections with the flow conduits 9160 at the installation site. This results in rapid installation and deployment of the modular nuclear waste storage units.

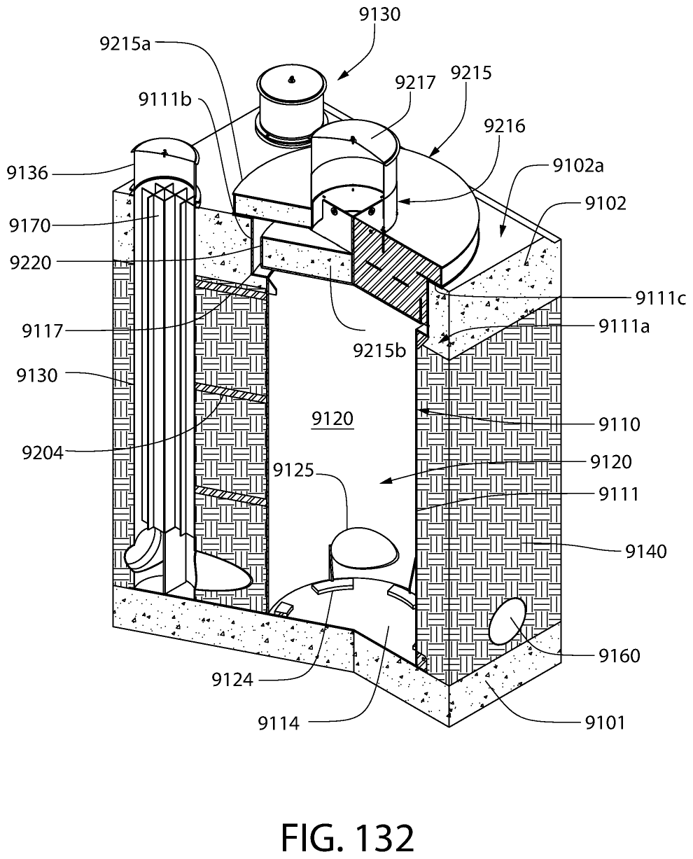

To install the modular nuclear waste storage units 9200 in the manner shown in FIG. 118 such as at a CIS site or facility, the installation process or method includes pouring the concrete base pad 9101 and then positioning and mounting a first storage unit 9200 on the pad when cured and hardened. A second storage unit 9200 is next positioned and mounted on the base pad adjacent to the first storage unit in a longitudinally spaced apart manner along the row 9R. The piping connections can now be made for the first storage unit. Each of the four cooling air feeder shells 9130 are then fluidly coupled directly to the CEC 9110 of the first storage unit by a separate flow conduit 9160. The piping connections between the CEC and feeder shells 9160 may be welded or preferably bolted piping flange type connections which can be made more expediently than welded connections. Since the air flowing inside the flow conduits 9160 is at most at air a slight negative (sub-atmospheric) pressure when the ventilation system is in operation, flanged type connections are suitable for these service conditions. The next additional third, fourth, so on nuclear waste storage units 9200 may then be added and installed in a similar manner. Once all units have been mounted to the base pad 9101 and fluidly coupled to their respective cooling air feeder shells 9130, the flowable engineered fill 9140 may be installed on top of the base pad and around the CECs and feeders shells of the CIS facility to fill the voids between this equipment for lateral support and radiation attenuation/blocking as shown in FIGS. 132-134 (note engineered fill not shown in FIG. 118 for clarity).

Next, the concrete top pad 9102 may be formed on top of the engineered fill. The modular nuclear waste storage units 9200 are now ready for receiving a nuclear waste canister 9150 in each cavity 9120. In some embodiments as disclosed in U.S. Pat. No. 9,852,822 which is incorporated herein by reference, a pair of canisters 9150 may be vertically stacked in each CEC 9110 and supported therein in the manner described. It bears noting that the CEC 9110 whether holding a single or two vertically stacked canisters 9150 has a cross-sectional area sufficient for holding only a single canister at a single elevation (i.e. no side-by-side canister placement).

It bears noting that in the preferred but non-limiting embodiment, the foregoing CECs 9110 of the multiple modular nuclear waste storage units 9200 are preferably positioned on the longitudinal axis 9LA of the storage row 9R (i.e. vertical centerline axis 9VC1 intersects longitudinal axis 9LA). This is similar to the previous two embodiments of the nuclear waste storage system 9100 shown in FIGS. 119-122 and 135 described above. In the present embodiment shown in FIGS. 116-118, the first and second cooling air feeder shells 9130 of the first pair of feeder shells may be transversely spaced apart perpendicularly to and on opposite sides of longitudinal axis 9LA). The first and second feeder shells are located on a first lateral side of a first CEC 9110. The third and fourth cooling air feeder shells of the second pair of feeder shells may similarly be transversely spaced apart in the same manner and located on a second lateral side of the first CEC 9110 opposite the first lateral side.

The first, second, third, and fourth cooling air feeder shells 9130 are preferably fluidly coupled directly to the first CECs by separate metallic flow conduits 9160 as shown in FIG. 118 (see also variously FIGS. 123-134). Accordingly, there are no intervening CECs or cooling air shells. Flow conduits 9160 may be formed by sections of piping as previously described herein.

In the present third embodiment, the flow conduits 9160 may each comprise a horizontally-extending straight piping section fluidly coupling a lower portion of the cavity 9120 of the first CEC 9110 to a lower portion of each of the cooling air feeder shells 9130. Each straight piping section flow conduit 9160 defines a horizontal centerline axis 9Hc which is acutely angled to longitudinal axis 9LA by angle 9A1 (see, e.g., FIG. 129). This angled arrangement of the cooling air feeder shells 9130 to the longitudinal axis is sufficient to ensure there is no straight line of sight between the first CEC 9110 and the next adjacent CEC which is mounted on a different support plate 9201. In certain embodiments, angle 9A1 may be between about and including 10 to 20 degrees.

As also shown in FIG. 129, the cooling air feeder shells 9130 in each pair on opposite lateral sides of the depicted CEC 9110 are on opposite sides of longitudinal axis 9LA. The geometric vertical centerline 9VC2 of each of the feeder shells falls on a horizontal reference line 9R1 which is oriented at an acute angle 9A2 to the longitudinal axis 9LA of the nuclear waste storage row 9R. Angle 9A2 may be about 30 degrees (+/−5 degrees) in one embodiment as illustrated. It bears noting that the angular arrangement of the flow conduits 9160 and cooling air feeder shells 9130 to the longitudinal axis 9LA by angles 9A1 and 9A2 respectively advantageously contributes to allow closer spacing between the CECs 9110 and feeder shells in each row. This allows more CECs to be tightly packed into each row 9R.

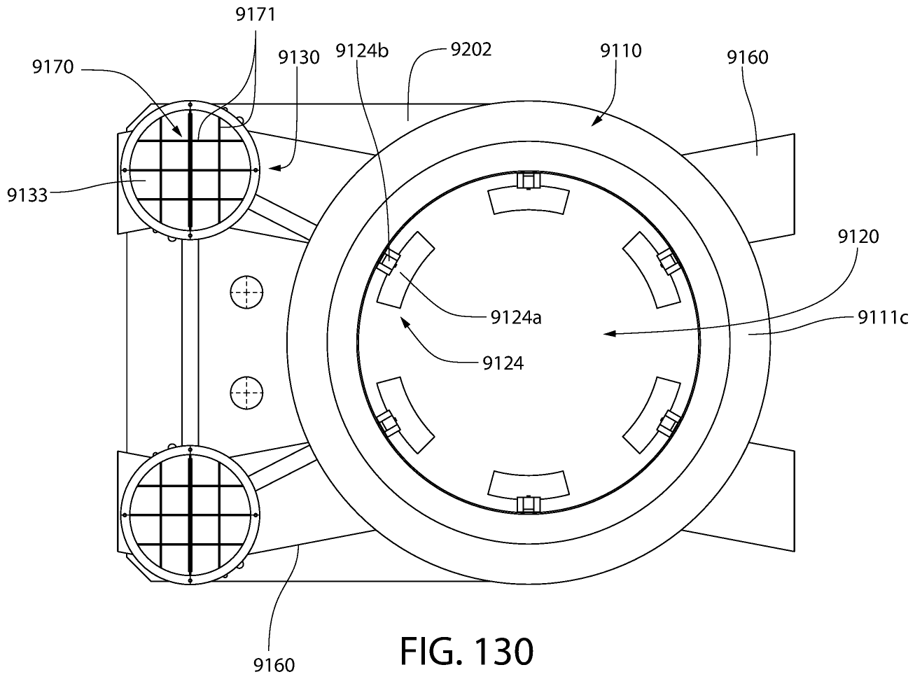

Referring to FIGS. 130-134, each cooling air feeder shell 9130 in some embodiments may include an array 9170 of vertically elongated radiation attenuator plates 9171. The plates 9171 may be flat, and are structurally coupled together (e.g. welded, via clips/brackets, etc.) and arranged in an orthogonal grid as shown. Plates 9171 are disposed in the vertical air passage 9133 of the cooling air feeder shells 9130 and create vertically-extending grid openings between them through which the ventilation air is drawn downwards through the shells. Attenuator plates 9171 may extend vertically for a majority of the 9H1 the cooling air feeder shells. In one embodiment, the attenuator plates extend vertically from top end 9135 of the shells downwards towards bottom end 9134 and terminate at a point just above and proximate to the top of the flow conduits 9160 so as to not interfere with the ventilation air flow from the shells 9130 to the CECs 9110. In one embodiment, attenuator plates 9171 may be formed of steel; however, other suitable materials including boron-containing materials and metals may be used. The attenuator plates 9171 advantageously help prevent radiation streaming to the ambient environment surrounding the nuclear waste storage system.

In operation, the ambient cooling air ventilation system of the present high airflow capacity embodiment shown in FIGS. 116-118 and 123-134 functions and follows the same general path as the previously described embodiments. The air inlets 9125 are each configured and arranged to introduce cooling ventilation air tangentially into the cavity 9120 of each CEC 9110 as shown. Ambient ventilation air is drawn downwards through and between the attenuator plates 9171 inside each cooling air feeder shell 9130, and then flows horizontal/laterally to the CEC 9110 through flow conduits 9160 to cool the canister 9150 in each CEC via the convective natural thermo-siphon effect previously described herein.

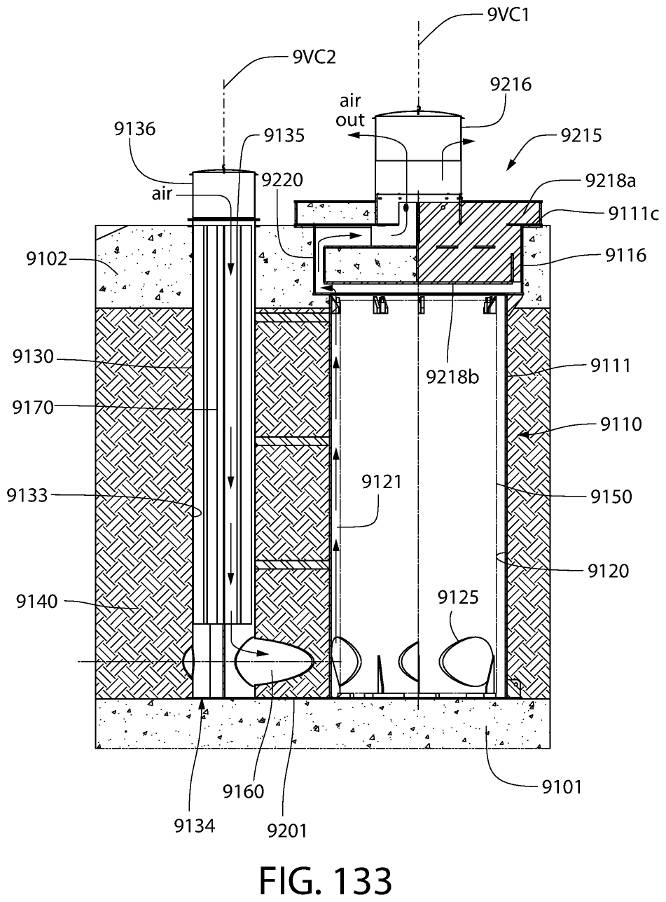

In the present embodiment of FIGS. 116-118 and 123-134, an alternative air outlet 9220 is shown which is formed directly through lid 9215 rather than between the periphery of the lid and upper portion 9111a of the CEC 9110 and top pad 9102 as with previous lid 9115 in prior embodiments of FIGS. 119-122 described herein. In the present embodiment, the air outlet 9220 forms a circuitous multi-angled passageway internally through the lid terminating in air discharge housing 9216 mounted to the top surface of the lid (see, e.g., FIG. 133 and directional airflow arrows). To accommodate this internal air outlet 9220 passage, lid 9215 is configured slightly differently than lid 9115 previously described herein.

Air discharge housing 9216 of present lid 9215 comprises a perforated cylindrical metal shell which projects vertically upwards from the top surface of the lid 9215 as shown. In one embodiment, housing 9216 comprises a plurality of lateral openings extending 360 degrees circumferentially around for discharging air laterally outwards therefrom back to the ambient environment. A circular cap 9217 encloses the top of the air discharge housing 9216 to prevent the ingress of rain. The air discharge housing 9216 and to cap 9217 may be formed of metal such as stainless steel for corrosion protection. Other shaped caps and intake housings may be used in other embodiments.

The present lid 9215 may have a composite metal and concrete construction and shape similar to previous lid 9115 in FIGS. 119-122 including an outer shell 9215a formed of steel such as stainless steel, and interior concrete lining 9215b. This robust construction not only provides radiation shielding, but also offers protection against projectile impacts. In one configuration, lid 9215 includes a circular upper portion 9218a and adjoining circular lower portion 9218b having an outer diameter smaller than an outer diameter of the upper portion similar to previous lid 9115. The present lid 9215 effectively seals off the upwardly open recess 9117 formed into the top surface 9102a of the top pad 9102 around the top end 9112 of each CEC 9110 by the upper diametrically enlarged top cylindrical section 9111b of the CEC.

In cooling operation, air rising upwards within ventilation annulus 9121 between the heat-emitting canister 9150 and shell body 9111 of CEC 9110 flows to the bottom of lid 9215 (see, e.g., FIG. 133 and directional airflow arrows). The air then flows radially outwards and then turns upwards around the periphery of the smaller diameter lower portion 9218b of the lid within air outlet 9220. The air then flows radially inwards and turns 90 degrees upwards towards the discharge housing 9216. The heated air is discharged laterally and radially from housing 9216 through the perforations back to ambient atmosphere. The cooling cycle operates continuations via the thermo-siphon as long as the nuclear waste canister 9150 continues to emit heat generated by the nuclear waste inside.

While the foregoing description and drawings represent some example systems, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made. One skilled in the art will further appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims and equivalents thereof, and not limited to the foregoing description or embodiments. Rather, the appended claims should be construed broadly, to include other variants and embodiments of the invention, which may be made by those skilled in the art without departing from the scope and range of equivalents of the invention.

1. An impact amelioration system for nuclear fuel storage components comprising:
a fuel storage canister comprising a first shell extending along a vertical centerline, the canister configured for storing nuclear fuel;
an outer cask defining a cavity receiving the canister, the cask comprising a second shell and a bottom closure plate attached to the second shell;
a plurality of impact limiter assemblies disposed on the bottom closure plate at a canister to cask interface, each of the impact limiter assemblies comprising a plug frictionally engaged with a corresponding plug hole formed in the bottom closure plate;
wherein the plugs engage the canister.

2. The system according to claim 1, wherein the plugs protrude upwards beyond the bottom closure plate to engage the canister.

3. The system according to claim 2, wherein the canister comprises a baseplate supported by and resting on the plugs which form pedestals.

4. The system according to claim 3, wherein the canister is separated from the bottom closure plate of the cask by a vertical gap.

5. The system according to claim 3, wherein the plugs have a planar top surface which abuttingly engages the baseplate of the canister via a flat-to-flat interface.

6. The system according to claim 1, wherein the plug holes have a closed bottom and open top.

7. The system according to claim 1, wherein the plugs are tapered and the plug holes have a corresponding taper.

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. A storage system for radioactive nuclear waste comprising:
a longitudinal axis;
a cask comprising a hermetically sealable internal cavity configured to hold an inventory of water sufficient to submerge the nuclear waste therein; and
a pressure surge capacitor disposed in the cask, the pressure surge capacitor comprising a vacuum cavity evacuated to sub-atmospheric conditions;
wherein the pressure surge capacitor is configured to suppress a pressure surge in the internal cavity of the cask.

63. The system according to claim 62, wherein the pressure surge capacitor further comprises at least one pressure relief device constructed to burst at a predetermined pressure level inside the cask, the pressure relief device when burst placing the vacuum chamber of the pressure surge capacitor in fluid communication with the internal cavity to reduce pressure inside the cask.

64. The system according to claim 61, wherein the pressure surge capacitor has a longitudinally elongated tubular body having a height extending for at least a majority of a height of the internal cavity of the cask.

65. The system according to claim 63, wherein the pressure relief device comprises a rupture disk which seals the vacuum cavity of the pressure surge capacitor.

66. The system according to claim 65, wherein the rupture disk is disposed in a first end cap of the pressure surge capacitor.

67. The system according to claim 66, further comprising a second pressure relief device comprising a second rupture disk disposed in a second end cap of the pressure surge capacitor which seals the vacuum cavity of the pressure surge capacitor.

68. The system according to claim 65, wherein the rupture disk is recessed in the first end cap and disposed in a flow inlet opening formed through the first end cap into the vacuum chamber.

69. (canceled)

70. (canceled)

71. (canceled)

72. (canceled)

73. (canceled)

74. (canceled)

75. (canceled)

76. (canceled)

77. (canceled)

78. A passively ventilated nuclear fuel storage cask comprising:
an elongated cask body defining a top end, a bottom end, a sidewall, and an internal cavity extending between the ends along a longitudinal axis, the internal cavity being configured for holding a nuclear fuel storage canister;
a plurality of cooling air inlet ducts spaced circumferentially apart around the body, the inlet ducts each forming a radial air inlet passageway fluidly coupling ambient atmosphere with a lower portion of the internal cavity;
at least one cooling air outlet ducts disposed at the top end of the cask body, the at least one outlet duct forming an air outlet passageway fluidly connecting ambient atmosphere with an upper portion of the internal cavity; and
a vertically adjustable shutter plate coupled to each the air inlet ducts, the shutter plate defining a flow opening area configured to throttle an inflow of cooling air through the internal cavity of the cask.

79. The cask according to claim 78, wherein the shutter plates are vertically adjustable in position on the cask to vary the flow opening area to increase or decrease the inflow of cooling air.

80. The cask according to claim 79, wherein shutter plates are vertically movable between a first position associated with a first flow opening area, and a second position associated with a second flow opening area larger than the first open area.

81. The cask according to claim 79, wherein the first position is a lower position and the second position is an upper position.

82. The cask according claim 79, wherein the flow opening area is defined between a bottom edge of the shutter plate and the bottom end of the cask body.

83. The cask according to claim 82, wherein the bottom end of the cask body is defined by a bottom surface of a baseplate configured to anchor the cask to a support surface.

84. (canceled)

85. (canceled)

86. (canceled)

87. (canceled)

88. (canceled)

89. (canceled)

90. (canceled)

91. (canceled)

92. (canceled)

93. (canceled)

94. (canceled)

95. (canceled)

96. (canceled)

97. (canceled)

98. (canceled)

99. (canceled)

100. (canceled)

101. (canceled)

102. (canceled)

103. (canceled)

104. (canceled)

105. (canceled)

106. (canceled)

107. (canceled)

108. (canceled)

109. (canceled)

110. (canceled)

111. (canceled)

112. (canceled)

113. (canceled)

114. (canceled)

115. (canceled)

116. (canceled)
